(19) United States
(12) Patent Application Publication
(10) Pub. No.: US 2002/0095007 A1
(43) Pub. Date: Jul. 18, 2002

(54) Lewis acid-catalyzed polymerization of biological oils and resulting polymeric materials

(76) Inventors: Richard C. Larock, Ames, IA (US); Mark Hanson, West Lafayette, IN (US); Fengkui Li, Ames, IA (US)

Correspondence Address: DICKSTEIN SHAPIRO MORIN & OSHINSKY LLP, 2101 L STREET NW, WASHINGTON, DC, 20037-1526, US

(21) Appl. No.: 09/969,874

(22) Filed: Oct. 4, 2001

Related U.S. Application Data
(63) Continuation-in-part of application No. 09/584,405, filed on Jun. 1, 2000.
Application No. 09/584,405 is a continuation-in-part of application No. 09/190,056, filed on Nov. 12, 1998.

(51) Int. Cl. C08K 5/10

(52) U.S. Cl. 524/310; 524/515; 524/518

(57) ABSTRACT

Biological oils, conjugated biological oils, and metathesized or cometathesized biological oils are polymerized or co-polymerized with comonomers, which include styrene and divinylbenzene, norbornadiene and dicyclopentadiene, using a BF₃.OEt₂ initiator to provide plastics from renewable resources. The compositions are thermosetting polymers having damping and shape memory characteristics. These compositions can become industrial products of an unlimited variety.

### CROSS REFERENCE TO RELATED PATENTS AND APPLICATIONS

This application is a continuation-in-part of co-pending U.S. patent application Ser. No. 09/584,405 filed Jun. 1, 2000, entitled LEWIS ACID-CATALYZED POLYMERIZATION OF BIOLOGICAL OILS AND RESULTING POLYMERIC MATERIALS, which is a continuation-in-part of U.S. patent application Ser. No. 09/190,056 filed Nov. 12, 1998, entitled LEWIS ACID-CATALYZED POLYMERIZATION OF BIOLOGICAL OILS AND RESULTING POLYMERIC MATERIALS (now U.S. Pat. No. No. 6,211,315 Bi). The entirety of each of these is hereby incorporated by reference.

### FIELD OF THE INVENTION

This invention relates generally to the synthesis of polymers ranging from soft elastomers to thermoset plastics from biological oils and the products made form such polymers. Particularly, this invention relates to polymerization of biological oils, such as soybean oil, tung oil and fish oil, and to copolymerization of these oils with various olefins, to produce elastomers, rubbers and plastics from renewable resources. The polymers are used in industrial products.

### BACKGROUND OF THE INVENTION

The natural environment is being overwhelmed by non-biodegradable, petroleum-based polymeric materials. The ever-increasing demand for such materials has increased dependence on petroleum products and left landfills overflowing with non-renewable, indestructible materials. The great current interest in cheap, biodegradable polymeric materials has recently encouraged the development of such materials from readily available, inexpensive natural sources, such as carbohydrates, starches and proteins, but relatively little work has been done on the conversion of fats and oils to such materials. The development of polymeric materials from biological oils, such as vegetable and fish oils, could dramatically expand and diversify the market for biological oils, while also improving the environment and reducing dependence on petroleum products.

Vegetable oils and fish oils are readily available in large quantities throughout the world. Of all the biological oils, soybean oil is probably the most preferable oil for industrial use, because it is inexpensive and produced in extremely large volume.

Soybean oil is principally composed of three unsaturated fatty acids: oleic acid, linoleic acid (also called linolic acid), and linolenic acid. These three fatty acids are the primary unsaturated fatty acids found in vegetable oils. Palmitoleic acid is primarily derived from fish oil. Arachidonic acid is primarily derived from animal sources. These five fatty acids comprise the major unsaturated fatty acids of commercial value. The structures of these fatty acids are shown below:

| | |
|---|---|
| CH₃(CH₂)₅CH═CH(CH₂)₇CO₂H | palmitoleic |
| | acid |
| CH₃(CH₂)₇CH═CH(CH₂)₇CO₂H | oleic |
| | acid |
| CH₃(CH₂)₄CH═CHCH₂CH═CH(CH₂)₇CO₂H | linoleic |
| | acid |
| CH₃CH₂CH═CHCH₂CH═CHCH₂CH═CH(CH₂)₇CO₂H | linolenic |
| | acid |
| CH₃(CH₂)₄(CH═CHCH₂)₄(CH₂)₂CO₂H | arachidonic |
| | acid |

The fatty acids typically occur in nature as esters, the carboxylic hydrogen being replaced by, for example, a methyl group, ethylene glycol, or glycerol. Low saturated soybean oil is structurally similar to soybean oil, but with a higher degree of unsaturation, that is with more carbon-carbon double bonds in the triglyceride side chains.

Tung oil is also a very useful vegetable oil. It is readily available as a major product from the seeds of the tung tree. It is practically colorless in its natural state, but the commercial product is generally a yellow color and possesses an earthy odor. Its principal constituent is a glyceride of elaeostearic acid, a conjugated triene. This highly unsaturated, conjugated system is largely responsible for the rapid polymerization and outstanding drying properties of this oil.

Fish oil is a by-product of the production of fish meal. Fish oil has a triglyceride structure with a high percentage of polyunsaturated omega-3 fatty acid side chains, which contain 5-7 non-conjugated C-C double bonds. Chemical analysis indicates that fish oil is a mixture of primarily three key structures: docosa-4,7,10,13,16,19-hexaenoic acid (DHA, 24.72%); eicosa-5,8,11,14,17-pentaenoic acid (EPA, 31.68%) and docosa-7,10,13,16,19-pentaenoic acid (DPA, 4.27%). This high degree of unsaturation has prompted researchers to examine fish oil as a potential monomer for polymerization or co-polymerization. The reports that have appeared in the literature typically refer to the production of viscous oils.

Very short oligomers such as dimers and trimers have been produced from soybean oil using thermal polymerization processes, as described by R. W. Johnson, et al., Polymerization of Fatty Acids, Fatty Acids in Industry 153-75 (1989). However, these processes are poorly controllable. In addition, the processes produce mainly dimers and trimers, and tend to destroy carbon-carbon double bonds.

The Minnesota Mining and Manufacturing (3M) company has two series of polymeric damping products. All of the damping polymers are claimed to be acrylic polymers. However, no detailed compositions for these damping polymers have been made available.

The viscoelastic damping polymers include 110-, 112-, and 130-viscoelastic damping polymer/liner. The typical temperature range for good damping performance of the 110-Viscoelastic Damping Polymers/Liners (110P02, 110P05) is 40-105° C. (ΔT=65° C.). The typical temperature range for good damping performance of the 112-Viscoelastic Damping Polymers/Liners (112P01, 112P02, 112P05) is 0-65° C. (ΔT=65° C.). The typical temperature range for good damping performance of the 130-Viscoelastic Damping Polymers/Liners (130P02, 130P05) is 20-90° C. (ΔT=70° C.).

3M viscoelastic damping polymers 110-, 112-, and 130- are designed to be used in damping applications as free-layer dampers, as part of a constrained layer damping design or as part of a laminate construction. These damping polymers have been used for constrained layer dampers or multi-layer damped laminates with a variety of substrates, such as stainless steel, aluminum and polyester. These polymers can also be used in vibration and shock isolation designs. The application areas include automotive, aerospace, electrical, mechanical and general industry. Potential applications include disk drive and automotive cover constrained layer dampers, multi-layer laminates using metals or polymeric films, suspension dampers, isolators, panel dampers, pipe dampers, wing dampers, etc.

3M viscoelastic damping polymers are enhanced for thermal stability and offer excellent thermal stability and damping performance for long term applications at moderate temperatures and also applications that experience short high temperature excursions.

Ultra-pure viscoelastic damping polymers include 242F01, 242F02 and 242F04 damping polymers. The typical temperature range for good damping performance of all the above ultra-pure viscoelastic damping polymers is 0-65° C. (ΔT=65° C.).

3M ultra-pure viscoelastic damping polymers are designed to be used in damping applications as part of free-layer damper, constrained layer damper or damped laminate designs, and in applications that require low outgassing and ionic levels and still provide robust damping performance. These polymers can also be used in vibration and shock isolation designs, and the market application areas include automotive, aerospace, electronics and general industry. The potential users include cover dampers, damped laminate constructions, suspension dampers, isolators, panel dampers, space craft applications, etc.

Sorbothane, a product of Sorbothane Incorporated, was developed to exhibit a unique combination of physical properties into one revolutionary material. This material offers uniquely high, stable damping characteristics over a broad temperature and frequency range. Most damping materials are one-dimensional. This means that they either isolate vibration or absorb shock. Sorbothane's unique liquid-solid properties allow it simultaneously to absorb shock and isolate vibration even at high frequency ratios.

ANOCAST designs and manufactures non-metallic polymer composite castings used in the machine tool and semiconductor industries. Polymer composite structures are distinctive engineered materials, which provide significantly greater vibration damping characteristics than structures made from traditional cast iron, steel, aluminum or natural granite. The vibration damping characteristics of the ANOCAST polymer composite, cast iron, steel, and aluminum have been evaluated according to ASTM E756-83. The results show that when ANOCAST polymer composite bar is used, the vibration diminishes rapidly.

It would be advantageous to have damping materials comparable or even much better than the above commercially available damping polymeric materials, but based on biological polymers. For example, the damping temperature range of the commercial dampers is around ΔT=60-70° C., so it would be an advantage for a biological oil polymer to show ΔT=90-110° C., or even higher. It would be an advantage for the friction between the filler and polymer chains to contribute additional damping to the bulk composites.

It would be an advantage if a biological oil polymer had properties so that the damping intensity and damping temperature region could be varied for different applications, and the polymers could be either rubbery or plastic. These characteristics should open up a wide range of applications for such advantageous damping materials.

What is needed is a process capable of polymerizing the unsaturated fatty acids in biological oils to produce useful plastic materials. Also needed is a process that can produce a high yield of product with a small catalyst load in a controlled process that minimizes the use of non-renewable, environmentally harmful materials.

All the above and further advantages are achieved by the biological oil polymer invention herein disclosed.

### SUMMARY OF THE INVENTION

The present invention provides a process for polymerizing biological oils to provide plastics from renewable resources. The invention also provides various end use products, such as molded articles, and composites, containing thermoset plastics derived from fish oil, soybean oil, tung oil and other biological oils.

To achieve the objects and in accordance with the purpose of the invention, as embodied and broadly described herein, the present invention provides methods for preparing plastics by polymerizing unsaturated fatty acid esters via Lewis-acid catalysis. The unsaturated fatty acid esters are esters of acids commonly found in biological oils, such as palmitoleic acid, oleic acid, linoleic acid, linolenic acid or arachidonic acid. Preferably, a natural or modified soybean oil, fish oil, or other biological oil containing one or more unsaturated fatty acid esters, is used.

Methods for Lewis-acid catalyzed copolymerization of unsaturated fatty acid esters and an olefin, and including the copolymerization of two or more olefins and a biological oil, are also provided. The preferred olefin comonomers include divinylbenzene, norbornadiene, dicyclopentadiene and styrene, particularly monofunctional styrene. In a particularly preferred embodiment, a natural biological oil is modified prior to the Lewis-acid catalyzed copolymerization by one or more of a variety of suitable modification processes, including conjugation, metathesis, or cometathesis.

According to particularly preferred aspects of the invention, thermoset plastics are obtained by conjugating a natural biological oil, or by metathesizing or cometathesizing such oils with additional olefins such as norbornadiene, and copolymerizing the conjugated, metathesized or cometathesized oil with a quantity of an additional olefin via Lewis-acid catalysis. The preferred Lewis-acid catalyst is boron trifluoride diethyl etherate. The resulting plastic materials are solid thermoset plastics suitable for a wide variety of industrial uses. Among the plastics made by the processes described herein are many plastics which are expected to be biodegradable.

In still another embodiment of the invention, the Lewis acid catalyst is first admixed with a small amount of an additive before copolymerization of the biological oil and the olefin. This additive can include yet another biological oil or a chemical compound, as hereinafter described.

The invention provides environmentally acceptable substitutes for polyethylene and polystyrene, and various consumer and industrial products containing biological oil thermoset plastics, and composites containing such plastics. In particular, the invention provides plastic materials for the medical, agricultural, and packaging industries, molded articles and composite materials for example, for the marine, aerospace, automobile, and sporting goods industries, construction materials, such as, for example, plating materials, insulating materials, machine parts, engineering plastics, laminates, paints, coatings, resins and adhesives, and biocompatable materials, such as surgical implants and prosthesis equipment containing plastics, produced by the processes described herein.

### BRIEF DESCRIPTION OF THE DRAWINGS

FIG. 1 provides a comparison of the temperature dependence of the dynamic mechanical properties of a commercial epoxy, a commercial polystyrene, a commercial polyethylene (LDPE), and a fish oil plastic according to the present invention.

FIG. 2 depicts the temperature dependence of the dynamic mechanical properties of fish oil plastics derived from natural fish oil and from conjugated fish oil.

FIG. 3 depicts the temperature dependence of the dynamic mechanical properties of fish oil plastics derived from the Lewis-acid catalyzed polymerization of conjugated fish oil and various amounts of comonomers.

FIGS. 4a and 4b show unreacted and reacted, respectively, fish oil fractions in natural fish oil and conjugated fish oil bulk polymers.

FIG. 5 shows thermogravimetric analysis (TGA) thermographs for various conjugated fish oil plastics prepared according to the method of the invention.

FIGS. 6a and 6b show temperatures at 5% weight loss as a function of fish oil concentration for natural, and for conjugated, fish oil plastics, respectively.

FIG. 7 is a graph of storage modulus vs. temperature for various polymer samples according to the invention.

FIG. 8 is a graph of Tan delta vs. temperature for the polymers set forth in FIG. 7.

FIG. 9 is a graph of storage modulus vs. temperature for various polymer samples according to another embodiment of the invention.

FIG. 10 is a graph of Tan delta vs. temperature for the polymers set forth in FIG. 9.

FIG. 11 is a graph of storage modulus vs. temperature for various polymer samples according to another embodiment of the invention.

FIG. 12 is a graph of Tan delta vs. temperature for the polymers set forth in FIG. 11.

FIG. 13 is a graph of storage modulus vs. temperature for various polymer samples according to another embodiment of the invention.

FIG. 14 is a graph of Tan delta vs. temperature for the polymers set forth in FIG. 13.

FIG. 15 is a graph of storage modulus vs. temperature for various polymer samples according to another embodiment of the invention.

FIG. 16 is a graph of Tan delta vs. temperature for the polymers set forth in FIG. 15.

FIG. 17 is a graph of Tg (C) vs. weight percent of divinylbenzene in the polymer according to one embodiment of the invention.

FIG. 18 is a graph of Vₑ (mol/m³) vs. weight percent of divinylbenzene in the polymer according to one embodiment of the invention.

FIG. 19 is a graph of Tg (C) vs. Vₑ (mol/m³) for two polymer samples.

FIG. 20 is a graph showing differences in the crosslinking structures of (a) low saturated soybean oil polymer and (b) a conjugated low saturated soybean oil polymer with the same degree of crosslinkng.

FIG. 21 is a graph of (tan delta)ₘₐₓ vs. Vₑ (mol/m³) for the polymers set forth in FIG. 19.

FIG. 22 is a schematic illustration of the shape memory test.

FIG. 23 is a chart showing the dynamic mechanical behavior of polymers in accordance with the invention.

FIG. 24 shows the molecular structures of the crosslinking agents divinylbenzene (DVB), norbornadiene (NBD) and dicyclopentadiene (DCP).

FIG. 25 is a chart of shape recovery for polymers in accordance with the invention as a function of temperature.

FIG. 26 is a chart of shape recovery for polymers in accordance with the invention as a function of temperature.

FIG. 27 is a chart of dynamic mechanical behavior of the soybean oil polymers in FIG. 26.

FIG. 28 is a chart of temperature dependence of the loss tangent for SOY polymers prepared by varying the SOY concentration.

FIG. 29 is a chart of temperature dependence of the loss tangent for the SOY polymers SOY45-(ST+DVB)47-(NFO5−BFE3) prepared by varying the DVB concentration.

FIG. 30 is a chart of the dependence of the glass transition temperatures on crosslinking densities of polymers in accordance with the invention.

FIG. 31 is a chart of the dependence of loss tangent max on the crosslinking densities of polymers in accordance with the invention.

FIG. 32 is a chart of the dependence of the damping peak half width on the crosslinkng densities of polymers in accordance with the invention.

FIG. 33 is a chart of dependence of the TA value on the crosslinking densities of different polymers in accordance with the invention.

FIG. 34 is a chart of the temperature dependence of the loss tangent for the polymers in accordance with the invention (DVD10-)NFO5−BFE3)) at differing frequencies.

FIG. 35(a) and (b) illustrate ¹H NMR spectra of (a) NFO and (b) CFO.

FIG. 36 shows molecular structures of the representative fatty acid ethyl esters DHA and EPA in the native Norway fish oil.

FIG. 37 shows mechanism of cationic polymerization of simple alkenes.

FIG. 38 shows ¹H and ¹³C NMR spectra of the soluble materials extracted from the bulk polymer CFO65−DCP30−BFE5.

FIG. 39 shows solid state ¹³C NMR spectrum of the insoluble materials remaining after extraction of the bulk polymer CFO65-DCP30-BFE5.

FIG. 40 shows derivative TGA curves of the bulk polymer CFO50-DVB15-NBD30-BFE5, its soluble materials and remaining insoluble materials after extraction.

FIG. 41(a)-(c) shows ¹H NMR spectra of (a) NFO, (b) CFO and (c) TFO.

FIG. 42 shows molecular structures of the fatty acids DHA and EPA in the fish oils.

FIG. 43 shows ¹H NMR spectra of the soluble substances extracted from a number of NFO polymers NFO49-(ST+DVB)48-BFE3 with (a) 5 wt %, (b) 10 wt %,(c) 15 wt %, (d)20 wt %,(e) 25 wt %, (f) 30 wt % and(g)48 wt %DVB, respectively.

FIG. 44 shows TGA curves and their derivatives for the NFO polymers prepared by varying the NFO concentration.

FIG. 45 shows temperature relation to the storage modulus and loss factor for the NFO polymers prepared by varying the NFO concentration.

FIG. 46 shows temperature relation to the storage modulus and loss factor for the NFO polymers prepared by varying the DVB concentration.

FIG. 47 shows temperature relation to the storage modulus and loss factor for NFO, CFO and TFO polymers with the same stoichiometry.

FIG. 48 shows plots of shape memory results versus DVB composition in the fish oil polymers.

FIG. 49 shows the shape recovery rates of the NFO polymers as a function of temperature.

FIG. 50 shows tensile stress-strain curves for the NFO polymers prepared by varying the NFO concentration.

FIG. 51 shows tensile stress-strain curves for the NFO polymers prepared by varying the DVB concentration.

FIG. 52 shows tensile stress-strain curves for NFO, CFO and TFO polymers with the same stoichiometry.

FIG. 53 shows plots of Young's modulus (E), ultimate tensile strength (σ_{b}) and elongation at break (ε_{b}) against crosslink densities (νₑ) for the fish oil polymers.

FIG. 54 shows an SEM photograph of the fracture surface of the rigid plastic NFO30-ST46-DVB21-BFE3.

FIG. 55 shows SEM photographs of the fracture surfaces of (a) NFO, (b) CFO and (c) TFO plastics with the same stoichiometry (OIL49-ST33-DVB15-BFE3).

### DETAILED DESCRIPTION OF THE PREFERRED EMBODIMENTS

Reference will now be made in detail to the presently preferred embodiments of the invention, which, together with the following examples, serve to explain the principles of the invention.

Virtually any biological oil or oils can be used as a starting oil in the process of the present invention, whether naturally derived or obtained via genetic engineering, such as plant breeding processes. “Biological oil”, as used herein, shall be understood to mean an oil of animal, fish or vegetable origin, which contains one or more unsaturated fatty acid esters, and excluding oils of a mineral origin, such as petroleum. Examples of usable oils include, but are not limited to, corn, safflower, sunflower, canola, peanut, sesame, palm, coconut, walnut, olive, tung, castor, dehydrated castor, soybean, low saturated soybean, and fish oils, as well as combinations of any of the foregoing.

The biological oil starting material may be used in an unprocessed (crude) state, or may be processed either commercially or in the laboratory. Commercially processed oils sold under the WESSON, CRISCO NEW HORIZON and HY-VEE (for LoSatSoy) brand names are all suitable for carrying out the process of the invention. Fish oil sources include, for example, Norway fish oil, as supplied by Pronova Biocare (Bergen, Norway) and Capelin fish oil, as supplied by SR-Mjol HF (Reykjavik, Iceland), as well as ARBP Menhaden fish oil and LCP Menhaden fish oil from Omega Protein (Reedville, Va.) (triglyceride fish oils), as well as the esterified versions of any of the foregoing, especially the ethyl esters thereof. The various biological oil starting materials may be processed in the laboratory before Lewis-acid catalysis by, for example, transesterification, chromatography, purification, conjugation, epoxidation, metathesis, and cometathesis. Conjugated fish oil and conjugated, metathesized, or cometathesized soy oil are particularly preferred. Also preferred is conjugated low saturated soybean oil. While not wishing to be bound by any particular theory, it is believed that conjugation of carbon-carbon double bonds in the triglyceride side chains significantly improves reactivity.

The term “biodegradable” as used herein shall be understood to mean that, as a result of environmental factors, e.g., exposure to microorganisms, insects, sunlight, heat, water, oxygen, wind, wave action, sand, and combinations of one or more of these factors, the materials decompose, degrade or erode in the ambient environment or in landfill conditions to a significantly greater extent or at a greater rate than polyethylene, polystyrene, or various other commercially available petroleum based plastic materials.

The general method of carrying out the Lewis-acid catalyzed polymerization process of the invention is described as follows. In a typical reaction, a vessel is charged with the natural or modified biological oil(s), preferably one or more soybean, low saturated soybean or fish oil(s) that has previously been conjugated, metathesized or cometathesized (as described below) to enhance the Lewis-acid catalyzed polymerization reaction rate and yield. Preferably, one or more olefinic comonomers is also charged to the vessel and thoroughly mixed with the biological oil. The olefinic comonomers may be provided in any desired amount, although 5 to 50 weight percent is preferred, depending on the particular comonomers and also depending upon the starting biological oil. If the biological oil is conjugated or metathesized, useful plastics may be obtained with no or very minimal amounts of olefin comonomers.

Any olefin may be used in the Lewis-acid catalyzed copolymerization process of the present invention. Thermoset plastics have been produced with structurally diverse olefins, including acyclic alkenes, as well as cyclic alkenes, and including diallyl phthalate, dicyclopentadiene and norbornadiene. In addition, two or more biological oils may be copolymerized by the process of the present invention. In one preferred embodiment, the biological oil is a mixture of about 5 to 10% fish oil and about 90 to 95% soybean oil.

Various comonomers can be polymerized with the biological oil starting materials. These comonomers include, for example, styrene, divinylbenzene, disopropenylbenzene, norbornadiene, norbornene, dicyclopentadiene, alpha-methylstyrene, isoprene, myrcene, 1,1-dichloroethene, linalool, phenol, cyclopentadiene, 1,3-di-(2-propenyl)benzene, dipentene, 1,1-diphenylethene, 2,5-dimethylhexa-2,5-diene, ethyl 2-carboethoxy-3-methyl-2-butenoate, ethyl vinyl ether, 4-vinylcyclohexene, ethyl acrylate, acrylonitrile, diallyl terephthalate, diallyl phthalate, furan, furfural, ρ-benzoquinone and ρ-mentha-1,8-diene. The preferred comonomers include one or more of divinylbenzene, norbornadiene, dicyclopentadiene, styrene, alpha-methylstyrene, furfural, ρ-benzoquinone, ρ-mentha-1,8-diene, and furan. Combinations of divinylbenzene, norbornadiene, dicyclopentadiene, and styrene are desirable, with a combination of divinylbenzene and styrene perhaps being more preferred.

The reaction vessel is then charged with a Lewis-acid catalyst. The reaction can be carried out with various catalyst amounts, preferably between about 0.1% and 7%, more preferably between about 0.5% and 6%, and even more preferably between about 1% and 5% by weight of the reaction mixture. SnCl₄, AlCl₃, ZnCl₂, FeCl₃, BCl₃ and various other suitable Lewis-acid catalysts may be used. The most preferred catalyst, however, is boron trifluoride diethyl etherate (BF₃.OEt₂). The Lewis-acid catalyst is typically added via either a syringe or cannula, depending on the amount. The biological oil/comonomer/catalyst mixture is then agitated to ensure homogeneity. In some cases, it is desirable to dissolve the Lewis acid in a biological oil, such as fish oil, before mixing the catalyst with the other reagents.

The reaction vessel is then subjected to the desired reaction conditions. The reaction may be carried out at any temperature within the range of about 100 to 125° C., but is preferably carried out within the range of 25° C. to 110° C. A most preferred range is 60° C. to 110° C. The reaction is allowed to proceed for sufficient time to allow the formation of a thermoset plastic product. This time is generally within the range of about 5 h to 96 h, but can be as short as about 1 h.

Any suitable method for removing unreacted substances to form a separated insoluble plastic material from the bulk reaction product may be used, if desired. A preferred method is the addition of a solvent that dissolves the unreacted substances. The Lewis-acid catalysis reaction product typically comprises 60-90% of an insoluble thermoset material which is insoluble in CH₂Cl₂, THF or DMF solvents. Preferred solvents include CH₂Cl₂ and tetrahydrofuran (THF). The insoluble plastic component may be extracted by Soxhlet extraction techniques using methylene chloride as a refluxing solvent.

The Lewis-acid catalysis typically provides quantitative yields of bulk polymer. The resulting bulk thermosets possess good thermal stability. Upon thermogravimetric analysis (“TGA”), 5% weight loss is typically noted between 200-270° C. and 10% weight loss is typically noted between 250-330° C. for the bulk reaction product. The THF and CH₂Cl₂ insoluble materials typically have TGA 5% weight losses at 350-375° C. and 10% weight losses at typically about 420° C. Soxhlet extraction of the bulk biological oil thermosets indicates that these materials are highly crosslinked (Crosslink densities can be measured by the swelling ratios according to known methods. In addition, DMA can provide indirect evidence of the crosslinking structure. Crosslink densities can be measured on the basis of the rubber elasticity theory known in the art).

Natural biological oils can be modified prior to Lewis-acid catalysis by a suitable conjugation or metathesis process. When a conjugated or metathesized oil is used in the Lewis-acid catalyzed reactions, harder and shinier plastics are produced. Smaller amounts of alkene additives, such as 0-10% as opposed to 10-30%, may be needed to produce rigid thermosets in the conjugated and metathesized oil reactions. Fish oil thermosets prepared using the BF₃.OEt₂ chemistry are both harder and less dense than the soybean oil materials prepared using the same chemistry. Preferred conjugation processes are described in copending U.S. Provisional Patent Application Ser. No. 60/080,068, which is hereby incorporated by reference herein in its entirety. In general, the biological oil in EtOH is added to a rhodium catalyst, SnCl₂.2H₂O, and (ρ-CH₃C₆H₄)₃P. The reaction mixture is then stirred under an inert atmosphere, such as an N₂ blanket, at 60° C. for 24 hours. The resulting solution may be concentrated to an oil and purified by flash chromatography on a silica gel column if desired using a 3:1 hexanes/ethyl acetate eluent or other suitable system. The resulting conjugated biological oil is then used as a modified biological oil starting material in the Lewis-acid catalyzed polymerization process of the invention. Other methods of conjugations lead to oils which are also useful in this polymerization process.

The preferred conjugation catalysts are the Rh complexes RhCl(PPh₃)₃ and [RhCl(C₈H₁₄)₂]₂ or [RhCl(C₂H₄)₂]₂. Three Mol % RhCl(PPh₃)₃ provides conjugated biological oil products in 93% yield at only 60° C. A preferred procedure utilizes 2.5 equivalents of SnCl₂.2H₂O per RhCl(PPh₃)₃ at 60° C. in EtOH. In the presence of EtOH, the reaction proceeds at a much lower temperature (60° C. vs 120-150° C.), gives increased conjugation, and avoids generation of hydrogenated products. One mol % of RhCl(PPh₃)₃ provides excellent results, and 0.5 mol % RhCl(PPh₃)₃ gives only slightly lower yields.

The rhodium complex [RhCl(C₈H₁₄)₂]₂ is even more preferred than RhCl(PPh₃)₃, when combined with SnCl₂.2H₂O and an appropriate phosphine ligand. Various phosphine ligands are suitable and tri-ρ-tolylphosphine is preferred. The most preferred procedure for conjugation of the biological oil is 0.1 mol % [RhCl(C₈H₁₄)₂]₂, 0.4 mol % (ρ-CH₃C₆H₄)₃P, 0.8 mol % SnCl₂.2H₂O in EtOH at 60° C. Fish oil, soybean oil, corn oil, sunflower oil, safflower oil, and various other biological oils all provide high yields of conjugated products under these reaction conditions in approximately 24 hours at 60° C.

The preferred method of carrying out metathesis, for pre-processing of biological oils prior to Lewis-acid catalysis, is described in copending U.S. patent application Ser. No. 09/075,326, which is hereby incorporated by reference herein in its entirety, as well as in J. Am. Oil Chem. Soc. 76, 99 (1999) by M. D. Refvik and R. C. Larock. “Metathesis”, as used herein, shall be understood to mean the reaction of two alkenes, at least one of which is an unsaturated fatty acid ester, to form two new alkenes. The two reactants may be the same compound, or they may be different compounds, in which case the process is sometimes referred to more specifically as “cometathesis ”. The metathesis reaction is generally carried out in a reduced oxygen atmosphere, and preferably in an inert atmosphere. The reaction may be carried out at atmospheric pressure, or under reduced atmospheric pressure.

In a typical metathesis reaction, a catalyst vessel is charged with a ruthenium catalyst, most preferably bis(tricyclohexylphosphine) benzylidene ruthenium dichloride, inside a nitrogen-filled glove box before being connected to a dual line Schlenk system with vacuum and argon capabilities. Other preferred ruthenium catalysts include ruthenium complexes of the formula RCH═RuR′₂(R″₃P)₂, where R is an alkyl, aryl or vinylic group, R′ is a halogen, and R″ is an aryl or alkyl group, preferably PhCH═RuCl₂(Cy₃P)₂, where Ph is a phenyl group and Cy is a cyclohexyl group. The reaction can be carried out with various catalyst amounts, preferably between 0.05 mol % and 1.6 mol %, most preferably, between 0.08 and 0.15 mol %. The biological oil is then added to the catalyst flask. The oil/catalyst mixture is agitated and then added to a reaction vessel containing a volume of biological oil. If the process is a cometathesis process, the other alkene is preferably added during this step. The preferred alkene for cometathesis is norbornadiene at about 20 to 25 wt % of the cometathesis reaction mixture.

The reaction vessel is then subjected to reaction conditions. The metathesis or cometathesis reaction may be carried out at any temperature within the range of about 20 to 250° C., but is preferably carried out within the range of 20 to 100° C. A most preferred range is about 50 to 60° C. The reaction is allowed to proceed for sufficient time to allow the formation of a metathesized product. This time is generally within the range of about 3 to 192 hours, but more preferably is within the range of about 12 to 48 hours.

The natural or modified biological oil in either a separated or unseparated state may also be pre-processed by epoxidization. Any suitable epoxidation process may be used, preferably a low acid process. A suitable process utilizes a methyltrioxorhenium(VII) and pyridine catalytic system as developed by J. Rudolph, K. L. Reddy, J. P. Chiang, and K. B. Sharpless, “Highly Efficient Epoxidation of Olefins Using Aqueous H₂O₂ and Catalytic Methyltrioxorhenium/Pyridine: Pyridine-Mediated Ligand Acceleration, J. Am. Chem. Soc. 119:6189-90 (1997), which is hereby incorporated herein by reference in its entirety. The preferred epoxidation process is described in copending U.S. patent application Ser. No. 09/075,326.

The modified biological oils may be used directly as the conjugation, metathesis or epoxidation reaction product. Alternatively, any suitable method for removing unreacted substances and by-products to form separated conjugated, metathesized, or expoxidized products from the reaction mixture may be used. A typical method is the addition of a solvent that preferentially dissolves the unreacted substances. The insoluble pure products may then be collected, and evacuated to remove any remaining volatile contaminants. The resulting conjugated, metathesized or epoxidized product is then used as a modified biological oil and subject to the polymerization and copolymerization processes of the invention to make new plastics by the Lewis-acid catalysis method described herein.

The use of chemically modified oils and olefin additives in the Lewis-acid catalyzed thermoset reaction typically gives thermosets which are harder, more stable, and less prone to blooming than natural, unmodified oil. These modified oils include various metathesized oils, cometathesized oils, and conjugated oils from natural biological oils.

It has now been found that conjugated soybean and low saturated soybean oils and soybean and low saturated soybean oils cometathesized with norbornadiene give particularly hard, stable solid materials from the boron trifluoride diethyl etherate copolymerization with divinylbenzene. Natural soybean oil and metathesized soybean oil are, on the other hand, preferably copolymerized with a combination of dicyclopentadiene and divinylbenzene, or norbornadiene and divinylbenzene, to give hard, stable materials, or alternatively, copolymerization with styrene plus divinylbenzene is preferred as well.

In a further embodiment of the invention, an additive is included with the Lewis acid catalyst before copolymerization of the biological oil(s) and the olefin(s), e.g. alkene(s). The presence of this additive often serves to provide a more homogeneous reaction mixture, which in turn can provide a more homogeneous final plastic product. In particular, the presence of the additive often results in higher conversions of the starting oil/olefin materials to crosslinked polymers than use of the catalyst alone, thereby often resulting in higher yields. The additive may be, for example, the same or a different additional biological oil and may also be a chemical compound. Examples of additives which may be included with the Lewis acid catalyst include fish oil ethyl ester (e.g. Norway Prenova fish oil ethyl ester EPAX 5500 EE), soybean oil methyl esters (e.g. Soygold-1100 and 2000 and Soygold methyl ester prepared from LoSatSoy oil, AG Environmental Products, LLC), and even tetrahydrofuran (THF). Of these, fish oil ethyl ester is often preferred. The additive(s) is included with the Lewis acid catalyst in an effective amount to enhance homogenization of the reaction mixture and/or final product, and may preferably be included in amounts of about 3 to 20% by weight of the total reaction mixture materials, and more desirably will comprise about 3 to 10% by weight thereof. The additive and the Lewis acid catalyst can together be referred to as a “modified initiating system.” In one preferred embodiment of the invention, there will be as reaction mixture materials about 20 to 60% of one or more biological oils, about 30 to 60% of one or more olefin materials, about 3 to 10% of at least one additive and about 0.5 to 10% of catalyst. Another preferred embodiment will comprise as reaction mixture materials about 40 to 50% of biological oils, about 40 to 60% of olefin materials (preferably styrene with one or more of divinylbenzene, norbornadiene, or dicyclopentadiene), about 3 to 10% of at least one additive and about 1 to 10% of catalyst. In another preferred embodiment, there will be about 25% tung oil and/or fish oil, about 25% soybean oil and/or low saturated soybean oil (which may be conjugated), about 35% divinylbenzene, about 10% of Norway fish oil ethyl ester and about 5% of boron trifluoride diethyl etherate as the reaction mixture materials. An especially preferred embodiment will comprise about 35 to 55%, preferably about 40 to 50%, of at least one member selected from the group consisting of soybean oil, low saturated soybean oil, and conjugated low saturated soybean oil; about 25 to 40% of styrene, about 10 to 20% of divinylbenzene, norbornadiene and/or dicyclopentadiene (preferably divinylbenzene); about 3 to 10% of fish oil ethyl ester and/or soybean oil methyl esters, and about 3 to 10% of boron trifluoride diethyl etherate. Yet another embodiment will comprise about 40 to 60% of low saturated soybean oil, about 30 to 40% of divinylbenzene, about 5 to 15% of fish oil ethyl ester, and about 3 to 10% of boron trifluoride diethyl etherate. This formulation, however, may tend to be somewhat brittle. In each of the foregoing embodiments, one or more of the biological oils may be modified, preferably conjugated, according to the procedures set forth above. Of all the foregoing, polymers derived from styrene together with divinylbenzene may be particularly preferred. In general, it has now been found that use of two or more comonomers, e.g. styrene with one or more of divinylbenzene, norbornadiene and dicylcopentadiene in a weight ratio of about 2:1 to 3:1, tend to produce polymers which are less brittle and provide a wider variety of viable polymeric materials from hard plastics to soft rubbers than does polymeric material obtained using divinylbenzene as the only comonomer. The person skilled in the art may seek to utilize differing amounts of starting materials (biological oils as well as comonomeric material) than those set forth above in order to affect certain characteristics of the final polymer such as, for example, tensile strength and other characteristics. Thus, some especially preferred formulations may comprise about 45% of low saturated soybean oil or conjugated low saturated soybean oil, about 32% of styrene, about 12% of divinylbenzene, about 5% of Norway fish oil ethyl ester and about 3% of boron trifluoride diethyl etherate. This formulation tends to produce relatively ductile polymers. Another especially desirable formulation may include about 55% of low saturated soybean oil or conjugated low saturated soybean oil, about 25% of styrene, about 12% of divinylbenzene, about 5% of Norway oil ethyl ester and about 3% of boron trifluoride diethyl etherate. This formulation tends to produce relatively rubbery polymers. Yet another especially desirable formulation will include about 35% of low saturated soybean oil or conjugated low saturated soybean oil, about 39% of styrene, about 18% of divinylbenzene, about 5% of Norway fish oil ethyl ester and about 3% of boron trifluoride diethyl etherate. This formulation tends to produce relatively rigid polymers. In general, the conjugated low saturated soybean oil polymers have a higher toughness than do the low saturated soybean oil polymers with the same crosslink density. Moreover, crosslinking appears to increase the elastic modulus of rubbery polymers, and appears to significantly increase the elastic modulus of the glassy plastics.

The Lewis-acid catalyzed copolymerization of fish oil and conjugated fish oil with alkene additives according to the invention also provides particularly useful thermoset plastics. As set forth above, copolymers ranging from rubbers to hard plastics may be synthesized by changing the types and amounts (stoichiometric ratios) of biological oils and/or alkenes used. As for additives, polymers prepared from conjugated fish oil are typically harder and shinier than those prepared from natural fish oil. Soxhlet extraction of the fish oil thermosets indicates that these are highly crosslinked materials with no apparent thermal phase transitions. The fish oil thermosets are thermally stable up to 250-300° C. and partially soluble in CH₂Cl₂, THF, and DMF solvents. The insoluble materials remaining after the extraction of the fish oil thermosets are thermally stable up to 400-450° C.

The glass transition temperatures of the bulk thermosets are typically between 50° C. and 130° C. The modulus at ambient temperature is typically above 10⁸ and can reach as high as 10⁹ Pa, the same magnitude as polyethylene. The decreased presence of unreacted free oil molecules gives the conjugated fish oil polymers improved mechanical properties and thermal stabilities.

The thermoset plastics of the invention, i.e., both the bulk reaction product or, if desired for particular applications, the insoluble component, may be used in a wide variety of products including molded articles, such as automotive parts and toys, construction materials, such as composites, laminates, paints, inks, coating materials, adhesives, biocompatible materials for medical uses, food additives, cosmetics, resins, plasticizers, lubricants, corrosion inhibitors, rubbers, oils, and fibers and may be used in compression molding, or transfer or extrusion processes, or any other suitable method known to those skilled in the art of using thermoset plastics to prepare industrial or consumer products.

The thermosetting plastic materials according to the invention may also be combined with one or more additional materials to form a composite, thus taking advantage of certain desirable properties of each component. The additional component can be organic, inorganic or metallic, and may be present in a variety of forms, such as fibers, rods, particles, plates, foams, etc. The thermoset plastic, typically in the form of a resin, rubber, or adhesive, may be laminated with wood (veneer), paper, fabric and other known materials to make a polymerized biological oil laminate; may be mechanically mixed with fibers, such as glass, carbonaceous types (e.g., pitch), flax, hemp, Irish linen, polymer (e.g., nylon), inorganic types (e.g., boron nitride, silicon carbide and aluminum silicates) and metals (steel, tungsten, etc.) to form a reinforced biological oil plastic; or may be filled with glass flakes or other small particles, such as clay, sand, talc, diatomaceous earth, carbon black, or mica, to form a linoleum or other filled biological oil composite material.

The polymerized biological oil composites according to the invention will typically comprise a polymerized biological oil thermoset and at least one fiber, powder, flake or sheet material which is a solid in the finished state and insoluble with respect to the biological thermoset. The composite may comprise a biological oil thermoset as a continuous matrix phase in which is embedded a three-dimensional distribution of randomly oriented reinforcing elements, e.g., a particulate filled composite; an ordered two-dimensional structure, e.g., an impregnated cloth; or a highly aligned array of parallel fibers, e.g., a filament-wound structure. The composite may also comprise a laminated stacking of sheets of a biological oil thermoset and various other materials in the form of stacked sheets, e.g., plywood, insulation board, laminated paperboard and particle board, wherein the second material is a wood veneer or is a panel of small chips, flakes or particles.

The composite may also contain optional coupling agents to assist in keeping all materials together. These can include effective amounts of such materials as 3-aminopropyltris(methoxyethoxyethoxy)silane (3-AMS), N-(2-aminoethyl)-3-aminopropylmethyldimethoxysilane (N-2-A-3-AMS), alkoxysilylalkane ester with alkylpolyolpolyalkenylate ester (AE-APPE), and modified vinyltriethoxysilane (VTO).

The thermosetting biological oil plastics of the invention are particularly convenient and light weight matrix materials which can embed and grip the second phase fillers, fibers, or other reinforcing materials of the composite. The thermosetting biological oil plastics may be applied in a fluid state, which facilitates penetration and wetting in the unpolymerized state, followed by hardening of the system. The methods used to make the composite material and structure will depend, among other factors, on the type of reinforcement, the required performance level, and the shape of the article. Large diameter, single-filament materials, such as boron, silicon carbide or metal wires, may be fed in precisely controlled, parallel arrays to form tapes of sheet materials. In the case of finer filaments, such as fiberglass, carbon fiber, or boron nitride fiber, bundles of thousands of loosely aggregated fibers may be handled as an entity. When these fibers are to be incorporated into a polymer matrix composite, it is typically most convenient to form a semiprocessed, shapable, intermediate ribbon or sheet prepeg in which the fibers will then be infiltrated by the incompletely cured biological thermosetting material. Another approach is to form dry structures first, such as wire armatures, which are then impregnated with the biological oil matrix material.

The biological oil thermoset composites of the invention may be molded or machined, i.e., sawed, drilled, ground, sanded, milled or turned, to make, for example, plastics for aircraft and marine applications, health related applications, such as prosthesis equipment, sporting goods equipment, automobile parts, and various engineering plastics. They are also useful for construction applications (e.g., corrugated sheets, space dividers, flooring, showers/tubs, light-control panels) and for the electrical and chemical industries (e.g., insulation panels, printed circuits, pipes, ducts, and tanks).

It is to be understood that the application of the teachings of the present invention to a specific problem or environment will be within the capabilities of one having ordinary skill in the art in light of the teachings contained herein. Examples of the products and processes of the present invention appear in the following examples.

### EXAMPLE 1

### Preparation of Soybean Oil Plastics By Polymerization of Soy Oil and Modified Soy Oil

Materials.

The soybean oil used in the following experiments was a commercial, food-grade quality and was used without further purification. Conjugated soybean oil was prepared by the rhodium-catalyzed isomerization of soy oil, as disclosed in U.S. Provisional Patent Application Ser. No. 60/080,068, filed Mar. 31, 1998, which is hereby expressly incorporated by reference herein in its entirety. Metathesized soybean oil and soybean oil cometathesized with norbornadiene were prepared according to the method disclosed in U.S. patent application Ser. No. 09/075,326, filed May 11, 1998, which is hereby expressly incorporated by reference herein in its entirety. All other reagents were supplied by Aldrich Chemical Co. and were used without further purification unless otherwise stated. In the tabulated data, the following abbreviations have been used: comet. soy=soybean oil-olefin cometathesis product as synthesized with the stated amount by weight of norbornadiene; con. soy=conjugated soybean oil; met. soy=olefin metathesized soybean oil; comet. not sep.=crude product from olefin cometathesis of soybean oil and norbornadiene; met. not sep.=crude product from the olefin metathesis of soybean oil; comet. sep.=soybean oil and norbornadiene cometathesis product purified with an ethanol wash; met. sep.=soybean oil metathesis product purified by an ethanol wash.

Representative Procedure A: Polymerization of Soybean Oil Using Boron Trifluoride Diethyl Etherate Complex.

Soybean oil (4.810 g), cyclopentadiene dimer (1.400 g), and divinylbenzene (0.968 g) were mixed in an oven-dried vial (6 dram) using a wooden stick. Boron trifluoride diethyl etherate complex (0.28 g) was added by disposable syringe. The components were thoroughly mixed using a wooden stick. The vial was purged with argon and capped. The vial was placed in an oil bath or an oven (110° C.) for 48 h. The reaction mixture set in 1 h (did not flow). At 48 h, the vial was broken and a brown, hard solid was obtained in quantitative yield.

Representative Procedure B: Polymerization of a Modified Soybean Oil Using Boron Trifluoride Diethyl Etherate Complex.

An oven-dried vial (2 dram) was charged with prepolymer (olefin metathesis product of soybean oil and 25% by weight of norbornadiene) and diallyl terephthalate (0.1950 g). The components were mixed using a wooden stick. Boron trifluoride diethyl etherate complex (0.088 g) was added by disposable syringe. The components were mixed using a wooden stick. The mixture immediately became a black color. The vial was capped, and placed in an oil bath or an oven (40° C.) for 48 h. The mixture was set (unable to flow) in 1 h. At 48 h, the vial was broken, and a shiny, black, semi-hard, pliable material (1.60 g) was obtained.

A) Thermosets of Soybean Oil

The heating of soybean oil in the presence of boron trifluoride diethyl etherate complex (4-7% by weight) caused the oil to set to a solid that resembled natural rubber. This chemical process occurred efficiently at 110° C. The samples obtained were of a brown color, and had rubbery physical characteristics.

Soybean oil that had been chemically modified by olefin cometathesis with norbornadiene (20% by weight) was polymerized with varying amounts of the boron catalyst (Table 1, entries 9-13). A hard, glossy, black solid was obtained with as little as 2% boron trifluoride diethyl etherate (entry 11) and the catalyst at the 1% level (entry 12) still gave a firm, black solid. Blooming was decreased using a modified soybean oil. To obtain a thermoset with long-term stability to moisture, at least 4% catalyst was required.

B) Thermosets of Soybean Oil with Two Olefin Additives

The reaction of soybean oil, divinylbenzene, and dicyclopentadiene for 48 h at 110° C. produced materials that were brown in color. The physical nature of the thermosets varied with the formulation of the reaction mixture. When 30% by weight of the product thermoset was composed of divinylbenzene and dicyclopentadiene, a hard, brown solid was produced.

The reactions of norbornadiene and divinylbenzene with soybean oil using the boron catalyst proved similar to the reactions of dicyclopentadiene. A temperature of 70° C. for 24 h was held so the reaction mixture could gel without boiling off the norbornadiene. The temperature was then increased to 110° C. for 48 h to set the polymer. The compositions which had 10% or a greater amount of both divinylbenzene and norbornadiene gave a suitable product. With the addition of norbornadiene as an additive only 1% of the boron catalyst was required to achieve a thermoset which was hard and stable to moisture.

C) Thermosets of Soybean Oil/Norbornadiene Cometathesized Copolymer with One Additive

The reactivity of the modified oil was much faster than that of the natural soy oil to boron trifluoride diethyl etherate catalysis. A number of olefins were evaluated as potential additives in the thermoset reaction of soybean oil cometathesized with 25% by weight of norbornadiene. The temperature at which these materials reacted was much lower (40° C.) than that of soybean oil itself.

The cometathesized oil by itself gave a glossy, black solid, but the material was very crumbly. However, the use of divinylbenzene, styrene, and alpha-methylstyrene as additives gave curable materials.

The tables below tabulate the effect of changing the norbornadiene content in the modified oil, the ratio of boron catalyst, and the ratio of olefin additive. The objective was to discover the lowest ratio of norbornadiene content in the modified oil, as well as the lowest ratios of olefin additive and catalyst needed to obtain a stable, hard thermoset material.

In Table 2, the best materials obtained with the modified oil containing 20% norbornadiene are listed in entries 1-5. The copolymer used was not purified before use and was, in fact, crude reaction material from the olefin metathesis reaction. The boron catalyst is preferably present in at least 5% by weight when using divinylbenzene as an additive, since the thermosets were fragile when lower amounts of catalyst were used. The materials were hard, black, stable solids without much dependence upon the level of divinylbenzene.

The purified cometathesized soy oils with 20 weight % norbornadiene were studied using the same additives and the results were listed in Tables 3-5. The results are comparable to those of the unpurified cometathesized oil. The best materials were obtained from the purified, cometathesized soybean oils with a level of at least 11 to 20% norbornadiene and a catalyst load of 5% boron trifluoride diethyl etherate plus divinylbenzene (Table 6).

D) Thermosets of Conjugated Soybean Oil

Conjugated soybean oil is more reactive in these thermoset reactions than natural soybean oil. The use of a two additive system with conjugated soybean oil in the thermoset reaction was very successful.

Norbornadiene and divinylbenzene were thermoset in the presence of conjugated soybean oil to give glossy, rubbery, brown solids (Table 7). These thermosets had excellent properties, i.e., no oily phases in the thermoset, little blooming of oils, and no significant decomposition over time in air when the boron catalyst ratio was at least 2% by weight. The higher the ratio of divinylbenzene, the harder the thermoset was (Table 7, entry 5). The lower concentrations of divinylbenzene gave a more rubbery material (entry 3). These thermosets have a tendency to continue the curing process at room temperature over time. Most samples studied with higher concentrations of divinylbenzene became more rigid over a period of months. The use of 1% boron trifluoride catalyst still gave materials with very desirable properties. Conjugated soybean oil with 1% catalyst and 10% each of norbornadiene and divinylbenzene by weight gave a solid that was brown in color, glossy, and slightly rubbery in nature (entry 16). The thermosets with divinylbenzene used alone (Table 8) gave hard, glossy, brown solids when the divinylbenzene content was 15% or higher (entries 3-6).

The divinylbenzene-dicyclopentadiene-conjugated soybean oil thermoset system achieved very tough materials (Table 9). This could be accomplished with as little as 1% catalyst (entries 13-18). Again the higher the level of divinylbenzene, the tougher the material. The bottom of the thermoset plugs were usually harder than the top. This is due to increased heating on the bottom of the samples during the curing process from the radiant heat coming from the heating elements on the bottom of the oven.

E) Thermosets of Metathesized Soybean Oil

The modified soybean oil resulting from the olefin metathesis of soybean oil readily formed solids in the boron trifluoride-catalyzed thermoset reaction. These oils are more reactive than unmodified soybean oil, but are less reactive than cometathesized or conjugated soybean oil.

The modified oils were used as the crude reaction mixture from the olefin metathesis or the modified oils were purified by washing with ethanol. The ethanol wash aided in removing the unreacted soybean oil giving higher molecular weight oligomers. These modified oils were reacted with divinylbenzene, divinylbenzene and dicyclopentadiene, or divinylbenzene and norbornadiene.

The purified, metathesized soybean oils (Tables 10-12) gave thermosets which were less tacky, oily, and rubbery than the unseparated, metathesized oils. The reaction of separated, metathesized soybean oil with divinylbenzene using boron trifluoride diethyl etherate gave glossy, firm to hard, brown solids after curing at 110° C. for 72 h. The amount of boron catalyst did not greatly effect the nature of the thermoset (Table 10). The greatest impact that was noted for the properties of the thermosets was that the greater the amount of divinylbenzene, the harder the thermoset materials. With 30% divinylbenzene (entry 6), a hard, glossy, dark-brown solid was obtained. The thermoset formed from 5% by weight divinylbenzene was glossy, but rubbery. Over a period of weeks to months, all of the samples in Table 10 became somewhat more rigid as they sat at room temperature.

Table 11 lists the materials obtained from the reaction of the two additives, dicyclopentadiene and divinylbenzene, with separated, metathesized soybean oil. These materials were more rubbery than those that were thermoset with just divinylbenzene. However, when the amounts of dicyclopentadiene were 10% and above, the thermoset materials were hard and glossy. The amounts of boron catalyst in this two additive system did affect the physical properties of the thermosets. When 2 to 6% boron catalyst was used, the thermosets were firm to hard, but with the catalyst load at 1%, the materials were rubbery.

Table 12 shows the thermosets of purified, metathesized soybean oil, divinylbenzene, and norbornadiene. The amount of catalyst did not affect the physical nature of the thermosets. The ratio of norbornadiene did greatly influence the hardness of the thermosets. When 10% or greater by weight of the thermoset formulation was norbornadiene, the product materials were hard, glossy, dark-brown solids. The yields are nearly quantitative.

TABLE 1
Polymerization of Soy Oil and Divinylbenzene or Soy Oil, Divinyl-
benzene, and Dicyclopentadiene Using Varying Amounts of Boron
Trifluoride Diethyl Etherate at 110° C. for 48 h

| | | | | dicyclo- | |
|---|---|---|---|---|---|
| | | | divinyl- | penta- | |
| | soy oil | BF₃.OEt₂ | benzene | diene | |
| | (weight | (weight | (weight | (weight | appearance of |
| entry | %) | %) | %) | %) | product material |
| 1 | 69 | 3 | 14 | 14 | glossy, hard, brown |
| | | | | | solid, harder on |
| | | | | | bottom |
| 2 | 70 | 2 | 14 | 14 | sticky, fragile, |
| | | | | | brown solid |
| 3 | 71 | 1 | 14 | 14 | sponge-like, brown |
| | | | | | solid |
| 4 | 71.5 | 0.5 | 14 | 14 | brown liquid |
| 5 | 69 | distilled | 14 | 14 | hard, brown solid |
| | | 3 | | | |
| 6 | 70 | distilled | 14 | 14 | hard, brown solid |
| 7 | 71 | distilled | 14 | 14 | soft, gummy, |
| | | 1 | | | fragile, solid |
| 8 | 71.5 | distilled | 14 | 14 | brown liquid |
| | | 0.5 | | | |
| 9 | comet. | 27 | 13 | — | oily, brittle, black |
| | Soy (20) | | | | solid |
| | 60 | | | | |
| 10 | 80 | 4 | 16 | — | hard, glossy, black |
| | | | | | solid |
| 11 | 81 | 2 | 17 | — | hard, glossy, black |
| | | | | | solid |
| 12 | 82 | 1 | 17 | — | slightly glossy and |
| | | | | | firm, black solid |
| 13 | 82 | 0.6 | 17 | — | soft, black solid |

TABLE 2
Polymerization of Cometathesized (20% Norbornadiene, Not Separ-
ated) Soy Oil and Divinylbenzene Using Catalytic Boron Trifluoride
Diethyl Etherate at 110° C. for 48 h

| | Comet. | | | | |
|---|---|---|---|---|---|
| | soy | BF₃.OEt₂ | additive | | |
| | (weight | (weight | (weight | Appearance of product | % |
| entry | %) | %) | %) | material | yield |
| 1 | 90 | 5 | 5 | black, hard solid | 96 |
| 2 | 85 | 5 | 10 | black, hard solid | 96 |
| 3 | 80 | 5 | 15 | black, hard solid | 96 |
| 4 | 75 | 5 | 20 | black, hard solid | 91 |
| 5 | 70 | 5 | 25 | black, hard solid | 91 |
| 6 | 65 | 5 | 30 | black, hard solid with white | 93 |
| | | | | inclusions | |
| 7 | 93 | 2 | 5 | fragile, soft, slight gloss, | 88 |
| | | | | black solid | |
| 8 | 88 | 2 | 10 | fragile, soft, slight gloss, | 83 |
| | | | | black solid | |
| 9 | 83 | 2 | 15 | fragile, black solid | 92 |
| 10 | 78 | 2 | 20 | fragile, black solid | 92 |
| 11 | 73 | 2 | 25 | fragile, black solid | 95 |
| 12 | 68 | 2 | 30 | fragile, hard black solid | 93 |
| 13 | 94 | 1 | 5 | fragile, soft, black solid | 93 |
| 14 | 89 | 1 | 10 | fragile, soft, black solid | 93 |
| 15 | 84 | 1 | 15 | fragile, firm, black solid | 94 |
| 16 | 79 | 1 | 20 | fragile, firm, black solid | 92 |
| 17 | 74 | 1 | 25 | fragile, firm, black solid | 89 |
| 18 | 69 | 1 | 30 | hard, brown-black solid | 89 |

TABLE 3
Polymerization of Cometathesized (20% Norbornadiene, Separated)
Soy Oil and Divinylbenzene Using Catalytic Boron Trifluoride
Diethyl Etherate at 110° C. for 48 h

| | Comet. | | divinyl- | | |
|---|---|---|---|---|---|
| | soy | BF₃.OEt₂ | benzene | | |
| | (weight | (weight | (weight | Appearance of product | % |
| entry | %) | %) | %) | material | yield |
| 1 | 90 | 5 | 5 | smooth, hard, black solid | 93 |
| 2 | 85 | 5 | 10 | glossy, smooth, hard, black | 94 |
| | | | | solid | |
| 3 | 80 | 5 | 15 | glossy, smooth, hard, black | 93 |
| | | | | solid | |
| 4 | 75 | 5 | 20 | glossy, hard, black solid | 93 |
| 5 | 70 | 5 | 25 | glossy, hard, black solid | 94 |
| 6 | 65 | 5 | 30 | glossy, smooth, hard, black | 87 |
| | | | | solid | |
| 7 | 93 | 2 | 5 | slightly wet, soft, black | 95 |
| | | | | solid | |
| 8 | 88 | 2 | 10 | slightly wet, slightly soft, | 86 |
| | | | | brown, black solid | |
| 9 | 83 | 2 | 15 | smooth, hard, black solid | 90 |
| 10 | 78 | 2 | 20 | hard, black solid | 88 |
| 11 | 73 | 2 | 25 | glossy, hard, black solid | 90 |
| 12 | 68 | 2 | 30 | glossy, hard, black solid | 95 |
| 13 | 94 | 1 | 5 | dull, soft, black solid | 87 |
| 14 | 89 | 1 | 10 | soft, black solid | 89 |
| 15 | 84 | 1 | 15 | very soft, brown-black solid | 85 |
| 16 | 84 | 1 | 15 | very soft, brown-black solid | 83 |
| 17 | 74 | 1 | 25 | wet, brown solid | 80 |
| 18 | 69 | 1 | 30 | dull, brown-black solid | 80 |

TABLE 4
Polymerization of Cometathesized (20% Norbornadiene, Separated)
Soy Oil and Styrene Using Catalytic Boron Trifluoride Diethyl
Etherate at 110° C. for 48 h

| | Comet. | | | | |
|---|---|---|---|---|---|
| | soy | BF₃.OEt₂ | styrene | | |
| | (weight | (weight | (weight | Appearance of product | % |
| entry | %) | %) | %) | material | yield |
| 1 | 90 | 5 | 5 | Fragile, hard, black solid | 89 |
| 2 | 85 | 5 | 10 | Glossy, hard, black solid | 93 |
| 3 | 80 | 5 | 15 | oily, slightly soft, black | 94 |
| | | | | solid | |
| 4 | 75 | 5 | 20 | oily, slightly soft, black | 95 |
| | | | | solid | |
| 5 | 70 | 5 | 25 | Slightly soft, brown-black | 96 |
| | | | | solid | |
| 6 | 65 | 5 | 30 | Slightly wet, dull, soft, | 92 |
| | | | | black solid | |
| 7 | 93 | 2 | 5 | Slightly wet, glossy, hard, | 96 |
| | | | | black solid | |
| 8 | 88 | 2 | 10 | Glossy, hard, black solid | 88 |
| 9 | 83 | 2 | 15 | Slightly soft, black solid | 87 |
| 10 | 78 | 2 | 20 | soft, black-brown solid | 84 |
| 11 | 73 | 2 | 25 | soft, black solid | 95 |
| 12 | 68 | 2 | 30 | soft, black solid | 86 |
| 13 | 94 | 1 | 5 | Fragile, soft, black solid | 94 |
| 14 | 89 | 1 | 10 | Fragile, soft, black solid | 89 |
| 15 | 84 | 1 | 15 | Fragile, soft, black solid | 84 |
| 16 | 79 | 1 | 20 | soft, black solid with liquid | 79 |
| | | | | phase | |
| 17 | 74 | 1 | 25 | soft, black solid with liquid | 74 |
| | | | | phase | |
| 18 | 69 | 1 | 30 | Rubbery, soft, black solid | 69 |

TABLE 5
Polymerization of Cometathesized (20% Norbornadiene, Separated)
Soy Oil and Styrene Using Catalytic Boron Trifluoride Diethyl
Etherate at 110° C. for 48 h

| | | | α- | | |
|---|---|---|---|---|---|
| | Comet. | | methyl- | | |
| | soy | BF₃.OEt₂ | styrene | | |
| | (weight | (weight | (weight | Appearance of product | % |
| entry | %) | %) | %) | material | yield |
| 1 | 90 | 5 | 5 | Slightly soft, black solid | 92 |
| 2 | 85 | 5 | 10 | wet, slightly soft, black | 86 |
| 3 | 80 | 5 | 15 | wet, slightly soft, black | 98 |
| | | | | solid | |
| 4 | 75 | 5 | 20 | Glossy, wet, slightly soft, | 94 |
| | | | | black solid | |
| 5 | 70 | 5 | 25 | Glossy, wet, slightly soft, | 97 |
| | | | | black solid | |
| 6 | 65 | 5 | 30 | wet, slightly soft, black | 95 |
| | | | | solid | |
| 7 | 93 | 2 | 5 | Glossy, firm, black solid | 83 |
| 8 | 88 | 2 | 10 | firm, black solid with soft | 80 |
| | | | | top | |
| 9 | 83 | 2 | 15 | very fragile, very soft, | 64 |
| | | | | black solid | |
| 10 | 78 | 2 | 20 | very fragile, very soft, | 75 |
| | | | | black solid | |
| 11 | 73 | 2 | 25 | Gooey, black solid | 64 |
| 12 | 68 | 2 | 30 | soft, rubbery, black solid | 82 |
| 13 | 94 | 1 | 5 | soft, gooey, black solid | 69 |
| 14 | 89 | 1 | 10 | soft, gooey, black solid | 60 |
| 15 | 84 | 1 | 15 | Dark liquid | — |
| 16 | 79 | 1 | 20 | Dark liquid | — |
| 17 | 74 | 1 | 25 | Dark liquid | — |
| 18 | 69 | 1 | 30 | Dark liquid | — |

TABLE 6
Polymerization of Cometathesized (11% Norbornadiene, Separated)
Soy Oil and α-Methylstyrene, Styrene, or Divinylbenzene Using
Catalytic Boron Trifluoride Diethyl Etherate at 110° C. for 48 h

| | Comet. | | | | |
|---|---|---|---|---|---|
| | soy | BF₃.OEt₂ | additive | | |
| | (weight | (weight | (weight | Appearance of product | % |
| entry | %) | %) | %) | material | yield |
| 1 | 90 | 5 | divinyl- | Glossy, firm but pliable, | 96 |
| | | | benzene | black solid | |
| 2 | 85 | 5 | 10 | Glossy, firm but pliable, | 97 |
| | | | | black solid | |
| 3 | 80 | 5 | 15 | Glossy, hard, black solid | 96 |
| 4 | 75 | 5 | 20 | very hard, glossy, black | 89 |
| | | | | solid | |
| 5 | 70 | 5 | 25 | Pliable, black solid with | 95 |
| | | | | bubbled bottom | |
| 6 | 65 | 5 | 30 | Glossy, hard, dark-brown | 97 |
| | | | | solid | |
| 7 | 90 | 5 | styrene | Pliable, black solid with | 95 |
| | | | 5 | bubbled bottom | |
| 8 | 85 | 5 | 10 | soft, black solid with | 94 |
| | | | | bubbled bottom | |
| 9 | 80 | 5 | 15 | Glossy, slightly pliable, | 97 |
| | | | | black solid | |
| 10 | 75 | 5 | 20 | Pliable, black solid | 98 |
| 11 | 70 | 5 | 25 | Sticky, soft, black solid | 96 |
| 12 | 65 | 5 | 30 | Tacky, soft, black solid | 91 |
| | | | | with bubbled bottom | |
| 13 | 90 | 5 | α- | Bubbled, soft, sticky, black | 84 |
| | | | methyl- | solid | |
| | | | styrene | | |
| 14 | 85 | 5 | 10 | soft, bouncy, black solid | 95 |
| | | | | with bubbled bottom | |
| 15 | 80 | 5 | 15 | soft, black solid with liquid | 68 |
| | | | | phase | |
| 16 | 75 | 5 | 20 | soft, black solid with liquid | 86 |
| | | | | phase | |

TABLE 7
Polymerization of Conjugated Soy Oil, Divinylbenzene, and
Norbornadiene Using Catalytic Boron Trifluoride Diethyl Etherate
at 60° C. for 24 h then 110° C. for 48 h

| | con. | | norbor- | Divinyl- | |
|---|---|---|---|---|---|
| | soy | BF₃.OEt₂ | nadiene | benzene | |
| | (weight | (weight | (weight | (weight | appearance of product |
| entry | %) | %) | %) | %) | material |
| 1 | 84 | 5 | 5 | 5 | rubbery, glossy, dark- |
| | | | | | brown solid |
| 2 | 80 | 5 | 5 | 10 | glossy, rubbery, dark- |
| | | | | | brown solid but firm on |
| | | | | | bottom |
| 3 | 79 | 5 | 10 | 5 | glossy, rubbery, dark- |
| | | | | | brown solid but firm on |
| | | | | | bottom |
| 4 | 75 | 5 | 10 | 10 | glossy, firm, dark-brown |
| | | | | | solid, hard on bottom |
| 5 | 65 | 5 | 10 | 20 | glossy, firm, dark-brown |
| | | | | | solid, very hard on |
| | | | | | bottom |
| 6 | 65 | 5 | 20 | 10 | very glossy, very hard, |
| | | | | | dark-brown solid |
| 7 | 87 | 2 | 5 | 5 | glossy, slightly rubbery, |
| | | | | | slightly brittle, dark- |
| | | | | | brown solid |
| 8 | 83 | 2 | 5 | 10 | glossy, firm, dark-brown |
| | | | | | solid, more firm on |
| | | | | | bottom |
| 9 | 83 | 2 | 10 | 5 | glossy, slightly rubbery, |
| | | | | | dark |
| 10 | 78 | 2 | 10 | 10 | glossy, firm, dark-brown |
| | | | | | solid, hard on bottom |
| 11 | 68 | 2 | 10 | 20 | glossy, firm, dark-brown |
| | | | | | solid, very hard on |
| | | | | | bottom |
| 12 | 71 | 2 | 21 | 6 | glossy, firm, dark-brown |
| | | | | | solid, more firm on |
| | | | | | bottom |
| 13 | 88 | 1 | 5 | 5 | glossy, rubbery, dark- |
| | | | | | brown solid |
| 14 | 84 | 1 | 5 | 10 | glossy, rubbery, dark- |
| | | | | | brown solid, firm on |
| | | | | | bottom |
| 15 | 83 | 1 | 10 | 5 | slightly brittle, glossy, |
| | | | | | rubbery, dark-brown |
| | | | | | solid |
| 16 | 79 | 1 | 10 | 10 | glossy, slightly rubbery, |
| | | | | | dark-brown solid, hard |
| | | | | | on bottom |
| 17 | 69 | 1 | 10 | 20 | very hard, glossy, dark- |
| | | | | | brown solid |
| 18 | 72 | 1 | 21 | 6 | glossy, firm on top, dark- |
| | | | | | brown solid |
| 19 | 68 | 2 | 20 | 10 | very hard, glossy, dark- |
| | | | | | brown solid |
| 20 | 69 | 1 | 20 | 10 | slightly brittle, glossy, |
| | | | | | hard, dark-brown solid |

TABLE 8
Polymerization of Conjugated Soy Oil, and Divinylbenzene Using
Catalytic Boron Trifluoride Diethyl Etherate at 110° C. for 72 h

| | con. | | Divinyl- | | |
|---|---|---|---|---|---|
| | soy | BF₃.OEt₂ | benzene | | |
| | (weight | (weight | (weight | Appearance of product | % |
| entry | %) | %) | %) | material | yield |
| 1 | 90 | 5 | 5 | Glossy, firm, dark-brown | 97 |
| | | | | solid | |
| 2 | 85 | 5 | 10 | Glossy, firm, dark-brown | 95 |
| | | | | solid with yellow | |
| | | | | particulates on bottom | |
| 3 | 80 | 5 | 15 | Hard, glossy, dark-brown | 93 |
| | | | | solid, harder on bottom, | |
| | | | | yellow particulates on | |
| | | | | bottom | |
| 4 | 75 | 5 | 20 | Hard, glossy, dark-brown | 93 |
| | | | | solid, harder on bottom, | |
| | | | | yellow particulates on | |
| | | | | bottom | |
| 5 | 70 | 5 | 25 | Glossy, very hard, dark- | 96 |
| | | | | brown solid with yellow | |
| | | | | particulates on bottom | |
| 6 | 65 | 5 | 30 | Glossy, very hard, dark- | 97 |
| | | | | brown solid with yellow | |
| | | | | particulates on bottom | |
| 7 | 92 | 2 | 6 | Slightly rubbery, glossy, | 96 |
| | | | | dark-brown solid | |
| 8 | 88 | 2 | 10 | very slightly rubbery, glos- | 96 |
| | | | | sy, dark-brown solid, | |
| | | | | hard crust with yellow | |
| | | | | particulates | |
| 9 | 83 | 2 | 15 | Glossy, firm, dark-brown | 97 |
| | | | | solid with yellow | |
| | | | | particulates on bottom | |
| 10 | 78 | 2 | 20 | Glossy, hard, dark-brown | 97 |
| | | | | solid, harder on bottom, | |
| | | | | yellow particulates on | |
| | | | | bottom | |
| 11 | 73 | 2 | 25 | Glossy, very hard, dark- | 96 |
| | | | | brown solid, yellow | |
| | | | | particulates on bottom | |
| 12 | 68 | 2 | 30 | Glossy, rubbery, dark- | 97 |
| | | | | brown solid, bottom firm | |
| | | | | with yellow particulates | |
| 13 | 94 | 1 | 5 | Glossy, rubbery, brittle, | 95 |
| | | | | dark-brown solid, darker | |
| | | | | brown on top | |
| 14 | 88 | 1 | 11 | Glossy, rubbery, dark- | 96 |
| | | | | brown solid, bottom firm | |
| | | | | with yellow particulates | |
| 15 | 84 | 1 | 15 | Rubbery, clear-amber solid | 94 |
| | | | | on top; hard, brown solid | |
| | | | | bottom with yellow | |
| | | | | particulates | |
| 16 | 79 | 1 | 20 | Rubbery, clear-amber solid | 94 |
| | | | | on top; hard, brown solid | |
| | | | | bottom with yellow | |
| | | | | particulates | |
| 17 | 74 | 1 | 25 | Rubbery, clear-amber solid | 95 |
| | | | | on top; hard, brown solid | |
| | | | | bottom with yellow | |
| | | | | particulates | |
| 18 | 69 | 1 | 30 | Rubbery, clear-amber solid | 97 |
| | | | | on top; hard, brown solid | |
| | | | | bottom with yellow | |
| | | | | particulates | |

TABLE 9
Polymerization of Conjugated Soy Oil, Divinylbenzene, and Dicyclo-
pentadiene Using Catalytic Boron Trifluoride Diethyl Etherate at
110° C. for 72 h

| | | | dicyclo- | | |
|---|---|---|---|---|---|
| | con. | | penta- | Divinyl- | |
| | soy | BF₃.OEt₂ | diene | benzene | |
| | (weight | (weight | (weight | (weight | appearance of product |
| entry | %) | %) | %) | %) | material |
| 1 | 85 | 5 | 5 | 5 | rubbery, glossy, dark- |
| | | | | | brown solid |
| 2 | 80 | 5 | 5 | 10 | glossy, firm, dark-brown |
| | | | | | solid but harder on |
| | | | | | bottom |
| 3 | 80 | 5 | 10 | 5 | glossy, firm, dark-brown |
| | | | | | solid |
| 4 | 74 | 6 | 10 | 10 | glossy, firm on top, hard |
| | | | | | on bottom, dark-brown |
| | | | | | solid |
| 5 | 64 | 5 | 10 | 20 | glossy, hard, dark-brown |
| | | | | | solid |
| 6 | 65 | 5 | 20 | 10 | very glossy, very hard, |
| | | | | | dark black-brown solid |
| 7 | 88 | 2 | 5 | 5 | glossy, rubbery, brown |
| | | | | | solid |
| 8 | 83 | 2 | 5 | 10 | glossy, hard, brown sol- |
| | | | | | id, harder on the bottom |
| 9 | 83 | 2 | 10 | 5 | glossy, rubbery, dark- |
| | | | | | brown solid, harder crust |
| | | | | | on bottom |
| 10 | 78 | 2 | 10 | 10 | glossy, rubbery, dark- |
| | | | | | brown solid, hard on |
| | | | | | bottom |
| 11 | 68 | 2 | 10 | 20 | very glossy, hard, dark- |
| | | | | | brown solid, harder on |
| | | | | | bottom, yellow particu- |
| | | | | | lates on bottom |
| 12 | 68 | 2 | 20 | 10 | very glossy, firm, dark- |
| | | | | | brown solid |
| 13 | 89 | 1 | 5 | 5 | glossy, rubbery, brittle, |
| | | | | | dark-brown solid |
| 14 | 84 | 1 | 5 | 10 | glossy, rubbery, brittle, |
| | | | | | dark-brown solid, more |
| | | | | | rubbery on top |
| 15 | 84 | 1 | 10 | 5 | glossy, rubbery, very |
| | | | | | slightly brittle, dark- |
| | | | | | brown solid |
| 16 | 79 | 1 | 10 | 10 | somewhat rubbery, |
| | | | | | glossy, dark-brown solid |
| 17 | 69 | 1 | 10 | 20 | glossy, firm, dark-brown |
| | | | | | solid, hard on bottom, |
| | | | | | yellow particulates on |
| | | | | | bottom |
| 18 | 69 | 1 | 20 | 10 | extremely rubbery, |
| | | | | | glossy, dark-brown solid |

TABLE 10
Polymerization of Metathesized (Separated) Soy Oil, and Divinylbenzene
Using Catalytic Boron Trifluoride Diethyl Etherate at 110° C. for 72 h

| | met. soy | BF₃.OEt₂ | divinylbenzene | % |
|---|---|---|---|---|
| entry | (weight %) | (weight %) | (weight %) | yield |
| 1 | 90 | 5 | 5 | 96 |
| 2 | 84 | 6 | 10 | 97 |
| 3 | 80 | 5 | 15 | 96 |
| 4 | 74 | 6 | 20 | 96 |
| 5 | 70 | 6 | 24 | 97 |
| 6 | 64 | 6 | 30 | 95 |
| 7 | 93 | 2 | 5 | 96 |
| 8 | 88 | 2 | 10 | 93 |
| 9 | 83 | 2 | 15 | 94 |
| 10 | 75 | 2 | 23 | 96 |
| 11 | 72 | 2 | 26 | 96 |
| 12 | 68 | 2 | 30 | 95 |
| 13 | 94 | 1 | 5 | 88 |
| 14 | 89 | 1 | 10 | 95 |
| 15 | 84 | 1 | 15 | 92 |
| 16 | 79 | 1 | 20 | 90 |
| 17 | 78 | 1 | 21 | 94 |
| 18 | 69 | 1 | 30 | 95 |
| 19 | 74 | 1 | 25 | 97 |

TABLE 11
Polymerization of Metathesized Soy Oil (Separated), Divinylbenzene,
and Dicyclopentadiene Using Catalytic Boron Trifluoride Diethyl
Etherate at 110° C. for 72 h

| | | | dicyclo- | | | |
|---|---|---|---|---|---|---|
| | met. | | penta- | | | |
| | soy | BF₃.OEt₂ | diene | divinyl- | | |
| | (weight | (weight | (weight | benzene | appearance of | % |
| | %) | %) | %) | (weight) | produce material | yield |
| 1 | 85 | 6 | 5 | 5 | glossy, somewhat | 97 |
| | | | | | rubbery, very slight- | |
| | | | | | ly brittle, dark- | |
| | | | | | brown solid | |
| 2 | 79 | 6 | 5 | 10 | glossy, firm, dark- | 97 |
| | | | | | brown solid, firmer | |
| | | | | | on bottom | |
| 3 | 79 | 6 | 10 | 5 | glossy, slightly rub- | 97 |
| | | | | | bery, dark-brown | |
| | | | | | solid, firmer on | |
| | | | | | bottom | |
| 4 | 74 | 6 | 10 | 10 | glossy, firm, dark- | 97 |
| | | | | | brown solid, firmer | |
| | | | | | on bottom | |
| 5 | 65 | 6 | 10 | 20 | hard, glossy, dark- | 96 |
| | | | | | brown solid, harder | |
| | | | | | on bottom | |
| 6 | 65 | 6 | 20 | 10 | hard, glossy, dark- | 96 |
| | | | | | brown solid, harder | |
| | | | | | on bottom | |
| 7 | 87 | 2 | 5 | 5 | glossy, slightly rub- | 97 |
| | | | | | bery, dark-brown | |
| | | | | | solid | |
| 8 | 83 | 2 | 5 | 10 | glossy, firm, dark- | 97 |
| | | | | | brown solid, firmer | |
| | | | | | on bottom | |
| 9 | 83 | 2 | 10 | 5 | slightly rubbery, | 97 |
| | | | | | glossy, dark-brown | |
| | | | | | solid | |
| 10 | 77 | 2 | 10 | 11 | glossy, slightly rub- | 96 |
| | | | | | bery, dark-brown | |
| | | | | | solid, hard on | |
| | | | | | bottom | |
| 11 | 68 | 2 | 10 | 20 | glossy, hard, dark- | 97 |
| | | | | | brown solid, harder | |
| | | | | | on bottom | |
| 12 | 67 | 2 | 21 | 10 | glossy, hard, dark- | 97 |
| | | | | | brown solid, harder | |
| | | | | | on bottom | |
| 13 | 89 | 1 | 5 | 5 | very rubbery and | 95 |
| | | | | | crumbly, dark- | |
| | | | | | brown solid | |
| 14 | 83 | 1 | 5 | 10 | glossy, rubbery, | 94 |
| | | | | | dark-brown solid | |
| 15 | 82 | 1 | 10 | 7 | glossy, very rub- | 96 |
| | | | | | bery, slightly brittle, | |
| | | | | | dark-brown solid | |
| 16 | 79 | 1 | 10 | 10 | very rubbery, brittle, | 93 |
| | | | | | crumbly, dark- | |
| | | | | | brown solid | |
| 17 | 69 | 1 | 10 | 20 | glossy, hard, dark- | 96 |
| | | | | | brown solid, very | |
| | | | | | hard bottom | |
| 18 | 69 | 1 | 20 | 10 | dark-brown solid, | 88 |
| | | | | | very soft and tacky | |
| | | | | | bottom, top is | |
| | | | | | rubbery | |

TABLE 12
Polymerization of Metathesized Soy Oil (Separated),
Divinylbenzene, and Dicyclopentadiene Using Catalytic Boron
Trifluoride Diethyl Etherate at 110° C. for 72 h

| | met. Soy oil | BF₃·OEt₂ | norbornadiene | divinylbenzene | | % |
|---|---|---|---|---|---|---|
| entry | (weight %) | (weight %) | (weight %) | (weight %) | appearance of product material | yield |
| 1 | 85 | 5 | 5 | 5 | glossy, slightly rubbery, dark-brown solid | 96 |
| 2 | 79 | 5 | 6 | 10 | glossy, dark-brown solid, slightly rubbery on top hard on bottom | |
| 3 | 79 | 6 | 10 | 5 | glossy, dark-brown solid, slightly rubbery on top, more firm on | 97 |
| | | | | | bottom | |
| 4 | 75 | 5 | 10 | 10 | glossy, dark-brown solid, slightly rubbery on top, hard on bottom | 97 |
| 5 | 64 | 5 | 10 | 20 | glossy, hard, dark-brown solid, very hard on bottom | 98 |
| 6 | 64 | 5 | 20 | 10 | glossy, very hard, dark-brown solid | 97 |
| 7 | 87 | 2 | 5 | 5 | slightly rubbery, glossy, dark-brown solid98 | |
| 8 | 82 | 2 | 5 | 10 | glossy, dark-brown solid, slightly rubbery on top, hard on bottom | 97 |
| 9 | 83 | 2 | 10 | 5 | glossy, firm, dark-brown solid | 98 |
| 10 | 78 | 2 | 10 | 11 | glossy, dark-brown solid, firm on top, hard on bottom | 98 |
| 11 | 68 | 2 | 10 | 20 | very hard, glossy, dark-brown solid | 98 |
| 12 | 71 | 2 | 21 | 10 | very glossy, very hard, dark-brown solid | 99 |
| 13 | 88 | 1 | 5 | 5 | glossy, dark-brown solid, rubbery but firm on the bottom, slightly | 96 |
| | | | | | brittle | |
| 14 | 83 | 1 | 5 | 10 | glossy, firm, dark-brown solid, top is sticky | 96 |
| 15 | 83 | 1 | 10 | 7 | glossy, firm, dark-brown solid, top is sticky and barely solid | 96 |
| 16 | 79 | 1 | 10 | 10 | glossy, firm, dark-brown solid, hard on bottom | 96 |
| 17 | 69 | 1 | 10 | 20 | glossy, hard, dark-brown solid, top is sticky and barely solid | 94 |
| 18 | 73 | 1 | 21 | 10 | glossy, dark-brown solid, hard on bottom, top is rubbery and | 95 |
| brittle | | | | | | |
| 19 | 86 | 2 | 20 | 10 | very glossy, hard, dark-brown solid | 96 |
| 20 | 69 | 1 | 20 | 10 | glossy, hard, dark-brown solid, top is sticky and barely solid | 96 |

### EXAMPLE 2

### Preparation of Fish Oil Plastics by Polymerization of Fish Oil and Modified Fish Oil

General.

All ¹H and ¹³C NMR spectra were recorded in CDCl₃ using a Varian Unity spectrometer at 300 MHz and 75.5 MHz, respectively. IR spectra were recorded on a BIORAD FTS-7 Infrared Spectrometer. UV-Visible spectra were obtained using a Shimadzu UV-2101PC Scanning Spectrophotometer. Thin-layer chromatography (TLC) was performed using commercially prepared 60 mesh silica gel plates (Whatman K6F). The plates were visualized using UV light (254 nm) or basic KMnO₄ solution [3 g KMnO₄+20 g K₂CO₃+5 mL NaOH (5%) +300 mL H₂O].

Thermal Analysis.

Thermogravimetric analysis (TGA) data was collected using a Perkin Elmer TGA7 Thermogravimetric Analyzer. For TGA, purging gases and their flow rates have to be indicated. Temperature ranges of 50-500° C. were used with ramps of 20° C./min. Differential scanning calorimetry data was obtained using a Perkin Elmer Pyris 1 Differential Scanning Calorimeter. An initial heating of 100-500° C., a cool-down cycle, and a second heating from 100-500° C. were used for each sample. Temperature ramps of 20° C./min were used in both heating cycles.

Solid State CP MAS ¹³C NMR.

Cross-polarization magic angle spinning (CP MAS) ¹³C NMR was performed on solid polymer samples using a Bruker MSL 300 spectrometer. Samples were examined at 2 spinning frequencies (2.5 and 3.0 K) to differentiate between actual signals and spinning sidebands.

Gel Permeation Chromatography.

Molecular weight measurements were performed using a Waters gel permeation system (410 refractive index detector) coupled with a Wyatt miniDAWN. Multiple angle laser light scattering (MALLS) or calibrated polystyrene standards (1.2×10²-1.1×10⁵) were used in determining the molecular weights. Three ultrastyragel columns (Waters HR 1, 4, and 5), tetrahydrofuran eluent, a flow rate of 1.0 mL/min., and an equilibration temperature of 40° C. were used in performing the chromatography.

Reagents.

All reagents obtained from commercial vendors were used as received unless otherwise noted. The Norway fish oil ethyl ester was supplied by Pronova Biocare (Bergen, Norway), and the Capelin fish oil was obtained from SR-Mjol HF (Reykjavik, Iceland). Divinylbenzene, norbornadiene, dicyclopentadiene, styrene, myrcene, phenol, linalool, β-citronellol, furfural, 4-vinylcyclohexene, 1,4-benzoquinone, 2-allylphenol, ρ-mentha-1,8-diene, furan, 1,2-dimethoxybenzene, bisphenol A, 1,3-cyclohexadiene, maleic anhydride, methyl acrylate, vinyl acetate, vinylidene chloride, acrylonitrile, methyl crotonate, acrolein, isoprene, dimethyl acetylenedicarboxylate, diallyl phthalate, boron trifluoride diethyl etherate, iron(III) chloride, and tin tetrachloride (anh.) were obtained from Aldrich Chemical Co. (Milwaukee, Wis.). Aluminum chloride, zinc(II) chloride, titanium tetrachloride, and concentrated sulfuric acid were purchased from Fisher Scientific (Fair Lawn, N.J.). Tin tetrachloride pentahydrate was obtained from Mallinckrodt Chemical Co. (St. Louis, Mo.).

Representative Procedure for the Polymerization of Fish Oil.

All of the fish oil polymerization reactions were performed on a 2.0 g scale. The amount of each reactant used is reported as a weight percent. To 1.3 g (65%) of fish oil in a 2 dram vial (17×60 mm) was added 0.4 g (20%) of divinylbenzene and 0.2 g (10%) of norbornadiene. The reaction mixture was then stirred to ensure homogeneity prior to the addition of 0.1 g (5%) of BF₃.OEt₂. The resulting solution was vigorously stirred and sealed under a nitrogen atmosphere. The reaction was allowed to proceed at 25° C. for 1 d, and then 60° C. for 1 d, and finally 110° C. for 3 d to produce 1.94 g (97% yield) of a very hard, shiny, pressure-resistant, dark-brown polymer.

Representative Procedure for the Polymerization of Conjugated Fish Oil.

All of the conjugated fish oil polymerization reactions were performed on a 2.0 g scale. The amount of each reactant used is reported as a weight percent. To 1.78 g (89%) of conjugated fish oil in a 2 dram vial (17×60 mm) was added 0.1 g (5%) of divinylbenzene and 0.1 g (5%) of norbornadiene. The reaction mixture was then stirred to ensure homogeneity prior to the addition of 0.02 g (1%) of BF₃.OEt₂. The resulting solution was vigorously stirred and sealed under a nitrogen atmosphere. The reaction was allowed to proceed at 25° C. for 1 d, and then 60° C. for 1 d, and finally 110° C. for 2 d to produce 1.92 g (96% yield) of a hard, shiny, dark-brown polymer that gives slightly to applied pressure.

Extractions of Fish Oil Polymers.

A 2 g fish oil polymer sample was extracted with 100 mL of refluxing solvent (methylene chloride) using soxhlet extraction in air for 24-48 h. After extraction, the resulting solution was concentrated, and the soluble extract was isolated for further characterization. The remaining insoluble polymeric material was dried under vacuum prior to further analysis.

Work-up Procedure for NMP and DMF Extracts of Fish Oil Polymers.

The 100 mL extracts were added to a mixture of saturated ammonium chloride (100 mL) and distilled water (50 mL) in a separatory funnel. The resulting solution was extracted 3 times with 70 mL of diethyl ether. The ether layers were combined and dried over MgSO₄ (anh.). Concentration of the dried ether solution produced a mixture of the desired extract and residual amounts of NMP or DMF. The extract was then purified by flash chromatography on a silica gel column using a 5:1 hexanes/ethyl acetate eluent system to produce a light-yellow oil.

Representative Procedure for the Polymerization of Epoxidized Fish Oil.

To 1.96 g (98%) of 100% epoxidized Norway fish oil ethyl ester in a 2 dram vial (17×60 mm) was added 0.04 g of BF₃.OEt₂ at 0° C. The reaction was stirred and then sealed under an air atmosphere at 0° C. for 2 h. The reaction mixture was then allowed to slowly warm to room temperature and proceed at 25° C. for 22 h. The product was slurried in 125 mL of CH₂Cl₂, and the resulting slurry was concentrated to approximately 10-15 mL. Hexanes (200 mL) were added to the resulting dispersion with vigorous stirring for 1 h. The hexanes solution was cooled at 0° C. for 30 min. to produce 1.22 g (61% yield) of a white powdery solid.

Ruthenium-catalyzed Acyclic Diene Metathesis of Pronova Fish Oil.

The ruthenium catalyst (Cy₃P)₂Cl₂Ru═CHPh (0.002 g, 0.002 mmol, 0.1 mol %) is placed in a 50 mL Schlenk flask under argon atmosphere in a glove box. The Schlenk flask is then connected to a vacuum line, and the fish oil (1.742 g, 1.74 mmol) is added to the catalyst via a gas tight syringe under argon atmosphere. The reaction mixture is then placed under vacuum or argon atmosphere and stirred for 24 h at 55° C. The reactions are quenched by adding 18 mL of dichloromethane and 0.2 mL of ethyl vinyl ether.

A) Polymerization of Fish Oil

The Norway fish oil ethyl ester readily polymerized with divinylbenzene in the presence of BF₃.OEt₂ to form dark-colored thermoset polymers ranging from plastics to soft, rubbery materials (Table 13). The polymerization reactions were allowed to go for 3 days at 110° C. The mass recoveries for all of the BF₃.OEt₂-catalyzed polymerization reactions were nearly quantitative. When a catalyst load of 5 weight percent was used, 10% divinylbenzene produced a soft thermoset (entry 2). As the amount of divinylbenzene was increased, the thermoset products became harder and shinier in appearance (entries 3-6). If the amount of BF₃.OEt₂ used in the reaction was reduced to 1-2 weight percent, 15% divinylbenzene produced a soft, solid thermoset (entries 9, 15). The fish oil-divinylbenzene thermosets had physical properties similar to the soybean oil-divinylbenzene thermosets prepared by the same BF₃.OEt₂-catalyzed reactions.

Two additives may be polymerized with the Norway fish oil ethyl ester at the same time using this chemistry. The BF₃.OEt₂-catalyzed reaction between the Norway fish oil ethyl ester, divinylbenzene and norbornadiene produced dark-colored plastics that were shinier and much harder than the fish oil-divinylbenzene polymers (Table 14). These reactions were run at room temperature for 1 day, 60° C. for 1 day, and then 110° C. for 3 days because norbornadiene is quite volatile and the reactions were violently exothermic when they were immediately heated. The presence of 5% by weight norbornadiene and 10% by weight divinylbenzene produced solid polymeric materials (entries 3, 9, 15). Smaller amounts of additives resulted in the production of viscous, dark-colored oils. The hardest materials were produced from reactions with 10 weight percent norbornadiene and 20 weight percent divinylbenzene (entries 6, 12, 18). The fish oil-norbornadiene-divinylbenzene system generally produced harder and shinier thermosets than the soybean oil-norbornadiene-divinylbenzene system.

Dicyclopentadiene and divinylbenzene were simultaneously copolymerized with the Norway fish oil ethyl ester using BF₃.OEt₂ to produce dark-colored thermosets (Table 15). The hardest plastics were prepared using 10% by weight dicyclopentadiene and 20% by weight divinylbenzene (entries 6, 12, 18). The fish oil-dicyclopentadiene-divinylbenzene thermosets were more dense than the fish oil-norbornadiene-divinylbenzene materials, but less dense than the corresponding soybean oil polymers.

Many other additives were examined in the BF₃.OEt₂-catalyzed polymerization reactions of the Norway fish oil ethyl ester (Table 16). The copolymerization of furfural, divinylbenzene, and the Norway fish oil ethyl ester produced very hard, dark-colored thermosets in excellent overall mass recoveries (entries 2-4). Interestingly, ρ-benzoquinone and divinylbenzene polymerized with the Norway fish oil ethyl ester violently at room temperature to produce dark-colored polymeric materials (entries 7-10). The most interesting material was produced when 20% divinylbenzene and 10% ρ-mentha-1,8-diene were polymerized with the Norway fish oil ethyl ester using 5 weight percent BF₃.OEt₂ (entry 11). This reaction produced a very hard, shiny, dark-brown thermoset after being heated at 60° C. for one day and then 110° C. for 2 days. Furan and divinylbenzene were copolymerized with the Norway fish oil ethyl ester to produce very firm, dark-colored thermosets that were resistant to applied pressure (entries 13, 14).

The Capelin fish oil from Iceland was also polymerized using the BF₃.OEt₂ catalyst (Table 17). The lower number of double bonds in the Capelin fish oil is clearly evident in its polymerization chemistry. The Capelin fish oil reactions generally produced softer thermosets than the Norway fish oil ethyl ester reactions. However, reasonably hard thermosets were prepared from the Capelin fish oil using BF₃.OEt₂. The reaction of 30% by weight divinylbenzene with the Capelin fish oil produced a hard plastic when 1 or 5% by weight BF₃.OEt₂ was used (entries 2, 3). The copolymerization of 20% dicyclopentadiene and 10% divinylbenzene with the Capelin fish oil produced a dark-colored thermoset (entry 4). The copolymerization of the Capelin fish oil, 10% divinylbenzene, and 20% norbornadiene produced a homogeneous, dark-colored plastic that resisted applied pressure (entries 5, 6).

B) Polymerization of Conjugated Fish Oil

The 80-90% conjugation of fish oil using [RhCl(PPh₃)₃],(ρ-CH₃C₆H₄)₃P, and SnCl₂.2H₂O in ethanol solvent is described above.

The conjugated Norway fish oil ethyl ester reacted with divinylbenzene in the presence of BF₃.OEt₂ to produce very hard, shiny, dark-colored thermosets (Table 18). The conjugated Norway fish oil ethyl ester is much more reactive in this chemistry than the native Norway fish oil ethyl ester. While the native Norway fish oil ethyl ester reactions were run for 3 days at 110° C. (Table 13), the conjugated Norway fish oil reactions were run at 60° C. for 1 day and then 110° C. for 2 days to avoid violent, exothermic reactions. A hard, shiny, pressure-resistant, dark-colored thermoset was produced using only 5% by weight divinylbenzene, 94% conjugated fish oil, and 1% BF₃.OEt₂ (entry 13). The product thermosets became shinier and more rigid as the amount of divinylbenzene additive was increased from 5-30% (entries 1-6). Extremely hard, light weight plastics were produced by polymerizing the conjugated Norway fish oil with 30% by weight divinylbenzene using 1, 2 or 5% BF₃.OEt₂ (entries 6, 12, 18). The conjugated fish oil-divinylbenzene thermosets were shinier and more rigid than the conjugated soybean oil-divinylbenzene copolymers. When small catalyst loads and low divinylbenzene concentrations were used, the conjugated fish oil polymerizations produced harder materials than the corresponding reactions of conjugated soybean oil.

Divinylbenzene and norbornadiene were simultaneously copolymerized with the conjugated Norway fish oil ethyl ester using BF₃.OEt₂ to produce light weight, extremely hard, dark-brown plastics (Table 19). As seen previously with the divinylbenzene system, the conjugated Norway fish oil ethyl ester seems to be much more reactive than the native Norway fish oil ethyl ester in its copolymerization with norbornadiene and divinylbenzene. While the reaction of the Norway fish oil ethyl ester with 5% norbornadiene, 5% divinylbenzene and 5% BF₃.OEt₂ produced only a soft, dark-colored gel (Table 14, entry 1), the same reaction with the conjugated Norway fish oil ethyl ester produced a shiny, hard, dark-colored thermoset in a 96% overall mass recovery (Table 19, entry 1). Very hard thermosets were prepared using 10% by weight norbornadiene, 20% by weight divinylbenzene, and 1, 2, or 5% BF₃.OEt₂ (entries 6, 12, 18). Interestingly, the rigidity of the conjugated fish oil-divinylbenzene-norbornadiene thermosets did not suffer as the catalyst load was decreased (entries 3, 9, 15). This system produced the hardest materials generated in this study.

The reaction of 85% by weight Norway fish oil ethyl ester, 5% dicyclopentadiene, 5% divinylbenzene, and 5% BF₃.OEt₂ produced a viscous oil (Table 15, entry 1), but the same reaction produced a hard, shiny, pressure-resistant, dark-colored thermoset when the conjugated Norway fish oil ethyl ester was used (Table 20, entry 3). The polymers appeared to become shinier and firmer as the amounts of additives were increased (entries 1-6). When the amounts of dicyclopentadiene and divinylbenzene were held constant, the appearance of the polymeric products did not seem to change as the catalyst load was decreased (entries 3, 9, 15).

The conjugated Norway fish oil ethyl ester produced a soft, dark-colored rubber when it was reacted with 5% by weight dicyclopentadiene and 5% BF₃.OEt₂. Increasing the amounts of dicyclopentadiene used in these reactions improved the rigidity of the polymers. A soft, rubbery copolymer was produced by reacting the conjugated Norway fish oil ethyl ester with 10% by weight norbornadiene and 5% BF₃.OEt₂. The reactions between the conjugated Norway fish oil ethyl ester and dicyclopentadiene or norbornadiene were all run at 110° C. for 4 days.

A series of other additives were examined in the BF₃.OEt₂-catalyzed copolymerization reactions of the conjugated Norway fish oil ethyl ester. One very promising system is the copolymerization of conjugated Norway fish oil ethyl ester, divinylbenzene, and ρ-mentha-1,8-diene to produce very hard, light-weight plastics.

The conjugated Capelin fish oil was also more reactive in the BF₃.OEt₂-catalyzed polymerization reactions than the nonconjugated oil. Thermosets prepared from the conjugated Capelin fish oil and divinylbenzene were harder than the materials produced by the same reactions with the native Capelin fish oil. The conjugated Capelin fish oil-norbornadiene-divinylbenzene copolymers were not as hard as those made with the conjugated Norway fish oil ethyl ester, but they are more rigid than the copolymers made from the native Capelin fish oil.

C) Effect of Various Catalysts

AlCl₃, SnCl₄.5H₂O, and ZnCl₂ all produced a heterogeneous mixture of a few solids surrounded by viscous oils when reacted with 65% by weight Norway fish oil ethyl ester and 30% divinylbenzene (Table 21, entries 2-4). The same reaction catalyzed by FeCl₃ produced a soft, cloudy solid with dark-colored layers on the top and bottom surfaces (entry 5). Titanium tetrachloride produced some hard, dark-colored solids that were surrounded by a dark-colored, viscous oil (entry 6). A soft, porous, dark-brown solid was produced when 5% by weight concentrated sulfuric acid was reacted with 65% Norway fish oil ethyl ester and 30% divinylbenzene (entry 7). When anhydrous SnCl₄ reacted with the Norway fish oil ethyl ester and divinylbenzene, a hard, brittle, dark-colored solid was produced that appeared to have a darker layer on the bottom (entry 8). A solution of BCl₃ in CH₂Cl₂ (1 M) produced a dark-brown, free-flowing oil when reacted with the Norway fish oil ethyl ester and divinylbenzene.

D) Thermal Analysis of the Bulk Fish Oil Thermosets

Thermogravimetric analysis (TGA) data was obtained for many of the fish oil copolymers (Table 22). The temperatures corresponding to 10% polymer weight loss were obtained under both nitrogen and air atmospheres for each polymer system. The percentage of polymer mass remaining at 400° C. was also noted for each thermoset. Most of the polymers lose 10% of their mass between 250-300° C. However, after the initial loss of 10-15% of polymer mass, the remaining polymeric material appears to be thermally stable up to 375-400° C., when decomposition begins. Many of the thermosets still possess 75-80% of their initial mass at 400° C. Most of the fish oil thermosets have equal thermal stability in nitrogen and in air. Interestingly, there appears to be little correlation between rigidity and thermal stability in these materials. The thermal stability of the polymers does not seem to be a function of the catalyst load used in the reaction. The thermal stability of the fish oil copolymers is comparable to polystyrene which loses 10% of its mass at 343° C.

Differential scanning calorimetry (DSC) was also used to examine the thermal properties of the fish oil thermosets. In addition, Soxhlet extraction has indicated that these materials are highly crosslinked polymers that may continue to crosslink as they are heated during DSC analysis. As seen in the TGA data, decomposition was also noted in the DSC graphs between 400-500° C.

E) Solubility of the Fish Oil Thermosets

A complete solubility study was performed using the 65% conjugated Norway fish oil ethyl ester, 20% norbornadiene, 10% divinylbenzene, and 5% BF₃.OEt₂ copolymer (Table 23). Soxhlet extraction was used to determine the amount of soluble and insoluble polymeric material for each solvent. All of the extractions were allowed to proceed for 24 hours, except for the tetrahydrofuran extraction, which required 48 hours to thoroughly remove the soluble material from the polymer sample. Methylene chloride (CH₂Cl₂) and tetrahydrofuran (THF) both extracted approximately 20% of soluble material from the fish oil copolymer. When the polymer was prepared as a thin film, CH₂Cl₂ was only able to extract 13% of soluble material. N,N-Dimethylformamide (DMF) extracted 15% of soluble, dark-colored, viscous oil from the fish oil thermoset. The only other solvent capable of extracting a significant amount of material from the copolymer was 1-methyl-2-pyrrolidinone (NMP). Acetone was only able to extract 7% of soluble material from the bulk copolymer. The fish oil thermoset showed no solubility in water, methanol or 0.02 M KOH in ethanol. Interestingly, the fish oil copolymer was broken into small pieces by methanesulfonic acid and concentrated sulfuric acid, but the overall mass recoveries of copolymer were high.

After performing the initial solubility study on the conjugated Norway fish oil ethyl ester-norbornadiene-divinylbenzene copolymer, we extracted 10 other Norway fish oil ethyl ester thermosets using CH₂Cl₂, THF, and DMF (Table 24). The solubility data obtained from these extractions clearly show that tetrahydrofuran is the most effective solvent for removing the soluble material from the fish oil thermosets. After extracting the dark-colored fish oil copolymers with THF, the bulk copolymer broke down and insoluble orange flakes were left behind. In most cases, the CH₂Cl₂ and DMF removed approximately the same amount of soluble material from a given polymer.

When conjugated and native Norway fish oil ethyl ester thermosets having the same composition are compared, the conjugated Norway fish oil ethyl ester copolymer contains a smaller amount of soluble material (Table 24, entries 1 and 2). Decreasing the amount of divinylbenzene from 30 to 10% by weight in the conjugated Norway fish oil ethyl ester-divinylbenzene-BF₃.OEt₂ polymer system results in only small solubility differences in CH₂Cl₂ and tetrahydrofuran, but the solubility in DMF increases from 10 to 24% (entries 2, 3). Native Norway fish oil ethyl ester polymers containing dicyclopentadiene have more soluble material than those containing norbornadiene (entries 5, 9). This relationship does not hold true for the conjugated fish oil polymers, which seem to have similar amounts of soluble material (entries 6, 10).

Interestingly, the percentages of insoluble materials obtained from the CH₂Cl₂ extractions of the Norway fish oil ethyl ester thermosets (Table 24) correspond well with the percentages of bulk fish oil polymer remaining at 400° C. during TGA analysis (Table 22). For example, entry 6 in Table 18 for the 65% conjugated Norway fish oil ethyl ester, 20% norbornadiene, 10% divinylbenzene, and 5% BF₃.OEt₂ copolymer had 79% CH₂Cl₂ insolubles, and the same bulk polymer system in Table 16 (entry 6) retained 79% of its mass at 400° C. under a nitrogen atmosphere. This correlation holds true for many of the fish oil thermosets. The CH₂Cl₂ soluble material is apparently responsible for the initial 10-15% weight loss seen in the TGA data for the fish oil thermosets. Once the CH₂Cl₂ soluble material has been volatilized, the remaining polymer material is still reasonably thermally stable at 400° C.

A similar solubility study was performed on the Capelin fish oil thermosets using CH₂Cl₂ solvent. In general, the Capelin fish oil copolymers contained more soluble material than the Norway fish oil ethyl ester copolymers.

F) The Soluble Material from the Fish Oil Thermosets

The extractable materials from the fish oil thermosets are dark-colored oils. The ¹H and ¹³C NMR analysis of these soluble oils indicates that they are in the triglyceride form. Free fatty acids were not detected in the soluble oil by IR spectroscopy, but the carbonyl stretch of the esters was detected. The fatty acid chains of the soluble triglyceride contain very few double bonds. The ¹H NMR spectra show very few vinylic hydrogens (delta 5.2-5.5 ppm), and the ¹³C NMR spectra show a limited number of sp² carbons in the alkene region (delta 120-140 ppm). There are also no signs of unreacted additives in the ¹H or ¹³C NMR spectra of the soluble materials. Attempts to determine the molecular weight of the soluble material by gel permeation chromatography (GPC) and by mass spectrometry have not been successful. Multiple angle laser light scattering (MALLS) and calibrated polystyrene standards were both used in attempting to obtain a molecular weight for the soluble material by GPC. Evidently, the molecular weight of the soluble material is high enough to reduce its volatility to the point where GC-MS analysis becomes difficult.

G) The Insoluble Material from the Fish Oil Thermosets

The insoluble materials produced by the extraction of the fish oil thermosets with CH₂Cl₂ and THF are very interesting materials. In most cases, these insoluble materials account for approximately 75% of the total mass of the bulk fish oil thermosets. The CH₂Cl₂ and THF insolubles are dark-brown and orange-colored flakes, respectively. The THF insoluble materials resulting from the extraction of the 65% conjugated Norway fish oil ethyl ester, 30% dicyclopentadiene, and 5% BF₃.OEt₂ copolymer were examined using solid state, magic angle spinning (MAS) 13C NMR spectroscopy. The spectrum clearly showed the presence of ester carbonyls (delta 165-175 ppm) and carbon-carbon double bonds (delta 120-140 ppm). The presence of carbon-carbon double bonds in the insoluble materials could potentially make them processable through further crosslinking reactions. The THF insoluble materials from the 65% conjugated Norway fish oil ethyl ester, 30% divinylbenzene, and 5% BF₃.OEt₂ copolymer were also examined by solid state, MAS ¹³C NMR. This data also confirms the presence of ester carbonyls and carbon-carbon double bonds, although the double bonds present are largely due to the incorporation of divinylbenzene in the copolymer.

Thermogravimetric analysis (TGA) data was obtained for the CH₂Cl₂ and THF insoluble materials obtained from the extractions of the fish oil thermosets (Table 25). In general, the insoluble materials show remarkable thermal stability. Most of the systems examined lost 10% of their polymer mass at temperatures near 420° C. The thermal stability of the insoluble materials is not directly related to the percentage of organic additives in the bulk polymer. For instance, the CH₂Cl₂ and THF insoluble materials from the 94% conjugated Norway fish oil ethyl ester, 5% divinylbenzene, and 1% BF₃.OEt₂ copolymer (entry 4) are more thermally stable than the CH₂Cl₂ and THF insoluble materials resulting from the 65% conjugated Norway fish oil ethyl ester, 20% norbornadiene, 10% divinylbenzene, and 5% BF₃.OEt₂ copolymer (entry 6). All of the insoluble materials appear to be more thermally stable in nitrogen than in air. The highest thermal stability recorded for the insoluble materials was a 10% weight loss at 456° C. under a nitrogen atmosphere for the THF insoluble materials from the 65% Norway fish oil ethyl ester, 30% divinylbenzene, and 5% BF₃.OEt₂ copolymer (entry 1). The CH₂Cl₂ insoluble materials obtained from the extractions of the Capelin fish oil thermosets are less thermally stable than the corresponding materials obtained from the Norway fish oil ethyl ester copolymers.

Soxhlet extraction of the insoluble materials resulting from the extractions of the fish oil thermosets produced the same results seen for the bulk fish oil thermosets. The insoluble materials appear to be highly crosslinked materials that do not possess thermal phase transitions. The results indicate further crosslinking may be taking place as the temperature is ramped up during DSC analysis. The decomposition of the insoluble materials is also detected at temperatures above 450° C.

H) Polymerization of Epoxidized Norway Fish Oil Ethyl Ester

The complete epoxidation of fish oil using the Sharpless method has been described above. The polymerization of 95-98% by weight epoxidized fish oil with catalytic amounts of BF₃.OEt₂ produced light-colored, powdery polyethers that were relatively insoluble. Attempts to copolymerize the epoxidized Norway fish oil ethyl ester with divinylbenzene, dicyclopentadiene, and norbornadiene produced heterogeneous products. The epoxidized Norway fish oil ethyl ester was also copolymerized with THF in the presence of BF₃.OEt₂ to produce crumbly, light-brown solids.

The solubility of the polymers prepared from the copolymerization of the epoxidized Norway fish oil ethyl ester and tetrahydrofuran using BF₃.OEt₂ was examined. These materials were insoluble in methanol, acetone, DMF, THF, diethyl ether, dimethyl sulfoxide, CHCl₃, and CH₂Cl₂.

Thermogravimetric analysis (TGA) data was obtained for some of the polymers made from the epoxidized Norway fish oil ethyl ester. Interestingly, copolymerization with THF did not significantly change the thermal stability of the polymers. The polymer prepared using 98% epoxidized Norway fish oil ethyl ester and 2% BF₃.OEt₂ underwent a 10% weight loss at 215° C. under a nitrogen atmosphere, and the 75% epoxidized Norway fish oil ethyl ester, 21% tetrahydrofuran, 4% BF₃ .OEt₂ polymer lost 10% of its mass at 193° C. under a nitrogen atmosphere.

I) Further Characterizations of Fish Oil Plastics: Structure, Thermal, and Dynamic Mechanical Properties

Additional DSC thermographs of the samples were recorded over the temperature range from 30° C. to 300° C., using a Perkin-Elmer Pyris DSC-7 purged with nitrogen. Runs were conducted at a heating rate of 20° C./min. Indium was used as a standard for temperature calibration. The sample weight was about 10 mg.

Dynamic mechanical data were obtained using a three point bending mode in a dynamic mechanical analyzer Pyris DMA-7e of Perkin-Elmer Ltd. Thin sheet specimens of 1 mm thickness and 2.5 mm depth were used, and the span width was 10 mm. The measurements were carried out at a heating rate of 3° C./min at 1 Hz.

A Perkin-Elmer pyris-7 thermogravimeter was used to measure the weight losses of the polymeric materials. The samples were heated from room temperature to 900° C. at a heating rate of 20° C./min purged with air.

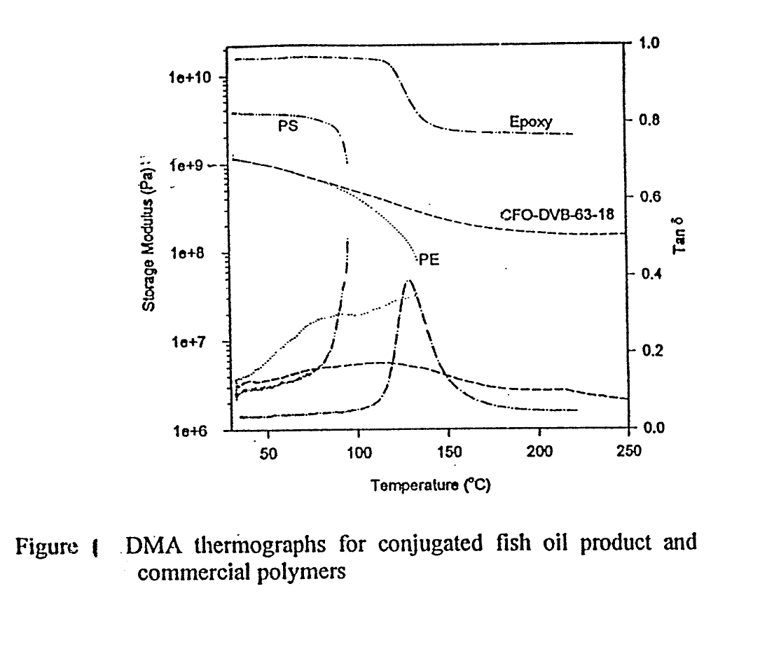

FIG. 1 gives the comparison between a typical fish oil product and some commercial polymers. The reference materials are Perkin-Elmer epoxy, polystyrene (Grd#210, Huntsman Corp.) and polyethylene (Paxon 3205, Viskase Corp.) The glass transition temperature of the conjugated fish oil material is between 110±10° C., slightly above that of the polystyrene but lower than that of the epoxy used in this study. The modulus at room temperature is about 1×10⁹ Pa, which is on the same order of magnitude as polyethylene. Due to their thermosetting nature, the fish oil plastics have significantly better properties at higher temperatures (T>200° C.) than those of the commercial polymers tested.

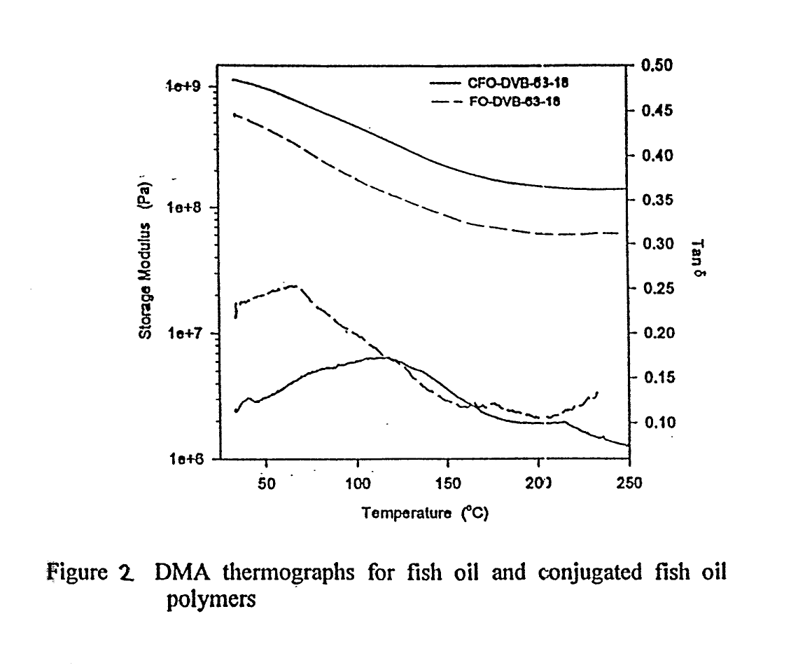

FIG. 2 shows the temperature dependence of storage modulus and damping tan gamma of the plastics based on native fish oil and its conjugated version, respectively. The nomenclature for the samples is as follows: FO and CFO represent fish oil and conjugated fish oil; DVB, NBD, and DCP denote divinylbenzene, norbornadiene and dicyclopentadiene, respectively. For example, CFO-DVB-DCP-62-18 corresponds to the sample based on conjugated fish oil with the comonomers of divinylbenzene and dicyclopentadiene; the weight percent of the oil is 62% and the mole percent is 18%. In the system with two comonomers, the mole ratio of DVB to NBD or DCP is 6. The modulus of conjugated fish oil plastics is evidently higher than that of the native oil counterparts over the whole temperature range. Appearance of an elastic plateau at high temperatures indicates the existence of good crosslinking structure in these materials. Generally a broad transition temperature range is observed from the damping behavior. Glass transition temperature, the maximum damping peak, of conjugated fish oil products is about 30° C. ˜50° C. higher than that of the native fish oil product. The glass transition temperatures of the commercial polymers ranged from 50° to 130° C.

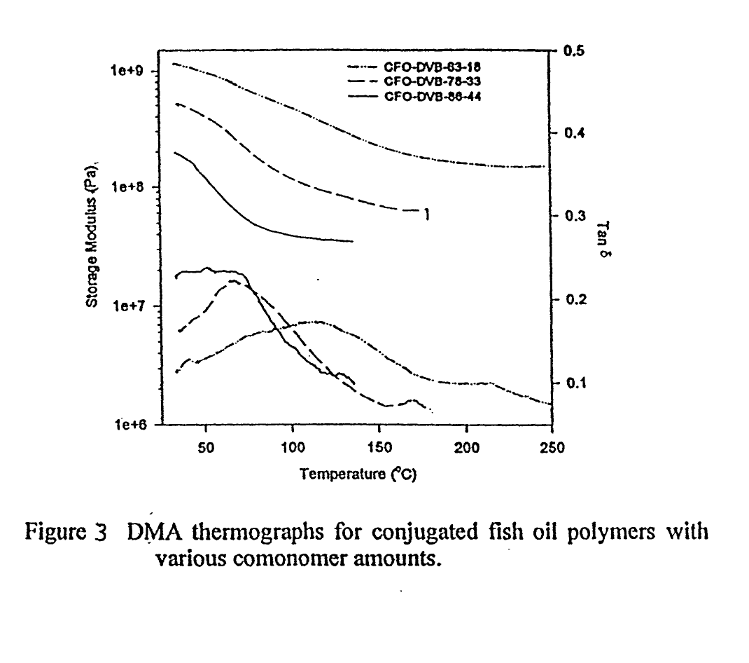

FIG. 3 shows the DMA thermographs of conjugated fish oil samples with various amounts of comonomers. Evidently, the samples having more comonomers in their compositions display better thermal mechanical properties, i.e., high modulus and glass transition temperatures. The crosslinking structure is also better when more comonomers are employed.

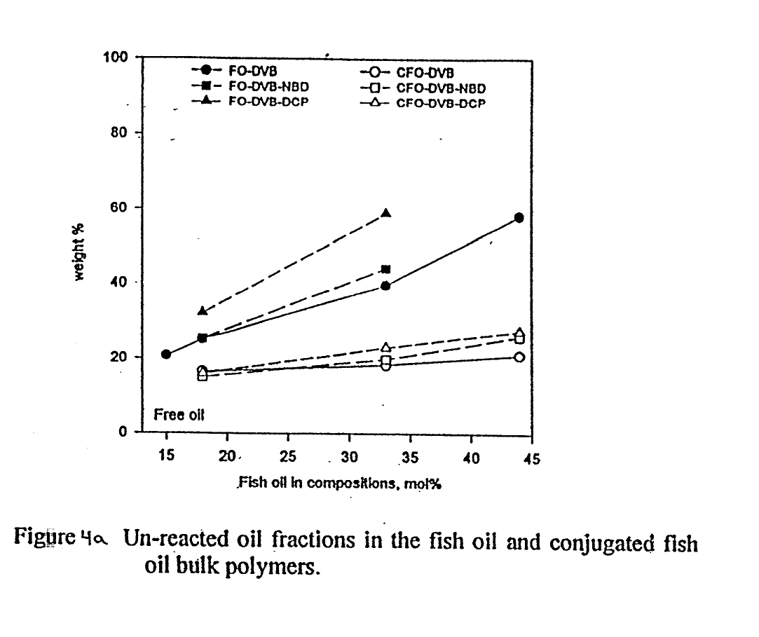

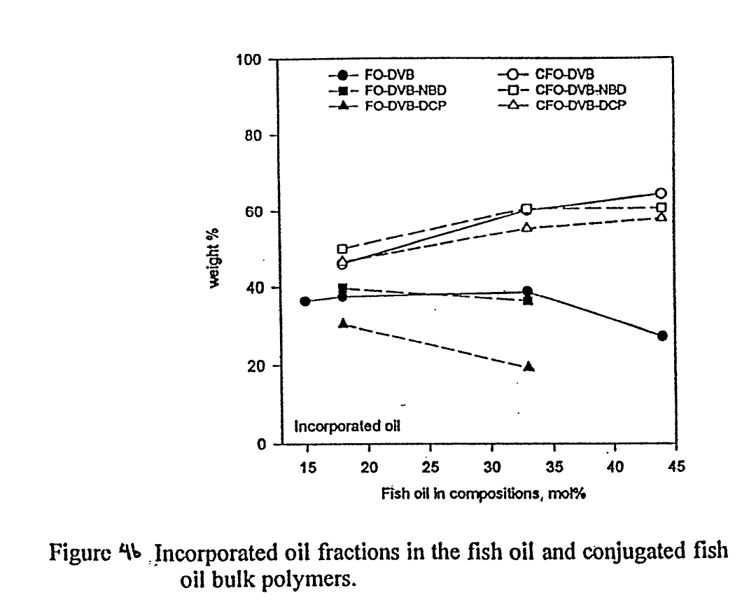

The variations in the properties are mainly attributed to the structures of the thermosetting polymers. FIG. 4a shows that more free oil molecules exist in fish oil products than in conjugated fish oil counterparts. These free molecules likely have a plasticizing effect. The number of free oil molecules may decrease if more comonomers are added into the reaction mixtures.

The number of incorporated oil molecules are also closely related to their compositions, as shown in FIG. 4b. Compared with native oil, conjugated fish oil can be efficiently consumed in the Lewis-acid catalysis reactions. These incorporated oil molecules typically contribute to about 20 mol % or less of the crosslink structure frameworks.

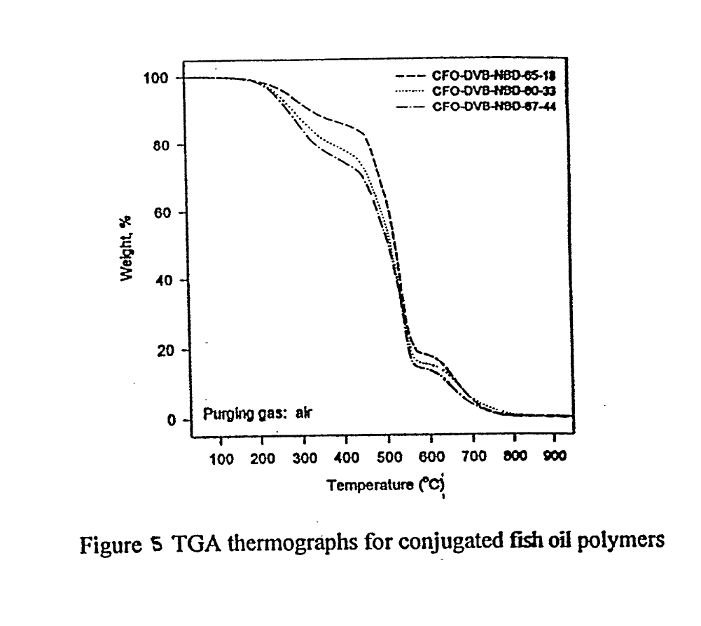

FIG. 5 shows the TGA thermographs of conjugated fish oil products purged in air. Generally, three distinct temperature regions are observed, i.e., 200° C. ˜400° C., 400° C.˜560° C., and 560° C.˜800° C. It has been found that the first temperature region is mainly the evaporation of un-reacted free oil molecules in the bulk; the second, the decomposition of the crosslinking structure, and; the last step is the formation of carbons and subsequent oxidation of the residual carbons.

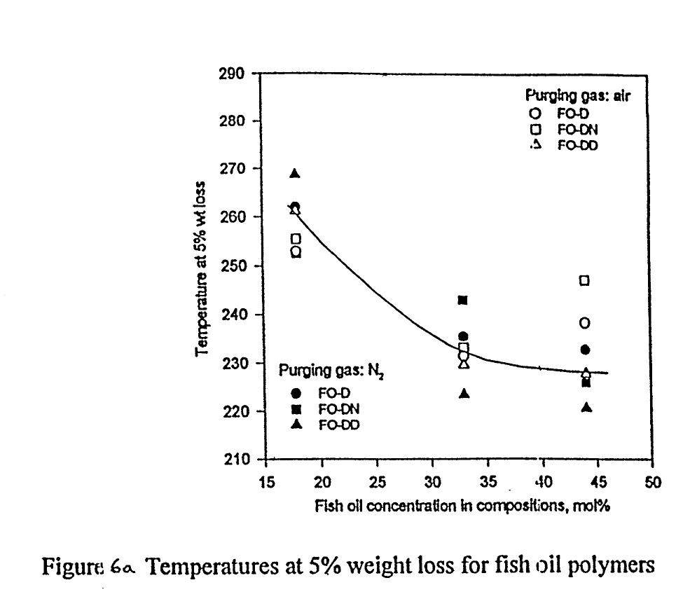

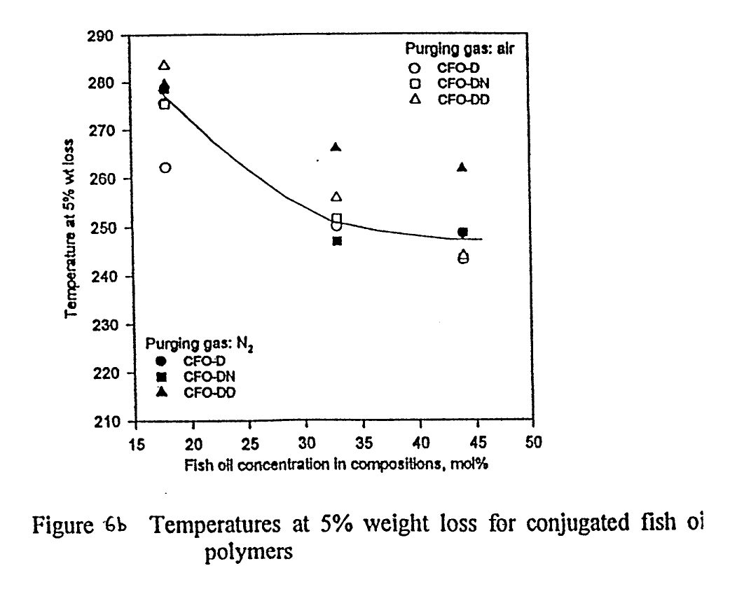

The unreacted free oil substances play a key role in the thermal stability of these materials. The temperature at 5% weight loss for all the materials are shown in FIGS. 6a and 6b. Generally, the decomposition temperatures of conjugated fish oil polymers are higher than those of their fish oil counterparts. This is consistent with the results of unreacted free oil weight presence. The decreased presence of unreacted free oil molecules gives the conjugated fish oil plastics improved mechanical properties and thermal stability.

TABLE 13
Polymerization of Norway fish oil ethyl ester and Divinylbenzene Using Boron Trffluoride Etherate

| | % Fish Oil | % BF₃·OEt₂ | % divinylbenzene | | % |
|---|---|---|---|---|---|
| Entry | (weight %) | (weight %) | (weight %) | Observations | Yield |
| 1 | 90 | 5 | 5 | very viscous, flowing, dark-colored oil; did not set-up | (—) |
| 2 | 85 | 5 | 10 | soft, rubbery, tacky, dark-colored solid; gives freely to | 98 |
| | | | | pressure | |
| 3 | 80 | 5 | 15 | hard, rubbery, dark-colored solid, gives slightly to pressure | 99 |
| 4 | 75 | 5 | 20 | hard, shiny, dark-colored solid; gives slightly to pressure | 99 |
| 5 | 70 | 5 | 25 | very hard, shiny, dark-colored solid; resistant to pressure | 97 |
| 6 | 65 | 5 | 30 | very hard, shiny, dark-colored solid; resistant to pressure | 99 |
| 7 | 93 | 2 | 5 | Viscous, dark-colored liquid; did not set up | |
| 8 | 88 | 2 | 10 | very soft, sticky, fragile, dark-colored solid; breaks apart | 97 |
| | | | | easily | |
| 9 | 83 | 2 | 15 | Rubbery, firm, dark-colored solid, gives to pressure | 99 |
| 10 | 78 | 2 | 20 | hard, shiny, dark-colored solid; gives slightly to pressure | 99 |
| 11 | 73 | 2 | 25 | hard, shiny, dark-colored solid; resistant to pressure | 99 |
| 12 | 68 | 2 | 30 | very hard, shiny, dark-colored solid; resistant to pressure | 99 |
| 13 | 94 | 1 | 5 | dark-colored free-flowing liquid, not viscous | (—) |
| 14 | 89 | 1 | 10 | dark-colored free-flowing liquid, not viscous | (—) |
| 15 | 84 | 1 | 15 | soft, rubbery, dark-colored solid; gives freely to pressure | 99 |
| 16 | 79 | 1 | 20 | hard, dull-looking, dark-colored solid; gives slightly to | 99 |
| | | | | pressure | |
| 17 | 74 | 1 | 25 | very hard, shiny, dark-colored solid; resistant to pressure | 99 |
| 18 | 69 | 1 | 30 | very hard, shiny, dark-colored solid; resistant to pressure | 99 |

TABLE 14
Polymerization of Norway fish oil ethyl ester and Divinylbenzene, and Norbornadiene Using Boron Trifluoride Etherate

| | | | | | | |
|---|---|---|---|---|---|---|
| | | | % | | | |
| | % Fish Oil | % BF₃·OEt₂ | norbornadiene | % divinylbenzene | | % |
| Entry | (weight %) | (weight %) | (weight %) | (weight %) | Observations | Yield |

| | | | | | | |
|---|---|---|---|---|---|---|
| 1 | 85 | 5 | 5 | 5 | sticky, soft, dark-colored gel; difficult to remove | 77 |
| | | | | | from vial | |
| 2 | 80 | 5 | 10 | 5 | rubbery, tacky, shiny, dark-colored solid; gives to | 97 |
| | | | | | pressure | |
| 3 | 80 | 5 | 5 | 10 | firm, tacky, dark-colored rubbery solid; gives slightly | 99 |
| | | | | | to pressure | |
| 4 | 75 | 5 | 10 | 10 | hard, shiny, dark-colored solid; gives slightly to | 96 |
| | | | | | pressure | |
| 5 | 65 | 5 | 20 | 10 | very hard, shiny, dark-colored solid; resistant to | 96 |
| | | | | | pressure | |
| 6 | 65 | 5 | 10 | 20 | very hard, shiny, dark-colored solid; resistant to | 97 |
| | | | | | pressure | |
| 7 | 88 | 2 | 5 | 5 | viscous, dark-colored liquid, did not set-up | |
| 8 | 83 | 2 | 10 | 5 | very viscous, dark-colored liquid, flows slowly | |
| 9 | 83 | 2 | 5 | 10 | very soft, tacky, dark-colored rubbery solid; gives to | 97 |
| | | | | | pressure | |
| 10 | 78 | 2 | 10 | 10 | rubbery, dull-looking, dark-colored solid; gives to | 95 |
| | | | | | pressure | |
| 11 | 68 | 2 | 20 | 10 | hard, shiny, dark-colored solid; gives a little to | 94 |
| | | | | | pressure | |
| 12 | 68 | 2 | 10 | 20 | very hard, shiny, dark-colored solid; resistant to | 99 |
| | | | | | pressure | |
| 13 | 89 | 1 | 5 | 5 | dark-colored liquid, free-flowing | |
| 14 | 84 | 1 | 10 | 5 | dark-colored liquid, free-flowing | |
| 15 | 84 | 1 | 5 | 10 | soft, rubbery, fragile, dark-colored solid; gives to | 95 |
| | | | | | pressure | |
| 16 | 79 | 1 | 10 | 10 | soft, tacky, fragile, dark-colored solid; gives to | 88 |
| | | | | | pressure | |
| 17 | 69 | 1 | 20 | 10 | very hard, shiny, dark-colored solid; gives very little | 99 |
| | | | | | to pressure | |
| 18 | 69 | 1 | 10 | 20 | very hard, shiny, dark-colored solid; resistant to | 99 |
| | | | | | pressure | |

TABLE 15
Polymerization of Norway fish oil ethyl ester, Divinylbenzene and Dicyclopentadiene Using Boron

| | | | % | % | | |
|---|---|---|---|---|---|---|
| | % Fish Oil | % BF₃·OEt₂ | Norbornadiene | Divinylbenzene | | % |
| Entry | (weight %) | (weight %) | (weight %) | (weight %) | Observations | Yield |
| 1 | 85 | 5 | 5 | 5 | sticky, thick, dark-colored liquid | (—) |
| 2 | 80 | 5 | 10 | 5 | very soft, tacky, dark-colored solid | 86 |
| 3 | 80 | 5 | 5 | 10 | rubbery, dull-looking, dark-colored | 98 |
| | | | | | solid; gives to pressure | |
| 4 | 75 | 5 | 10 | 10 | rubbery, dull-looking, dark-colored | 96 |
| | | | | | solid; gives to pressure | |
| 5 | 65 | 5 | 20 | 10 | shiny, dark-colored solid; gives a little | 93 |
| | | | | | to pressure | |
| 6 | 65 | 5 | 10 | 20 | very hard, shiny, dark-colored solid; 98 | |
| | | | | | pressure resistant | |
| 7 | 88 | 2 | 5 | 5 | free-flowing, slightly viscous, dark- | |
| | | | | | colored liquid | |
| 8 | 83 | 2 | 10 | 5 | free-flowing, viscous, dark-colored | |
| | | | | | liquid | |
| 9 | 83 | 2 | 5 | 10 | soft, tacky, fragile, dark-colored solid | 95 |
| 10 | 78 | 2 | 10 | 10 | soft, rubbery, tacky, dark-colored | 97 |
| | | | | | solid; gives to pressure | |
| 11 | 68 | 2 | 20 | 10 | rubbery, dull-looking, dark-colored | 97 |
| | | | | | solid; gives to pressure | |
| 12 | 68 | 2 | 10 | 20 | very hard, shiny, dark-colored solid; | 99 |
| | | | | | resistant to pressure | |
| 13 | 89 | 1 | 5 | 5 | free-flowing, dark-colored liquid | |
| 14 | 84 | 1 | 10 | 5 | free-flowing, dark-colored liquid | |
| 15 | 84 | 1 | 5 | 10 | very viscous, flowing dark-colored | |
| | | | | | liquid | |
| 16 | 79 | 1 | 10 | 10 | tacky, gel-like, dark-colored solid | |
| 17 | 69 | 1 | 20 | 10 | slightly tacky, rubbery, dull-looking, 92 | |
| | | | | | dark-colored solid | |
| 18 | 69 | 1 | 10 | 20 | very shiny, hard, dark-colored solid; | 99 |
| | | | | | resistant to pressure | |

TABLE 16
Polymerization of Norway fish oil ethyl ester With Additives Using Boron Trifluoride Etherate

| | % Fish Oil | % BF₃·OEt₂ | % Additive 1 | % Additive 2 | | | % |
|---|---|---|---|---|---|---|---|
| Entry | (weight %) | (weight %) | (weight %) | (weight %) | Conditions | Observations | Yield |
| 1 | 65 | 5 | 15 | 15 | 110° C. 3 d | soft, tacky, rubbery, porous, dark-colored | 90 |
| | | | β-citronellol | divinylbenzene | | solid | |
| 2 | 60 | 5 | 10 | 25 | 110° C. d | very hard, dull-looking, dark-colored | 93 |
| | | | frirfural | divinylbenzene | | solid | |
| 3 | 65 | 5 | 10 | 20 | 110° C. d | very hard, dull-looking, dark-colored | 98 |
| | | | furfural | divinylbenzene | | solid | |
| 4 | 70 | 5 | 5 | 20 | 110° C. d | very hard, shiny, dark-colored solid | 95 |
| | | | furfural | divinylbenzene | | | |
| 5 | 65 | 5 | 15 | 15 | 110° C. d | very soft, dark-colored, sticky solid | 95 |
| | | | 4- | divinylbenzene | | | |
| | | | vinylcyclohexene | | | | |
| 6 | 60 | 5 | 10 | 25 | 110° C. d | hard, dark-colored solid; reacts violently | 99 |
| | | | 4- | divinylbenzene | | | |
| | | | vinylcyclohexene | | | | |
| 7 | 65 | 5 | 15 | 15 | 25° C. 20 | hard, dark-colored solid; reacts violently | 90 |
| | | | ρ-benzoquinone | divinylbenzene | min, | | |
| | | | | | 110° C. 3 d | | |
| 8 | 60 | 5 | 10 | 25 | 25° C. 20 | hard, dark-colored solid; reacts violently | 99 |
| | | | ρ-benzoquinone | divinylbenzene | min, | | |
| | | | | | 110° C. 3 d | | |
| 9 | 75 | 5 | ρ-benzoquinone | 10 | 0° C. min, | hard, dark-colored, very dense solid | 97 |
| | | | | divinylbenzene | 110° C. 1 d | | |
| 10 | 65 | 5 | 10 | 20 | 0° C. min, | very hard, dark-colored, brittle solid | 98 |
| | | | ρ-benzoquinone | divinylbenzene | 110° C. 1 d | | |
| 11 | 65 | 5 | 15 | (—) | 60° C. 1 d | very hard, dark-colored, brittle solid | 98 |
| | | | furan | | 110° C. 2 d | | |
| 12 | 80 | 5 | 15 | (—) | 30° C. 3 d, | dark-colored solid flakes mixed with | 74 |
| | | | furan | | 110° C. 8 d | viscous oil | |
| 13 | 65 | 5 | 15 | 15 | 30° C. 2 d, | very hard, dark-colored solid; resistant to | 85 |
| | | | furan | divinylbenzene | 110° C. 8 d | pressure | |
| 14 | 70 | 5 | 10 | 15 | 30° C. 1 d, | hard, tacky, dark-colored solid; cracked | 85 |
| | | | furan | divinylbenzene | 110° C. 6 d | surface | |
| 15 | 65 | 5 | 15 | 15 | 110° C. 3 d | hard, tacky, dark-colored solid, cracked | 85 |
| | | | bisphenol A | divinylbenzene | | surface | |
| 16 | 70 | 5 | 10 | 15 | 110° C. 3 d | hard, tacky, dark-colored solid; cracked | 86 |
| | | | bisphenol A | divinylbenzene | | surface | |
| 17 | 94 | 6 | (—) | (—) | 110° C. 3 d | viscous, free-flowing, dark-colored oil | (—) |
| 18 | 79 | 6 | 15 | (—) | 110° C. 2 d | viscous, dark-colored oil, flows slowly | (—) |
| | | | styrene | | | | |
| 19 | 62 | 6 | 13 | 19 | 110° C. 2 d | dark-brown, very viscous oil, flows slowly | (—) |
| | | | styrene | dicyclopenradiene | | | |
| 20 | 74 | 6 | 20 | (—) | 110° C. 2 d | dark-colored, free-flowing oil | (—) |
| | | | myrcene | | | | |
| 21 | 80 | 5 | 15 | (—) | 110° C. 3 d | dark-colored, free flowing oil | (—) |
| | | | phenol | | | | |
| 22 | 65 | 5 | 15 | 15 | 110° C. 3 d | dark-colored, slow-flowing, viscous oil | (—) |
| | | | phenol | norbornadiene | | | |
| 23 | 65 | 5 | 15 | 15 | 110° C. 3 d | dark-colored, slow-flowing, viscous oil | (—) |
| | | | (+)−linalool | divinylbenzene | | | |
| 24 | 80 | 5 | 15 | (—) | 110° C. 3 d | very viscous, dark-colored oil | (—) |
| | | | furfural | | | | |
| 25 | 65 | 5 | 15 | 15 | 110° C. 3 d | very viscous, dark-colored oil | (—) |
| | | | furfural | divinylbenzene | | | |
| 26 | 85 | 5 | 10 | (—) | 110° C. 3 d | very viscous, dark-colored oil | (—) |
| | | | ρ-benzoquinone | | | | |
| 27 | 65 | 5 | 15 | (—) | 110° C. 3 d | very viscous, gel-like, dark-colored oil, | (—) |
| | | | ρ-benzoquinone | | | flows slowly | |
| 28 | 80 | 5 | 15 | (—) | 110° C. 3 d | dark-colored, slightly viscous oil, flows | (—) |
| | | | 2-allylphenol | | | slowly | |
| 29 | 65 | 5 | 15 | 15 | 110° C. 3 d | very viscous, dark-colored oil, flows | (—0 |
| | | | 2-allylphenol | divinylbenzene | | slowly | |
| 30 | 85 | 5 | 5 | 5 | 60° C. 1 d | very viscous, dark-colored oil | (—) |
| | | | divinylbenzene | ρ-mentha-1, | 110° C. 2 d | | |
| | | | | 8-diene | | | |
| 31 | 80 | 5 | 15 | (—) | 110° C. 5 d | dark-colored, viscous oil | (—) |
| | | | 1,2- | | | | |
| | | | dimethoxy- | | | | |
| | | | benzene | | | | |
| 32 | 65 | 5 | 15 | 15 | 110° C. 5 d | dark-colored, very viscous oil | (—) |
| | | | 1,2- | divinylbenzene | | | |
| | | | dimethoxy- | | | | |
| | | | benzene | | | | |
| 33 | 70 | 5 | 15 | 15 | 110° C. 5 d | dark-colored, viscous oil | (—) |
| | | | 1,2- | divinylbenzene | | | |
| | | | dimethoxy- | | | | |
| | | | benzene | | | | |
| 34 | 80 | 5 | 15 | (—) | 110° C. 4 d | dark-colored, viscous oil | (—) |
| | | | bisphenol A | | | | |

TABLE 17
Polymerization of Capelin Fish Oil With Additives Using Boron Trifluoride Etherate

| | % Fish Oil | % BF₃·OEt₂ | % Additive 1 | % Additive 2 | | | % |
|---|---|---|---|---|---|---|---|
| Entry | (weight %) | (weight %) | (weight %) | (weight %) | Observations | Yield | |
| 1 | 95 | 5 | (—) | (—) | 110° C. 3 d | dark-colored, free- | (—) |
| | | | | | | flowing oil | |
| 2 | 65 | 5 | 30 | (—) | 110° C. 6 d | very hard, dark-colored | 99 |
| | | | divinylbenzene | | | solid; resistant to | |
| | | | | | | pressure | |
| 3 | 69 | 1 | 30 | (—) | 110° C. 6 d | very hard, dark-colored | 99 |
| | | | divinylbenzene | | | solid; resistant to | |
| | | | | | | pressure | |
| 4 | 65 | 5 | 20 | 10 | 60° C. 1 d, | hard, dark-colored | 99 |
| | | | dicyclopentadiene | divinylbenzene | 110° C. 4 d | solid, harder on top | |
| | | | | | | than one pressure | |
| 5 | 65 | 5 | 20 | 10 | 25° C. 1 d, | hard, dark-colored | 98 |
| | | | norbornadiene | divinylbenzene | 60° C. 1 d | solid; gives slightly to | |
| | | | | | 60° C. 3 d | pressure | |
| 6 | 69 | 1 | 20 | 10 | 25° C. 1 d, | hard, dark-colored | 98 |
| | | | norbornadiene | divinylbenzene | 60° C. 1 d | solid; gives slightly to | |
| | | | | | | 110° C. 3 d | pressure |

TABLE 18
Polymerization of Conjugated Norway fish oil ethyl ester and Divinylbenzene Using Boron Trifluoride Etherate

| | % Conjugated | % BF₃·OEt₂ | % divinlbenzene | | % |
|---|---|---|---|---|---|
| Entry | (weight %) | (weight %) | (weight %) | Observations | Yield |
| 1 | 90 | 5 | 5 | Dark-colored, shiny, hard, rubbery solid; gives slightly to | 97 |
| | | | | pressure | |
| 2 | 85 | 5 | 10 | Dark-colored, shiny, hard, rubbery solid; gives slightly to | 97 |
| | | | | pressure | |
| 3 | 80 | 5 | 15 | dark-colored, shiny, very hard solid; resistant to pressure | 97 |
| 4 | 75 | 5 | 20 | dark-colored, shiny, very hard solid; resistant to pressure | 97 |
| 5 | 70 | 5 | 25 | dark-colored, shiny, very hard solid; resistant to pressure | 97 |
| 6 | 65 | 5 | 30 | dark-colored, quite shiny, very hard solid; resistant to | 99 |
| | | | | pressure | |
| 7 | 93 | 2 | 5 | dark-colored, shiny, hard, rubbery solid; gives slightly to | 98 |
| | | | | pressure | |
| 8 | 88 | 2 | 10 | dark-colored, shiny, quite hard solid; resistant to pressure | 99 |
| 9 | 83 | 2 | 15 | dark-colored, shiny, quite hard solid; resistant to pressure | 97 |
| 10 | 78 | 2 | 20 | dark-colored, shiny, hard solid; resists pressure | 98 |
| 11 | 73 | 2 | 25 | dark-colored, shiny, very hard solid; resists pressure | 98 |
| 12 | 68 | 2 | 30 | dark-colored, shiny, very hard solid; resists pressure | 99 |
| 13 | 94 | 1 | 5 | dark-colored, shiny, hard, rubbery solid; gives to extreme | 98 |
| | | | | pressure | |
| 14 | 89 | 1 | 10 | dark-colored, shiny, hard, rubbery solid; gives to extreme | 99 |
| | | | | pressure | |
| 15 | 84 | 1 | 15 | dark-colored, shiny, hard solid; resistant to pressure | 99 |
| 16 | 79 | 1 | 20 | dark-colored, shiny, hard solid; resistant to pressure | 99 |
| 17 | 74 | 1 | 25 | dark-colored, shiny, hard solid; resistant to pressure | 98 |
| 18 | 69 | 1 | 30 | dark-colored, shiny, very hard solid; resists pressure | 100 |

TABLE 19
Polymerization of Conjugated Norway fish oil ethyl ester and Divinylbenzene and
Norbornadiene Using Boron Trifluoride Etherate

| | % Conjugated | | | | | |
|---|---|---|---|---|---|---|
| | Fish Oil | % BF₃·OEt₂ | % norbornadiene | % divinylbenzene | | % |
| Entry | (weight %) | (weight %) | (weight %) | (weight %) | Observations | Yield |
| 1 | 85 | 5 | 5 | 5 | dark-colored, shiny, hard solid; gives | 96 |
| | | | | | slightly to pressure | |
| 2 | 80 | 5 | 10 | 5 | dark-colored, shiny, hard solid; resistant | 97 |
| | | | | | to pressure | |
| 3 | 80 | 5 | 5 | 10 | dark-colored, shiny, hard solid; resistant | 96 |
| | | | | | to pressure | |
| 4 | 75 | 5 | 10 | 10 | dark-colored, shiny, very hard solid; | 97 |
| | | | | | resists pressure | |
| 5 | 65 | 5 | 20 | 10 | dark-colored, shiny, extremely hard solid; | 96 |
| | | | | | resists pressure | |
| 6 | 65 | 5 | 10 | 20 | dark-colored, shiny, extremely hard solid; | 99 |
| | | | | | resists pressure | |
| 7 | 88 | 2 | 5 | 5 | dark-colored, shiny, hard solid; gives | 98 |
| | | | | | slightly to pressure | |
| 8 | 83 | 2 | 10 | 5 | dark-colored, shiny, hard solid; gives very | 97 |
| | | | | | little to pressure | |
| 9 | 83 | 2 | 5 | 10 | dark-colored, shiny, rigid solid; gives to | 98 |
| | | | | | extreme pressure | |
| 10 | 78 | 2 | 10 | 10 | dark-colored, shiny, very hard solid; | 98 |
| | | | | | resists pressure | |
| 11 | 68 | 2 | 20 | 10 | dark-colored, quite hard, shiny solid; | 98 |
| | | | | | resists pressure | |
| 12 | 68 | 2 | 10 | 20 | dark-colored, shiny, extremely hard solid; | 99 |
| | | | | | resists pressure | |
| 13 | 89 | 1 | 5 | 5 | dark-colored, slightly shiny, hard solid; | 96 |
| | | | | | gives to pressure | |
| 14 | 84 | 1 | 10 | 5 | dark-colored, shiny, hard solid; gives | 99 |
| | | | | | slightly to pressure | |
| 15 | 84 | 1 | 5 | 10 | dark-colored, shiny, hard solid; resistant | 97 |
| | | | | | to pressure | |
| 16 | 79 | 1 | 10 | 10 | dark-colored, shiny, very hard solid; | 97 |
| | | | | | resistant to pressure | |
| 17 | 69 | 1 | 20 | 10 | dark-colored, shiny, very hard solid; | 96 |
| | | | | | resistant to pressure | |
| 18 | 69 | 1 | 10 | 20 | dark-colored, shiny, extremely hard solid; | 99 |
| | | | | | resists pressure | |

TABLE 20
Polymerization of Conjugated Norway fish oil ethyl ester and Divinylbenzene and
Norbornadiene Using Boron Trifluoride Etherate

| | % Conjugated | | | | | |
|---|---|---|---|---|---|---|
| | Fish Oil | % BF₃·OEt₂ | % norbomadiene | % divinylbenzene | | % |
| Entry | (weight %) | (weight %) | (weight %) | (weight %) | Observations | Yield |
| 1 | 85 | 5 | 5 | 5 | hard, shiny, dark-colored solid; gives slightly | 97 |
| | | | | | to pressure | |
| 2 | 80 | 5 | 10 | 5 | hard, shiny, dark-colored solid; gives slightly | 97 |
| | | | | | to pressure | |
| 3 | 80 | 5 | 5 | 10 | hard, shiny, dark-colored solid; resists | 97 |
| | | | | | pressure | |
| 4 | 75 | 5 | 10 | 10 | very hard, shiny, dark-colored solid; pressure | 96 |
| | | | | | resistant | |
| 5 | 65 | 5 | 20 | 10 | very hard, shiny, dark-colored solid; pressure | 95 |
| | | | | | resistant | |
| 6 | 65 | 5 | 10 | 20 | very hard, shiny, dark-colored solid; pressure | 99 |
| | | | | | resistant | |
| 7 | 88 | 2 | 5 | 5 | shiny, rubbery, dark-colored solid; gives to | 96 |
| | | | | | pressure | |
| 8 | 83 | 2 | 10 | 5 | shiny, rubbery, dark-colored solid; gives to | 97 |
| | | | | | pressure | |
| 9 | 83 | 2 | 5 | 10 | hard, shiny, dark-colored solid; gives slightly | 97 |
| | | | | | to pressure | |
| 10 | 78 | 2 | 10 | 10 | hard, shiny, dark-colored solid; gives slightly | 97 |
| | | | | | to pressure | |
| 11 | 68 | 2 | 20 | 10 | very hard, shiny, dark-colored solid; pressure | 94 |
| | | | | | resistant | |
| 12 | 68 | 2 | 10 | 20 | very hard, shiny, dark-colored solid; pressure | 99 |
| | | | | | resistant | |
| 13 | 89 | 1 | 5 | 5 | firm, rubbery, dark-colored solid; gives | 92 |
| | | | | | slightly to pressure | |
| 14 | 84 | 1 | 10 | 5 | firm, rubbery, dark-colored solid; gives | 90 |
| | | | | | slightly to pressure | |
| 15 | 84 | 1 | 5 | 10 | hard, shiny, dark-colored solid; gives slightly | 96 |
| | | | | | to pressure | |
| 16 | 79 | 1 | 10 | 10 | hard, shiny, dark-colored solid; gives slightly | 93 |
| | | | | | to pressure | |
| 17 | 69 | 1 | 20 | 10 | hard, shiny, dark-colored solid; gives to | 93 |
| | | | | | extreme pressure | |
| 18 | 69 | 1 | 10 | 20 | very hard, shiny, dark-colored solid; resistant | 99 |
| | | | | | to pressure | |

TABLE 21
Polymerization of Norway fish oil ethyl ester and Divinylbenzene Using Lewis Acid Catalysts

| | Fish Oil | 5% Catalyst | % divinylbenzene | | % |
|---|---|---|---|---|---|
| Entry | (weight %) | (weight %) | (weight %) | Observations | Yield |
| 1 | 65 | BF₃·OEt₂ | 30 | very hard, shiny, dark-colored solid, | 99 |
| | | | | resistant to pressure | |
| 2 | 65 | AlCl₃ | 30 | heterogeneous mixture of dark-brown | |
| | | | | solids and a free-flowing oil | |
| 3 | 65 | SnCl₄·5H₂O | 30 | heterogeneous mixture of dark-brown | 87 |
| | | | | solids surrounded by a viscous oil | |
| 4 | 65 | ZnCl₂ | 30 | heterogeneous mixture of brown | 93 |
| | | | | solids surrounded by a viscous oil | |
| 5 | 65 | FeCl₃ | 30 | cloudy, soft, fragile solid with dark- | 92 |
| | | | | colored layers on the top and bottom | |
| 6 | 65 | TiCl₄ | 30 | hard, tacky, dark-brown solids | 96 |
| | | | | surrounded by a viscous oil | |
| 7 | 65 | H₂SO₄ | 30 | soft, tacky, porous, dark-brown solid, | 96 |
| | | | | harder on the bottom than on top | |
| 8 | 65 | SnCl₄(anh.) | 30 | soft, tacky, porous, dark-brown solid, | 99 |
| | | | | harder on the bottom than on top | |
| 9 | 65 | BCL3 | 30 | dark-brown, free-flowing oil | (—) |
| | | (1 Mm CH₂Cl₂) | | | |

TABLE 22
Thermogravimetric Analysis of Fish Oil Polymers

| | | TGA^{a} | | | |
|---|---|---|---|---|---|
| | | | % Massₙ₂^{b} | | % Massₐᵢᵣ ^{b} |
| Entry | Polymer | T_{N2} (° C.) | (400 ° C.) | Tₐᵢᵣ (° C.) | (400 ° C.) |
| 1 | 65% Norway fish oil ethyl ester | 265 | 72 | 269 | 74 |
| | 30% Divinylbenzene | | | | |
| | 5% BF₃ · OEt₂ | | | | |
| 2 | 65% Conjugated Norway fish oil ethyl ester | 239 | 76 | 271 | 79 |
| | 30% Divinylbenzene | | | | |
| | 5% BF₃ · OEt₂ | | | | |
| 3 | 85% Conjugated Norway fish oil ethyl ester | 284 | 75 | 283 | 76 |
| | 10% Divinylbenzene | | | | |
| | 5% BF₃ · OEt₂ | | | | |
| 4 | 94% Conjugated Norway fish oil ethyl ester | 238 | 65 | 245 | 67 |
| | 5% Divinylbenzene | | | | |
| | 1% BF₃ · OEt₂ | | | | |
| 5 | 65% Norway fish oil ethyl ester | 234 | 74 | 234 | 76 |
| | 20% Norbornadiene | | | | |
| | 10% Divinylbenzene | | | | |
| | 5% BF₃ · OEt₂ | | | | |
| 6 | 65% Conjugated Norway fish oil ethyl ester | 244 | 79 | 231 | 80 |
| | 20% Norbornadiene | | | | |
| | 10% Divinylbenzene | | | | |
| | 5% BF₃ · OEt₂ | | | | |
| 7 | 69% Norway fish oil ethyl ester | 249 | 76 | 254 | 79 |
| | 20% Norbornadiene | | | | |
| | 10% Divinylbenzene | | | | |
| | 1% BF₃ · OEt₂ | | | | |
| 8 | 50% Conjugated Norway fish oil ethyl ester | 334 | 87 | 338 | 87 |
| | 30% Norbornadiene | | | | |
| | 15% Divinylbenzene | | | | |
| | 5% BF₃ · OEt₂ | | | | |
| 9 | 89% Conjugated Norway fish oil ethyl ester | 249 | 67 | 246 | 70 |
| | 5% Norbornadiene | | | | |
| | 5% Divinylbenzene | | | | |
| | 1% BF₃ · OEt₂ | | | | |
| 10 | 65% Norway fish oil ethyl ester | 285 | 77 | 290 | 79 |
| | 20% Dicyclopentadiene | | | | |
| | 10% Divinylbenzene | | | | |
| | 5% BF₃ · OEt₂ | | | | |
| 11 | 65% Conjugated Norway fish oil ethyl ester | 226 | 72 | 239 | 76 |
| | 20% Dicyclopentadiene | | | | |
| | 10% Divinylbenzene | | | | |
| | 5% BF₃ · OEt₂ | | | | |
| 12 | 65% Conjugated Capelin Fish Oil | 253 | 60 | 245 | 57 |
| | 30% Divinylbenzene | | | | |
| | 5% BF₃ · OEt₂ | | | | |
| 13 | 65% Conjugated Gapelin Fish Oil | 274 | 72 | 282 | 76 |
| | 20% Norbornadiene | | | | |
| | 10% Divinylbenzene | | | | |
| | 5% BF₃ · OEt₂ | | | | |

^{a}The TGA temperature ramp used was 20° C./min.
^{b}The bulk polymer mass remaining at 400° C.

TABLE 23
Solubility of the 65% Conjugated Norway fish oil ethyl ester,
20% Norbornadiene, 10% Divinylbenzene, and 5% BF₃.OEt₂
Polymer in Various Solvent Systems

| | Time | Temp. | % | % |
|---|---|---|---|---|
| Solvent | (h) | (° C.) | Insoluble | Soluble |
| THF | 48 | 66 | 75 | 23 |
| CH₂Cl₂ | 24 | 40 | 79 | 17 |
| 1-Methyl-2-pyrrolidinone | 24 | 150 | 78 | 17 |
| DMF | 24 | 153 | 83 | 15 |
| CH₂Cl₂ (thin film) | 24 | 40 | 86 | 13 |
| Acetone | 24 | 56 | 93 | 7 |
| MeOH | 24 | 65 | 99 | — |
| Methanesulfonic Acid | 24 | 150 | 94 | — |
| H₂O | 24 | 100 | 99 | — |
| Conc. H₂SO₄ | 24 | 25 | 95 | — |
| EtOH (0.02 M KOH) | 24 | 79 | 95 | — |

TABLE 24
Solubilities of Norway fish oil ethyl ester Polymers in CH₂Cl₂, THF, and DMF

| | | | Time | Temp. | | |
|---|---|---|---|---|---|---|
| Entry | Polymer | Solvent | (h) | (° C.) | % Insoluble | % Soluble |
| 1 | 65% Fish Oil | CH₂Cl₂ | 24 | 40 | 58 | 37 |
| | 30% Divinylbenzene | | | | | |
| | 5% BF₃ · OEt₂ | THF | 48 | 66 | 65 | 32 |
| | | DMF | 24 | 153 | 66 | 27 |
| 2 | 65% Conjugated Fish Oil | CH₂Cl₂ | 24 | 40 | 77 | 19 |
| | 30% Divinylbenzene | | | | | |
| | 5% BF₃ · OEt₂ | THF | 48 | 66 | 78 | 19 |
| | | DMF | 48 | 153 | 84 | 10 |
| 3 | 85% Conjugated Fish Oil | CH₂Cl₂ | 24 | 40 | 74 | 22 |
| | 10% Divinylbenzene | | | | | |
| | 5% BF₃ · OEt₂ | THF | 72 | 66 | 72 | 26 |
| | | DMF | 48 | 153 | 68 | 24 |
| 4 | 94% Conjugated Norway fish oil ethyl | CH₂Cl₂ | 24 | 40 | 64 | 31 |
| | ester | | | | | |
| | 5% Divinylbenzene | THF | 48 | 66 | 64 | 34 |
| | 1% BF₃ · OEt₂ | | | | | |
| | | DMF | 48 | 153 | 67 | 26 |
| 5 | 65% Fish Oil | CH₂Cl₂ | 24 | 40 | 73 | 25 |
| | 20% Norbornadiene | | | | | |
| | 10% Divinylbenzene | THF | 48 | 66 | 60 | 38 |
| | 5% BF₃ · OEt₂ | | | | | |
| | | THF (thin film) | 48 | 66 | 67 | 28 |
| | | DMF | 48 | 153 | 75 | 17 |
| 6 | 65% Conjugated Fish Oil | CH₂Cl₂ | 24 | 40 | 79 | 17 |
| | 20% Norbornadiene | | | | | |
| | 10% Divinylbenzene | THF | 48 | 66 | 75 | 23 |
| | 5% BF₃ · OEt₂ | | | | | |
| | | DMF | 24 | 153 | 83 | 15 |
| 7 | 50% Conjugated Fish Oil | CH₂Cl₂ | 24 | 40 | 86 | 10 |
| | 30% Norbornadiene | | | | | |
| | 15% Divinylbenzene | THF | 48 | 66 | 84 | 16 |
| | 5% BF₃ · OEt₂ | | | | | |
| | | DMF | 48 | 153 | 77 | 15 |
| 8 | 89% Conjugated Fish Oil | CH₂Cl₂ | 24 | 40 | 68 | 26 |
| | 5% Norbornadiene | | | | | |
| | 5% Divinylbenzene | THF | 48 | 66 | 66 | 33 |
| | 1% BF₃ · OEt₂ | | | | | |
| | | DMF | 48 | 153 | 70 | 29 |
| 9 | 65% Fish Oil | CH₂Cl₂ | 24 | 40 | 52 | 47 |
| | 20% Dicyclopentadiene | | | | | |
| | 10% Divinylbenzene | THF | 48 | 66 | 49 | 47 |
| | 5% BF₃ · OEt₂ | | | | | |
| | | DMF | 48 | 153 | 56 | 35 |
| 10 | 65% Conjugated Fish Oil | CH₂Cl₂ | 24 | 40 | 75 | 17 |
| | 20% Dicyclopentadiene | | | | | |
| | 10% Divinylbenzene | THF | 48 | 66 | 74 | 23 |
| | 5% BF₃ · OEt₂ | | | | | |
| | | DMF | 48 | 153 | 82 | 13 |
| 11 | 65% Conjugated Fish Oil | CH₂Cl₂ | 24 | 40 | 81 | 15 |
| | 20% Norbornadiene | | | | | |
| | 10% Divinylbenzene | THF | 72 | 66 | 79 | 21 |
| | 5% BF₃ · OEt₂ | | | | | |
| | (110° C.for 5 d) | | | | | |

TABLE 25
Thermogravimetric Analysis of the Insoluble Material Remaining After Soxhlet Extraction
of the Fish Oil Polymers

| | | TGA^{a} | | | |
|---|---|---|---|---|---|
| | | T (° C.)_{N}₂ | T (° C.)_{N}₂ | T (° C.)ₐᵢᵣ | T (° C.)ₐᵢᵣ |
| Entry | Polymer | (5%) | (10%) | (5%) | (10%) |
| 1 | 65% Norway fish oil ethyl ester | | | | |
| | 30% Divinylbenzene | | | | |
| | 5% BF₃ · OEt₂ | | | | |
| | CH₂Cl₂ Insolubles | 424 | 445 | 408 | 436 |
| | THF Insolubles | 439 | 456 | 420 | 442 |
| 2 | 65% Conjugated Fish Oil | | | | |
| | 30% Divinylbenzene | | | | |
| | 5% BF₃ · OEt₂ | | | | |
| | CH₂Cl₂ Insolubles | 421 | 438 | 385 | 405 |
| | THF Insolubles | 420 | 436 | 370 | 389 |
| 3 | 85% Fish Norway fish oil ethyl ester | | | | |
| | 10% Divinylbenzene | | | | |
| | 5% BF₃ · OEt₂ | | | | |
| | CH₂Cl₂ Insolubles | 395 | 418 | 357 | 382 |
| | THF Insolubles | 402 | 422 | 367 | 387 |
| 4 | 94% Conjugated Norway fish oil ethyl | | | | |
| | ester | | | | |
| | 5% Divinylbenzene | | | | |
| | 1% BF₃ · OEt₂ | | | | |
| | CH₂Cl₂ Insolubles | 400 | 423 | 366 | 393 |
| | THF Insolubles | 406 | 427 | 371 | 396 |
| 5 | 65% Conjugated Norway fish oil ethyl | | | | |
| | ester | | | | |
| | 5% Divinylbenzene | | | | |
| | 1% BF₃ · OEt₂ | | | | |
| | CH₂Cl₂ Insolubles | 391 | 426 | 372 | 410 |
| | THF Insolubles | 414 | 432 | 373 | 396 |
| 6 | 65% Conjugated Norway fish oil ethyl | | | | |
| | ester | | | | |
| | 20% Norbornadiene | | | | |
| | 10% Divinylbenzene | | | | |
| | 5% BF₃ · OEt₂ | | | | |
| | CH₂Cl₂ Insolubles | 360 | 401 | 354 | 413 |
| | THF Insolubles | 345 | 373 | 333 | 358 |
| 7 | 50% Conjugated Norway fish oil ethyl | | | | |
| | ester | | | | |
| | 30% Norbornadiene | | | | |
| | 15% Divinylbenzene | | | | |
| | 5% BF₃ · OEt₂ | | | | |
| | CH₂Cl₂ Insolubles | 361 | 402 | 334 | 394 |
| | THF Insolubles | 358 | 386 | 338 | 371 |
| 8 | 89% Conjugated Norway fish oil ethyl | | | | |
| | ester | | | | |
| | 5% Norbornadiene | | | | |
| | 5% Divinylbenzene | | | | |
| | 1% BF₃ · OEt₂ | | | | |
| | CH₂Cl₂ Insolubles | 407 | 432 | 385 | 424 |
| | THF Insolubles | 403 | 427 | 385 | 415 |
| 9 | 65% Norway fish oil ethyl ester | | | | |
| | 20% Dicyclopentadiene | | | | |
| | 10% Divinylbenzene | | | | |
| | 5% BF₃ · OEt₂ | | | | |
| | CH₂Cl₂ Insolubles | 414 | 445 | 415 | 448 |
| | THF Insolubles | 412 | 433 | 369 | 392 |
| 10 | 65% Conjugated Norway Fish Oil | | | | |
| | 20% Dicyclopentadiene | | | | |
| | 10% Divinylbenzene | | | | |
| | 5% BF₃ · OEt₂ | | | | |
| | CH₂Cl₂ Insolubles | 415 | 438 | 391 | 417 |
| | THF Insolubles | 418 | 438 | 397 | 421 |
| 11 | 65% Conjugated Capelin Fish Oil | | | | |
| | 30% Divinylbenzene | | | | |
| | 5% BF₃ · OEt₂ | | | | |
| | CH₂Cl₂ Insolubles | 188 | 351 | 188 | 329 |
| | THF Insolubles | | | | |
| 12 | 65% Conjugated Capeline Fish Oil | | | | |
| | 20% Norbornadiene | | | | |
| | 10% Divinylbenzene | | | | |
| | 5% BF₃ · OEt₂ | | | | |
| | CH₂Cl₂ Insolubles | 273 | 366 | 270 | 345 |

TABLE 26
Tensile Properties of the Composites (ASTM-D5083-90)

| | | | | Young's | Tensile | Elongation | |
|---|---|---|---|---|---|---|---|
| Composites | | | Pressure | Modulus | Strength | at break | Toghness |
| Binder | GF %^{a} | CA^{b} | (Mpa) | E (Gpa) | E_{b} (Mpa) | ε_{b} (%) | (Mpa) |
| SOY50-DVB35-(NFO01-BFE5) | 50 | No | 3.0 | 1.82 | 54.8 | 3.9 | 1.29 |
| LSS50-DV35-(NF010-BFE5) | 50 | No | 3.0 | 2.12 | 50.7 | 3.1 | 0.81 |
| CLS50-DVB35-(NFO10-BFE5) | 50 | No | 2.13 | 64.9 | 3.8 | 1.33 | 1.33 |
| CLS50-DVB35-(NFO10-BFE5) | 50 | No | 3.0 | 2.13 | 64.9 | 3.8 | 1.33 |
| CLS50-DVB35-(NFO10-BFE5) | 50 | No | 5.0 | 2.16 | 66.8 | 3.9 | 1.43 |
| CLS50-DVB35-(NFO10-BFE5) | 50 | No | 9.0 | 2.01 | 70.7 | 4.4 | 1.70 |
| CLS50-DVB35-(NFO10-BFE5) | 35 | No | 9.0 | 2.53 | 29.9 | 2.1 | 0.28 |
| CLSSO-DVB35-(NFO10-BFE5) | 50 | No | 9.0 | 2.01 | 70.7 | 6.5 | 1.70 |
| CLS50-DVB35-(NFO10-BFE5) | 65 | No | 9.0 | 2.01 | 88.7 | 6.5 | 2.77 |
| CLS50-DVB3S-(NFO10-BFE5) | 50 | No | 5.0 | 2.16 | 66.8 | 3.9 | 1.43 |
| CLSSO-DVB35-(NFO10-BFE5) | 50 | A0773-KG | 5.0 | 2.04 | 47.2 | 4.5 | 1.15 |
| CLS50-DVB35-(NFO10-BFE5) | 50 | A0699-KG | 5.0 | 2.48 | 69.3 | 5.7 | 1.74 |
| CLS50-DVB35-(NFO10-BFE5) | 50 | No | 9.0 | 2.01 | 70.7 | 4.4 | 1.70 |
| CLS50-DVB35-(NFO10-BFE5) | 50 | PC-2A | 9.0 | 2.03 | 71.5 | 5.7 | 2.36 |
| CLS50-DVB35-(NFO10-BFE5) | PC-2A | 9.0 | 2.03 | 71.5 | 5.7 | 2.36 | 2.36 |
| CLS50-DVB35-(NFO10-BFE5) | PC-2A/PC-1B | 9.0 | 9.0 | 2.02 | 56.6 | 4.5 | 1.36 |
| CLS50-DVB35-(NFO10-BFE5) | 50 | No | 9.0 | 2.01 | 70.7 | 4.4 | 1.70 |
| CLS50-DVB35-(NFO10-BFE5) | 50 | No | 9.0 | 2.00 | 57.2 | 4.0 | 1.17 |

^{a}Weight % of glass fiber used in the composites.
^{b}Coupling agent. “No” means that the composite was made without any coupling agent.

J) Homopolymerization and Copolymerization of Fish Oil Plastics

The Lewis acid-initiated cationic homopolymerization of Norway fish oil ethyl ester (NFO) or the corresponding conjugated fish oil (CFO) and their copolymerization with various alkene comonomers have been investigated. Among the Lewis acids employed, boron trifluoride diethyl etherate (BF₃.OEt₂=BFE) has been found to be the most effective initiator for cationic polymerization of the NFO and CFO systems. The BFE-initiated homopolymerization of NFO generally results in low molecular weight viscous oils, while that of the CFO leads to a solid elastic gel with a gel time of more than 72 hours at room temperature. Copolymerization of the NFO or CFO with some alkene comonomers significantly facilitates gelation. The gel times are largely dependent upon the stoichiometry, the type of fish oil and the alkene comonomer. After post-curing at elevated temperatures, the cationic copolymerization affords polymers ranging from soft rubbery materials to rigid plastics. These NFO and CFO polymers are composed of highly crosslinked materials and a certain amount of free oils, and have been found to be fully cured theromosets. Generally, CFO polymers appear to be harder than the corresponding NFO polymers. However, the thermal properties of the bulk polymers are similar to each other, and their insoluble extracts exhibit much higher thermal stability than the bulk thermosets.

Materials

The Norway fish oil (NFO) used was Norwegian Pronova EPAX 5500 EE fish oil ethyl ester (Bergen, Norway). The conjugated fish oil (CFO) was prepared from the NFO in our laboratory by using Wilkinson's catalyst [RhCl(PPh₃)₃]. The degree of conjugation was calculated to be about 90%. Divinylbenzene (DVB), norbornadiene (NBD), dicyclopentadiene (DCP), styrene, myrcene, phenol, linalool, furfural, ρ-benzoquinone, 2-allylphenol, ρ-mentha-1,8-diene, furan, 1,2-dimethoxybenzene, bisphenol A, 1,3-cyclohexadiene, maleic anhydride, methyl acrylate, vinyl acetate, vinylidene chloride, acrylonitrile, methyl crotonate, acrolein, isoprene, dimethyl acetylenedicarboxylate, diallyl phthalate, boron trifluoride diethyl etherate (BFE), iron(III) chloride and tin tetrachloride were obtained from Aldrich Chemical Co. (Milwaukee, Wisconsin). Aluminum chloride, zinc chloride, titanium tetrachloride and concentrated sulfuric acid were purchased from Fisher Scientific (Fair Lawn, N.J.). Tin tetrachloride pentahydrate was obtained from Mallinckrodt Chemical Co. (St. Louis, Mo.). All reagents obtained from commercial vendors were used as received unless otherwise noted.

Copolymerization

All of the NFO and CFO polymerization reactions were performed on a 2.0 g scale. The amount of each reactant used has been reported as a weight percent. For example, to 1.3 g (65%) of NFO in a 2 dram vial (17×60 mm) was added 0.4 g (20%) of DVB and 0.2 g (10%) of NBD. The reaction mixture was then stirred to ensure homogeneity prior to the addition of 0.1 g (5%) of BF₃.OEt₂ (BFE). The resulting solution was vigorously stirred and sealed under a nitrogen atmosphere. The reaction was allowed to proceed at 25° C. for 24 hours, then 60° C. for 24 hours, and finally 110° C. for 72 hours to produce 1.94 g (97% yield) of a hard polymer identified by its composition as NFO65-DVB20-NBD10-BFE5.

Characterization Techniques

Soxhlet Extractions of the Bulk NFO and CFO Polymers. Soxhlet extraction was used to characterize the structure of the bulk polymers. Typically, a 2 g bulk polymer sample was extracted with 100 mL of refluxing solvent CH₂Cl₂ or THF using a Soxhlet extractor in air for 24 h. After extraction, the resulting solution was concentrated and the soluble extract was isolated for further characterization. The remaining insoluble polymeric material was dried under vacuum prior to further analysis.

Spectroscopy.

¹H and ¹³C NMR spectroscopy were used to characterize the starting materials and the soluble materials extracted from the bulk polymers. All of the ¹H and ¹³C NMR spectra were recorded in CDCl₃ using a Varian Unity spectrometer at 300 MHz and 75.5 MHz, respectively. Cross-polarization magic angle spinning (CP MAS) ¹³C NMR was performed on the remaining insoluble materials extracted from the bulk polymers using a Bruker MSL 300 spectrometer. Samples were examined at 2 spinning frequencies (2.5 and 3.0 K) to differentiate between actual signals and spinning sidebands.

Thermal Analysis.

Differential scanning calorimetry (DSC) was used to measure the phase transitions and post-curing behavior of the bulk polymers. The DSC data were obtained using a Perkin-Elmer Pyris-7 Differential Scanning Calorimeter with a temperature ramp of 20° C./min. Thermogravimetric analysis (TGA) was employed to measure the thermal properties of the bulk polymers, as well as the remaining insoluble materials after extraction by CH₂Cl₂ or THF. The TGA data were collected using a Perkin-Elmer Pyris-7 Thermogravimetric Analyzer. A temperature range of 50-900° C. was used with ramps of 20° C./min purged with a nitrogen or air atmosphere.

Molecular Structures of NFO and CFO

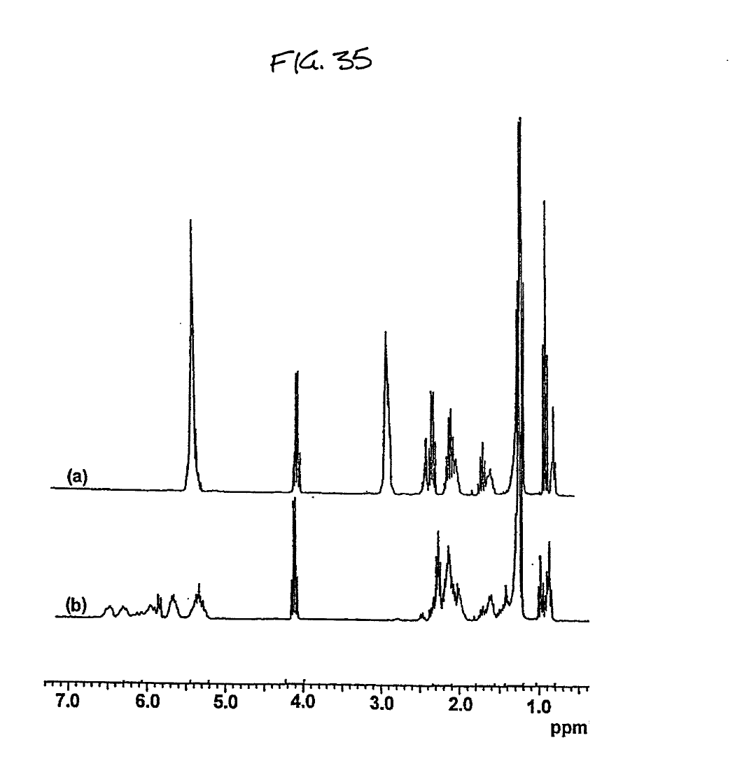

FIG. 35(a) shows the ¹H NMR spectrum of the regular fish oil ethyl ester (NFO) employed in this study. The NFO is a mixture of fatty acid ethyl esters (δ=4.0-4.3 ppm) with a high degree of unsaturation (vinylic hydrogens at δ=5.1-5.5 ppm). Table 27 indicates that the NFO is composed of approximately 90% of unsaturated fatty acid ethyl esters. More than 60% of them have ≧5 non-conjugated C═C bonds. Based on its ¹H NMR spectrum, the NFO has been found to possess 3.7 C═C bonds per molecule on average. The ¹H NMR spectrum of the conjugated NFO (CFO) in FIG. 35(b) indicates that conjugation does not affect the degree of unsaturation (vinylic hydrogens at δ=5.1-6.6 ppm). Approximately 90% of the C═C bonds have been conjugated in the fatty acid ethyl esters.

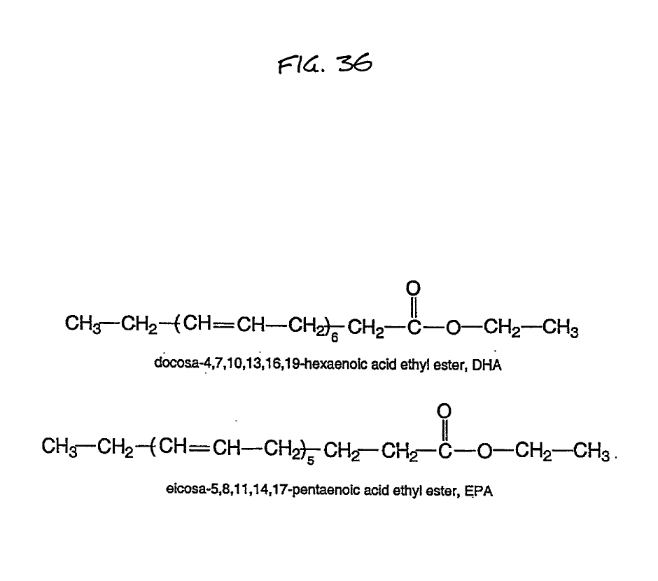

FIG. 36 shows the molecular structures of two significant ω-3 fatty acid ethyl esters in the NFO, docosa-4,7,10,13,16,19-hexaenoic acid ethyl ester (DHA, 24.72%) and eicosa-5,8,11,14,17-pentaenoic acid ethyl ester (EPA, 31.68%). Conjugating the C═C bonds of the DHA and EPA produces a number of fatty acid ethyl ester isomers, but the number of C═C bonds remains unchanged. The NFO and particularly CFO are expected to be cationically polymerizable monomers due to the large number of C═C bonds.

Initiators for Cationic Homopolymerization and Copolymerization of Fish Oils

Lewis acids, i.e. AlCl₃, SnCl₄.5H₂O, TiCl₄, ZnCl₂, FeCl₃, SnCl₄, BCl₃, BF₃.OEt₂ and sulfuric acid, have proved to be very effective initiators for cationic polymerizations. While the simple homopolymerization of NFO or CFO by the above initiators leads to viscous oils in most cases, copolymerization of the NFO or CFO with some alkene comonomers, such as divinylbenzene (DVB), norbornadiene (NBD) and dicyclopentadiene (DCP), has afforded viable solid polymeric materials. When 30% of alkene comonomers are employed, the initiators AlCl₃, SnCl₄.5H₂O, TiCl₄ and ZnCl₂ all produce heterogeneous mixtures of solid materials and viscous oils. The same reaction initiated by FeCl₃ or sulfuric acid produces soft solids. Anhydrous SnCl₄ affords a hard, brittle solid that appears to have a darker layer on the bottom. A solution of BCl₃ in CH₂Cl₂ (1 M) produced only a dark-brown, free-flowing oil. On the other hand, boron trifluoride diethyl etherate (BF₃.OEt₂=BFE) produces rigid plastics, and appears to be the best initiator employed in this study.

Mechanism of the BFE-Initiated Cationic Copolymerization

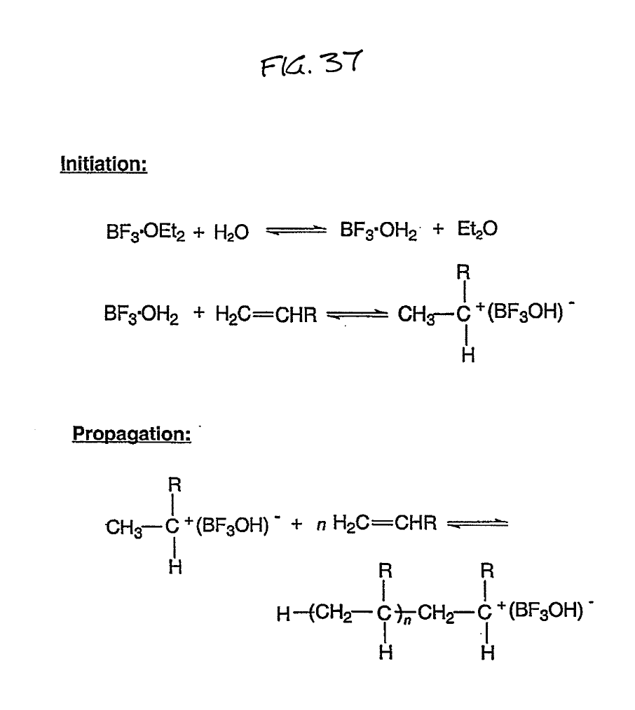

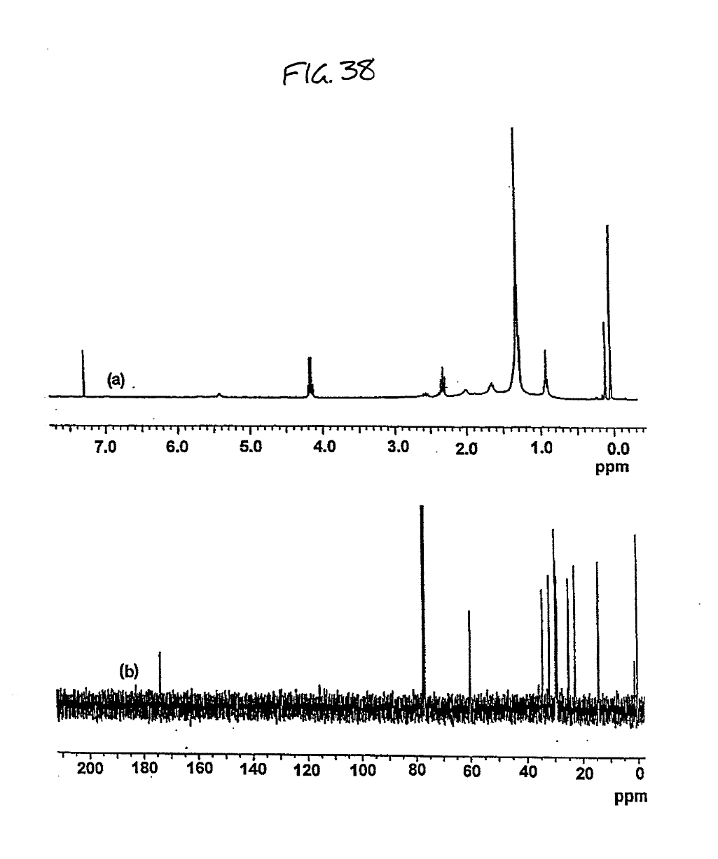

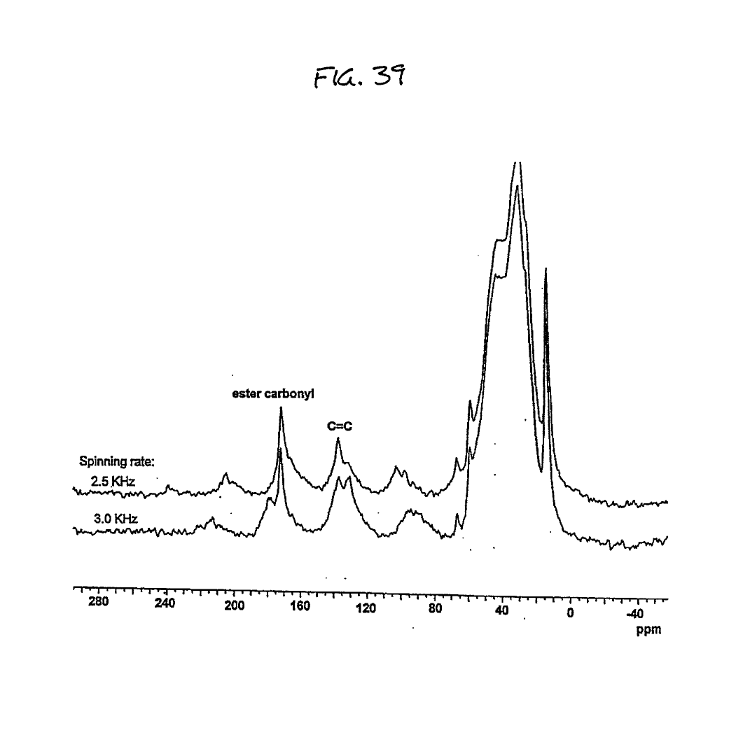

The BFE-initiated cationic polymerization of simple alkenes is well-understood. The initiation and propagation mechanisms are shown in FIG. 37. The initiation process occurs in two steps. The BFE first reacts with a small amount of water that may be present in the reaction mixture to produce the hydrate complex. The boron trifluoride hydrate then reacts with the alkene to produce the initiator-coinitiator complex. Propagation then may occur through subsequent insertions of the alkene monomer into the initiator-coinitiator complex. Termination may occur at any time during the polymerization through chain transfer to monomer, chain transfer to polymer, or through spontaneous termination involving the donation of a proton from the propagating ion pair to the counterion regenerating the boron trifluoride hydrate and producing a double bond in the polymer.

The BFE-initiated homopolymerization or copolymerization of the NFO or CFO with alkene comonomers is assumed to follow a similar cationic mechanism. The initiation processes may be similar to those mentioned above. However, the polyunsaturation of the NFO and CFO, plus the presence of several different alkene comonomers in these reactions, may complicate the chain propagation mechanisms. The homopolymerization of the NFO or CFO occurs by repetitive attack by an electrophilic carbocation on the π systems of the fatty acid ester molecules. From the standpoint of the structures in FIG. 36, the fatty acid ethyl esters may not be sufficiently nucleophilic to support extensive chain propagation, or steric hindrance of the long ethyl ester molecules may inhibit the chain propagation of ˜˜M₁M₁⁺ after cationic initiation (M₁ represent a molecule of NFO or CFO). Thus, simple homopolymerization of the NFO or CFO results in only low molecular weight viscous oils in most cases. The introduction of small alkene comonomers (M₂) not only increases the nucleophilicity of the reactants, but also reduces the steric hindrance by generating ˜˜M₁M₂⁺ species during chain propagation, which results in much higher molecular weight solid polymers.

Due to the multiple functional groups in the fish oils and the alkene comonomers, the polymers formed by cationic copolymerization are expected to be thermosets. The curing of the thermosets through a cationic mechanism may involve several steps. Copolymerization is also initiated by boron trifluoride diethyl etherate by the formation and linear growth of chains that soon begin to branch, and then crosslink. As the reaction proceeds, the increase in molecular weight accelerates, and eventually several chains become linked together into a network of infinite molecular weight, which corresponds to the gel point, an irreversible transformation from a viscous liquid to an elastic gel or rubber. The polymers lose their ability to flow and are not readily processable beyond this point.

Gelation does not necessarily inhibit the curing process. In other words, the reaction rate may remain almost unchanged after the gel point. Vitrification of the growing networks follows when the continuously increasing glass transition temperature of the growing network becomes coincidental with the cure temperature, i.e. T_{g}=T_{cure}=Tᵣₒₒₘ. In the glassy state, there is usually a significant decrease in reaction rate as the reaction becomes diffusion controlled. In order to obtain fully cured networks, the materials are subsequently post-cured at 60° C. for 24 hrs and 110° C. for 48 hrs.

Cationic Copolymerization of NFO or CFO with Alkenes

NFO-DVB-NBD-DCP Systems.

The gelation of the cationic copolymerization has been measured by approximating the time it takes for the liquid reactants to reach a certain high viscosity, i.e. elastic gel. The homopolymerization of NFO initiated by BF₃.OEt₂ results in viscous oils, and does not gel at all at room temperature and above.

The addition of alkene comonomers, such as DVB, NBD and DCP, obviously facilitates gelation of the NFO system. The gel times vary from 1 minute to a few hours at room temperature, depending on the stoichiometry and specific alkene comonomer employed. For cationic copolymerization, the gelation has been found to occur at approximately 20% conversion, which is much lower than the 60-80% of condensation copolymerization systems. The final products are obtained after three vitrification steps at different temperatures, and are thus composed of fully cured networks.

The NFO readily polymerizes with DVB in the presence of BFE to form soft to hard thermosets depending on the amount of DVB employed. Polymerization reactions with 1, 2 or 5% BFE and 5-30% DVB have been conducted and the mass recoveries for all of the reactions producing solid materials are nearly quantitative. When 5% BFE is used, 10% DVB is required to produce a soft material. As the amount of DVB is increased, the products become harder. If the amount of BFE used in the reaction is reduced to 1-2%, 15% DVB is required to produce a soft, solid material. When DVB is greater than 20%, the resulting polymers are hard materials with plastic characteristics.

The BFE-initiated reaction between NFO, DVB and NBD also produces hard plastics with appropriate stoichiometries. A small amount of the alkene comonomers results in the production of viscous oils. Typical hard plastics have been produced from reactions with 20% DVB and 10% NBD. DVB and DCP have also been simultaneously copolymerized with the NFO to produce thermosets. Similarly, hard plastics have been prepared using 20% DVB and 10% DCP. However, attempts to produce solid materials by polymerizing just the NFO and DCP or NBD have been unsuccessful. In both cases, only dark, viscous oils are produced, no matter how much of the alkene comonomer is used in the reaction.

CFO-DVB-NBD-DCP Systems.

Conjugated NFO (CFO) is more reactive than the regular NFO. As a result, simple homopolymerization of the CFO results in a soft solid material. Its gel time reaches more than 72 hours at room temperature. As expected, the gel times from its copolymerization with various alkene comonomers decrease significantly, and the reaction rates appear to be similar to those of the above NFO systems.

The CFO reacts with DVB in the presence of BFE to produce very hard thermosets after three post-curing steps. A hard, pressure-resistant thermoset has been produced using only 5% DVB, 94% CFO and 1% BFE. The products become more rigid as the amount of DVB additive is increased from 5 to 30%. Hard plastics have been produced by polymerizing the CFO with 30% DVB using 1, 2 or 5% BFE.

Copolymerization of the CFO with DVB and NBD also produces hard plastics. Very hard thermosets have been prepared using 20% DVB, 10% NBD and 1, 2 or 5% BFE. Like the NFO systems, copolymerization of CFO with DVB and DCP also substantially improves the rigidity of the resulting thermosets.

Since the CFO is more reactive than the NFO, its copolymerization with alkene comonomers is quite different in some cases. While the reaction of NFO with 5% DVB, 5% NBD and 5% BFE produces only a soft gel, the same reaction with the CFO produces a hard thermoset with 96% overall mass recovery. The reaction of 85% NFO, 5% DVB, 5% DCP and 5% BFE produces a viscous oil, but the same reaction produces a hard pressure-resistant thermoset when CFO is used. Although the native NFO failed to produce solid thermosets when polymerized with DCP in the presence of BFE, the CFO produces a soft solid material when it is reacted with 5% DCP and 5% BFE. Increasing the amounts of DCP used in these reactions improves the rigidity of the polymers. A soft, rubbery copolymer may also be produced by reacting the CFO with 10% NBD and 5% BFE. However, increasing the amount of NBD used in the reaction results in the production of viscous oils. In general, thermosets prepared from CFO appear to be harder than the materials produced by the same reactions with the NFO.

Other Alkene Comonomers.

Table 28 shows that many other alkene comonomers, such as furfural, ρ-benzoquinone, ρ-mentha-1,8-diene, furan, Diels-Alder adducts 1-3, maleic anhydride, and vinyl acetate, have also been examined in the BFE-initiated copolymerization. Copolymerization of these alkene comonomers with NFO or CFO generates soft to hard polymers in the presence of DVB, NBD or DCP. However, without the DVB, NBD or DCP comonomers, solid polymers cannot be obtained by copolymerizing NFO or CFO with any of the following comonomers: Diels-Alder adducts 1 and 2, ρ-mentha-1,8-diene, methyl acrylate, vinylidene chloride, methyl crotonate, isoprene, dimethyl acetylenedicarboxylate, diallyl phthalate, myrcene, phenol, linalool, furfural, 2-allylphenol, 1,2-dimethoxybenzene or bisphenol A.

Interestingly, the copolymerization of acrolein and the CFO using catalytic BFE results in a violent exothermic reaction that is not slowed by cooling the reactants to 0° C. The addition of DVB to the acrolein-CFO system also produced an immediate exothermic reaction upon the addition of BFE.

Characteristics of the NFO and CFO Bulk Polymers

Structure of the Bulk Polymers.

The yields of the bulk polymers have been found to be essentially quantitative. Table 29 gives the elemental analysis results of some NFO and CFO bulk polymers. Apparently, the elemental compositions of the bulk polymers are very close to the results calculated from the reactants. It follows that the NFO (or CFO) and alkene comonomers are present in the resulting bulk polymers.

The structure of the bulk polymers has been studied by Soxhlet extraction with CH₂Cl₂ or THF as the refluxing solvents. Table 30 shows that 25-47% of soluble materials have been extracted from the NFO bulk polymers, and 17-34% of soluble materials from the CFO bulk polymers by CH₂Cl₂ or THF. In most cases, the remaining insoluble materials account for more than 70% of the total mass of the bulk NFO and CFO thermosets. The CFO bulk polymers possess much higher amounts of insoluble materials than the NFO bulk polymers. It has been found that the CH₂Cl₂ extraction results are very similar to the THF results, which indicates that both CH₂Cl₂ and THF are good solvents for the soluble materials present in the NFO and CFO bulk polymers.

FIG. 38 contains the ¹H (a) and ¹³C (b) NMR spectra of the soluble materials extracted from the bulk polymer CFO65-DVB30-BFE5. The results show that the extracted materials have a structure similar to that of the CFO, except that a substantial number of the C═C bonds have disappeared. The ¹H NMR spectrum shows very few vinylic hydrogens (δ=5.2-5.5 ppm), and the ¹³C NMR spectrum shows a limited number of sp² carbons in the alkene region (δ=120-140 ppm). It follows that the extracted soluble materials are unreacted free oils with very few C═C bonds. However, their molecular weights could not be measured by gel permeation chromatography (GPC) or mass spectrometry.

The insoluble materials are expected to be highly crosslinked polymeric materials. The THF insoluble materials resulting from the extraction of the CFO65-DCP30-BFE5 copolymer have been examined using solid state, magic angle spinning (MAS) ¹³C NMR spectroscopy (FIG. 39). The spectrum shows the presence of ester carbonyls (δ=165-175 ppm) and carbon-carbon double bonds (δ=120-140 ppm). The THF insoluble materials from the CFO65-DVB30-BFE5 copolymer were also examined by solid state, MAS ¹³C NMR. The data confirms the presence of ester carbonyls and carbon-carbon double bonds, although the double bonds present are largely due to the incorporation of DVB into the copolymer backbone.

The preceding discussion implies that the NFO and CFO bulk polymers are composed of crosslinked polymer networks with a certain amount of unreacted free oil. The fish oil segments incorporated into the crosslinked networks still have some unreacted C═C bonds present however.

Thermal Characterization of the Bulk Polymers.

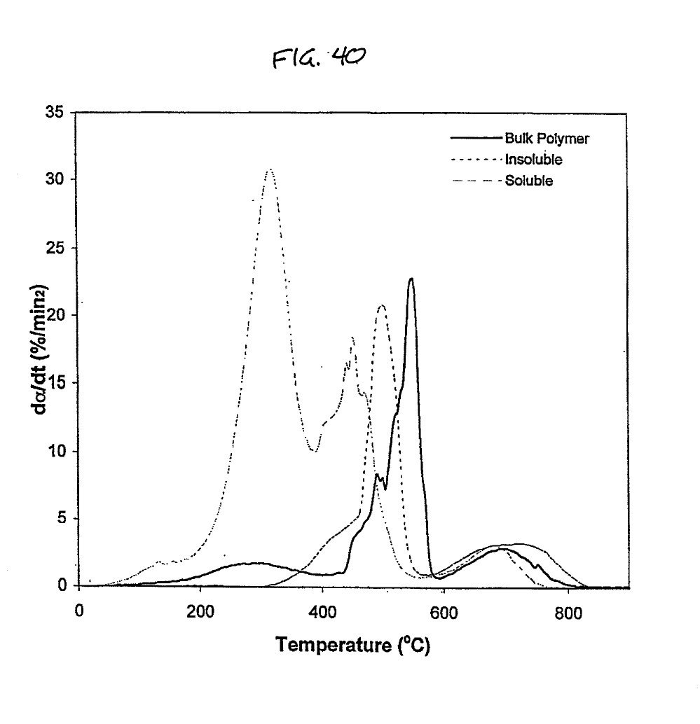

FIG. 40 shows the derivatives of the thermogravimetric analysis (TGA) curves of the bulk polymer CFO50-DVB15-NBD30-BFE5, plus its soluble and insoluble materials after extraction. Three characteristic weight loss steps are observed for the bulk polymer at approximately 200-400° C., 400-600° C. and 600-800° C., in an air atmosphere. In the first step, the bulk polymer loses approximately 10% of its weight. The second decomposition is the major process and corresponds to nearly 70% weight loss, which starts at 400° C. and ends around 600° C. The third step affords about 20% weight loss at 600-800° C. By comparing the TGA derivatives of the soluble and insoluble materials in FIG. 40, it becomes clear that the first decomposition of the bulk polymer corresponds to the major decomposition process of the free oils, the second decomposition corresponds to degradation and char formation of the crosslinked polymer network, and the final decomposition corresponds to oxidation of the char residues in air. In a nitrogen atmosphere, the third decomposition does not appear.

TGA data have been obtained for some NFO bulk polymers (Table 31, entries 1-4). The temperatures corresponding to 10% weight loss have been obtained under both nitrogen and air atmospheres for each bulk polymer. The percentage of polymer mass remaining at 400° C. was also noted for each thermoset. Generally, most of the NFO polymers lose 10% of their mass between 234 and 290° C. All of the thermosets still possess 72-79% of their initial mass at 400° C. Specifically, when some DVB is replaced by NBD, the resulting polymer shows a lower thermal stability (entries 1 and 2). As 1% initiator is used instead of 5%, the thermal stability of the resulting polymer slightly increases (entries 2 and 3). However, the NFO polymer with the highest thermal stability has been obtained by using DVB plus DCP comonomers (entry 4). It is also noteworthy that the NFO thermosets have a little higher thermal stability in air than in nitrogen. Such behavior is unexpected.

Table 31 also shows the TGA results for the CFO bulk polymers under both nitrogen and air atmospheres. Most of the CFO polymers appear to lose 10% of their mass between 226 and 338° C., a temperature region similar to that of the NFO bulk polymers. Generally, the thermal stability of the CFO bulk polymers is also related to their stoichiometries. Unlike the NFO bulk polymers, however, the thermal stability of the resulting polymers decreases when NBD or DCP replaces part of the DVB (entries 5, 8, 11). When more comonomers are used, the thermal stability of the resulting CFO polymer has been substantially increased (entries 8 and 9). For example, the polymer CFO50-DVB15-NBD30-BFE5 loses 10% of its mass at approximately 334-338° C. in both nitrogen and air atmospheres. The percentage of polymer mass remaining at 400° C. reaches as high as 87% (entry 9).

One might expect that the thermal stability would be, to some extent, related to the rigidity of the materials. However, in some cases, there appears to be little correlation. For instance, the polymer CFO65-DVB10-NBD20-BFE5 (entry 8) is much harder than the polymer NFO65-DVB10-DCP20-BFE5 (entry 4), but the softer polymer loses 10% of its mass under nitrogen at 285° C., while the harder polymer loses 10% of its mass at 244° C. The thermal stability of the polymers does not seem to be a function of the catalyst load used in the reaction either. For example, NFO69-DVB10-NBD20-BFE1 loses 10% of its weight at 249° C., while NFO65-DVB10-NBD20-BFE5 loses 10% of its weight at 234° C. Thus, the polymer produced using a smaller catalyst load is slightly more thermally stable. Generally, the 10% weight loss corresponds to the first decomposition step, i.e. evaporation and degradation of the free oils in the bulk polymers. This step is actually composed of two distinct processes, diffusion of the oil from the bulk to the surface and subsequent degradation or evaporation. Since the diffusion process is expected to be determined by many factors, it is difficult to correlate the polymer rigidity or stoichiometry with the thermal properties.

Differential scanning calorimetry (DSC) has also been used to examine the thermal properties of the NFO and CFO bulk polymers. A very broad shoulder has been observed at approximately 100° C., corresponding to the glass transitions of the thermosets. No post-curing behavior has been detected, which indicates that the glass transition temperatures are representative of fully cured thermosets.

Thermal Characterization of the Extracted Insoluble Materials.

Table 31 lists the TGA data for the CH₂Cl₂ and THF insoluble materials obtained after extraction of the NFO and CFO thermosets. Compared with the bulk polymers, the insoluble materials show remarkable thermal stability. The insoluble materials examined lost 10% of their mass at temperatures above 400° C.

The compositions of the bulk polymers seem to have no direct effect on the thermal stability of the insoluble materials. For instance, contrary to expectations, the CH₂Cl₂ and THF insoluble materials from the CFO94-DVB5-BFE1 copolymer (entry 7) are more thermally stable than the CH₂Cl₂ and THF insoluble materials resulting from the CFO65-DVB10-NBD20-BFE5 copolymer (entry 8). The insoluble materials do not contain low molecular weight substances. Thus, their thermal stability is expected to be determined by the nature of the crosslink network structure, which, at this stage, is difficult to characterize.

However, unlike the bulk polymers, all of the insoluble materials appear to be more thermally stable in nitrogen than in air. The highest thermal stability recorded for any of the insoluble materials was a 10% weight loss at 456° C. under a nitrogen atmosphere for the THF insoluble materials from the NFO65-DVB30-BFE5 copolymer (entry 1).

The NFO and CFO have proven to be cationically polymerizable monomers. Homopolymerization of the NFO or CFO only affords low molecular weight viscous oils in most cases. Copolymerization of NFO or CFO with a wide range of alkene comonomers results in viable solid plastics within appropriate stoichiometries. Among a number of Lewis acids, boron trifluoride diethyl etherate (BFE) has proven to be the most effective initiator for copolymerization. Comonomers, such as divinylbenzene, norbornadiene and dicyclopentadiene, are necessary for copolymerization to afford viable thermoset plastics. The gelation process of the copolymerization is largely dependent upon the stoichiometry, the type of comonomer employed, and the reaction conditions. Following post-curing at elevated temperatures, the BFE-initiated copolymerization affords solid materials ranging from soft rubbers to rigid plastics, which appear to be fully cured thermosets.

The resulting NFO and CFO bulk polymers are composed of a crosslinked polymer network and a certain amount of free oils. Generally, the CFO bulk materials possess more crosslinked polymer than the NFO bulk materials. However, their thermal properties are similar to each other. The bulk polymers lose 10% of their weight at 230-330° C., and the percentage of polymer mass remaining at 400° C. ranges from 65% to 87%. The insoluble materials remaining after extraction exhibit much higher thermal stability with 10% weight loss at 401-445° C.

TABLE 27
Fish oil fatty acid (ethyl ester) composition

| number of C═C bonds | % |
|---|---|
| 0 | 8.90 |
| 1 | 18.20 |
| 2 | 1.10 |
| 3 | 0.99 |
| 4 | 6.03 |
| 5 (EPA + DPA) | 37.25 |
| 6 (DHA) | 24.72 |
| unknown | 2.81 |

TABLE 28
Some alkene comonomers used for cationic copolymerization with NFO or CFO

| Entry | Comonomers | Examples | Products |
|---|---|---|---|
| 1 | furfural | 60-70% NFO + 5-10% furfural + 20-25% DVB + 5% BFE | hard thermosets |
| 2 | p-benzoquinone | 60-70% NFO + 10-15% p-benzoquinone + 10-25% DVB + 5% BFE | hard thermosets |
| 3 | p-mentha-1,8-diene | 65% NFO + 10% p-mentha-1,8-diene + 20% DVB + 5% BFE | hard thermosets |
| | | 65% CFO + 10% p-mentha-1,8-diene + 20% DVB + 5% BFE | |
| 4 | furan | 65-70% NFO + 10-15% furan + 15% DVB + 5% BFE | hard thermosets |
| 5 | 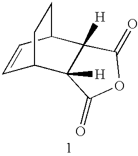 | 65% CFO + 10% 1, 2 or 3 + 20% DVB + 5% BFE | hard thermoset |
| | 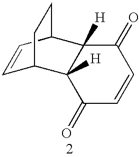 | 65% CFO + 30% 1, 2 or 3 + 5% BFE | soft polymer |
| | 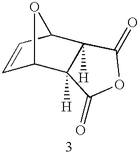 | | |
| 6 | maleic anhydride | 65 CFO + 30% maleic anhydride + 5% BFE | rubbery material |
| | | 65% NFO + 10-20% maleic anhydride + 10-20% DVB + 5% BFE | rigid thermosets |
| 7 | vinyl acetate | 75% CFO + 15% vinyl acetate + 5% DVB + 5% BFE | hard thermoset |
| | | 75% CFO + 20% vinyl acetate + 5% BFE | soft polymer |

TABLE 29
Elemental analysis of some bulk polymers

| | | Theoretical results | | Calculated results | |
|---|---|---|---|---|---|
| Entry | Polymers | C | H | C | H |
| 1 | NFO65-DVB10-DCP20-BFE5 | 80.8 | 10.3 | 78.0 | 10.2 |
| 2 | CFO65-DVB30-BFE5 | 80.0 | 9.8 | 79.0 | 9.7 |
| 3 | CFO94-DVB5-BFE1 | 78.2 | 10.8 | 79.7 | 10.8 |
| 4 | CFO65-DVB10-NBD20-BFE5 | 79.8 | 10.1 | 78.3 | 10.0 |

TABLE 30
Soxhlet extraction results for the NFO and CFO polymers

| | | Bulk Polymer Extraction | |
|---|---|---|---|
| | | (% insoluble − % soluble) | |
| Entry | Polymer | CH₂Cl₂ | THF |
| 1 | NFO65-DVB30-BFE5 | 58-37 | 65-32 |
| 2 | NFO65-DVB10-NBD20-BFE5 | 73-25 | 60-38 |
| 3 | NFO69-DVB10-NBD20-BFE1 | 55-45 | 58-42 |
| 4 | NFO65-DVB10-DCP20-BFE5 | 52-47 | 49-47 |
| 5 | CFO65-DVB30-BFE5 | 77-19 | 78-19 |
| 6 | CFO85-DVB10-BFE5 | 74-22 | 72-26 |
| 7 | CFO94-DVB5-BFE1 | 64-31 | 64-34 |
| 8 | CFO65-DVB10-NBD20-BFE5 | 79-17 | 75-23 |
| 9 | CFO50-DVB15-NBD30-BFE5 | 86-10 | 84-16 |
| 10 | CFO89-DVB5-NBD5-BFE1 | 68-26 | 66-33 |
| 11 | CFO65-DVB10-DCP20-BFE5 | 75-17 | 74-23 |

TABLE 31
TGA results for the NFO and CFO polymers and their extracted materials

| | | Bulk Polymer TGA | | | | Extracted Polymer TGA | |
|---|---|---|---|---|---|---|---|
| | | 10% T_{N2} | % Mass N₂ | 10% Tₐᵢᵣ | % Mass air | 10% T_{N2}-Tₐᵢᵣ (° C.) | |
| Entry | Polymer | (° C.) | (400° C.) | (° C.) | (400° C.) | CH₂Cl₂ | THF |
| 1 | NFO65-DVB30-BFE5 | 265 | 72 | 269 | 74 | 445-436 | 456-442 |
| 2 | NFO65-DVB10-NBD20-BFE5 | 234 | 74 | 234 | 76 | 426-410 | 432-396 |
| 3 | NFO69-DVB10-NBD20-BFE1 | 249 | 76 | 254 | 79 | 431-428 | 418-410 |
| 4 | NFO65-DVB10-DCP20-BFE5 | 285 | 77 | 290 | 79 | 445-448 | 433-392 |
| 5 | CFO65-DVB30-BFE5 | 239 | 76 | 271 | 69 | 438-405 | 436-389 |
| 6 | CFO85-DVB10-BFE5 | 284 | 75 | 283 | 76 | 418-382 | 422-387 |
| 7 | CFO94-DVB5-BFE1 | 238 | 65 | 245 | 67 | 423-393 | 427-396 |
| 8 | CFO65-DVB10-NBD20-BFE5 | 244 | 79 | 231 | 80 | 401-413 | 373-358 |
| 9 | CFO50-DVB15-NBD30-BFE5 | 334 | 87 | 338 | 87 | 402-394 | 386-371 |
| 10 | CFO89-DVB5-NBD5-BFE1 | 249 | 67 | 246 | 70 | 432-424 | 427-415 |
| 11 | CFO65-DVB10-DCP20-BFE5 | 226 | 72 | 239 | 76 | 438-417 | 438-421 |

K) Properties of Fish Oil Plastics

Polymeric materials have been prepared from the cationic copolymerization of fish oil ethyl ester (NFO), conjugated fish oil ethyl ester (CFO) or triglyceride fish oil (TFO) with styrene and divinylbenzene initiated by boron trifluoride diethyl etherate (BF₃.OEt₂). These materials are typical thermosetting polymers with crosslink densities ranging from 1.1×10² to 2.5×10³ mol/m³. The thermogravimetric analysis of the new fish oil polymers exhibits three distinct decomposition stages at 200-340° C., 340-500° C. and >500° C., respectively, with the maximum weight loss rate at approximately 450° C. Single glass-transition temperatures of T_{g}=30-109° C. have been obtained for the fish oil polymers. As expected, these new polymeric materials exhibit tensile stress-strain behavior ranging from soft rubbers through ductile to relatively brittle plastics. The Young's modulus (E) of these materials varies from 2 to 870 MPa, the ultimate tensile strength (σ_{b}) varies from 0.4 to 42.6 MPa, and the percent elongation at break (ε_{b}) varies from 2% to 160%. The failure topography indicates typical fracture mechanisms of rigid thermosets, and the unique fibrillation on the fracture surface gives rise to relatively high mechanical properties for the corresponding NFO polymer. The fish oil polymers not only exhibit thermophysical and mechanical properties comparable to petroleum-based rubbery materials and conventional plastics, but also possess more valuable properties, such as good damping and shape memory behavior, which most petroleum-based polymers do not possess, suggesting numerous promising applications of these novel fish oil-based polymeric materials.

Materials

The Norway fish oil ethyl ester (NFO) used was Norwegian Pronova EPAX 5500 EE, Bergen, Norway. The conjugated NFO (CFO) was prepared from the NFO in our laboratory by using Wilkinson's catalyst [RhCl(PPh₃)₃]. The degree of conjugation was calculated to be about 90 mol %. The triglyceride fish oil (TFO) is Norwegian Pronova EPAX 5500 TG, Bergen, Norway. Styrene and divinylbenzene (80 mol % DVB and 20 mol % ethylvinylbenzene) have been purchased from Aldrich Chemical Company and used as received. The distilled grade boron trifluoride diethyl etherate (BF₃.OEt₂) used to initiate cationic polymerization of the various fish oils was also supplied by Aldrich.

Copolymerization

The polymeric materials have been prepared by the cationic copolymerization of NFO, CFO or TFO with ST and DVB initiated by BFE. The desired amounts of ST and DVB were added to the fish oil. The total amount of reactants was around 50 grams. The reaction mixture was vigorously stirred, followed by the addition of an appropriate amount of BFE initiator. The reaction mixture was then injected into a Teflon mold, which was sealed by silicon adhesive and heated for a given time at the appropriate temperatures, usually 12 hours at room temperature, followed by 12 hours at 60° C. and then 24 hours at 110° C. The yields of resulting polymers are essentially quantitative. The nomenclature adopted in this work for the polymer samples is as follows: NFO, CFO and TFO represent fish oil ethyl ester, conjugated fish oil ethyl ester and triglyceride fish oil, respectively; ST and DVB are the styrene and divinylbenzene comonomers; BFE is the boron trifluoride diethyl etherate initiator. For example, NFO49-ST33-DVB15-BFE3 corresponds to a polymer sample prepared from 49 wt % NFO, 33 wt % ST, 15 wt % DVB and 3 wt % BFE initiator. Since the amount of ethylvinylbenzene present in the DVB is minimal, we have omitted it from our nomenclature to avoid confusion.

Characterizations

Soxhlet extraction was used to characterize the structures of the fish oil bulk polymers. A 2 g sample of the bulk polymer was extracted for 24 hours with 100 ml of refluxing methylene chloride using a Soxhlet extractor. After extraction, the resulting solution was concentrated by rotary evaporation and subsequent vacuum drying. The soluble substances were isolated for further characterization. The insoluble solid was dried under vacuum for several hours before weighing.

A Perkin-Elmer Pyris-7 thermogravimeter was used to measure the weight loss of the polymeric materials in air. Generally, 6 mg of bulk polymer was used in the thermogravimetric analysis. The polymer samples were heated from 30 to 650° C. at a heating rate of 20° C./min, and the weight loss was recorded as a function of temperature.

The dynamic mechanical properties of the bulk polymers were obtained by using a Perkin-Elmer dynamic mechanical analyzer DMA Pyris-7e in a three-point bending mode. The rectangular specimen was made by copolymerizing the reactants in an appropriate mold. Thin sheet specimens of 2 mm thickness and 5 mm depth were used, and the span to depth ratio was maintained at approximately 2. Each specimen was first cooled to ca. −35° C., and then heated at 3° C./min and a frequency of 1 Hz under helium. The viscoelastic properties, i.e. storage modulus E′, and mechanical loss factor (damping) tan δ, were recorded as a function of temperature. The glass-transition temperature T_{g} of the polymer was obtained from the peak of the loss factor curve.

The damping properties have been quantitatively evaluated by the loss tangent maximum (tan δ)ₘₐₓ, the temperature range ΔT for efficient damping (tan δ>0.3), and the integral under the linear tan δ-temperature curve (tan δ area, TA). The TA values have been determined by first subtracting out the background, and then cutting and weighing the paper portions representing the tan δ area under consideration.

The shape memory behavior of the fish oil polymers was examined by a bending test. The specimen (80 mm×12 mm×3 mm) was first deformed to a maximum angle θₘₐₓ at the temperature T_{g}+50° C. by an external force (the specimen tended to break at deformed angles greater than θₘₐₓ). The deformed specimen was then rapidly brought to ambient temperature under the external force. When the external force was released at room temperature, minor shape recovery may occur, and the deformed angle changes from θₘₐₓ to θ (the deformed angle θ fixed at room temperature is typically a little smaller than the originally deformed angle θₘₐₓ). Finally, the deformed specimen was heated to various temperatures rapidly, and the remaining angle θ₁ at each temperature was recorded. The following definitions are employed in order to quantitatively characterize the shape memory properties of the polymers. The deformability (D) of the specimen at the deformation temperature T_{D}=T_{g}+50° C. is defined as D=θₘₐₓ/180×100%. The fixed deformation (FD) at room temperature, which depicts the ability of the specimen to fix its deformation at room temperature, is defined as FD=θ/θₘₐₓ×100%. The shape recovery is defined as R=(θ−θ₁)/θ×100%. The ¹H NMR spectra were recorded in CDCl₃ using a Varian Unity spectrometer at 300 MHz and 75.5 MHz, respectively.

The tensile tests have been conducted at 25° C. according to ASTM-D638M specifications using an Instron universal testing machine (Model-4502) at a cross-head speed of 5 mm/min. The dumbbell-shaped test specimen has a gauge section with a length of 50 mm, a width of 10 mm, and a thickness of 3 mm. The gauge section is joined to wider end sections by two long tapered sections. The dumbbell-shaped specimens were prepared by cutting the material out of a polymer plate, and at least five identical specimens were tested for each polymer sample. The Young's modulus (E), ultimate tensile strength (σ_{b}) and elongation at break (ε_{b}) of the polymers were obtained from the tensile tests. The toughness of the polymer, which is the fracture energy per unit volume of the specimen, was obtained from the area under the corresponding tensile stress-strain curve.

Scanning electron microscopy (SEM) observations have been made using a Joel 5800LV SEM microscope. The failure surfaces of the test samples were carefully cut, and sputter-coated with palladium and gold, and then examined under the microscope.

Structures of the Fish Oils, Alkene Comonomers, and their Cationic Copolymerization

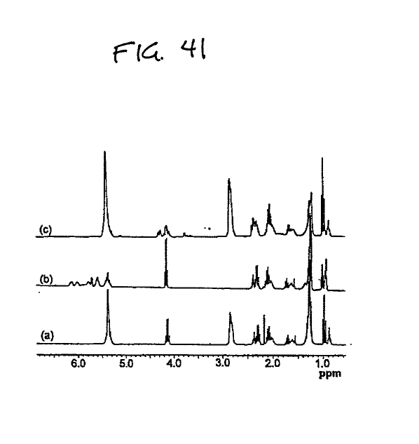

The ¹H NMR spectra of the three fish oils used in this study are shown in FIGS. 41(a) and (c). FIG. 35(a) indicates that the NFO used in this study is a mixture of fatty acid ethyl esters (the CH₂ of the ethyl esters is at δ=4.0-4.3 ppm) with a high degree of unsaturation (vinylic hydrogens at δ=5.1-5.5 ppm). This oil is known to contain approximately 90 mol % of unsaturated fatty acid ethyl esters, more than 60 mol % of which have ≧5 non-conjugated C═C bonds. The ¹H NMR spectrum of the conjugated NFO (CFO) in FIG. 41(b) indicates that conjugation does not affect the degree of unsaturation (vinylic hydrogens at δ=5.1-6.5 ppm), and approximately 90 mol % of the C═C bonds that can be conjugated have been conjugated in the fatty acid ethyl esters. The ¹H NMR spectrum of the TFO in FIG. 41(c) shows the protons in the methylene groups of the triglyceride at δ=4.0-4.4 ppm. The TFO is actually composed of 52 mol % triglyceride, 40 mol % diglyceride, 7 mol % monoglyceride and 1 mol % ethyl ester. Based on the spectra in FIG. 41(a)-(c), the NFO and CFO have been found to possess 3.6 C═C bonds per molecule on average, and the TFO has approximately 10 C═C bonds per triglyceride on average.

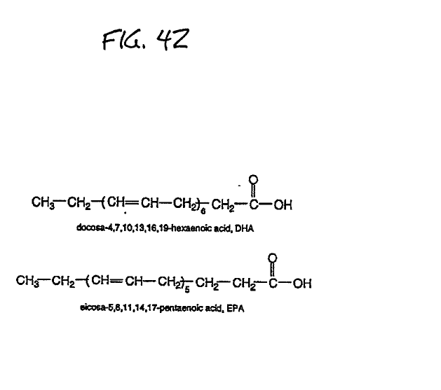

FIG. 42 shows the molecular structures of the two most abundant ω-3 fatty acids (esters) in the NFO and TFO, docosa-4,7,10,13,16,19-hexaenoic acid (DHA) and eicosa-5,8,11,14,17-pentaenoic acid (EPA). Accordingly, conjugated DHA and EPA, which are the major components of the CFO, exist as a number of fatty acid isomers, but the number of C═C bonds remains unchanged (not shown in FIG. 42).

The high degree of unsaturation of the three fish oils makes it possible to polymerize these oils by cationic polymerization. However, the viscous fish oils have relatively low mobility, and their reactivities are not high enough to give rise to high molecular weight polymers. Thus, alkene comonomers, such as ST and DVB, are added to get decent polymeric materials. These alkene comonomers possess lower molecular weights than the fish oils used. The conjugation of the C═C bonds with the aryl rings makes the ST and DVB more reactive towards cationic polymerization. Viable solid polymeric materials have been obtained.

Microstructure of the Fish Oil Polymers

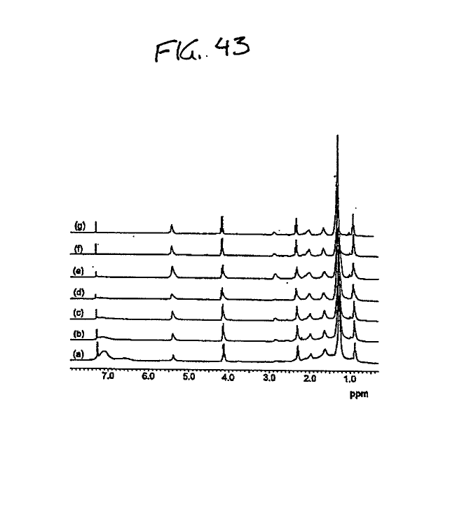

A wide variety of viable polymeric materials ranging from soft rubbers to tough and rigid plastics have been prepared from cationic copolymerization of the fish oils and the alkene comonomers. The yields of the bulk polymers have been found to be essentially quantitative. These bulk materials are typical thermosetting polymers due to the multitude of C═C bonds present in the fish oils and the DVB comonomer. Soxhlet extraction using methylene chloride as the refluxing solvent was used to study the structure of the polymeric materials. Typically, after Soxhlet extraction for 24 hours, about 56-88 wt % of insoluble substances are retained from the fish oil bulk polymers. These insoluble substances are found to be crosslinked fish oil-ST-DVB copolymers by solid state ¹³C NMR spectroscopy. The extracted soluble substances account for approximately 12-44 wt % of the bulk polymers. FIG. 43 shows the ¹H NMR spectra of the soluble substances extracted from a number of NFO-based bulk polymers. The spectra show the presence of aromatic polymer segments (δ=6.5-7.5 ppm), as well as the NFO segments (δ=4.0-4.3 ppm). These soluble substances appear to be mainly composed of fish oil-ST-DVB copolymers, but with relatively low molecular weights and less-crosslinked structures.

Table 32 lists the segmental compositions of the fish oil polymers prepared in this study. For all of the NFO polymers, the insoluble crosslinked NFO-ST-DVB copolymers contain greater amounts of rigid aromatic (ST+DVB) segments, whereas the soluble less-crosslinked fish oil-ST-DVB copolymers contain greater amounts of flexible polymerized fish oil segments in the polymer backbones (entries 1-9). An increase in NFO concentration does not obviously influence the polymerized NFO segments in the insoluble crosslinked copolymers, but significantly increases the amounts of NFO segments in the soluble less-crosslinked copolymers (entries 1-3). On the other hand, with increasing DVB concentration, the wt % of the aromatic segments and fish oil polymer segments both gradually increase in the insoluble crosslinked copolymers (entries 4-9).

With the same composition, the resulting polymers based on different fish oils have different compositions in their copolymer backbones (entries 10-12). Compared with the NFO polymer (entry 10), the more reactive conjugated C═C bonds in the CFO result in greater amounts of fish oil segments being incorporated into the insoluble crosslinked copolymers, but the aromatic segments still dominate the composition (entry 11). The TFO has a triglyceride structure and approximately 10 C═C bonds, and thus essentially acts as a crosslinking agent like DVB. As a result, a greater amount of fish oil polymer segments than aromatic polymer segments has been obtained in the insoluble crosslinked polymer backbones (entry 12).

Thermogravimetric Analysis (TGA)

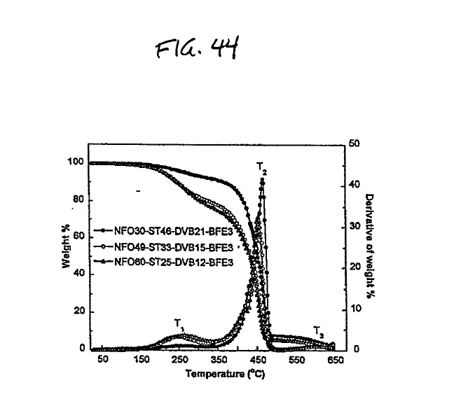

FIG. 44 shows the TGA curves and their derivatives for the NFO polymers prepared by varying the NFO concentrations. The thermosetting polymers appear to be relatively thermally stable at temperatures lower than 200° C. These materials lose about 8-23% of their weight at temperatures between 200 and 350° C., followed by an abrupt weight loss of 72-84% at temperatures between 350 and 500° C. The residual 10% weight loss occurs at T>500° C. The weight % derivative curves show the appearance of three decomposition stages at T₁=200-340° C., T₂=340-500° C., and T₃>500° C., respectively, with the maximum weight loss rate at T₂. Table 33 (entries 1-3) gives the TGA results for the NFO polymers. When the NFO concentration increases, the resulting NFO polymers exhibit an increased weight loss from 7.8% to 22.8% at T₁, an decreased weight loss from 84.4% to 71.6% at T₂, and an decreased weight loss from 7.8 to 5.6% at T₃. We have found that the weight losses at T₁ are associated with the low molecular weight and less-crosslinked fish oil-ST-DVB copolymers in the bulk materials. The second stage (T₂) corresponds to degradation and char formation of the crosslinked polymer networks, and the third decomposition stage (T₃) corresponds to oxidation of the char residues in air.

The DVB concentration is also expected to affect the thermal properties of the resulting NFO polymers. An increase in DVB concentration obviously reduces the amounts of the soluble less-crosslinked copolymers in the resulting bulk materials (Table 32, entries 4-9). As a result, a gradual decrease in the weight loss at T₁ is observed in Table 33, entries 4-9. Greater amounts of DVB also result in an increase in crosslinking density, and thus increase the weight loss at T₂, and facilitate formation of residual chars at T₃ for the resulting polymers.

The thermal decomposition properties of the different fish oil-based polymers are also effected by their polymer compositions and crosslinking structures, even though they have the same original composition (Table 33, entries 10-12). When more reactive CFO replaces NFO, the weight % loss at T₁ significantly decreases, whereas the weight % loss at T₂ significantly increases. Although the conjugated C═C bonds in the CFO are expected to be more reactive than the non-conjugated C═C bonds in the TFO, the TFO has a higher number of C═C bonds, and its triglyceride structure essentially contributes more to crosslinking than the linear CFO. As a result, TFO polymer possesses higher thermal properties than either the NFO or the CFO polymer.

Dynamic Mechanical Behavior

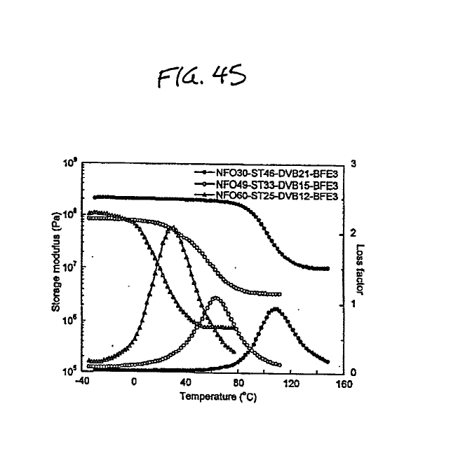

FIG. 45 shows that the NFO polymers prepared by varying the NFO concentration exhibit dynamic mechanical behavior similar to one another. The storage modulus initially remains almost constant at lower temperatures. As the temperature increases, the storage modulus exhibits a sharp drop, followed by a modulus plateau at higher temperatures, where the polymer behaves like a rubber. Apparently, the modulus drop corresponds to the onset of segmental mobility in the crosslinked polymer networks. The appearance of a relatively constant modulus at higher temperatures indicates that stable crosslinked networks exist in the bulk polymer. The storage moduli of the NFO polymers are related to the NFO concentrations in the polymer composition. As the NFO concentration increases, the resulting polymers show lower storage modulus over most of the temperature range studied. The onset of segmental mobility also shifts to lower temperatures. In addition, the rubbery moduli of the NFO polymers at T>T_{g} are associated with their degree of crosslinking. Based upon rubber elasticity theory, the crosslinking densities νₑ of these three NFO polymers are calculated to be approximately 9.9×10², 3.7×10², and 1.1×10² mol/m³ (Table 33, entries 1-3). The gradual decrease in crosslink densities is presumably due to the decreased amounts of crosslinking agent DVB in their compositions.

For each NFO polymer studied, a single loss factor peak has been observed. These loss factor peaks correspond to the glass-transition temperatures, i.e. α-relaxations of the crosslinked NFO polymers. As the NFO concentration increases, the loss factor peaks of the resulting NFO polymers shift to lower temperatures from 109° C. to 30° C., and the loss factor becomes intense. The single a-relaxation indicates that the new NFO polymers obtained in this study exhibit a single homogeneous phase at the molecular level. The structures of these polymers are mainly composed of insoluble crosslinked NFO-ST-DVB copolymer matrix interpenetrated with some soluble low molecular weight and less-crosslinked NFO-ST-DVB copolymers. Apparently, these copolymers, although containing different segmental compositions as mentioned in Table 32, are thermodynamically miscible.

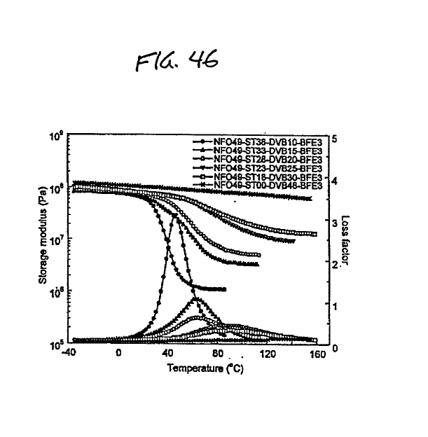

FIG. 46 shows the temperature dependence of the storage moduli E′ and loss factors for NFO polymers prepared by varying the DVB concentration, while the total concentration of the comonomers ST plus DVB remains constant at 48 wt %. When less than 5 wt % DVB is used, the resulting polymers behave like a non-vulcanized rubber, which cannot be made into specimens suitable for DMA measurements. Viable polymeric materials have been obtained by employing at least 10 wt % DVB. The polymer NFO49-ST38-DVB10-BFE3 shows very low moduli, especially at high temperatures, and its loss factor shows a very sharp peak at about 46° C. An increase in the DVB concentration does not greatly affect the low temperature moduli of the resulting polymers, but their high temperature moduli exhibit a dramatic increase. Such behavior is expected, because increasing the DVB concentration increases the degree of crosslinking. As the DVB concentration further increases, the molecular motions become more and more restricted, and thus the amount of energy that can be dissipated throughout the polymer specimen decreases dramatically. Therefore, the loss factor peak positions of the polymers shift to higher temperatures, and the loss factor intensities diminish accordingly. At an extremely high level of crosslinking, the tan δ peak almost disappears. As a result of crosslinking, a significant broadening of the α-relaxation is also observed. The broadening of the glass-to-rubber transition region is often assumed to be due to a broader distribution in molecular weight between crosslinks or some other kinds of heterogeneities in the network structure.

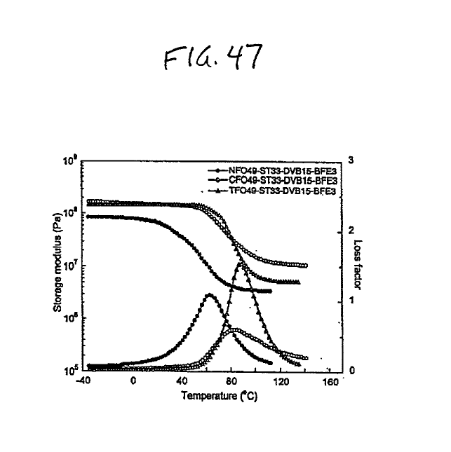

FIG. 47 gives the temperature dependence of the storage modulus E′ and the loss factor for the NFO, CFO and TFO polymers with the same composition. Compared with the NFO, the CFO is more reactive due to its conjugated C═C bonds. Thus, the resulting CFO polymer CFO49-ST33-DVB15-BFE3 possesses higher storage moduli over the whole temperature region than the corresponding NFO polymer. The glass-transition temperatures also increase from 63 to 83° C. The triglyceride structure of the more highly unsaturated TFO should contribute more to crosslinking than the ethyl esters of CFO. In fact, the TFO segments are much more flexible than the rigid aromatic segments in the crosslinked polymer networks. As a result, the TFO polymer with the same composition shows a lower rubbery modulus, i.e. a lower crosslinking density than the corresponding CFO polymer. However, their moduli at low temperatures are very similar to each other, and the glass-transition temperatures are of the same order of magnitude.

Damping Properties

These fish oil polymers exhibit good damping properties. Based upon group contributions to damping, the presence of ester groups attached to the polymer backbones in our fish oil bulk polymers should greatly contribute to their damping intensities. On the other hand, crosslinking restricts segmental motion, and thus reduces the fish oil polymer's ability to dissipate sound or vibration mechanical energy into thermal energy, i.e. reduces damping intensities near the glass transition. In addition, crosslinking increases the segmental heterogeneities of the polymer backbone, and thus effectively broadens the glass-transition (damping) regions of the fish oil polymers. With appropriate compositions and crosslinking densities, therefore, these new fish oil polymeric materials are capable of showing efficient damping over a wide temperature range. Good damping materials should exhibit a high loss factor (tan δ>0.3) over a temperature range of at least 60-80° C.

The loss factor tan δ, which indicates the damping ability of the material, is the ratio of the mechanical dissipation energy to the storage energy. Thus, a high tan δ value indicates good damping materials. Table 33 (entries 1-3) shows that, as the NFO concentration is increased, the loss tangent maxima (tan δ)ₘₐₓ of the resulting NFO polymers rises from 0.94 to 2.07. The polymer NFO30-ST46-DVB21-BFE3 exhibits efficient damping (tan δ>0.30) over a temperature range of ΔT=50° C. (entry 1). The damping of this polymer is improved by increasing the NFO concentration due presumably to the increasing number of ester groups in the resulting polymer backbone. The polymers NFO49-ST33-DVB15-BFE3 and NFO60-ST25-DVB12-BFE3 show high damping (tan δ>0.3) over much broader temperature ranges of ΔT=60° C. and ΔT=86° C. (entries 2 and 3), and are therefore also good damping materials. Their TA values reach 59 and 111, respectively, which are even higher than those of polyurethane-based IPN damping materials.

At a constant NFO concentration, the amounts of the crosslinking agent DVB obviously determine the crosslink densities, and thus significantly influence the damping properties of the resulting NFO polymers. As previously mentioned, at least 10 wt % DVB is required to afford a viable solid polymer material. The polymer NFO49-ST38-DVB10-BFE3 exhibits a (tan δ)ₘₐₓ value as high as 3.1, a temperature region of AT =58° C. at tan δ>0.3, and a high TA value of 95 K (entry 4). As the DVB concentration increases, the (tan δ)ₘₐₓ and TA values of the resulting polymers gradually decrease. However, the ΔT value first increases, reaching a maximum at 15 wt % DVB, and then gradually decreases. Overall, when less than 15 wt % DVB is employed, the resulting polymers exhibit high damping (tan δ>0.3) over a wide temperature range (ΔT=58-60° C.) (entries 4 and 5). When 20-25 wt % DVB is used, the resulting NFO polymers still show a relatively broad temperature range for efficient damping (ΔT=46-50° C.) (entries 6 and 7). However, when more than 30 wt % DVB is employed, the resulting polymers exhibit (tan δ)ₘₐₓ values in the vicinity or much lower than 0.3, and are no longer good damping materials (entries 8 and 9).

The damping results for polymers based on different fish oils are also listed in Table 33, entries 10-12. The polymer NFO49-ST33-DVB15-BFE3 is a good damping material (entry 10). The high reactivity of the conjugated NFO (CFO) results in a high crosslink density, and the reduction of damping intensity by crosslinking becomes pronounced. As a result, the damping properties of the CFO polymers are inferior to those of the corresponding NFO polymer. As mentioned above, the triglyceride TFO is likely to contribute more to crosslinking of the polymer backbones. The relatively greater amounts of ester groups incorporated into the TFO polymer backbones give rise to the highest (tan δ)ₘₐₓvalue of the three different fish oil polymers.

Thermally Stimulated Shape Memory Behavior

Shape memory refers to the ability of certain materials to remember a shape, on demand, even after rather severe deformations. The basic principle of the shape memory effect in polymeric materials can be well described by their elastic modulus-temperature behavior. At temperatures above the glass-transition temperature (T_{g}), the polymer achieves a rubbery elastic state where it can be easily deformed. When the material is then cooled below its T_{g}, the deformation is fixed and the deformed shape is obtained. The deformed material can easily return to its original shape by reheating the material to a temperature higher than the T_{g}. This is the shape memory effect.

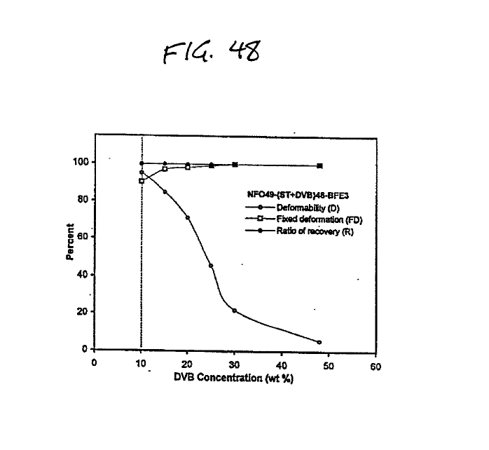

As previously mentioned, most of the fish oil polymers possess glass-transition temperatures higher than room temperature (Table 33), and stable crosslinked polymer networks have been shown to exist in the bulk materials. Thus, the fish oil polymers are expected to show shape memory effect. The shape memory results of the fish oil polymers are also included in Table 33. The NFO polymer NFO30-ST46-DVB21-BFE3 has a relatively low deformability at T>T_{g} (D=53%), but exhibits a good ability to fix its deformation (FD=99%) at room temperature (entry 1). As the NFO concentration is increased, the resulting polymer shows an improved deformability (D=85%) at T>T_{g}, but its ability to fix the deformation is reduced to FD=97% (entry 2). When the NFO concentration exceeds 50 wt %, the resulting polymer actually shows characteristics of an elastomer with FD=10% (entry 3). As expected, the DVB concentration has an effect on the shape memory behavior of the resulting NFO polymers contrary to that of the NFO concentration. Typically, an increase in DVB concentration reduces the deformability of the resulting NFO polymers at T>T_{g}, but improves the ability of the polymers to fix their deformation at ambient temperature (entries 4-9). It follows that the deformability of the polymer at T>T_{g} is determined by the rubbery modulus at high temperatures, whereas the ability of the polymer to fix its deformation at room temperature is determined by the room temperature modulus. The driving force for shape recovery of the deformed fish oil polymers is the strong relaxations of the oriented polymer chains between crosslinks, which occurs during heating above the glass-transition temperature. Note that the polymers show 100% recovery of the fixed deformation upon reheating to T_{g}+50° C., indicating that the crosslink density is high enough to effectively store and release the stored elastic energy at various temperatures. FIG. 48 shows the plot of shape memory results versus the DVB concentration. The optimal combinations of shape memory properties are found in two NFO polymers NFO49-ST38-DVB10-BFE3 and NFO49-ST33-DVB15-BFE3 (Table 33; entries 4 and 5). Their properties are very close to those of the petroleum-based shape-memory polymers with deliberately designed molecular structures, such as grafted copolymers, segmented block copolymers, and some hybrid copolymers. In addition, the polymers based on different fish oils show similar abilities to fix deformation at ambient temperature (entries 10-12), although their deformabilities are different from one another. Overall, the NFO polymer exhibits better shape memory properties than the corresponding CFO and TFO polymers.

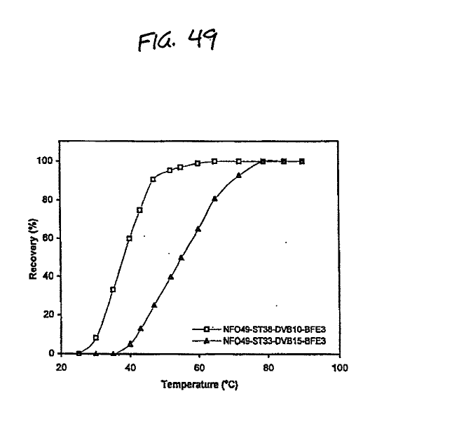

FIG. 49 shows the shape recovery results at various temperatures for two NFO polymers. The polymer NFO49-ST38-DVB10-BFE3 shows an onset of shape recovery at low temperatures; 100% recovery is reached at about 60° C. The NFO49-ST33-DVB15-BFE3 shows an onset of shape recovery at relatively high temperatures, and full shape recovery is obtained at about 80° C. These initial shape recovery processes are inherently related to the onset of segmental motions (glass transition) in the NFO polymers. Due to the broad glass transitions (damping), the shape recovery temperature ranges for the two NFO polymers are also very broad, i.e. 40-50° C.

Tensile Mechanical Properties

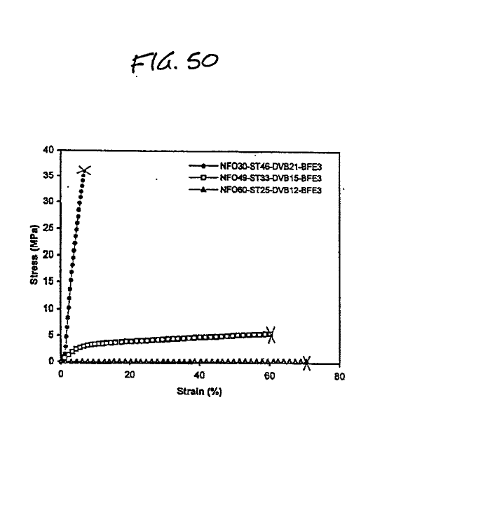

FIG. 50 shows the tensile stress-strain behavior of the NFO polymers prepared by varying the NFO concentration, while the weight ratio of ST to DVB comonomers remains at approximately 2:1. The tensile behavior of the polymers is highly dependent upon the NFO concentration. For example, the polymer NFO30-ST46-DVB21-BFE3 has a composition with rigid aromatic comonomers prevalent in the stoichiometry. This polymer shows the typical tensile behavior of a rigid plastic with a Young's modulus E of 870 MPa, an ultimate tensile strength σ_{b} of 36.1 MPa, and an elongation at break σ_{b} of about 7% (Table 34, entry 1). As the NFO concentration increases and the NFO becomes equivalent to the ST plus DVB comonomers in weight, the resulting polymer NFO49-ST33-DVB15-BFE3 shows the typical stress-strain behavior of a soft plastic. Compared with the rigid plastic NFO30-ST46-DVB21-BFE3, the soft plastic NFO49-ST33-DVB15-BFE3 shows a big decrease in the Young's modulus E and ultimate tensile strength σ_{b}, but a significant increase in the ductility and toughness (entry 2). As the NFO concentration exceeds that of the comonomers, the resulting polymer NFO60-ST25-DVB12-BFE3 exhibits tensile behavior similar to a very soft rubbery material (entry 3).

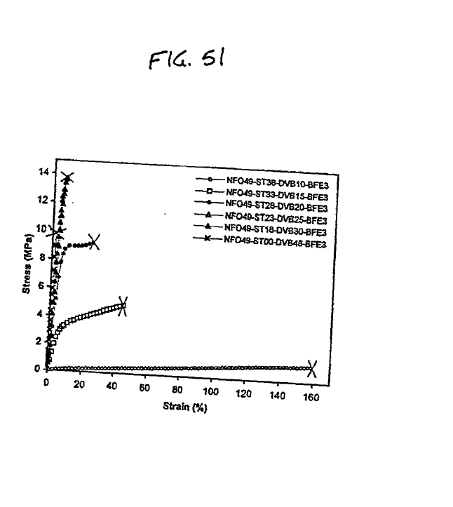

FIG. 51 shows the room temperature tensile behavior of the NFO polymers prepared by varying the DVB concentration. The polymers NFO49-ST48-DVB00-BFE3 and NFO49-ST43-DVB05-BFE3 appear to be non-vulcanized rubbers without elasticity. When 10 wt % of DVB is employed, the resulting polymer NFO49-ST38-DVB10-BFE3 shows a rubbery modulus, a viable ultimate tensile strength σ_{b} and an elongation at break σ_{b} of approximately 160% (Table 34, entry 4). Even though its glass-transition temperature T_{g} (46° C.) is a little higher than room temperature, this polymer exhibits tensile test behavior similar to a vulcanized natural rubber. When further increasing the amount of DVB, the Young's modulus E and ultimate tensile strength σ_{b} of the resulting polymers obviously increase, but their elongation at break σ_{b} gradually decreases (entries 5-8). When DVB has completely replaced the ST, the polymer NFO49-ST00-DVB48-BFE3 possesses the highest elastic modulus, but its ultimate tensile strength σ_{b} and elongation at break σ_{b} are considerably reduced (entry 9). The toughness of the NFO polymer first increases with an increase in DVB concentration. It reaches a maximum at 15 wt % DVB (entry 5) and then gradually decreases. A very brittle NFO plastic with rather low toughness is obtained when pure DVB is employed (entry 9).

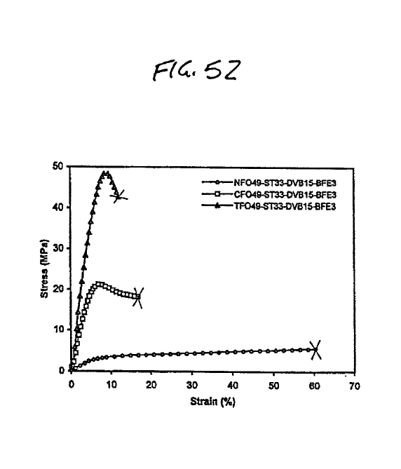

FIG. 52 shows the tensile stress-strain behavior of different fish oil polymers with the same composition. The NFO polymer exhibits characteristics of a soft plastic (Table 34, entry 10). The more reactive CFO results in a relatively hard plastic (entry 11), which shows the appearance of yielding behavior, followed by strain softening. No strain hardening behavior is observed before the specimen breaks. A very rigid plastic is obtained from the TFO. Its Young's modulus E reaches 820 MPa, and its ultimate tensile strength σ_{b} reaches 42.6 MPa (entry 12). The TFO plastic specimen breaks on the verge of its intrinsic yielding point.

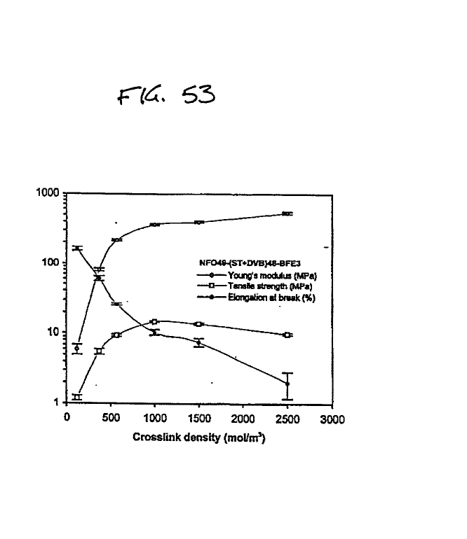

FIG. 53 plots the Young's modulus E, ultimate tensile strength σ_{b} and elongation at break ε_{b} against crosslink densities νₑ of the NFO polymers prepared in this study. It shows that crosslinking dramatically affects the mechanical properties of the thermosetting polymers. Generally, the polymer segmental motions are frozen in a glassy state. The elastic modulus is obtained from the initial strain resulting from changes in the covalent bond lengths and angles generated upon loading. Thus, crosslinking has relatively little effect on the magnitude of the elastic modulus of the thermosetting polymers in the glassy state (i.e., at temperatures below their glass-transition temperatures). However, the room temperature Young's moduli of the fish oil polymers shown in FIG. 53 have been greatly influenced by the degree of crosslinking, even though most of the materials possess a T_{g} higher than room temperature (refer to Table 33). However, it should be noted that the glass-transition regions of the fish oil polymers cover a wide temperature range, apparently including room temperature. This means that these glassy polymers contain frozen-in segmental chains, as well as mobile segmental chains. The change in covalent bond length and segmental deformations both contribute to the elastic behavior of the polymers. The segmental deformation, which is determined by the crosslinking density, is of course expected to make a major contribution. Thus, the Young's modulus of the fish oil polymers at room temperature is effected by the degree of crosslinking.

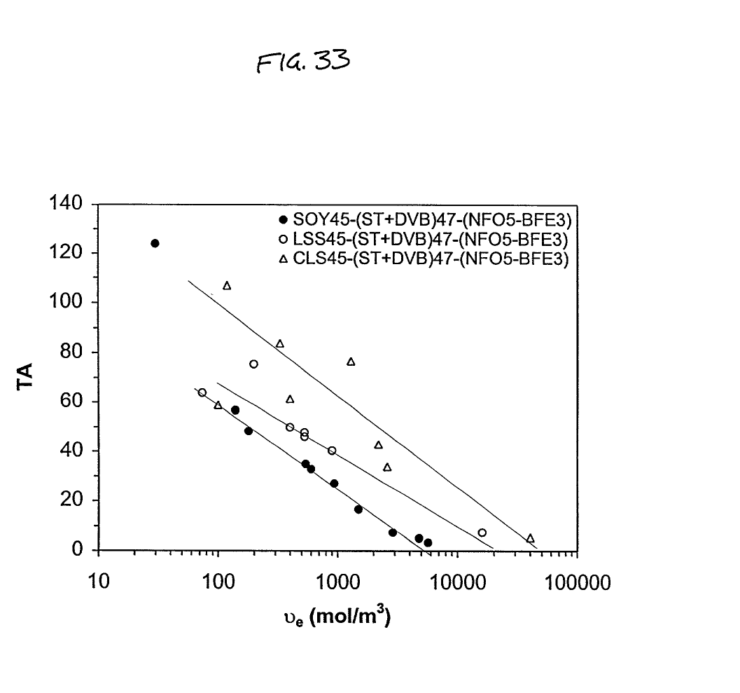

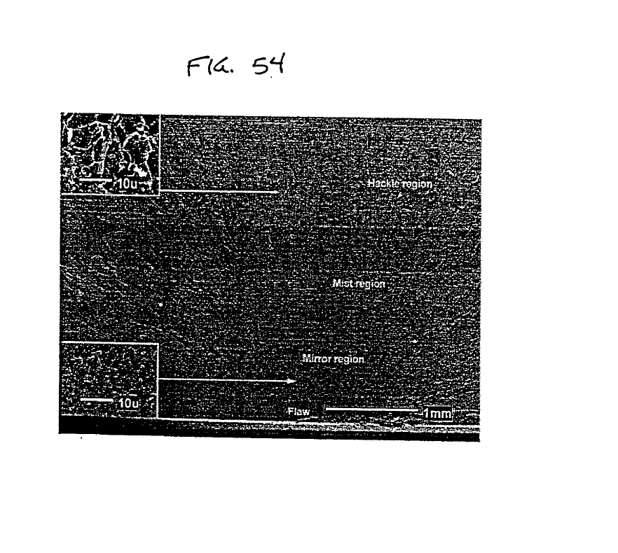

In addition, crosslinking increases the number of bonding chains at a crack tip, and thus improves the ultimate tensile strength σ_{b} of the fish oil polymers (FIG. 33). However, when further increasing the crosslink density νₑ, the ultimate tensile strength σ_{b} of the polymers slightly decreases. It is speculated that high crosslinking reduces the number of conformations that the polymer can adopt upon being loaded. As a crack grows to a failure, the matrix can dissipate only a small amount of energy, leading to low ultimate tensile strength σ_{b}. FIG. 54 also shows a steady decrease in elongation at break ε_{b} with increasing crosslink density νₑ. Such behavior is expected, because crosslinking reduces the segmental mobility and flexibility of the polymer chains.

Failure Topography and Fracture Mechanisms

FIG. 54 shows the SEM photograph of the tensile fracture surface of the rigid NFO plastic NFO30-ST46-DVB21-BFE3. Apparently, the fracture is initiated by a flaw, which normally is due to a material defect (flaw), such as a pore, an inclusion or any other local inhomogeneity. The flaw region is surrounded by a slow-growth mirror region, an area with a smooth, glossy appearance. Although rigid thermosets can and often exhibit plastic deformation under conditions of fracture, this is the first time, to our knowledge, that plastic deformations result in a thin layer of broken polymer fibrils in the glossy mirror region. This particular plastic deformation behavior results in high mechanical properties for the NFO plastic (Table 34, entry 1). Rapid-growth mist and hackle regions cover the remainder of the surface, which shows a ridged and furrowed structure running parallel to the propagation direction. The direction of crack growth can be determined from river markings in the slow-growth region, which radiate from the point where the crack is initiated.

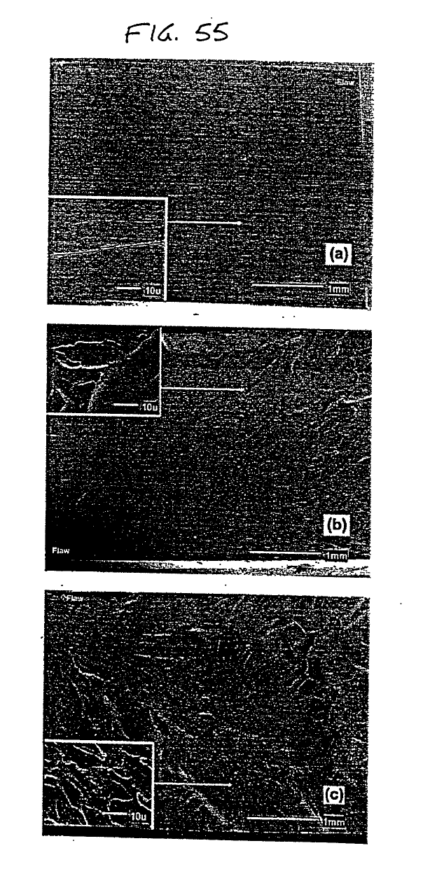

FIG. 55 shows the tensile fracture surfaces of the NFO, CFO, and TFO plastics with the same composition. Their fracture morphologies are consistent with their mechanical properties. For example, the polymer NFO49-ST33-DVB15-BFE3 has the lowest Young's modulus E and ultimate tensile strength σ_{b} (Table 34, entry 10), and a smooth fracture surface is observed even at high magnification. Comparatively, the CFO49-ST33-DVB15-BFE3 has a higher Young's modulus E and ultimate tensile strength σ_{b} (entry 11). Accordingly, mirror, mist and hackle regions all are observed on the fracture surface, and the fracture surface becomes increasingly rough along the crack propagation. The polymer TFO49-ST33-DVB15-BFE3 has a much higher Young's modulus E and ultimate tensile strength σ_{b} (Table 34, entry 12). Its whole fracture surface is rather rough. No single fracture mechanism is expected.

A variety of new polymeric materials ranging from elastomers through ductile to rigid plastics have been prepared from the cationic copolymerization of NFO, CFO or TFO with ST and DVB initiated by BFE. These thermosetting polymers possess crosslink densities ranging from 1.1×10² to 2.5×10³ mol/m³, and glass-transition temperatures ranging from 30 to 109° C. Although the materials are composed of fish oil-ST-DVB copolymers with various segmental compositions, all of the components are thermodynamically miscible in a single phase. The new polymers appear to be thermally stable at temperatures lower than 200° C. A multiple thermal decomposition behavior is observed with the maximum weight loss rate at approximately 450° C., which is inherently associated with the compositions and structures of the bulk polymers.

The tensile stress-strain behavior of the new fish oil polymers have been investigated as a function of their stoichiometry and the type of fish oil employed. The resulting polymers demonstrate a range of tensile behavior from soft rubbery materials through ductile to rigid plastics. Yielding behavior is observed in the tensile stress-strain curves of the CFO and TFO plastics. The TFO polymer possesses the highest mechanical properties, with the roughest fracture surfaces, compared to the corresponding NFO and CFO polymers.

In addition to thermophysical and mechanical properties comparable to petroleum polymers, the new fish oil polymers with appropriate compositions exhibit good damping properties and typical shape memory effects. These new and more promising properties make it possible to fabricate novel, value-added polymer products from these fish oil polymeric materials.

TABLE 32
Segmental compositions of the fish oil polymers

| | | Bulk polymer composition^{a} | |
|---|---|---|---|
| Entry | Polymer sample | Insoluble part | Soluble part^{b} |
| 1 | NFO30-ST46-DVB21-BFE3 | 88 (22 + 66) | 9 (8 + 1) |
| 2 | NFO49-ST33-DVB15-BFE3 | 72 (28 + 44) | 25 (21 + 4) |
| 3 | NFO60-ST25-DVB12-BFE3 | 56 (24 + 32) | 41 (36 + 5) |
| 4 | NFO49-ST38-DVB10-BFE3 | 64 (23 + 41) | 33 (26 + 7) |
| 5 | NFO49-ST33-DVB15-BFE3 | 72 (28 + 44) | 25 (21 + 4) |
| 6 | NFO49-ST28-DVB20-BFE3 | 77 (31 + 46) | 20 (18 + 2) |
| 7 | NFO49-ST23-DVB25-BFE3 | 78 (31 + 47) | 19 (18 + 1) |
| 8 | NFO49-ST18-DVB30-BFE3 | 81 (34 + 47) | 16 (15 + 1) |
| 9 | NFO49-ST00-DVB48-BFE3 | 86 (38 + 48) | 11 (11 + 0) |
| 10 | NFO49-ST33-DVB15-BFE3 | 72 (28 + 44) | 25 (21 + 4) |
| 11 | CFO49-ST33-DVB15-BFE3 | 85 (38 + 47) | 12 (11 + 1) |
| 12 | TFO49-ST33-DVB15-BFE3 | 85 (46 + 39) | 12 (3 + 9) |

^{a}Both the insoluble (crosslinked) and soluble (low molecular weight and less-crosslinked) substances by extraction in methylene chloride are composed of fish oil-ST-DVB copolymers. The result, for example 88 (22 + 66) in entry 1, means that insoluble crosslinked copolymer constitutes 88 wt % of the bulk polymer, of which approximately 22 wt % are polymerized fish oil segments and approximately 66 wt % are aromatic segments in the copolymer backbones.
^{b}Since a minimal amount of initiator is incorporated into the polymer chains, about 3 wt % of initiator fragments should actually exist in the soluble substances. This amount of initiator residue has been subtracted from the soluble part in this table before calculation. Note that addition of the insoluble part and the soluble part plus 3 wt % initiator residue equals 100 wt %.

TABLE 33
Characteristics of the fish oil polymers

| | | | | | | | Damping results | | Shape memory | | | |
|---|---|---|---|---|---|---|---|---|---|---|---|---|
| | | Vₑ | TGA results, ° C. (wt % loss)^{a} | | | T_{g} | (tan | | results (%)^{C} | | | |
| Entry | Polymer sample | (mol/m³) | T₁ | T₂ | T₃ | (° C.) | δ)ₘₐₓ | ΔT^{b} | TA | D | FD | R |
| 1 | NFO30-ST46-DVB21-BFE3 | 9.9 × 10² | 264 (7.8) | 467 (84.4) | 620 (7.8) | 109 | 0.94 | 87-137 (50) | 43 | 53 | 99 | 100 |
| 2 | NFO49-ST33-DVB15-BFE3 | 3.7 × 10² | 247 (20.9) | 456 (72.5) | 610 (6.6) | 63 | 1.09 | 35-95 (60) | 59 | 85 | 97 | 100 |
| 3 | NFO60-ST25-DVB12-BFE3 | 1.1 × 10² | 263 (22.8) | 455 (71.6) | 608 (5.6) | 30 | 2.07 | −8-78 (86) | 111 | 100 | 10 | 100 |
| 4 | NFO49-ST38-DVB10-BFE3 | 1.2 × 10² | 260 (22.8) | 445 (72.0) | 605 (5.2) | 46 | 3.10 | 24-82 (58) | 95 | 95 | 90 | 100 |
| 5 | NFO49-ST33-DVB15-BFE3 | 3.7 × 10² | 247 (20.9) | 456 (72.5) | 610 (6.6) | 63 | 1.09 | 35-95 (60) | 59 | 85 | 97 | 100 |
| 6 | NFO49-ST28-DVB20-BFE3 | 5.7 × 10² | 250 (20.7) | 460 (70.8) | 620 (8.5) | 64 | 0.62 | 45-95 (50) | 44 | 71 | 98 | 100 |
| 7 | NFO49-ST23-DVB25-BFE3 | 1.0 × 10³ | 244 (15.5) | 460 (76.1) | 620 (8.4) | 88 | 0.44 | 69-115 (46) | 39 | 46 | 99 | 100 |
| 8 | NFO49-ST18-DVB30-BFE3 | 1.5 × 10³ | 220 (12.7) | 460 (78.4) | 605 (8.9) | 91 | 0.32 | 82-105 (23) | 33 | 22 | 100 | 100 |
| 9 | NFO49-ST00-DVB48-BFE3 | 2.5 × 10³ | 292 (9.8) | 474 (76.7) | 623 (13.5) | 105 | 0.14 | 0 | 15 | 6 | 100 | 100 |
| 10 | NFO49-ST33-DVB15-BFE3 | 3.7 × 10² | 247 (20.9) | 456 (72.5) | 610 (6.6) | 63 | 1.09 | 35-95 (60) | 59 | 85 | 97 | 100 |
| 11 | CFO49-ST33-DVB15-BFE3 | 1.1 × 10³ | 260 (11.9) | 434 (80.4) | 560 (7.7) | 83 | 0.59 | 64-117 (53) | 38 | 50 | 99 | 100 |
| 12 | TFO49-ST33-DVB15-BFE3 | 5.2 × 10² | 268 (8.5) | 455 (83.9) | 602 (7.6) | 88 | 1.53 | 66-118 (52) | 56 | 71 | 98 | 100 |

^{a}The results outside the parentheses represent the temperatures at which the fastest weight loss rate occurs during the corresponding decomposition stage, and the results inside the parentheses represent the total weight loss during the corresponding decomposition stage,
^{b}24-82 (58) means that the temperature ranges from 24 to 82 ° C. at tan δ> 0.3, and the ΔT = 58 ° C.
^{C}D is the deformability of the specimens at T_{g} + 50 ° C., FD is the percentage of fixed deformation at room temperature, and R is the final recovery of the fixed deformation.

TABLE 34
Tensile mechanical properties of the fish oil polymers

| | | Young's modulus | Tensile strength | Elongation at break | Toughness |
|---|---|---|---|---|---|
| Entry | Polymer sample | (MPa) | (MPa) | (%) | (MPa) |
| 1 | NFO30-ST46-DVB21-BFE3 | 870 | 36.1 | 6.9 | 1.21 |
| 2 | NFO49-ST33-DVB15-BFE3 | 80 | 5.5 | 60.3 | 2.50 |
| 3 | NFO60-ST25-DVB12-BFE3 | 2 | 0.4 | 70.6 | 0.15 |
| 4 | NFO49-ST38-DVB10-BFE3 | 6 | 1.2 | 160.1 | 0.91 |
| 5 | NFO49-ST33-DVB15-BFE3 | 80 | 5.5 | 60.3 | 2.50 |
| 6 | NFO49-ST28-DVB20-BFE3 | 214 | 9.3 | 26.1 | 2.23 |
| 7 | NFO49-ST23-DVB25-BFE3 | 359 | 14.6 | 10.3 | 0.99 |
| 8 | NFO49-ST18-DVB30-BFE3 | 393 | 13.7 | 7.5 | 0.63 |
| 9 | NFO49-ST00-DVB48-BFE3 | 537 | 9.8 | 2.0 | 0.14 |
| 10 | NFO49-ST33-DVB15-BFE3 | 80 | 5.5 | 60.3 | 2.50 |
| 11 | CFO49-ST33-DVB15-BFE3 | 450 | 18.3 | 16.8 | 2.44 |
| 12 | TFO49-ST33-DVB15-BFE3 | 820 | 42.6 | 12.0 | 3.56 |

### EXAMPLE 3

In this example, various composites were prepared according to the method of the invention. Table 26 (above) lists the composites, along with their tensile properties.

### EXAMPLE 4

Materials.

The natural oils used in this study were food-grade soybean oil and LoSatSoy oil commercially available in supermarkets, which were used without further purification. Conjugated LoSatSoy oil was prepared by the rhodium-catalyzed isomerization of regular LoSatSoy oil. The percent conjugation was calculated to be approximately 100%. Styrene, divinylbenzene, norbornadiene and dicyclopentadiene were purchased from Aldrich Chemical Company, and used as received. The distilled grade boron trifluoride diethyl etherate (BF₃OEt₂) used to initiate cationic polymerization of the various soybean oils was also supplied by Aldrich. Norway Pronova fish oil ethyl ester (EPAX 5500 EE) and soybean oil methyl esters (Soygold-1100, Soygold-2000 and a Soygold methyl ester prepared from LoSatSoy oil, AG Environmental Products, L.L.C.) were used to modify the original initiator, boron trifluoride diethyl etherate.

Cationic Copolymerization.

The following reaction procedure was usually employed, unless otherwise stated. The desired amounts of styrene and divinylbenzene were added to the soybean oil. The reaction mixture was vigorously stirred, followed by the addition of an appropriate amount of a modified initiator. The modified initiator was prepared by mixing an additive, such as Norway fish oil ethyl ester or Soygold methyl ester, with the original initiator, boron trifluoride diethyl etherate. The modified initiator was usually required to produce homogeneous reactions, as well as homogeneous polymers. The total amount of reactants was around 65 grams. The reaction mixture was then injected into a Teflon mold, which was sealed by silicon adhesive and heated for a given time at the appropriate temperatures, usually 12 hours at room temperature, followed by 12 hours at 60° C. and then 24 hours at 110° C. The yields of resulting polymer are essentially quantitative. The nomenclature adopted in this work for the polymer samples is as follows: SOY, LSS and CLS represent regular soybean oil, LoSatSoy oil and conjugated LoSatSoy oil, respectively; ST is the styrene comonomer; DVB, NBD and DCP represent divinylbenzene, norbornadiene and dicyclopentadiene comonomers, which serve as crosslinking agents. BFE is the initiator boron trifluoride diethyl etherate. NFO, SGI, SGII and SGIII are Norway fish oil ethyl ester, Soygold-2000, Soygold-1100 and LoSatSoy oil methyl ester Soygold, respectively. For example, LSS45-ST32-DVB15-(NFO5-BFE3) corresponds to a polymer sample prepared from 45 wt % LoSatSoy oil, 32 wt % styrene, 15 wt % divinylbenzene and 8 wt % NFO-modified BFE initiator (5 wt % NFO plus 3 wt % boron trifluoride diethyl etherate).

Soxhlet Extraction by Methylene Chloride.

A 2 g sample of the bulk polymer was extracted for 24 hours with 100 ml of refluxing methylene chloride using a Soxhlet extractor. After extraction, the resulting solution was concentrated by rotary evaporation and subsequent vacuum drying. The soluble substances were isolated for further characterization. The insoluble solid was dried under vacuum for several hours before weighing.

Dynamic Mechanical Analysis.

The dynamic mechanical properties of the bulk polymers were obtained by using a Perkin-Elmer dynamic mechanical analyzer DMA Pyris-7e in a three-point bending mode. The rectangular specimen was made by copolymerizing the reactants in an appropriate mold. Thin sheet specimens of 2 mm thickness and 5 mm depth were used, and the span to depth ratio was maintained at approximately 2. Each specimen was fired cooled to a ca. −35° C., and then heated at 3° C./min and a frequency of 1 Hz under helium. The viscoelastic properties, i.e. storage modulus E′, and mechanical loss factor (damping) tan δ were recorded as a function of temperature. The glass transition temperature ⁻T_{g} of the polymer was obtained from the peak of the loss factor tan δ.

Generally, when increasing the divinylbenzene in the compositions, the resulting polymers vary from soft rubbers to hard, tough or brittle plastics. Their glass transition temperatures gradually increase from approximately 0° C. to about 71° C., and the T₁₀ temperatures gradually increase from 312 to 315° C. When conjugated low saturated soybean oil is used, similar results are observed. Conjugated low saturated soybean oil typically affords higher yields of crosslinked polymers, and much higher glass transition temperatures and T₁₀ temperatures then the corresponding low saturated soybean oil polymers. However, the polymeric materials prepared from either type of soybean oil possess glass transition temperatures ranging from approximately 0° C. to 105° C., as well as room temperature moduli from about 6×10⁶ to 2×10⁹ Pa, which are comparable to those of commercially available rubbers and conventional plastics. In general, the polymers prepared from a combination of styrene and divinylbenzene have better mechanical properties than the polymers prepared using divinylbenzene only. Styrene successfully reduces the non-uniformity of the cross-linking structure. Thus, the mechanical properties of the resulting plastics are considerably improved. In addition to tough plastics, a wide range of viable polymeric materials, including elastomers, rubbery materials, and even functional polymeric materials, e.g., shape memory polymers, have been obtained. The polymers prepared from the new styrene compositions have viable mechanical properties, making them suitable replacements for petroleum-based polymeric materials.

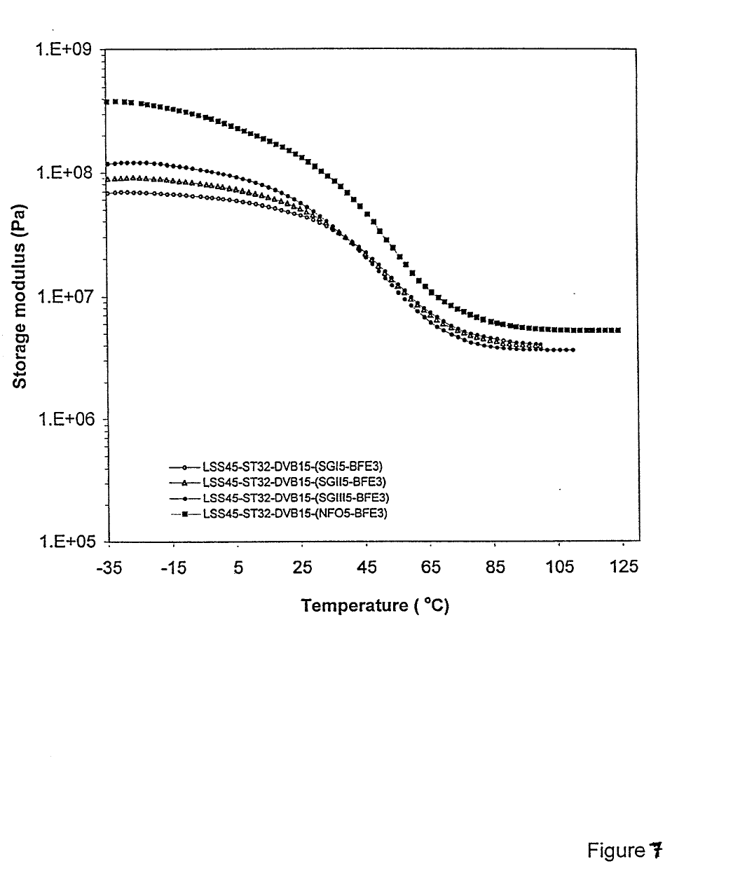

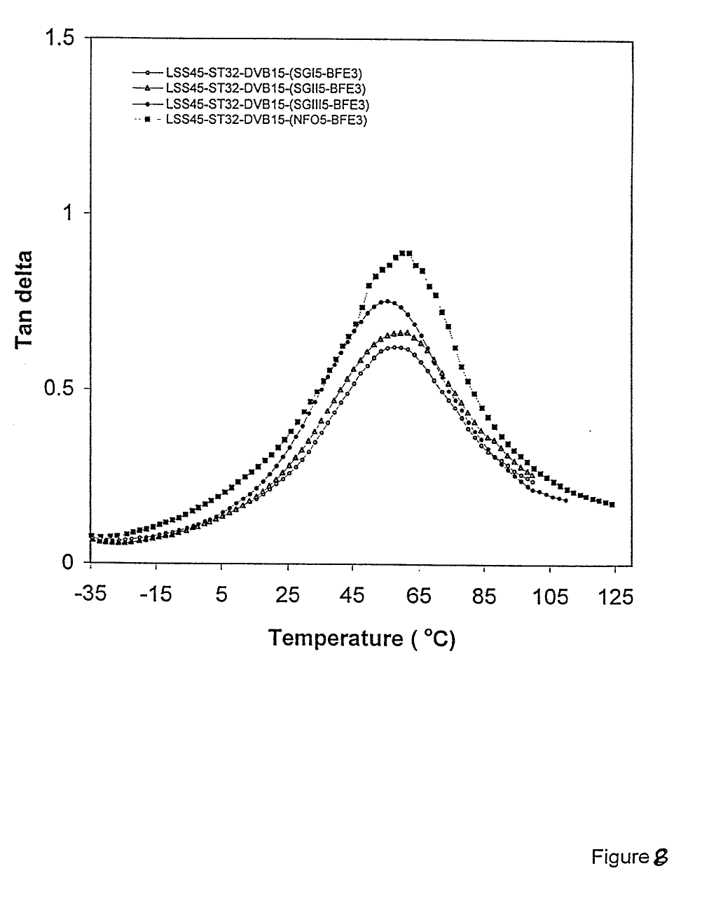

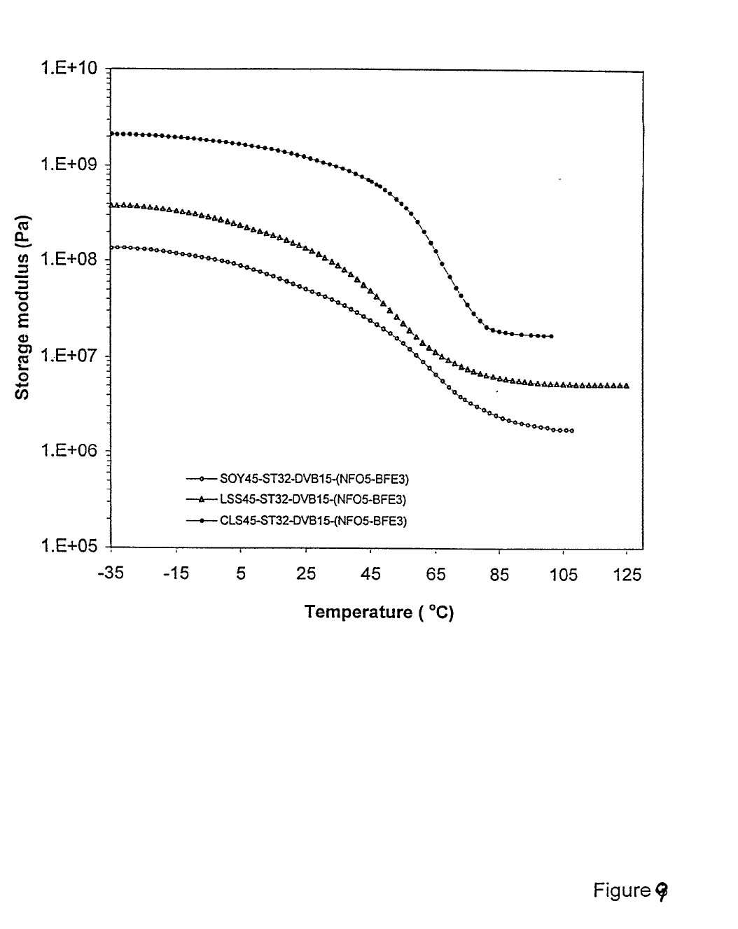

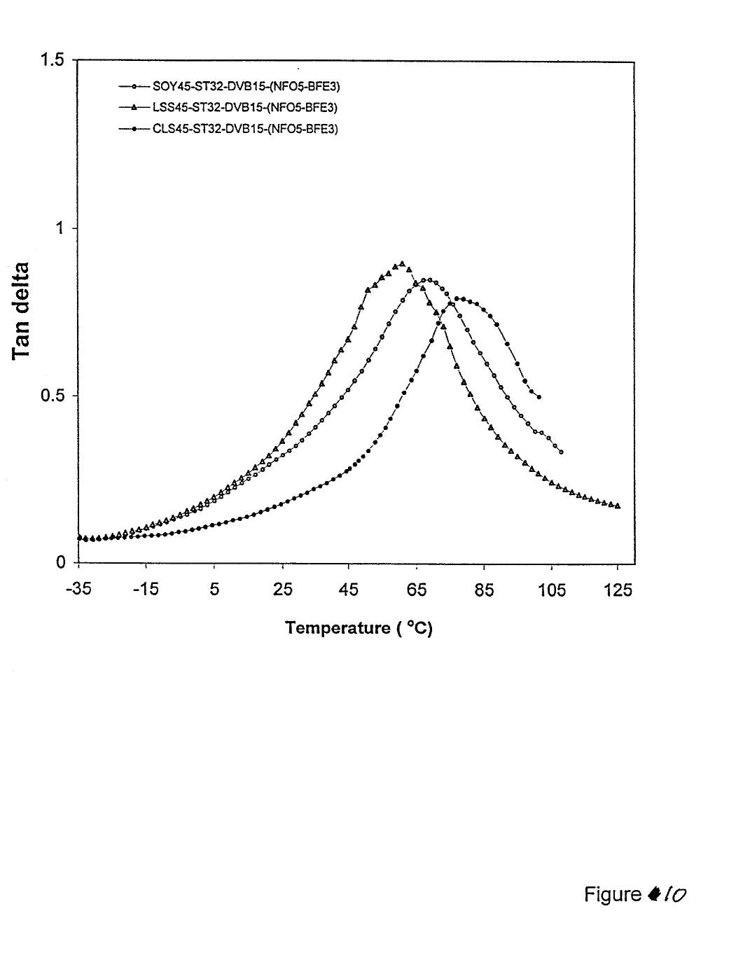

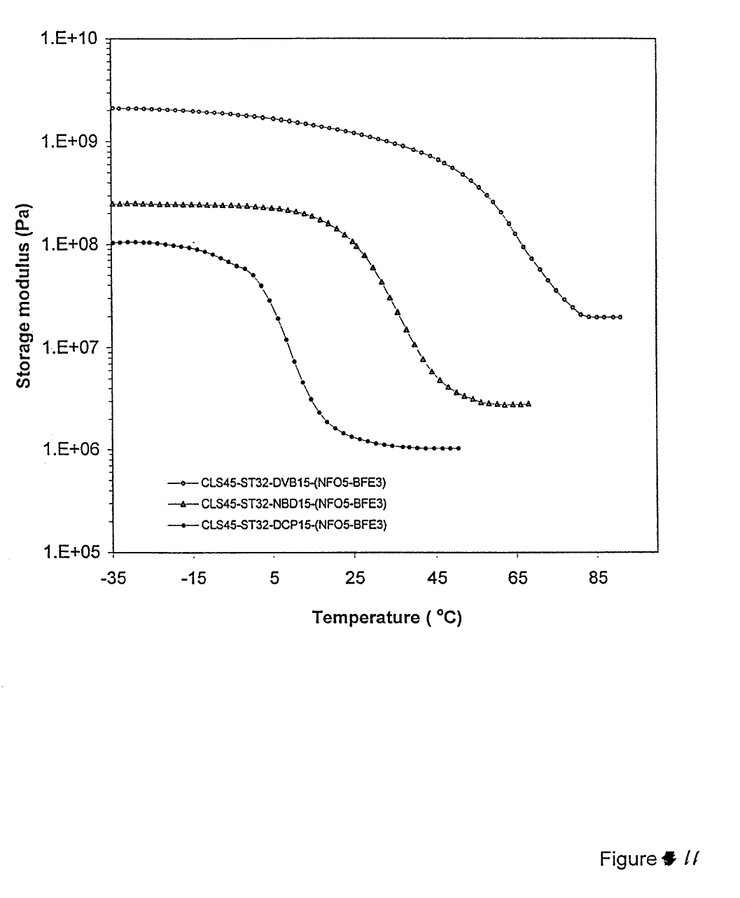

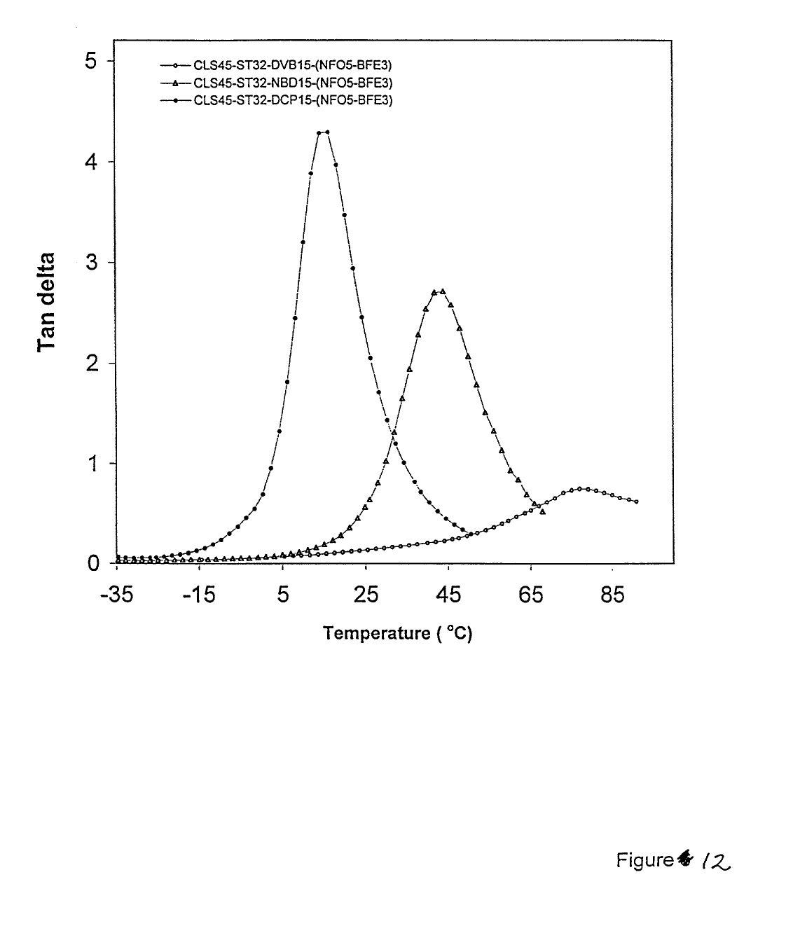

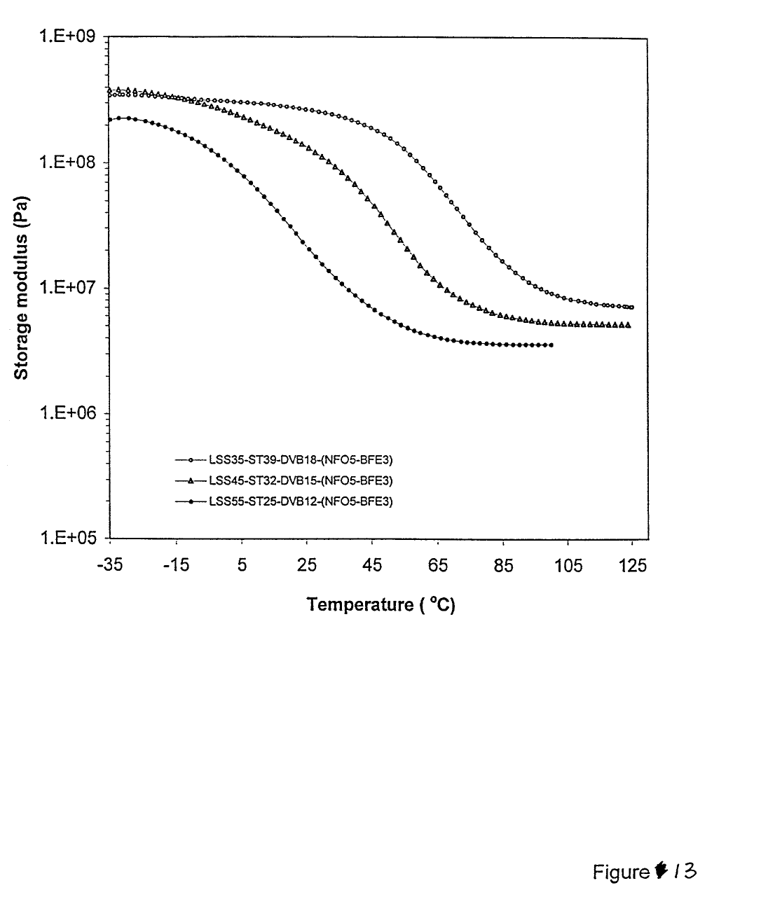

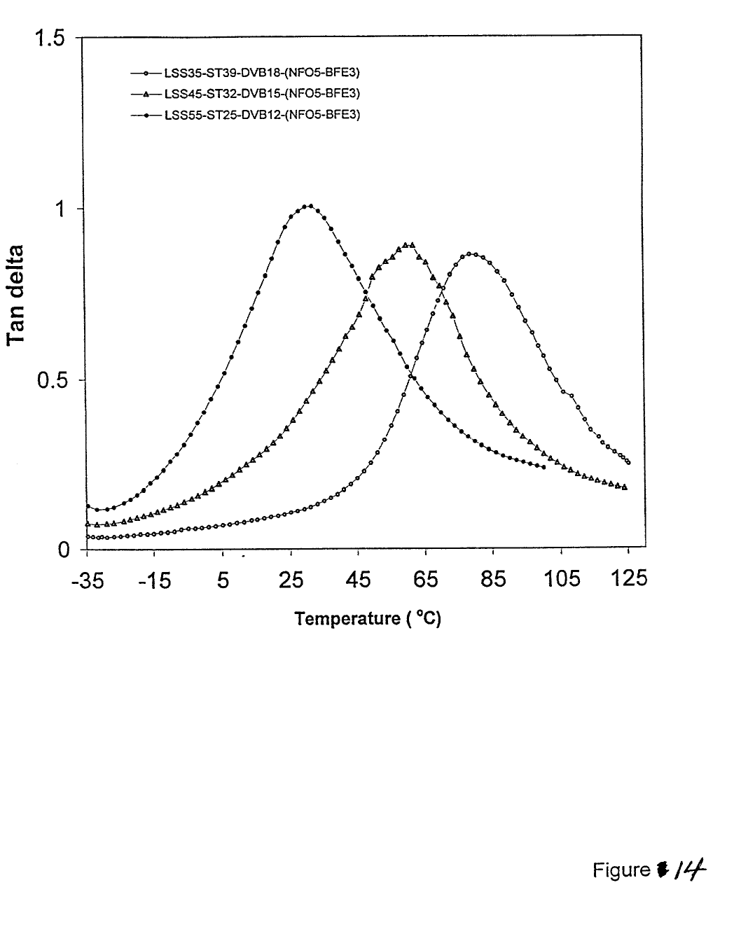

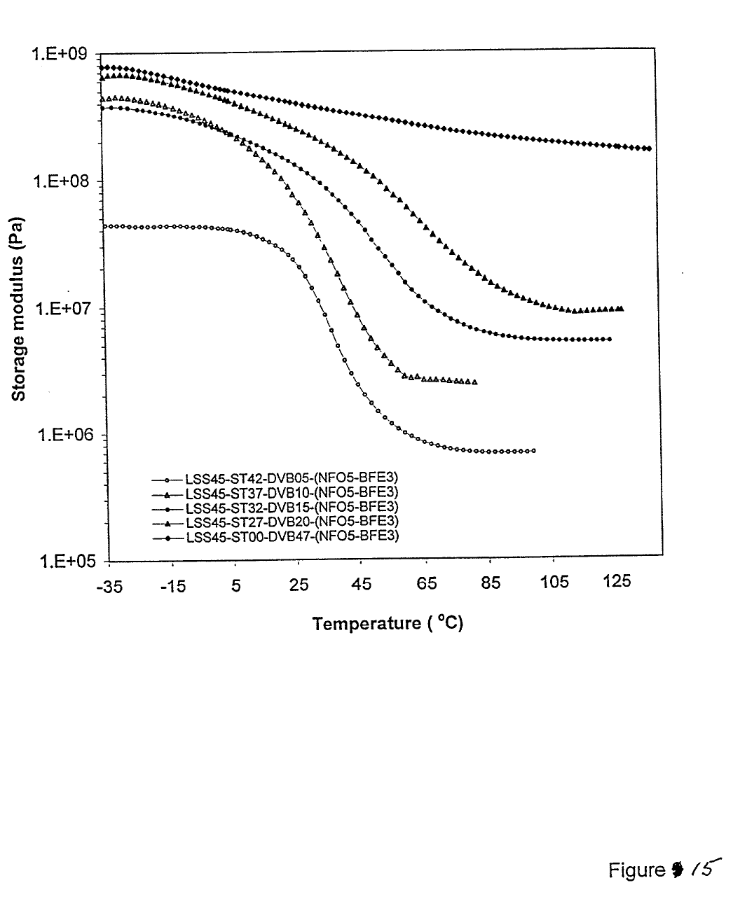

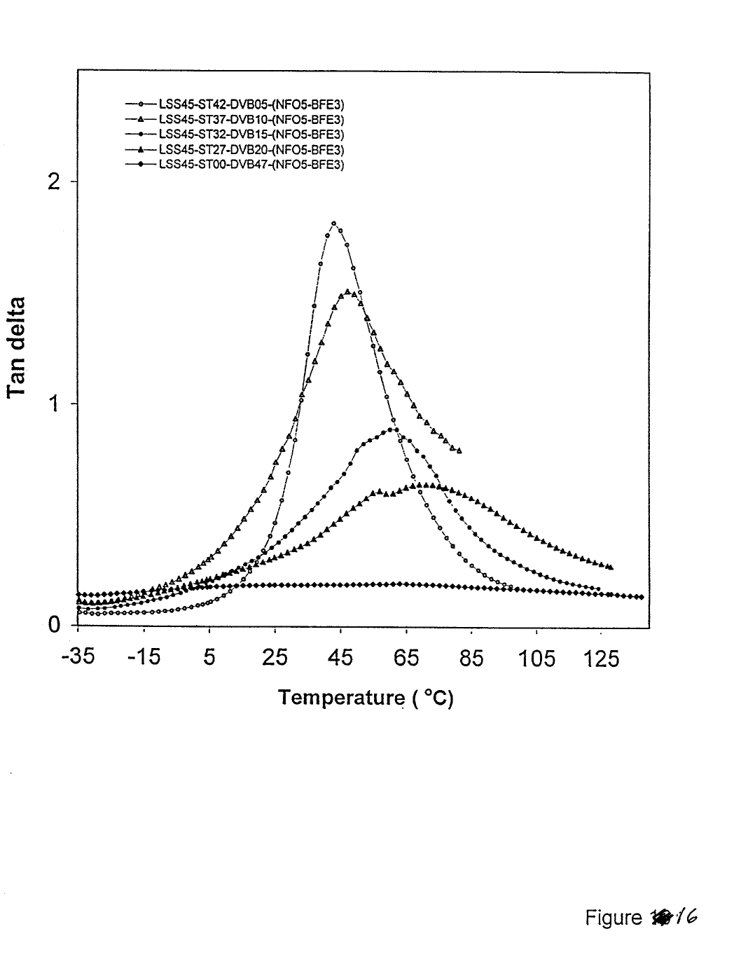

FIGS. 7 through 20 represent the results of testing various embodiments produced herein.

Polymers Based on Various Modified Initiators

FIG. 7 illustrates the temperature dependence of the storage modulus E′ for the low saturation soybean oil (LoSatSoy oil) polymers using different modified initiators. These LoSatSoy oil polymers have the same stoichiometry and have been prepared under identical conditions. FIG. 7 clearly indicates that the behavior of the storage modulus initially remains almost constant at lower temperatures. As the temperature increases, the storage modulus exhibits a sharp drop in the temperature region between 20 and 70° C. This is followed by a modulus plateau at higher temperatures, where the polymer behaves like a rubber. The bulk polymer possesses a crosslinked polymer network that constitutes the polymer matrix. This crosslinked LoSatSoy oil-styrene-divinylbenzene copolymers, and plasticized by a small amount of low molecular weight free oil. Therefore, the modulus drop in FIG. 7 apparently corresponds to the onset of segmental mobility in the crosslinked polymer networks. The appearance of a relatively constant modulus at higher temperatures indicates that stable crosslinked networks exist in the bulk polymer.

The storage moduli of the LoSatSoy oil polymers shown in FIG. 7 are obviously related to the degrees of unsaturation of the four additives used in this study. Soybean oil methyl esters SGI, SGII and SGIII have on average 1.5, 1.7 and 2.2 carbon-carbon double bonds per molecule. As a result, the LoSatSoy oil polymer based on SGIII has a higher storage modulus than those polymers based on SGI and SGII, especially when the temperature is below ambient temperature. However, their storage moduli become very similar to one another at higher temperatures. The additive NFO has a much higher degree of unsaturation (ca. 3.5 C═C per molecule) than the SGI, SGII and SGIII additives. As expected, the polymer LSS45-ST32-DVB15-(NFO5-BFE3) prepared using the NFO modified initiator has the highest storage modulus over the whole temperature range studied.

FIG. 8 shows the temperature dependence on the loss factor tan δ for the same LoSatSoy oil polymer samples as those in FIG. 7. For each LoSatSoy oil polymer studied, a single tan δ peak has been observed. Considering the storage moduli results in FIG. 7, the tan δ peaks in FIG. 8 apparently correspond to the glass transition temperatures, i.e. a-relaxations of the crosslinked LoSatSoy oil polymers. The LoSatSoy oil polymers based on the additives SGI, SGII and SGIII possess a-relaxations as determined from the tan δ curves located in the vicinity of 57° C., 58° C. and 55° C., respectively. The LoSatSoy oil polymer based on the additive NFO has a little higher glass transition temperature located at approximately 61° C. The single a-relaxation indicates that, unlike the soybean oil-divinylbenzene polymers the new LoSatSoy oil polymers obtained in this study exhibit a single homogeneous phase at the molecular level. The structures of these polymers have been shown to be a crosslinked polymer matrix interpenetrated with some linear or less crosslinked LoSatSoy oil-styrene-divinylbenzene copolymers, plasticized by a small amount of low molecular weight free oil. It follows that these linear or less crosslinked copolymers and free oil are thermodynamically miscible with the crosslinked polymer network. Thus, the dynamic mechanical behavior of the bulk polymer exhibits a single a-relaxation.

The characteristics of the new polymers at room temperature as provided by dynamic mechanical measurements are also of prime interest in this study. It has been found in FIG. 7 that the new LoSatSoy oil polymers based on the additives of SGI, SGII, SGIII and NFO have room temperature storage moduli Eᵣ′ of 5.8×10⁷ Pa, 7.0×10⁷ Pa, 1.0×10⁸ Pa and 2.5×10⁸ Pa, respectively. Their glass transition temperatures are approximately 55-61° C., well above the ambient temperature. These experimental results are consistent with the fact that all four LoSatSoy oil polymers appear to be hard plastics at room temperature. The plateau moduli in FIG. 7 are actually the rubbery moduli of the bulk LoSatSoy oil polymers above their glass transition temperatures. From the theory of rubber elasticity, the crosslinking density of νₑ of a crosslinked polymer can be determined by using a known equation, where E′ is the storage modulus of the crosslinked polymer in the rubbery plateau region above T_{g} (ca. T_{g}+40° C.), R is the gas constant (8.314 J·K⁻¹·mol⁻¹) and T is the absolute temperature in Kelvin. The crosslinking densities Vₑ of these new LoSatSoy oil polymers based on the additives SGI, SGII, SGIII and NFO are therefore calculated to be approximately 4.2×10², 4.3×10², 4.0×10², and 5.3×10² mol/m³. It is clear that

E′=3νₑRT (1)

these LoSatSoy oil plastics possess crosslinking densities that are the same order of magnitude as conventional thermosetting polyester plastics, but evidently higher than weakly crosslinked rubbery SBR materials (Vₑ<1×10² mol/m³). These results indicate that all of the modified initiators give rise to viable homogeneous polymers. However, the NFO-modified initiator results in a polymer having the highest glass transition temperature, as well as the highest storage modulus over the whole temperature range studied.

Polymers Based on Different Soybean Oils

Three different soybean oils were employed in this study. These soybean oils are regular soybean oil, low saturation soybean oil (LoSatSoy oil) and conjugated LoSatSoy oil. Regular soybean oil and LoSatSoy oil have approximately 4.5 and 5.1 non-conjugated C═C bonds per triglyceride, respectively. The conjugated LoSatSoy oil used in this study was prepared by rhodium catalyzed isomerization of the LoSatSoy oil. Thus, it has the same number of C═C bonds per triglyceride as the LoSatSoy oil, but approximately 100% of the C═C bonds in this LoSatSoy oil isomer are conjugated.

FIG. 9 illustrates the temperature dependence of the storage modulus E′ for polymers prepared from regular soybean oil, LoSatSoy oil and conjugated LoSatSoy oil. NFO has now been found to be the best additive to modify the original BFE initiator. Thus, different soybean oil polymers with the same reagents and stoichiometry have been prepared using the NFO-modified initiator. FIG. 9 indicates that the storage moduli E′ of the various soybean oil polymers are very different from one another, and are apparently very closely related to the degree of unsaturation and the reactivity of the soybean oils employed in the original composition. Regular soybean oil has the least unsaturation. Thus, the polymer SOY45-ST32-DVB15-(NFO5-BFE3) possesses the lowest storage modulus over the whole temperature region studied (FIG. 9). Conjugated LoSatSoy oil and LoSatSoy oil have the same degree of unsaturation, which is in turn higher than regular soybean oil. However, the conjugated C═C bonds in the conjugated LoSatSoy oil are more reactive than the non-conjugated C═C bonds present in the LoSatSoy oil. As a result, the DMA spectrum in FIG. 9 reveals a significant increase in the stiffness of the resulting polymer when conjugated LoSatSoy oil is used instead of LoSatSoy oil.

FIG. 9 also shows that the onset of segmental mobility of the triglyceride oil polymer chains is also intimately related to the degree of unsaturation and the reactivity of the soybean oils. The decrease in modulus of the conjugated LoSatSoy oil polymer occurs at the highest temperature, while the regular soybean oil polymer shows a decrease in modulus at the lowest temperature. The storage moduli at room temperature Eᵣ′ of the regular soybean oil, LoSatSoy oil and conjugated LoSatSoy oil polymers are 1.0×10⁸, 2.8×10⁸ and 1.9×10⁹ Pa, respectively. These high Eᵣ′ values are also consistent with plastics characteristics of the three soybean oil polymers at room temperature. The crosslinking density vₑ of the conjugated LoSatSoy oil polymer is approximately 2.2×10³ mol/m³, which is significantly higher than those of the regular soybean oil (Vₑ=1.8×10² mol/m³) and LoSatSoy oil polymers (vₑ=5.3×10² mol/m³). The conjugated LoSatSoy oil systems yield more crosslinked polymer than the regular soybean oil and LoSatSoy oil systems Thus, the differences in the storage modulus and onset of the segmental mobility of the crosslinked polymer chains are a direct result of the different crosslinking densities in the three soybean oil polymers.

FIG. 10 indicates the temperature dependence of the loss factor tan δ for three soybean oil polymers. The regular soybean oil and LoSatSoy oil polymers show loss factor peaks at approximately 68° C. and 61° C., respectively. The conjugated LoSatSoy oil polymer has a loss factor peak located at approximately 76° C. with a modest decrease in intensity. These peaks, corresponding to the decrease in moduli occurring in the same temperature region, are a manifestation of the glass transition temperatures of the crosslinked network in the bulk polymers. The single loss factor peak apparently indicates that these various soybean oil-styrene-divinylbenzene crosslinked copolymers possess a single homogeneous phase at the molecular level, irrespective of the variations in the soybean oils used.

The conjugated LoSatSoy oil is more active than the LoSatSoy oil and regular soybean oil. As a result, more side-chains of the conjugated LoSatSoy oil have participated in the copolymerization. The various soybean oils all have three side chains with multiple reactive C═C bonds, which actually serve as crosslinking agents like divinylbenzene. Thus, the results in FIGS. 9 and 10 show that the conjugated LoSatSoy polymer has the highest crosslinking density, which results in the highest glass transition temperature, and the highest storage moduli of the three soybean oil polymers.

Polymers Based on Different Crosslinking Agents

Polymers from conjugated LoSatSoy oil, the most reactive soybean oil used in this study, have been prepared to investigate the effect of different crosslinking agents on the dynamic mechanical behavior. Three crosslinking agents, divinylbenzene (DVB), norbornadiene (NBD) and dicyclopentadiene (DCP), have been employed in the preparation of these conjugated LoSatSoy oil polymers. The reactivity of the C═C bonds in these crosslinking agents dramatically affect the properties of the resulting polymers. The three crosslinking agents have the same number of reactive C═C bonds per molecule. The two C═C bonds in divinylbenzene are conjugated with the phenyl ring, and are expected to be more reactive than the non-conjugated C═C bonds in both norbornadiene and dicyclopentadiene.

FIG. 11 shows the temperature dependence of the storage modulus E′ for the conjugated LoSatSoy oil polymers prepared from different crosslinking agents. As expected, the polymer CLS45-ST32-DVB15-(NF05-BFE3) prepared from divinylbenzene exhibits considerably higher storage moduli than the polymers based on norbornadiene and dicyclopentadiene over the whole temperature range studied. The polymer CLS45-ST32-DVB15-(NF05-BFE3) also shows a storage modulus drop at the highest temperature, while the polymer CLS45-ST32-DCP15-(NF05-BFE3) shows a modulus drop at the lowest temperature, below room temperature. Thus, it is of interest to study the room temperature moduli of these polymers. The results in FIG. 11 indicate that the conjugated LoSatSoy oil polymers based on divinylbenzene, norbornadiene and dicyclopentadiene have room temperature storage moduli of 2.8×10⁸, 2.0×10⁸ and 1.0×10⁶ Pa, respectively. This means that divinylbenzene and norbornadiene result in hard plastics, while dicyclopentadiene results in a soft rubbery material at room temperature. The soft polymer CLS45-ST32-DCP15-(NF05-BFE3) actually possesses a room temperature modulus that is of the same order of magnitude as styrene-butadiene rubber (SBR) vulcanisates. The crosslinking densities of the three conjugated LoSatSoy oil polymers CLS45-ST32-DVB15-(NF05-BFE3), CLS45-ST32-NBD15(NF05-BFE3) and CLS45-ST32-DCP15-(NF05-BFE3) are approximately 2.2×10³, 3.3×10² and 1.2×10² Mol/M³, respectively. It follows that divinylbenzene may be the most effective of the three crosslinking agents.

Crosslinking hinders the polymer segmental motion, and thus requires a higher temperature for the onset of segmental motion of the polymer chains. FIG. 12 summarizes the temperature dependence of the loss factor tan δ for the conjugated LoSatSoy oil polymers based on the three different crosslinking agents. The polymer CLS45-ST32-DVB15-(NF05-BFE3) possesses the highest glass transition temperature at approximately 76° C. The polymers CLS45-ST32-NBD15-(NF05-BFE3) and CLS45-ST32-DCP15-(NF05-BFE3), however, have much lower glass transition temperatures, i.e. 43° C. and 14° C., respectively. The height and area of the tan δ peak associated with a-relaxation can be related to the crosslinking density, the impact resistance and the toughness of a material. Compared with the polymer CLS45-ST32-DVB15-(NF05-BFE3), the polymers based on norbornadiene and dicyclopentadiene exhibit considerably higher tan δ values due to lower crosslinking densities and higher inter- and intra-segmental friction coefficients in the bulk polymer. The height and area under the tan δ curve give an indication of the total amount of energy that can be absorbed by the material. A large area under the tan δ curve indicates a great degree of molecular mobility, which translates into better damping properties. This means that the material can better absorb and dissipate energy. The high damping properties can be an advantage in practical applications of such polymeric materials. For instance, damping reduces vibrations (mechanical and acoustical) and prevents resonance vibrations from building up to a dangerous level. High damping in a car tire tends to give intimate friction with the road surface. In fact, many other mechanical properties are intimately related to damping. These include fatigue life, toughness and impact strength, breaking strain, wear, and the coefficient of friction Desirable damping materials may thus be obtained if the high damping region can be further broadened through appropriate structure design.

Polymers Based on Different Stoichiometries

The chemical stoichiometry has been found to significantly affect the copolymerization reactions of the various soybean oil-styrene-divinylbenzene systems. It also considerably affects the dynamic mechanical properties of the resulting polymers. FIG. 13 shows the temperature dependence of the storage modulus E′ for polymers prepared by varying the LoSatSoy oil concentration in the original composition, while the weight ratio of the styrene/divinylbenzene comonomers remains constant at ˜2:1. It appears that by increasing the LoSatSoy oil concentration in the original composition, the storage modulus curve of the resulting polymer shifts to lower temperatures. As a result, the polymer samples CLS35-ST39-DVB18-(NF05-BFE3), CLS45-ST32-DVB15(NF05-BFE3) and CLS55-ST25-DVB12-(NF05-BFE3) have room temperature storage moduli of 2.0×10⁸ Pa, 1.6×10⁸ Pa and 2.2×10⁷ Pa, and their crosslinking densities are approximately 7.3×10², 5.3×10² and 3.9×10² mol/m³, respectively. FIG. 14 shows the temperature dependence of the loss factor tan δ for these same LoSatSoy oil polymers. A single damping peak appears for all the samples with almost equal intensity. The tan δ positions of the LoSatSoy oil polymers shift to lower temperatures as the LoSatSoy oil concentration increases in the original composition. This results because increasing the LoSatSoy oil concentration in the original composition results in polymers containing more LoSatSoy oil segments in the polymer backbone. The LoSatSoy oil segments are more mobile than the rigid aromatic segments in the polymer chains. Thus, the segmental mobility of the resulting polymer increases when more LoSatSoy oil is employed in the original composition.

FIGS. 15 and 16 show the temperature dependence of the storage moduli E′ and loss factors tan δ for LoSatSoy oil polymers prepared by varying the divinylbenzene concentration while the total concentration of the comonomers styrene plus divinylbenzene remains constant. It is known that divinylbenzene is an effective crosslinking agent for cationic copolymerizations The data summarized in FIGS. 15 and 16 are typical of how the dynamic mechanical properties change with a high degree of crosslinking. The polymer LSS45-ST42-DVB05-(NF05-BFE3) shows very low moduli, and its loss factor shows a very sharp peak at about 43° C. As the divinylbenzene concentration increases in the original composition, the resulting polymers have storage moduli that dramatically increase over the whole temperature range studied. This results because the degree of crosslinking increases with increasing divinylbenzene concentration. As molecular motions become more and more restricted, the amount of energy that can be dissipated throughout the polymer specimen decreases dramatically. Therefore, the loss factor peak positions of the polymers shift to higher temperatures. The tan δ intensities also diminish. In the meanwhile, a significant broadening of the α-relaxation is observed. At an extremely high level of crosslinking, the tan δ peak almost disappears. The broadening of the glass-to-rubber transition region seen in FIG. 16 may be due to a broader distribution in the molecular weight between crosslinks or some other kinds of heterogeneity in the network structure.

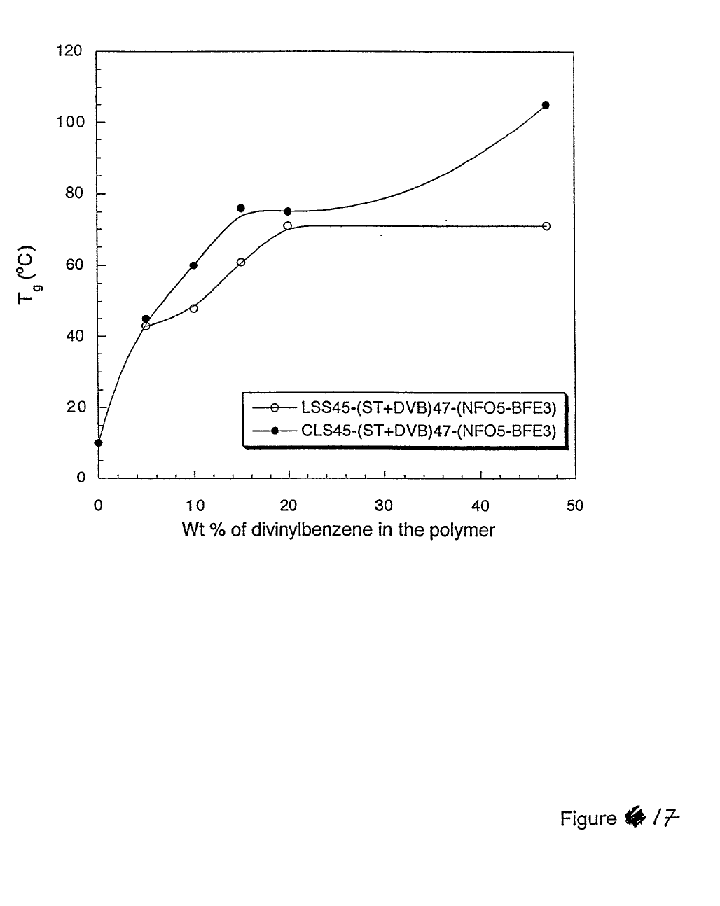

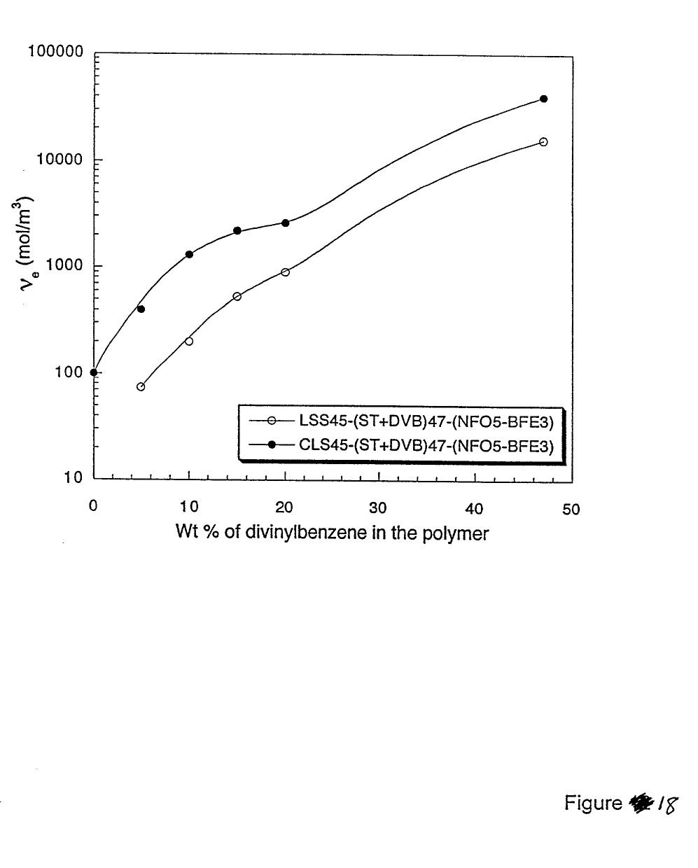

Similar results have been obtained when conjugated LoSatSoy oil is employed. FIG. 17 shows that the crosslinking densities vₑ of the conjugated LoSatSoy oil polymers significantly increase when increasing the divinylbenzene concentration in the original composition. As a result, the segmental motions of the polymers become more and more restricted. This results in a gradual increase of T_{g} for the conjugated LoSatSoy oil polymers as shown in FIG. 18. The conjugated LoSatSoy oil is more reactive than the LoSatSoy oil. The conjugated LoSatSoy oil polymers also have higher crosslinking densities than the LoSatSoy oil polymers when identical stiochiometries have been employed (FIG. 18). Accordingly, the glass transition temperatures T_{g} of the conjugated LoSatSoy oil polymers are also higher than those of the LoSatSoy oil polymers (FIG. 18).

Effects of Crosslinking Density vₑ on the T_{g} and the (tan δ)ₘₐₓ of the Polymers

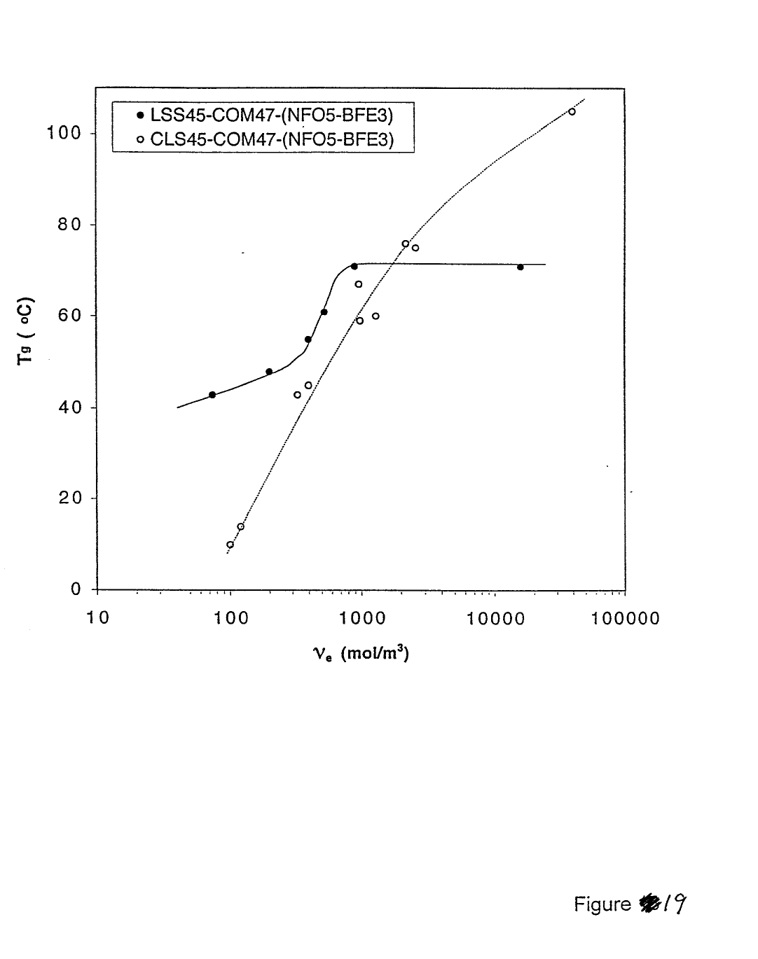

The new soybean oil polymers obtained in this study are typical thermosetting polymers according to the invention. FIG. 19 shows the effect of the crosslinking density vₑ on the glass transition temperature T_{g} of the LoSatSoy oil and conjugated LoSatSoy oil polymers. All of the polymers contain 45% soybean oil, 47% comonomers (styrene plus divinylbenzene=COM) and 8% modified initiators (5% NFO plus 3% BFE). Apparently, the glass transition temperatures T_{g} of these soybean oil polymers increase when increasing their crosslinking densities v_{e.}. However, the LoSatSoy oil polymers and the conjugated LoSatSoy oil polymers do not follow the same trend. The glass transition temperature T_{g} of the LoSatSoy oil polymers initially increases slightly with crosslinking within the low v_{e.}. region. This is in agreement with the results of normal vulcanized rubbers, in which modest crosslinking only slightly increases the T_{g} (vₑ<1×10² mol/m³). In highly crosslinked LoSatSoy oil polymers, the T_{g} is markedly increased by crosslinking. Within the region vₑ=3×10² to 1×10³ mol/m³, the glass transition temperatures T_{g} of the LoSatSoy oil polymers increase almost linearly when increasing the logarithmic v_{e.}. When the crosslinking density v_{e.} exceeds 1×10³ mol/m³, however, the glass transition temperature T_{g} of the LoSatSoy oil polymers remains unaffected by the degree of crosslinking. On the other hand, unlike the LoSatSoy oil polymers, the glass transition temperatures T_{g} of the conjugated LoSatSoy oil polymers are considerably increased by crosslinking over the wide range of crosslinking densities v_{e.} shown in FIG. 19. However, the conjugated LoSatSoy oil polymers do not exhibit a very linear relationship between their T_{g} and logarithmic v_{e.}

Crosslinking increases the glass transition of a polymer by introducing restrictions on the molecular motions of a chain. Nielsen averaged the data in the

$${T}_{g} - {T}_{go} \approx \frac{3.9 \times {10}^{4}}{{M}_{C}}$$

literature and arrived at the following approximate empirical equation:

where T_{g}, is the glass transition temperature of the uncrosslinked polymer having the same chemical composition as the crosslinked polymer. M_{c} is the number average molecular weight between crosslinked points, which is actually proportional to the reciprocal crosslinking density vₑ⁻¹. T_{g}-T_{go} is the shift in T_{g} due only to crosslinking after correcting for any copolymer effect of the crosslinking agent. This indicates that the glass transition temperatures T_{g} should exhibit a linear relationship with the crosslinking density vₑ of the bulk polymers. However, the results in FIG. 19 do not comply with Nielsen's empirical equation. Linear relationships between T_{g} and logarithmic vₑ have been found only within a limited vₑ region. In spite of the disagreement, the results in this study do not necessarily mean that Nielsen's equation is invalid for the new polymers described herein. In fact, both the divinylbenzene and the various soybean oils serve as crosslinking agents in this study. The structure of the resulting soybean oil polymers is composed of a crosslinked polymer network, specifically a soybean oil-styrene-divinylbenzene random copolymer.

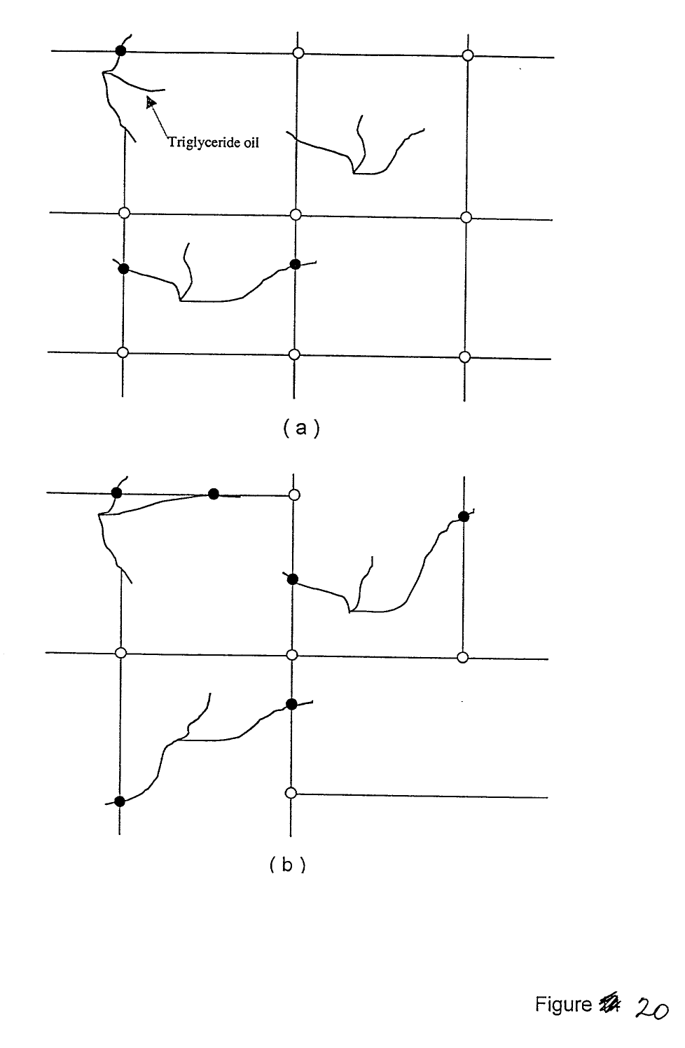

Even though all of the polymers in FIG. 19 contain the same amounts of the various soybean oils, comonomers (styrene+divinylbenzene), and the modified initiators, it is very difficult to make the correction for the copolymer effect caused by the crosslinking agents, which is in fact a prerequisite for fulfillment of Nielsen's equation. FIG. 18 indicates that, with the same stoichiometry, the resulting conjugated LoSatSoy oil polymers have higher glass transition temperatures T_{g} than the LoSatSoy oil polymers. This is a direct result of the differences in the crosslinking densities of the polymers. It has been observed that the conjugated LoSatSoy oil is more reactive than the LoSatSoy oil. As a result, the conjugated LoSatSoy oil polymers have higher crosslinking densities, and thus possess higher glass transition temperatures than the LoSatSoy polymers with the same stoichiometry. It is of interest to note in FIG. 19 that the LoSatSoy oil polymers, in most cases, show higher glass transition temperatures T_{g} than the conjugated LoSatSoy oil polymers with the same degree of crosslinking. This may be due to the differences in the polymer sequence structure. The crosslinked polymers obtained are no doubt soybean oil-styrene-divinylbenzene random copolymers. The results in FIG. 19 may be correlated with the soybean oil sequence distribution of the crosslinked polymer chains. Since both the soybean oil and divinylbenzene serve as crosslinking agents and the conjugated LoSatSoy oil is relatively more reactive than the LoSatSoy oil, and since the same amount of soybean oil (45 wt %) is used in the original composition, then less of a crosslinking agent, such as divinylbenzene, is actually needed for the conjugated LoSatSoy oil systems to achieve the same degree of crosslinking as the LoSatSoy oil systems. This may be illustrated by the structures of the LoSatSoy oil and conjugated LoSatSoy oil polymers with the same degree of crosslinking as seen in FIG. 20.

The open circles in FIG. 20 represent the crosslinks formed by the crosslinking agent divinylbenzene, and the solid circles correspond to the crosslinks provided by the triglyceride oil side chains. Both the LoSatSoy oil polymer and the conjugated LoSatSoy oil polymer have the same crosslinking density. However, more conjugated LoSatSoy oil side chains actually bridge the crosslinked polymer network and less divinylbenzene is required for crosslinking. These soybean oil segments are much more flexible than the rigid aromatic segments. That is why the conjugated LoSatSoy oil polymers have lower glass transition temperatures T_{g} than the LoSatSoy oil polymers with the same degree of crosslinking.

The crosslinking density vₑ greatly affects the tan δ intensity of a polymer. Typically, the loss factor tan δ is low when the temperature is below the T_{g} as the chain segments in that region are frozen in place. The deformations are thus primarily elastic, and the molecular slippage resulting in viscous flow is low. Above the T_{g}, the molecular segments are free to move. Consequently, there is little resistance to movement of the chain segments. As a result, the tan δ is also low. In the glass-rubber transition region, on the other hand, the loss factor becomes high due to the initiation of micro-Brownian motion of the molecular chains. Some of the molecular chain segments are free to move, but others are not. A frozen segment can store much more energy for a given deformation than a free-to-move rubbery segment. Thus, every time a stressed frozen segment becomes free to move, its excess energy is dissipated. Micro-Brownian motion is concerned with the cooperative diffusional motion of the main chain segments. The position and the intensity of the loss tangent peak in the relaxation spectra of a polymer are indicative of the structure and the extent to which a polymer is crosslinked.

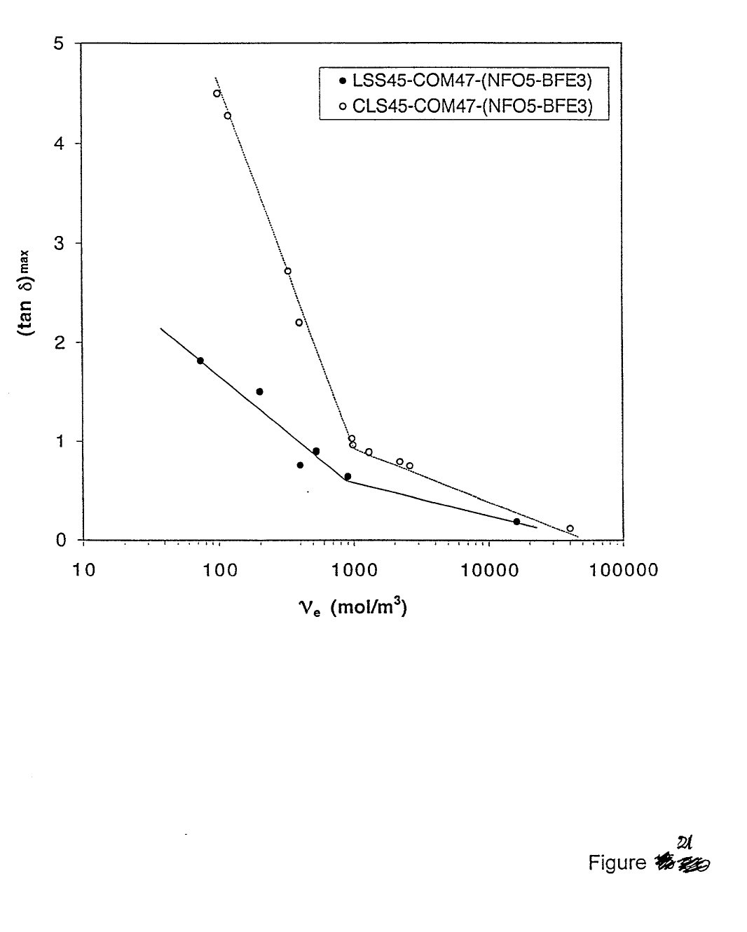

The damping (loss factor) has been found to decrease linearly when increasing the logarithmic crosslinking density of an SBR rubber, which is actually represented by a swelling ratio. FIG. 21 shows the effect of crosslinking density νₑ, on the loss factor intensity (tan δ)ₘₐₓ for the LoSatSoy oil and conjugated LoSatSoy oil polymers. The loss factor intensity has also been found to decrease when increasing the logarithmic crosslinking density νₑ of the polymers. However, two distinct νₑ regions have been observed in these polymers in which linear relationships between (tan δ)ₘₐₓ and logarithmic νₑ can be established. Their relationships can be well described by the following empirical equations:

$${( tan δ )}_{max} = ⟨ \begin{matrix}3.98 - 1.12 {log}_{10} {υ}_{e} & ( {υ}_{e} < 1 \times {10}^{3} mol \text{/} {m}^{3} ) \\ 1.71 - 0.36 {log}_{10} {υ}_{e} & ( {υ}_{e} > 1 \times {10}^{3} mol \text{/} {m}^{3} )\end{matrix}$$

For the conjugated LoSatSoy oil polymers

$${( tan δ )}_{max} = ⟨ \begin{matrix}11.68 - 3.58 {log}_{10} {υ}_{e} & ( {υ}_{e} < 1 \times {10}^{3} mol \text{/} {m}^{3} ) \\ 2.53 - 0.52 {log}_{10} {υ}_{e} & ( {υ}_{e} > 1 \times {10}^{3} mol \text{/} {m}^{3} )\end{matrix}$$

When the crosslinking density vₑ is lower than 1×10³ mol/m³, the (tan δ)ₘₐₓ for both the LoSatSoy oil and conjugated LoSatSoy oil polymers is markedly decreased when increasing the logarithmic νₑ. When the crosslinking density νₑ is higher than 1×10³ mol/m³, however, the decrease of (tan δ)ₘₐₓ as a function of the logarithmic υ, becomes less obvious.

Crosslinking restricts the segmental motion of the polymer chains, and thus reduces the energy that can be dissipated during the glass-rubber transition. So, it is understandable that the (tan δ)ₘₐₓ decreases when increasing the degree of crosslinking of the polymers. Here it is interesting to observe that the effect of crosslinking density νₑ on the loss factor (tan δ)ₘₐₓ is divided into two distinct regions in the new polymers. To our knowledge, similar observations have not been reported in the literature previously. Without being bound by any particular theory, it appears that the results in FIG. 21 may be ascribed to the existence of two kinds of segments with very different mobility. The crosslinked polymer chains are actually the soybean oil-styrene-divinylbenzene copolymers. The soybean oil segments in the copolymers are very flexible, while the aromatic styrene-divinylbenzene segments are very rigid. Both the rigid and flexible segments apparently interact well with each other in a homogeneous single-phase system at the molecular level. So, within the low crosslinking density νₑ region, the mobility of the polymer segments is very much affected by crosslinking. As the crosslinking density further increases as a result of increasing the crosslinking agent divinylbenzene, the flexible soybean oil segments may be easily restricted, and the rigid aromatic segments then become dominant. Thus, the effect of crosslinking on the mobility of the rigid segment-dominated polymer chains is no longer obvious as has been observed in this study.

In general, linear and weakly crosslinked polymers (elastomers) are brittle below their T_{g}, while above their T_{g} they are tough and rubbery. On the contrary, densely crosslinked polymers show a tough-brittle transition around the T_{g}. The crosslinking densities of the rubbery materials obtained in this study are similar to those of conventional rubber vulcanisates. In fact, the new polymer materials obtained herein possess a much wider range of crosslinking densities.

### EXAMPLE 5

A variety of new polymeric materials ranging from soft rubbers to hard, tough and brittle plastics have been prepared from cationic copolymerization of regular soybean oil, low saturation soybean oil (LoSatSoy oil) or conjugated LoSatSoy oil with styrene and divinylbenzene initiated by boron trifluoride diethyl etherate (BF₃.OEt₂) or related modified initiators according to various embodiments of the invention.

The bulk polymer has been found to be a crosslinked polymer network interpenetrated by some linear or less crosslinked soybean oil-styrene-divinylbenzene copolymers, and plasticized by a relatively small amount of low molecular weight free oil. All of the components are thermodynamically miscible in one single phase as evidenced by a single T_{g} obtained from dynamic mechanical analysis.

The dynamic mechanical behavior of the regular soybean oil, LoSatSoy oil and conjugated LoSatSoy oil polymers indicates that the various polymer materials obtained in this study possess a wide range of room temperature moduli from 6×10⁶ to 2×10⁹ Pa, and glass transition temperatures ranging from approximately 0° C. to 105° C., which are comparable to those of commercially available rubbery materials and conventional plastics.

The thermophysical properties of the new soybean oil polymers seem to be affected by the crosslinking density of the bulk polymers. However, the polymers based on different soybean oils do not follow the same trend when plotting the T_{g} vs. νₑ results. Empirical equations between the (tan δ)ₘₐₓ and logarithmic νₑ have been established for these particular polymers.

The dynamic mechanical properties of these new soybean oil polymers have provided useful insights into the characteristics of the bulk polymeric materials. The results suggest that these new soybean oil polymers may be able to replace the petroleum-based rubbers and conventional plastics widely used today.

### EXAMPLE 6

A series of new shape memory polymers have been synthesized by the cationic copolymerization of regular soybean oil and/or low saturation soybean oil (LoSatSoy oil), and/or conjugated LoSatSoy oil with styrene and divinylbenzene, norbornadiene or dicyclopentadiene initiated by boron trifluoride diethyl etherate (BF₃.OEt₂) or related modified initiators. The shape memory polymers created by the processes described in this application are implemented into a variedy of industrial products. These industrial products are used in applications in civil construction (e.g., rivets, gaskets, tube joints, etc.), in mechanics and manufacturing applications (e.g., automatic valve shrinkable casing tubes, shock proof devices, joint devices, e.g., materials, etc.), in electronics and communications applications (e.g., electromagnetic shield materials, cable joints, etc.), for applications in printing and packaging (e.g., shrinkable films, trademarks, laminate covers, etc.), in medical equipment applications (e.g., bandages, splints, orthopedical devices, blood vessel dilations devices, etc.), for household uses (e.g., table wares, neckties, artificial flowers, shower heads, etc.), for recreational uses and sports (e.g., stationary, toys, etc,) and a wide variety of other uses as would be understood by those of skill in the art.

The shape memory properties of the soybean oil polymers have been characterized by the deformability (D) of the materials at temperatures higher than their glass transition temperatures (T_{g}), the degree to which the deformation is subsequently fixed at ambient temperature (FD), and the final shape recovery (R) upon being reheated. It has been found that a T_{g} well above ambient temperature and a stable crosslinked network are two characteristics of these soybean oil polymers that exhibit shape memory effects. Good shape memory materials with high D, FD and R values have been prepared by controlling the crosslink densities and the rigidity of the polymer backbones. One advantage of the soybean oil polymers lies in the high degree of chemical control one has over the shape memory characteristics. This makes these materials particularly promising in applications where shape memory properties are desirable.

Shape memory refers to the ability of some materials to remember a specific shape, on demand, even after very severe deformations. In recent years, new shape memory polymers have received attention because of their low cost, low density, high shape recoverability and easy processibility, compared to conventional shape memory metals (alloys). Shape memory polymers basically consist of two phases: a reversible phase and a fixed phase. The reversible phase refers to the polymer matrix, which has a glass-transition temperature T_{g} (amorphous polymer) or a melting temperature Tₘ (crystalline polymer) well above the application temperature, usually the ambient temperature for most practical applications. The fixed phase is composed of either chemical or physical crosslinks that are relatively stable at temperatures higher than T_{g} or Tₘ of the reversible phase. Typically, at a temperature above the T_{g} or Tₘ, the shape memory polymer achieves a rubbery elastic state where it can be easily deformed by an external force. When the polymer is cooled to room temperature, the deformation is fixed due to the frozen micro-Brownian motion of the reversible phase. The hardened reversible phase effectively resists the elastic recovery resulting from the tendency of the ordered chains to return to a more random state, and thus the fixed deformation is regarded as a “permanent deformation” at room temperature. The deformed shape readily returns to its original shape upon being re-heated. The driving force for the shape recovery is due primarily to entropy, specifically the strong relaxations of the oriented polymer chains between crosslinks.

The first shape memory polymeric material of commercial importance was a polyethylene chemically crosslinked by using ionizing radiation during processing. However, both high capital expenditure and complicated techniques are required in the preparation, and the use of high-energy radiation is also limited to the preparation of articles with a thin cross section. Therefore, various routes have been developed to prepare new shape memory polymers, especially those with physical crosslinks. This new class of thermoplastic shape memory polymers includes a number of segmented block copolymers, grafted copolymer and hybrid copolymers with deliberately designed segmental structures. Most of the thermoplastic shape memory materials are segmented block copolymers, such as segmented polyurethanes and polyether-esters. In these copolymers, the soft segments form the polymer matrix (the reversible phase) with a T_{g} or Tₘ higher than room temperature, and the hard segments form a physically crosslinked network (the fixed phase) resulting from microphase segregation of the incompatible hard and soft segments. Introducing a chemically crosslinked structure not only facilitates full recovery of the deformation, but also renders better shape memory behavior under complex deformations. In addition to the segmented block copolymers, some grafted copolymers (polyethylene/polyamide-6 grafted copolymers) have been found to show shape memory effects. These grafted copolymers can be prepared by a melt-blending process. The crystalline polyethylene matrix acts as the reversible phase, whereas the polyamide-6 grafts aggregate and form physical crosslinks (fixed phase).

We have developed a series of new random copolymers prepared by the cationic copolymerization of regular soybean oil (SOY), low saturation soybean oil [LoSatSoy oil (LSS)], or conjugated LoSatSoy oil (CLS), with various alkene comonomers, including styrene (ST), divinylbenzene (DVB), norbornadiene (NBD) and dicyclopentadiene (DCP). A wide variety of viable chemically crosslinked polymeric materials have been obtained, ranging from elastomers through tough to relatively brittle plastics. These new soybean oil polymers not only exhibit competitive thermophysical and mechanical properties, but also possess very good damping properties over wide temperature and frequency ranges. By deliberately designing the structures, the soybean oil polymers possess stable crosslinked networks, as well as high T_{g}'s, well above the ambient temperature.

Materials

The soybean oils used in this study can be regular food-grade soybean oil (SOY) and low saturation soybean oil [LoSatSoy oil (LSS)], both commercially available in supermarkets and used without further purification. Conjugated LoSatSoy oil (CLS) has been prepared by the rhodium-catalyzed isomerization of LSS in our laboratory. The percent conjugation of the CLS has been calculated to be approximately 100%. The compositions of the three different soybean oils used in this study are listed in Table 35. ST, DVB (80% and 20% ethylvinylbenzene), NBD and DCP have been purchased from Aldrich Chemical Company and used as received. The distilled grade boron trifluoride diethyl etherate (BFE) used to initiate cationic polymerization of the various soybean oils was also supplied by Aldrich. Norway Pronova fish oil ethyl ester EPAX 5500 EE (NFO) was used to modify the original BFE initiator.

TABLE 35
Compositions of the various triglyceride soybean oils
% fatty acids^{b}

| Entry | Soybean oil | Type | number^{a} | C16:0 | C18:0 | C18:1 | | C18:3 |
|---|---|---|---|---|---|---|---|---|
| 1 | Soybean oil (SOY) | non-conjugated | 4.5 | 10.5 | 3.2 | 22.3 | 54.4 | 8.3 |
| 2 | LoSatSoy oil (LSS) | non-conjugated | 5.1 | 4.5 | 3.0 | 20.0 | 63.5 | 9.0 |
| 3 | Conjugated LoSatSoy oil (CLS) | conjugated | 5.1 | 4.5 | 3.0 | 20.0 | 63.5 | 9.0 |

^{a}The average number of carbon-carbon double bonds per triglyceride has been calculated by ¹H NMR spectral analysis.
^{b}For example, C18:2 represents the fatty acid (ester), which possesses 18 carbons and 2 C═C bonds.

Polymer Preparation

The polymeric materials have been prepared by the cationic copolymerization of SOY, LSS or CLS with ST and DVB, NBD or DCP initiated by BFE or related modified initiators. The detailed reaction procedures have been described elsewhere. The nomenclature adopted in this work for the polymer samples is as follows: SOY, LSS and CLS represent regular soybean oil, LoSatSoy oil and conjugated LoSatSoy oil, respectively; ST is the styrene comonomer; DVB, NBD and DCP represent divinylbenzene, norbornadiene and dicyclopentadiene comonomers used as crosslinking agents. BFE is the initiator boron trifluoride diethyl etherate; NFO is Norway fish oil ethyl ester. For example, a polymer sample prepared from 45 wt % LSS, 32 wt % ST, 15 wt % DVB and 8 wt % NFO-modified BFE initiator (5 wt % NFO plus 3 wt % BFE) is designated as LSS45-ST32-DVB15-(NFO5-BFE3). Since the amount of ethylvinylbenzene present in the DVB is minimal, we have omitted it from our nomenclature to avoid confusion.

Characterizations

The dynamic mechanical properties of the bulk polymers were obtained by using a Perkin-Elmer dynamic mechanical analyzer DMA Pyris-7e in a three-point bending mode. A rectangular specimen was made by injecting the reactants into an appropriate mold. Thin sheet specimens of 2 mm thickness and 5 mm depth were used, and the span to depth ratio was maintained at approximately 2. Each specimen was first cooled to ca. −35° C., and then heated at 3° C./min and a frequency of 1 Hz under helium. The viscoelastic properties, e.g., storage modulus E′, and mechanical loss factor (damping) tan δ, were recorded as a function of temperature. The glass-transition temperature T_{g} of the polymer was obtained from the peak of the loss factor curve. The crosslink density νₑ was calculated from the high temperature elastic modulus of the DMA results, based upon the theory of rubber elasticity.

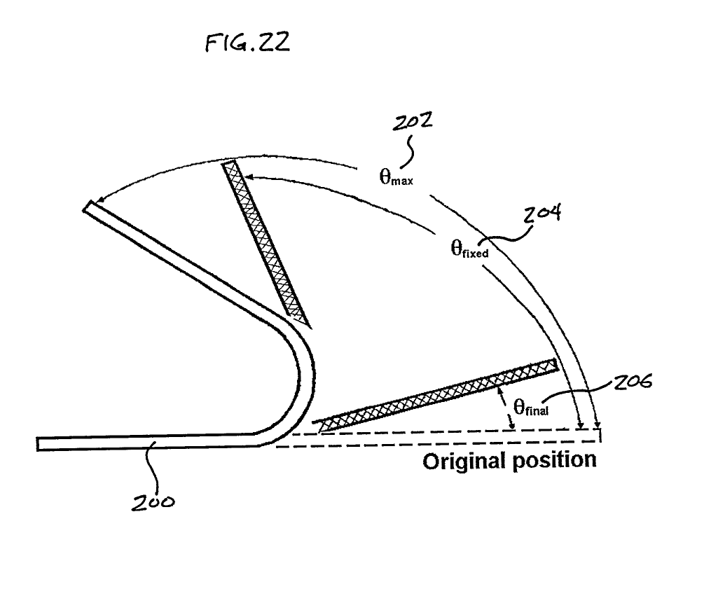

Now referring to FIG. 22, the shape memory behavior of the soybean oil polymers was examined by a bending test. FIG. 22 shows that the specimen 200 (80 mm×12 mm×3 mm) was first deformed to a maximum angle θₘₐₓ 202 at the temperature T_{g}+50° C. by an external force (the specimen tended to break at angles greater than θₘₐₓ202). The deformed specimen 200 was quenched in a water bath at ambient temperature while still under the external force. When the external force was released at room temperature, minor shape recovery might occur, and the deformed angle changed from θₘₐₓ202 to θ_{fixed}204 (the deformed angle θ_{fixed} 204 fixed at room temperature was typically a little smaller than the originally deformed angle θₘₐₓ202). Finally, the deformed specimen 200 was heated to various temperatures at a heating rate of approximately 50° C./min, and the remaining angle θ_{final} 206 was recorded after 10 minutes at each temperature. The following definitions are used in order to quantitatively characterize the shape memory properties of the polymers. The deformability (D) of the specimen at the temperature T_{g}+50° C. is defined as D θₘₐₓ/180×100%. The fixed deformation (FD) at room temperature, which depicts the ability of the specimen to fix its deformation at ambient temperature, is defined as FD=θ_{fixed}/θmax×100%. The shape recovery is defined as R=(θ_{fixed}-θ_{final})/θ_{fixed}×100%.

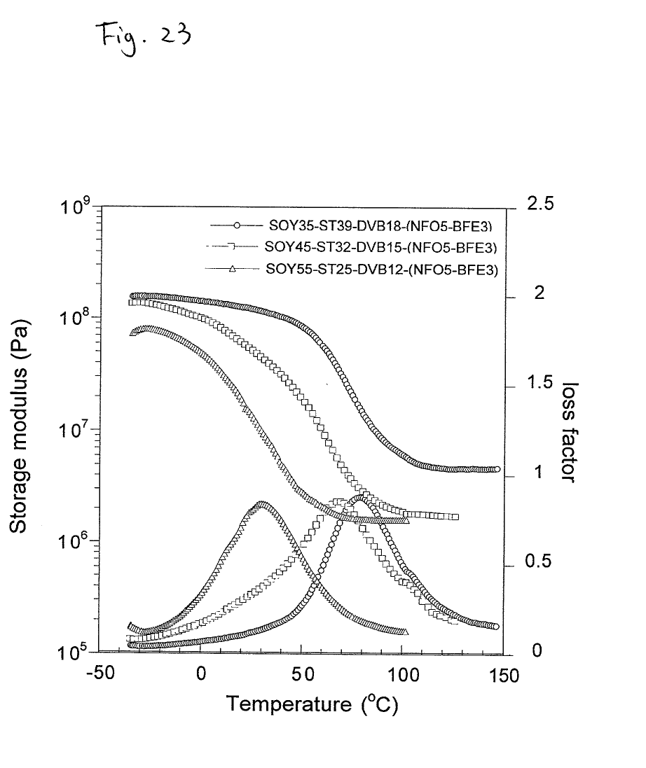

A shape memory polymer exhibits mechanical behavior that includes fixing the deformation of the plastic at room temperature and recovering the deformation as an elastomer at relatively high temperatures. Thus, a T_{g} well above ambient temperature and the formation of stable crosslinks are generally characteristic for a soybean oil polymer to show shape memory effect. FIG. 23 shows the dynamic mechanical behavior of three SOY polymers prepared by varying the SOY concentration with a constant ratio of ˜2:1 of ST to DVB comonomers. The storage moduli of the SOY polymers initially remain constant at low temperatures. As the temperature increases, the storage moduli exhibit large and sharp drops in the temperature region between 20 and 100° C., which correspond to the glass transitions of the SOY polymers as determined by the corresponding loss factor peaks. At temperatures above their T_{g}'s, the moduli appear to be the order of magnitude of rubbery materials (10⁶ Pa), and the rubbery modulus plateaus indicate the existence of stable crosslinks in the bulk SOY polymers.

Table 36, entries 1-3, gives the T_{g} values and crosslink densities υₑ of the three SOY polymers illustrated in FIG. 23. These SOY polymers possess T_{g}'s higher than room temperature, and various degrees of crosslinking have been obtained. As expected, the SOY polymers exhibit a shape memory effect. Table 28, entry 1, shows that the polymer SOY35-ST39-DVB18-(NFO5-BFE3) exhibits a deformability D 83% at T_{g}+50° C. Upon releasing the applied force, the deformation of the specimen can be fixed effectively with FD=98% at room temperature. No further recoverable strain is found until it is re-heated to high temperatures. As the SOY concentration increases, the resulting polymer shows an improved deformability (D=100%) at T_{g}+50° C., but its ability to fix the deformation at room temperature is reduced to FD=80% (entry 2). When the SOY concentration exceeds 50%, the resulting polymer actually behaves like an elastomer with FD=11% (entry 3). The T_{g} and crosslinking density υₑ play roles in determining the shape memory properties. An increase in SOY concentration results in a decreased rubbery modulus at T_{g}+50° C. (FIG. 28), which is inherently associated with the decreased crosslink density υₑ. A lower degree of crosslinking leads to a greater number of conformations that the polymer can adopt upon being loaded and deformed, thus enhancing the deformability as an elastomer at the higher temperatures. An increase in SOY concentration also reduces the T_{g} due to the decreased rigidity of the polymer chains and crosslink density υₑ. Thus, the micro-Brownian motion of the polymer chains cannot be effectively frozen, which leads to a low percentage of fixed deformation (FD) at room temperature. As the T_{g} is reduced to the vicinity of room temperature, the room temperature modulus is equivalent to that of a rubbery material (˜10⁶ Pa), and the polymer actually behaves like an elastomer with a very small amount of stable deformation fixed at ambient temperature (entry 3). For a typical shape memory material, the frozen Brownian motion is released upon being re-heated, and the extended polymer chain segments relax and return to the original random state. It has been found that less crosslinks lead to incomplete recovery of the deformed specimen. Note that the three polymers show 100% recovery of the fixed deformation upon reheating to T_{g}+50° C., indicating that the crosslink density is high enough to effectively store and release the elastic energy in the shape memory process.

TABLE 36
Shape memory properties of the SOY polymers

| | | T_{g} | Vₑ | Shape memory results (%) | | |
|---|---|---|---|---|---|---|
| Entry | Polymer | (° C.) | (mol/m³) | D | | R |
| 1 | SOY35-ST39-DVB18-(NFO5-BFE3) | 79 | 4.7 × 10² | 83 | 98 | 100 |
| 2 | SOY45-ST32-DVB15-(NFO5-BFE3) | 68 | 1.8 × 10² | 100 | 80 | 100 |
| 3 | SOY55-ST25-DVB12-(NFO5-BFE3) | 30 | 1.0 × 10² | 100 | 11 | 100 |
| 4 | SOY45-ST42-DVB5-(NFO5-BFE3) | 36 | 3.3 × 10 | 100 | 23 | 100 |
| 5 | SOY45-ST37-DVB10-(NFO5-BFE3) | 44 | 1.4 × 10² | 100 | 64 | 100 |
| 6 | SOY45-ST32-DVB15-(NFO5-BFE3) | 68 | 1.8 × 10² | 100 | 80 | 100 |
| 7 | SOY45-ST30-DVB17-(NFO5-BFE3) | 72 | 5.4 × 10² | 94 | 90 | 100 |
| 8 | SOY45-ST27-DVB20-(NFO5-BFE3) | 80 | 6.0 × 10² | 92 | 97 | 100 |
| 9 | SOY45-ST22-DVB25-(NFO5-BFE3) | 96 | 9.4 × 10² | 69 | 93 | 100 |
| 10 | SOY45-ST17-DVB30-(NFO5-BFE3) | 107 | 1.5 × 10³ | 50 | 99 | 100 |
| 11 | SOY45-ST12-DVB35-(NFO5-BFE3) | 100 | 2.9 × 10³ | 33 | 100 | 100 |
| 12 | SOY45-ST07-DVB40-(NFO5-BFE3) | 86 | 4.8 × 10³ | 17 | 100 | 100 |
| 13 | SOY45-ST00-DVB47-(NFO5-BFE3) | 72 | 5.7 × 103 | 8 | 100 | 100 |

Unlike the flexible soybean oil molecule, the crosslinking agent DVB is a very rigid aromatic molecule with more reactive C═C bonds (FIG. 29). An increase in the DVB concentration increases the degree of crosslinking and the T_{g}s of the resulting polymers. Thus, contrary to the SOY concentration discussed above, an increase in the DVB concentration gradually reduces the deformability of the materials from D=100% to 8% at T_{g}+50° C., and evidently enhances the ability of the polymers to subsequently fix their deformations as FD increases from 23% to 100% at ambient temperature (Table 36, entries 4-13). Complete shape recovery has been obtained for all of these specimens. Optimal combinations of the shape memory properties are found in the two SOY polymers SOY45-ST30-DVB17-(NFO5-BFE3) and SOY45-ST27-DVB20-(NFO5-BFE3), which possess D, FD and R values over 90% (entries 7, 8).

Aside from the chemical stoichiometry, the type of soybean oil employed also greatly affects the shape memory properties of the resulting polymers (Table 37, entries 1-3). Three different soybean oils have been used in this study—SOY, LSS and CLS. Although these soybean oils have a similar triglyceride structure, the compositions of the fatty acid side chains are varied (Table 35). Specifically, the SOY has approximately 4.5 non-conjugated C═C bonds per triglyceride, whereas the LSS has approximately 5.1 non-conjugated C═C bonds per triglyceride. Conjugation of the LSS does not change its triglyceride structure or the degree of unsaturation, but approximately 100% of the C═C bonds that can be conjugated are conjugated in the CLS. Thus, the reactivity towards cationic polymerization is SOY<LSS<CLS. Due to the triglyceride structure and multiple C═C bonds, the soybean oils also contribute to crosslinking like the crosslinking agent DVB. As a result, the CLS polymer possesses a higher degree of crosslinking and T_{g} than the corresponding SOY and LSS polymers. As expected, the more reactive soybean oil results in a polymer with a higher FD value and a lower D value. Complete shape recovery is also obtained for the above three different soybean oil polymers.

TABLE 37
Shape memory properties of the soybean oil polymers

| | | T_{g} | Vₑ | Shape memory results (%) | | |
|---|---|---|---|---|---|---|
| Entry | Polymer | (° C.) | (mol/m³) | D | | R |
| 1 | SOY45-ST32-DVB15-(NFO5-BFE3) | 68 | 1.8 × 10² | 100 | 80 | 100 |
| 2 | LSS45-ST32-DVB15-(NFO5-BFE3) | 61 | 5.3 × 10² | 86 | 96 | 100 |
| 3 | CLS45-ST32-DVB15-(NFO5-BFE3) | 76 | 2.2 × 10³ | 77 | 98 | 100 |
| 4 | SOY45-ST32-(DVB5-NBD5-DCP5)-(NFO5-BFE3) | 42 | 9.8 × 10 | 100 | 63 | 100 |
| 5 | (SOY22.5-LSS22.5)-ST32-(DVB5-NBD5-DCP5)-(NFO5-BFE3) | 43 | 1.3 × 10² | 100 | 74 | 100 |
| 6 | (SOY15-LSS15-CLS15)-ST32-(DVB5-NBD5-DCP5)-(NFO5-BFE3) | 44 | 2.7 × 10² | 100 | 75 | 100 |
| 7 | SOY45-ST20-(DVB9-NBD9-DCP9)-(NFO5-BFE3) | 68 | 3.1 × 10² | 100 | 97 | 100 |
| 8 | (SOY22.5-LSS22.5)-ST20-(DVB9-NBD9-DCP9)-(NFO5-BFE3) | 70 | 3.7 × 10² | 100 | 98 | 100 |
| 9 | (SOY15-LSS15-CLS15)-ST20-(DVB9-NBD9-DCP9)-(NFO5-BFE3) | 74 | 5.2 × 10² | 100 | 99 | 100 |

Despite the fact that 100% shape recovery (R) is obtained for all of these materials, good shape memory polymers should also possess both high D and FD results. It is known that the D and FD results are determined presumably by the crosslink densities and T_{g}s of the materials. A low crosslink density gives rise to a high D value, but significantly reduces shape recovery R, whereas a high crosslink density greatly reduces the D value. In addition, a T_{g} well above ambient temperature is necessary to afford a high FD value. Thus, good shape memory materials generally have simultaneously possess appropriate combinations of T_{g}s and crosslink densities, e.g., high T_{g}s well above ambient temperature and moderate crosslink densities. Apparently, appropriate combinations of these properties are generally not readily achieved by employing different soybean oils or simply varying the chemical stoichiometries as previously mentioned. In the above cases, the T_{g}s are enhanced to well above room temperature, which is usually accompanied by a significant increase in crosslink densities. As a result, the D and FD values generally are not improved simultaneously. However, it is noted that, in addition to crosslinking, increasing the rigidity of the polymer backbones can also be an effective means to enhance the T_{g}. Thus, less reactive and more rigid crosslinking agents have to be employed, so that the T_{g}s can be increased to well above the ambient temperature without significantly increasing the crosslink densities.

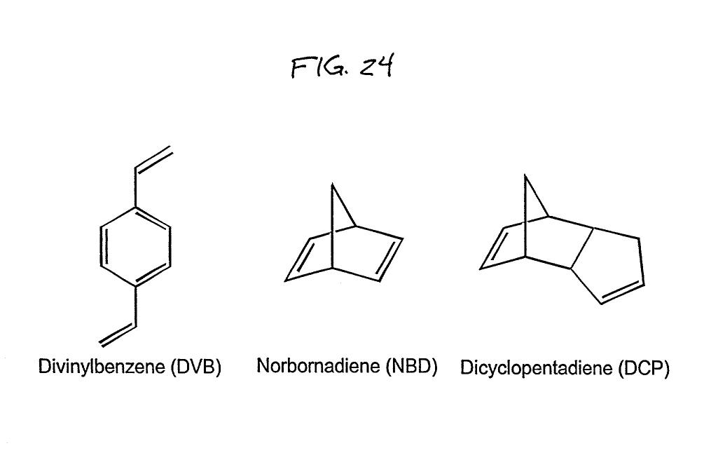

FIG. 24 shows the molecular structures of three different crosslinking agents, DVB, NBD and DCP, that we have studied. It has been found that DVB is the most reactive crosslinking agent, whereas DCP is the least reactive crosslinking agent. However, the rigidity of the three comonomers in the resulting polymer chains appears to be DVB<NBD<DCP. We have found that simple replacement of DVB with either NBD or DCP does not result in viable materials. Thus, mixed crosslinking agents have been employed in our copolymerizations. Table 37 shows that, as expected, mixed crosslinking agents result in a polymer with a lower crosslink density (entry 4) than the corresponding pure DVB-based SOY polymer (entry 1). Although the increased rigidity of the polymer chains tends to enhance the T_{g}, the polymers are not apparently rigid enough to compensate for the T_{g} depression resulting from the decreased crosslink density. Thus, a high D value is observed, but a very low FD value is obtained. It has also been found that the addition of more reactive soybean oils, such as LSS and CLS, does not apparently increase the T_{g}'s and the shape memory results (entries 5 and 6). To achieve good shape memory results, further increasing the rigidity of the polymer chains appears to be useful. Moderate crosslink densities and high T_{g}s, well above ambient temperature, have been simultaneously obtained by appropriately increasing the concentration of the rigid crosslinking agents. Thus, the resulting polymers show D, FD and R values of over 97%, and are apparently good shape memory materials (entries 7-9).

TABLE 38
Repeatability of the shape memory behavior of the soybean oil polymers

| Shape memory polymer | Shape memory results (%) | 1st | 2nd | 3rd | 4th | 5th | 6th | 7th |
|---|---|---|---|---|---|---|---|---|
| | | 100 | 100 | 100 | 100 | 100 | 100 | 100 |
| SOY45-ST20-(DVB9-NBD9-DCP9)-(NFO5- | FD | 97 | 95 | 94 | 93 | 90 | 90 | 89 |
| BFE3) | R | 100 | 100 | 100 | 100 | 100 | 100 | 100 |
| | D | 100 | 100 | 100 | 100 | 100 | 100 | 100 |
| (SOY22.5-LSS22.5)-ST20- | FD | 98 | 96 | 93 | 93 | 90 | 90 | 89 |
| (DVB9-NBD9-DCP9)-(NFO5-BFE3) | R | 100 | 100 | 100 | 100 | 100 | 100 | 100 |
| | D | 100 | 100 | 100 | 100 | 100 | 100 | 100 |
| (SOY15-LSS15-CLS15)-ST20- | FD | 99 | 97 | 93 | 93 | 89 | 90 | 90 |
| (DVB9-NBD9-DCP9)-(NFO5-BFE3) | R | 100 | 100 | 100 | 100 | 100 | 100 | 100 |

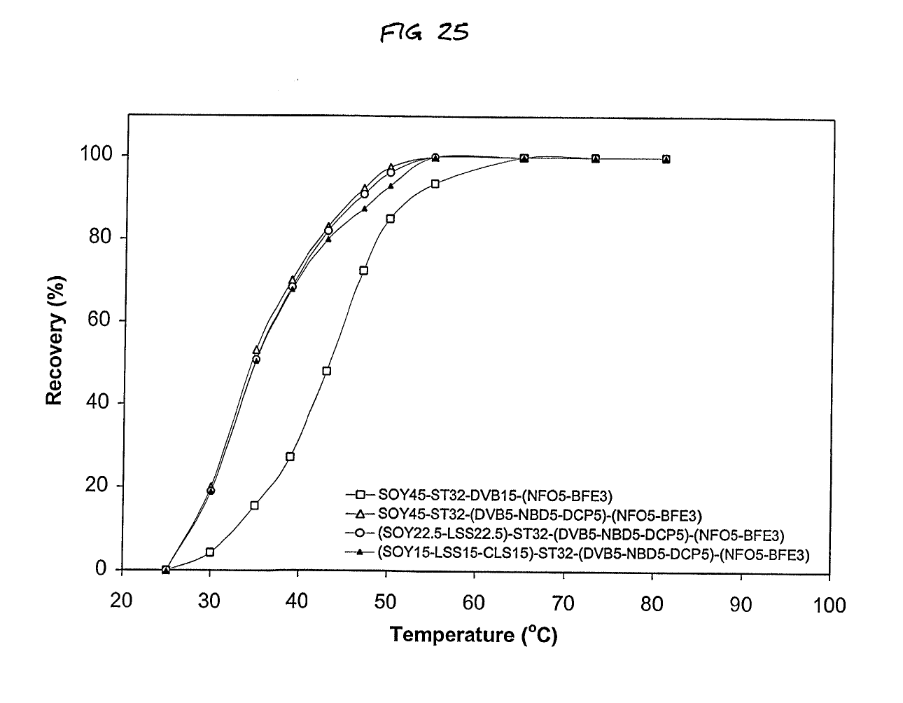

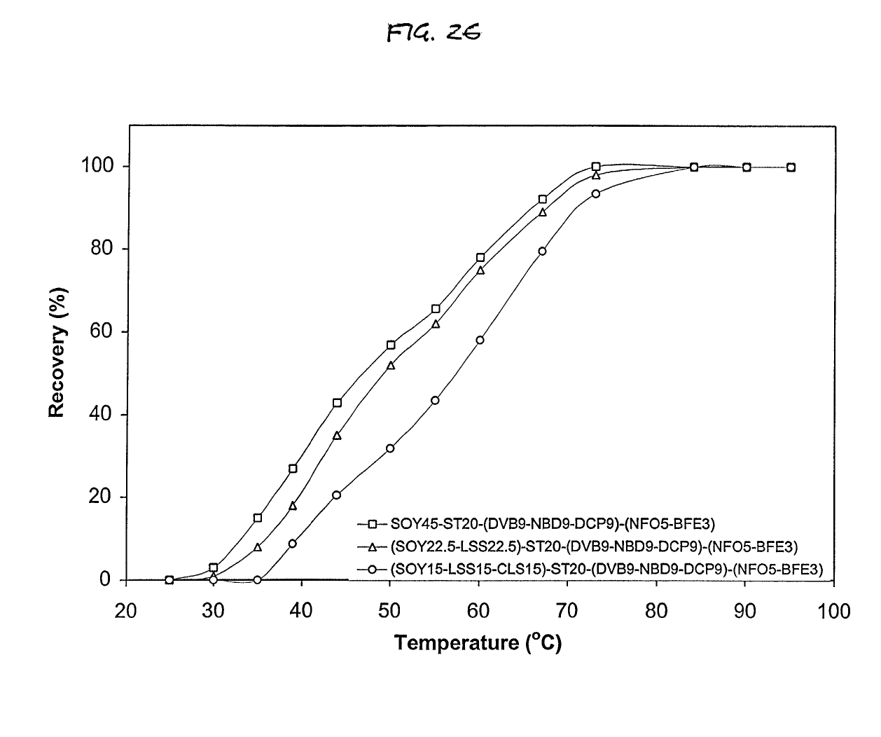

FIG. 25 gives the shape recovery results at various temperatures for the soybean oil polymers of entries 4-6 in Table 37. All of the polymers appear to show shape recovery behavior similar to one another. The polymer SOY45-ST32-DVB15-(NFO5-BFE3) exhibits a shape recovery at a relatively high temperature, and 100% shape recovery is reached at about 65° C. The other three specimens based on mixed crosslinking agents show shape recovery results which essentially overlap, and complete shape recovery is reached at about 55° C. Note that the onset of shape recovery is observed at temperatures slightly higher than ambient temperature, making the fixed deformations relatively unstable at room temperature. Thus, the polymers afford FD values of 63-75% (Table 37, entries 4-6), which make these materials inferior shape memory materials. As previously discussed, by increasing the concentration of the mixed crosslinking agents, the resulting plastics possess appropriate combinations of T_{g}s and crosslink densities, thus improving their shape memory properties. FIG. 26 shows that the polymers of entries 7-9 in Table 37 not only possess high D and FD values (>97%), but also exhibit much better shape recovery processes. No significant shape recovery is observed at temperatures slightly higher than ambient temperature, making the fixed deformations relatively stable at room temperature. Upon being reheated, complete shape recovery is achieved at approximately 85° C. Thus, the materials appear to be more suitable for applications at room temperature.

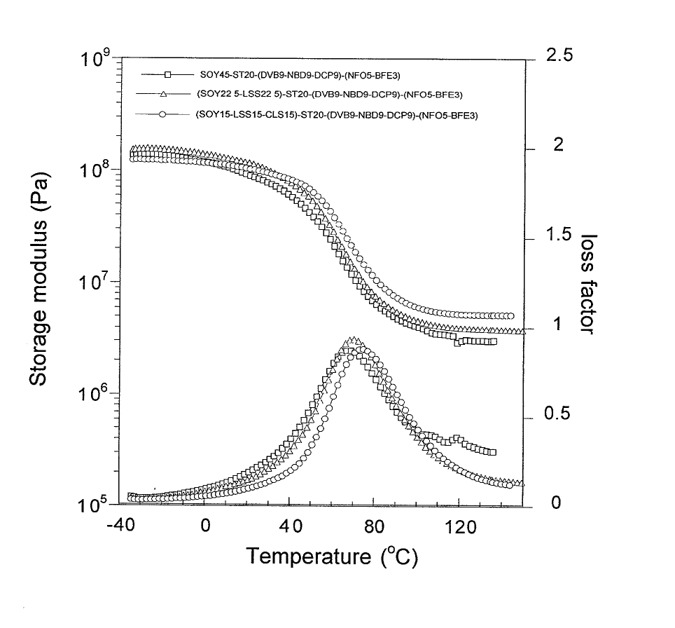

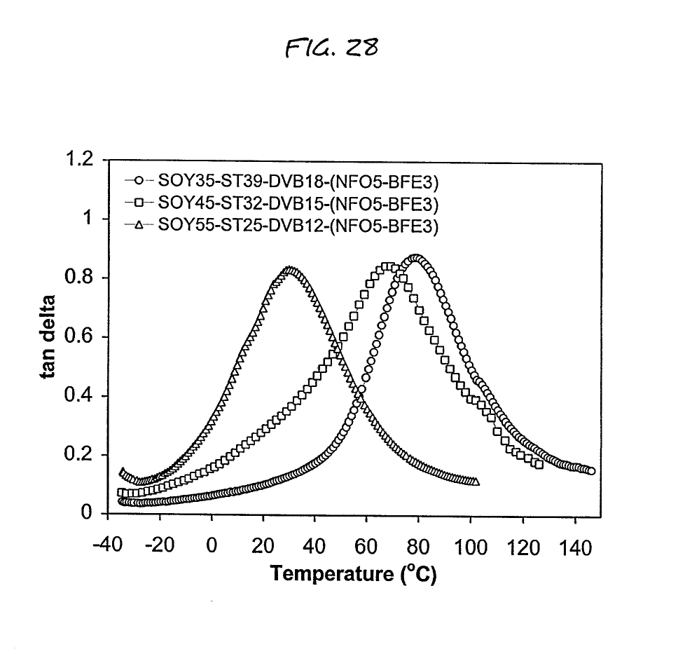

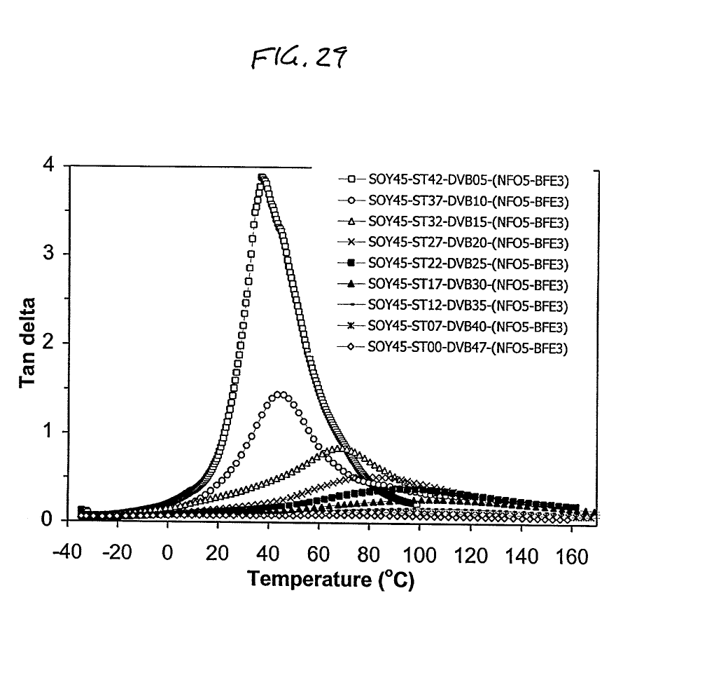

FIG. 27 shows the dynamic mechanical behavior of the soybean oil polymers shown in FIG. 26. Apparently, the wide temperature region for the shape recovery process is ascribed primarily to the broad glass transitions of the materials. The initial shape recovery processes are inherently related to the onset of segmental motion (glass transition) of the soybean oil polymers. Since shape recovery has been measured stepwise at different temperatures, but the dynamic mechanical analysis has been carried out by heating the samples continuously, the shape recovery processes do not cover exactly the same temperature regions as the corresponding glass transitions.

The shape recovery process of the materials at each temperature may be modeled by the viscoelastic behavior of the polymers. In the deformation of a linear viscoelastic polymer, the total strain ε_{T} can be described by a series combination of the Maxwell and Kelvin-Voigt models, which is used to predict the creep and recovery behavior of viscoelastic materials.

$${ϵ}_{T} = {ϵ}_{1} + {ϵ}_{2} + {ϵ}_{3} = \frac{σ}{{E}_{1}} + \frac{σ}{{E}_{2}} [ 1 - exp ( - \frac{{E}_{2} t}{{η}_{2}} ) ] + \frac{σ t}{{η}_{3}} \qquad \text{(EX.5-1)}$$

Here ε₁ is the instantaneous elastic deformation resulting from covalent bond stretching and the distortion of bond angles; ε₂ is the delayed elastic deformation resulting from micro-Brownian motion of the polymer chains; and ε₃ is the irreversible strain resulting from Newtonian flow, which is identical to the deformation of a viscous liquid obeying Newton's law of viscosity. For the shape memory soybean oil polymers, the deformation and shape recovery are conducted in a rubbery state, and the final recovery of the fixed deformation has been found to be essentially 100%. Thus, ε₁<<ε₂ and ε₃=0. The total strain can be defined as in equation (EX5-2).

$${ϵ}_{T} = \frac{σ}{{E}_{2}} [ 1 - exp ( - \frac{{E}_{2} t}{{η}_{2}} ) ] = \frac{σ}{{E}_{2}} [ 1 - exp ( - \frac{t}{τ} ) ] \qquad \text{(EX5-2)}$$

Here the retardation time τ=η₂/E₂. Due to the heterogeneity of the copolymer chains, a single retardation time is not sufficient to describe the deformation and shape recovery of the viscoelastic polymers. In fact, a viscoelastic polymer involves a spectrum of retardation times following a Gaussian distribution. Thus, the deformation is rewritten as follows.

$${ϵ}_{T} ( t ) = {\sum }_{1}^{n} {ϵ}_{i} ( ∞ ) [ 1 - exp ( - \frac{t}{{τ}_{i}} ) ] \qquad \text{(EX5-3)}$$

Here the ε_{ι}(∞) is the equilibrium strain when time is infinity. Therefore, the shape recovery at a certain temperature is actually described by a number (n) of Voigt-Kelvin models joined together in series. At a temperature below the glass transition, polymer segmental motions are frozen, and all of the retardation times (τ₁ to τₙ) are equal to infinity. Thus, no shape recovery is observed. At a temperature within the glass transition region, the retardation times of some segments become measurable, whereas others approach infinity. The elastic response is retarded by the viscous resistance of the material, and only partial shape recovery is observed. At a temperature well above the glass transition, complete shape recovery is achieved due to the shortening of all of the retardation times (τ₁ to τₙ).

Table 38 shows the relationship between the shape memory properties and the number of times the three polymers in FIG. 26 have been tested. The FD values of the polymers slowly decrease and reach steady values after about five tests. The D and R values approach 100% and are not evidently affected by the number of tests. Apparently, each of the three polymers tested shows very good reusability as a shape memory material.

A series of new polymers have been prepared by the cationic copolymerization of SOY, LSS, and/or CLS with ST and DVB, NBD or DCP initiated by the BFE initiator or related modified initiators. The shape memory properties of the soybean oil polymers have been investigated in relation to the chemical stoichiometry, and the type of the oil and comonomers employed. The shape memory properties are closely related to the crosslinking densities and glass transition temperatures. By achieving appropriate combinations of crosslink densities and glass transition temperatures through structural design of the polymer chain rigidity, soybean oil polymers exhibiting good shape memory effects with high D, FD and R results can be prepared. In addition, these new shape memory polymers have also been found to show good reusability.

### EXAMPLE 7

New polymeric materials with efficient damping characteristics have been prepared by the cationic copolymerization of regular soybean oil, low saturation soybean oil, i.e. LoSatSoy oil, or conjugated LoSatSoy oil with styrene and divinylbenzene, norbornadiene or dicyclopentadiene initiated by boron trifluoride diethyl etherate (BF₃.OEt₂) or related modified initiators. The effects of the stoichiometry, the type of soybean oil and the alkene comonomer on the damping behavior of the resulting polymers have been investigated.

Damping characteristics are defined as a material's ability to attenuate vibrational energy. The damping properties have been quantitatively evaluated by the loss tangent maximum (tan δ)ₘₐₓ, the temperature range ΔT for efficient damping (tan δ>0.3), and the integrals of the linear tan δ versus temperature curves (tan δ area, TA). These bulk materials are composed primarily of soybean oil-styrene-divinylbenzene random copolymers with considerable variability in the backbone compositions. The good damping properties of the soybean oil polymers are presumably determined by the presence of fatty acid ester side groups directly attached to the polymer backbone and the segmental heterogeneities resulting from crosslinking. In general, crosslinking reduces the (tan δ)ₘₐₓ and the TA values, but broadens the region of efficient damping (ΔT). Soybean oil polymeric materials with appropriate compositions and crosslink densities are capable of efficiently damping over a temperature region in excess of 110° C. and provide noise and vibration attenuation over broad temperature and frequency ranges.

Damping materials are finding numerous applications in the aircraft, automobile, and machinery industries for both the reduction of unwanted noise and the prevention of vibrational fatigue failure, and are especially useful as plating devices. The damping materials created in accordance with the processes described here are usefull in a wide variety of industrial applications including those in the transportation industry (e.g., automotive body panels, valve covers, and oil pans; aircraft panels, appendages, turbine engine components, and fuselage skin panels; ship hulls, decks, machinery, and piping; railroad car structure, panels, and wheels; etc.), applications for spacecraft (e.g., equipment panel supports, electrical circuit boards, optical equipment, antenna support structures, etc.), for industrial machinery applications (e.g., vehicles, drilling rigs, grinders, circular saw blades, load bearing pads, etc.), in commercial applications (e.g., appliances, office machines, computer components, metal cabinets, furniture, etc.), in construction applications (e.g., building parts, multilayer concrete slabs, window panes, etc.), and in military applications (e.g., submarine plating, coatings, etc.), as well as a variety of other uses as will be apparent to those of skill in the art.

The viscoelastic properties of polymers make them ideally suited for use as effective damping materials, because of their ability to dissipate mechanical energy. Specifically, the region of transition from the glassy to rubbery state (T_{g}) has the maximum potential for vibration damping. Thus, the damping characteristics of a polymer are dependent upon the intensity and breadth of the loss modulus or loss tangent (tan δ) peaks at the applicable temperature. Typically, the temperature range for efficient damping of known homopolymers is 20-30° C., which is rather narrow for practical applications. Good damping materials generally exhibit a high loss factor (tan δ>0.3) over a temperature range of at least 60-80° C. Materials with these characteritics make for efficient damping materials.

The glass transition can be broadened or shifted by the use of plasticizers or fillers, blending, grafting, copolymerization, crosslinking or the formation of interpenetrating polymer networks (IPNs). For sound and vibration damping, IPNs are a relatively new class of polymers capable of exhibiting relatively broad-band damping properties. IPNs are an intimate mixture of two or more network polymer components in which at least one network component is formed in the presence of the other. The introduction of crosslinks in IPNs restricts the domain size to very small phases and enhances the degree of formation of a microheterogeneous structure, which results in broad glass transition regions, making these polymers very useful for sound and vibration damping.

New thermosetting polymers can be prepared by the cationic copolymerization of regular soybean oil (SOY), low saturation soybean oil [LoSatSoy oil (LSS)], or conjugated LoSatSoy oil (CLS), with various alkene comonomers, including styrene (ST), divinylbenzene (DVB), norbornadiene (NBD) and dicyclopentadiene (DCP). By varying the stoichiometry and the type of oil and alkene, a wide variety of interesting polymeric materials have been obtained ranging from elastomers to tough and relatively brittle plastics. These new polymers exhibit physical and mechanical properties that are comparable to those of commercially available elastomers and conventional plastics, and may serve as replacements for petroleum-based polymer materials in many applications. These bulk polymeric materials are composed of a crosslinked soybean oil-ST-DVB copolymer and a certain amount of less highly crosslinked/branched soybean oil-ST-DVB copolymer, which interpenetrate each other in a manner analogous to the interpenetrating polymer networks (IPNs). The ester groups directly attached to the polymer backbone have already been found to make a significant contribution to the high damping of these polymeric materials. Thus, new bulk polymers with appropriate compositions exhibit good damping abilities, just like other IPN damping materials. These new soybean oil-based polymers are particularly attractive for a study of the effect of chemical structure on damping, since it is possible to change their T_{g}'s over a wide range of temperatures (0-100° C.).

Materials

The soybean oils used can be regular food-grade soybean oil (SOY) and low saturation soybean oil [LoSatSoy oil (LSS)], both commercially available in supermarkets and used without further purification. Conjugated LoSatSoy oil (CLS) has been prepared by the rhodium-catalyzed isomerization of LSS in our laboratory. The percent conjugation of the CLS has been calculated to be approximately 100%. ST, DVB (80% and 20% ethylvinylbenzene), NBD and DCP have been purchased from Aldrich Chemical Company and used as received. The distilled grade boron trifluoride diethyl etherate (BFE) used to initiate cationic polymerization of the various soybean oils was also supplied by Aldrich. Norway Pronova fish oil ethyl ester EPAX 5500 EE (NFO) was used to modify the original BFE initiator.

Polymer Preparation

The polymeric materials have been prepared by the cationic copolymerization of SOY, LSS or CLS with ST and DVB, NBD or DCP initiated by BFE or related modified initiators. The detailed reaction procedures have been described elsewhere. The nomenclature adopted in this work for the polymer samples is as follows: SOY, LSS and CLS represent regular soybean oil, LoSatSoy oil and conjugated LoSatSoy oil, respectively; ST is the styrene comonomer; DVB, NBD and DCP represent divinylbenzene, norbornadiene and dicyclopentadiene comonomers used as crosslinking agents. BFE is the initiator boron trifluoride diethyl etherate; NFO is Norway fish oil ethyl ester. A polymer sample prepared from 45 wt % LSS, 32 wt % ST, 15 wt % DVB and 8 wt % NFO-modified BFE initiator (5 wt % NFO plus 3 wt % BFE) is designated LSS45-ST32-DVB15-(NFO5-BFE3). Since the amount of ethylvinylbenzene present in the DVB is minimal, we have omitted it from our nomenclature to avoid confusion.

Characterizations

The damping properties of the bulk polymers have been obtained using a Perkin-Elmer dynamic mechanical analyzer DMA Pyris-7e in a three-point bending mode. The rectangular specimen was made by copolymerizing the reactants in an appropriate mold. Thin sheet specimens of 2 mm thickness and 5 mm depth have been used, and the span to depth ratio has been maintained at approximately 2. Each specimen has first been cooled to ca. −35° C., and then heated at 3° C./min under helium. The mechanical loss factor (damping) tan δ has been recorded as a function of temperature. All measurements have been performed at a frequency of 1 Hz, unless otherwise stated in the text. The glass transition temperature T_{g} of the polymer has been obtained from the peak of the loss factor tan δ curve. The crosslink densities have been calculated based upon rubber elasticity theory. The damping properties of the polymers have been quantitatively evaluated by the loss tangent maximum (tan δ)ₘₐₓ, the temperature range ΔT for efficient damping (tan δ>0.3), and the integral under the linear tan δ—temperature curve (tan δ area, TA). The TA values have been determined by first subtracting out the background and then cutting and weighing the paper portions representing the tan δ area under consideration.

Molecular Structures of the Soybean Oils

Three different soybean oils have been used in this study—SOY, LSS and CLS. The ¹H NMR spectrum for SOY indicates that it has approximately 4.5 C═C bonds per triglyceride. The LSS oil has a structure similar to that of SOY, but with approximately 5.1 C═C bonds per triglyceride. Conjugation of the LSS does not change its triglyceride structure or the degree of unsaturation, but approximately 100% of the C═C bonds that can be conjugated are conjugated in the CLS. Thus, SOY is the least reactive oil, while CLS is the most reactive oil.

Segmental Structures and Inhomogeneities of Soybean Oil-ST-DVB Copolymers

A variety of new polymeric materials ranging from elastomers to ductile and rigid plastics have been obtained from the cationic copolymerization of the various soybean oils and alkene comonomers, such as ST and DVB. These bulk materials are basically composed of a crosslinked soybean oil-ST-DVB copolymer network (50-92 wt %) and some less crosslinked/branched soybean oil-ST-DVB copolymers (8-50 wt %). Although these copolymers possess chemically similar structures, their chain compositions are apparently significantly different. The crosslinked soybean oil-ST-DVB copolymers contain greater amounts of rigid aromatic segments than flexible soybean oil segments, whereas the less crosslinked/branched soybean oil-ST-DVB copolymers are composed of greater amounts of flexible soybean oil segments in the polymer backbone than the rigid aromatic segments.

The presence of ester groups directly attached to polymer backbones have been known to greatly contribute to the damping intensities of bulk polymers. On the other hand, crosslinking restricts segmental motion, and reduces the polymer's ability to dissipate sound or vibration mechanical energy into thermal energy near the glass transition. Meanwhile, crosslinking increases the segmental heterogeneities of the polymer backbone, and effectively broadens the glass transition regions of the bulk polymeric materials. Thus, with appropriate compositions and crosslinking densities, our new polymeric materials are expected to show efficient damping over a wide temperature range. In general, random copolymerization shifts glass transitions, but does not greatly broaden the glass transitions of the resulting polymers. Thus, crosslinking is more likely to determine the damping behavior of the resulting polymers.

Damping Behavior of the Soybean Oil Polymers

(1) Regular Soybean Oil (SOY) Polymers

FIG. 28 shows the temperature dependence of the loss tangent (tan δ) for the SOY polymers prepared by varying the SOY concentration, while the weight ratio of ST to DVB comonomers remains constant at approximately 2:1. A broad and intense tan δ peak has been obtained, corresponding to the glass transition of each bulk polymer. As previously mentioned, although the two components of the bulk polymer possess different chemical compositions, they essentially have chemically similar structures. The single glass transition in FIG. 28 indicates that the two polymer components are quite compatible with each other in the bulk polymer, and, as expected, this results in a single phase, rather than phase separation. The increase in SOY concentration does not obviously affect the loss tangent intensity of the resulting polymers, but significantly shifts the damping peak to lower temperatures, from 80° C. to 30° C.

The loss factor tan δ, which indicates the damping ability of the material, is the ratio of the mechanical dissipation energy to the storage energy. Thus, a high tan δ intensity is essential for good damping materials. Table 39 shows that the loss tangent maxima (tan δ)ₘₐₓ of the three SOY polymers in FIG. 28 reach 0.84-0.88 (entries 1-3), which is even higher than those of polyurethane-based IPN damping materials. More specifically, the polymer SOY35-ST39-DVB18-(NFO5-BFE3) exhibits low damping at room temperature (tan δ)ᵣₜ=0.12, but shows efficient damping (tan δ>0.30) over a wide temperature range from 52° C. to 115° C. (ΔT=63° C.). The damping properties of the resulting polymer have obviously been improved by increasing the SOY concentration in the original composition. For example, the polymer SOY45-ST32-DVB15-(NFO5-BFE3) shows high damping (tan δ>0.3) over a much broader temperature range from 23° C. to 113° C. (ΔT=90° C.), and thus appears to be a good damping material. In addition, it is also a good damping material at room temperature where the (tan δ)ᵣₜ value equals 0.32. When the SOY concentration is increased further, the polymer SOY55-ST25-DVB12-(NFO5-BFE3) shows a very high loss tangent value at room temperature (tan δ)ᵣₜ=0.83. However, the temperature range for efficient damping (tan δ>0.3) becomes narrower (ΔT=67° C.). It follows that the polymer SOY45-ST32-DVB15-(NFO5-BFE3) not only exhibits the broadest temperature region for efficient damping (ΔT=90° C.), but also possesses the highest TA values, an expression of damping ability over the whole temperature range (entry 2). In other words, when the concentrations of the SOY and alkene comonomers (ST plus DVB) become approximately equivalent by weight (45% SOY and 47% alkene comonomers), the resulting SOY polymer exhibits optimal damping behavior.

TABLE 39
Damping properties of the SOY polymers

| | | T_{g} | vₑ | | | ΔT at | TA | Half width^{a} |
|---|---|---|---|---|---|---|---|---|
| Entry | Polymer | (° C.) | (mol/m³) | (tan δ)ₘₐₓ | (tan δ)ᵣₜ | tan δ > 0.3 | (K) | (° C.) |
| 1 | SOY35-ST39-DVB18-(NFO5-BFE3) | 79 | 4.7 × 10² | 0.88 | 0.12 | 52-115(63) | 37.5 | 47 |
| 2 | SOY45-ST32-DVB15-(NFO5-BFE3) | 68 | 1.8 × 10² | 0.85 | 0.32 | 23-113(90) | 48.4 | 61 |
| 3 | SOY55-ST25-DVB12-(NFO5-BFE3) | 30 | 1.0 × 10² | 0.84 | 0.83 | −2-65(67) | 36.3 | 51 |
| 4 | SOY45-ST42-DVB5-(NFO5-BFE3) | 36 | 3.3 × 10 | 3.90 | 1.36 | 7-90(83) | 124.1 | 27 |
| 5 | SOY45-ST37-DVB10-(NFO5-BFE3) | 44 | 1.4 × 10² | 1.46 | 0.60 | 15-125(110) | 56.8 | 36 |
| 6 | SOY45-ST32-DVB15-(NFO5-BFE3) | 68 | 1.8 × 10² | 0.85 | 0.32 | 23-113(90) | 48.4 | 61 |
| 7 | SOY45-ST30-DVB17-(NFO5-BFE3) | 72 | 5.4 × 10² | 0.55 | 0.22 | 41-111(70) | 35.1 | 78 |
| 8 | SOY45-ST27-DVB20-(NFO5-BFE3) | 80 | 6.0 × 10² | 0.53 | 0.17 | 50-124(74) | 33.0 | 89 |
| 9 | SOY45-ST22-DVB25-(NFO5-BFE3) | 96 | 9.4 × 10² | 0.39 | 0.13 | 67-127(60) | 27.3 | 121 |
| 10 | SOY45-ST17-DVB30-(NFO5-BFE3) | 107 | 1.5 × 10³ | 0.28 | 0.11 | 0 | 16.8 | 140 |
| 11 | SOY45-ST12-DVB35-(NFO5-BFE3) | 100 | 2.9 × 10³ | 0.17 | 0.10 | 0 | 7.5 | >200 |
| 12 | SOY45-ST07-DVB40-(NFO5-BFE3) | 86 | 4.8 × 10³ | 0.13 | 0.09 | 0 | 5.2 | >200 |
| 13 | SOY45-ST00-DVB47-(NFO5-BFE3) | 72 | 5.7 × 10³ | 0.09 | 0.07 | 0 | 3.5 | >200 |

^{a}Width of the damping peak at the half maxima point.

FIG. 29 shows the temperature dependence of the tan δ for the SOY polymers prepared by the cationic copolymerization of 45% SOY and 47% alkene comonomers, where the DVB concentration is varied. When 5% DVB is used, a narrow and extremely intense damping peak is obtained for the resulting SOY polymer. As the DVB concentration increases, the damping intensities of the resulting SOY polymers are reduced, and the damping temperature regions broaden significantly. The damping results for the above SOY polymers are also summarized in Table 39, entries 4-13. Without DVB, the polymer SOY45-ST47-DVB00-(NFO5-BFE3) has a very low average molecular weight, and appears to be a viscous fluid (not shown in the FIG. and the table). At least 5% DVB is required to afford a solid polymer material. The polymer SOY45-ST42-DVB5-(NFO5-BFE3) exhibits a (tan δ)ₘₐₓ value as high as 3.9, a (tan δ)ᵣₜ value of 1.36, and a temperature region at tan δ>0.3 ranging from 7 to 90° C. (ΔT=83° C.). A high TA value is obtained (TA=124 K), which appears to be much higher than those of other IPN-type damping materials. As the DVB concentration increases, the (tan δ)ₘₐₓ, (tan δ)ᵣₜ, and TA values of the resulting polymers gradually decrease. However, the ΔT value first increases and reaches a maximum at 10% DVB, and then gradually decreases. Overall, when 5-25% DVB is employed, the resulting polymers exhibit high damping (tan δ>0.3) over a wide range of temperatures (ΔT=60-110° C.) (entries 4-9). When more than 30% DVB is employed, the resulting polymers exhibit (tan δ)ₘₐₓ values much lower than 0.3, and are no longer good damping materials (entries 10-13).

(2) LoSatSoy Oil (LSS) and Conjugated LoSatSoy Oil (CLS) Polymers

Table 40 gives the damp i n g properties of the LSS polymers with the same compositions as the above SOY polymers. By varying the LSS concentrations, the resulting LSS polymers exhibit (tan δ)ₘₐₓ values of 0.86-1.00, TA values of 42-50 K and efficient damping (tan δ>0.3) over a temperature range of ΔT=66-89° C. (entries 1-3). Thus, these LSS polymers are good damping materials, just like the corresponding SOY polymers. The DVB concentration also affects the damping properties of the resulting LSS polymers in a manner similar to those of the SOY polymers. For example, the increase in DVB concentration reduces the (tan δ)ₘₐₓ values of the LSS polymers from 1.82 to 0.19 (entries 4-8). However, their ΔT and TA results do not change regularly as the DVB concentration varies, which is different from the SOY polymers. Generally, when less than 20% DVB is used, the resulting LSS polymeric materials appear to be good damping materials with efficient damping in a temperature range of ΔT=63-98° C. (entries 4-7). When too much DVB is used, the polymer LSS45-ST00-DVB47-(NFO5-BFE3), however, shows a (tan δ)ₘₐₓ value of less than 0.3 (entry 8).

TABLE 40
Damping properties of the LSS polymers

| | | T_{g} | vₑ | | | ΔT at | TA | Half width^{a} |
|---|---|---|---|---|---|---|---|---|
| Entry | Polymer sample | (° C.) | (mol/m³) | (Tan δ)ₘₐₓ | | tan δ > 0.3 | (K) | (° C.) |
| 1 | LSS35-St39-DVB18-(NFO5-BFE3) | 80 | 7.3 × 10² | 0.86 | 0.11 | 52-118 (66) | 41.5 | 51 |
| 2 | LSS45-St32-DVB15-(NFO5-BFE3) | 61 | 5.3 × 10² | 0.89 | 0.37 | 19-97 (78) | 46.2 | 52 |
| 3 | LSS55-St25-DVB12-(NFO5-BFE3) | 32 | 3.9 × 10² | 1.00 | 0.96 | −6-83 (89) | 50.1 | 57 |
| 4 | LSS45-St42-DVB05-(NFO5-BFE3) | 43 | 74 | 1.82 | 0.47 | 20-83 (63) | 63.9 | 30 |
| 5 | LSS45-St37-DVB10-(NFO5-BFE3) | 48 | 2.0 × 10² | 1.51 | 0.74 | 5-96 (91) | 75.4 | 57 |
| 6 | LSS45-St32-DVB15-(NFO5-BFE3) | 61 | 5.3 × 10² | 0.89 | 0.37 | 19-97 (78) | 47.9 | 52 |
| 7 | LSS45-St27-DVB20-(NFO5-BFE3) | 71 | 9.0 × 10² | 0.64 | 0.32 | 23-121 (98) | 40.5 | 92 |
| 8 | LSS45-St00-DVB47-(NFO5-BFE3) | 71 | 1.6 × 10⁴ | 0.19 | 0.18 | 0 | 7.6 | >200 |

^{a}Width of the damping peak at the half maxima point.

Table 41 shows the damping results of the corresponding CLS polymers. As expected, the CLS concentration (entries 1-3) and the DVB concentration (entries 4-9) affect the damping properties of the resulting CLS polymers in a manner similar to both the SOY and LSS polymers as previously mentioned. The most promising damping material from the CLS polymers appears to be CLS45-ST37-DVB10-(NFO5-BFE3) with efficient damping (tan δ>0.3) in a temperature range of 25 to 118° C. (ΔT=93° C.) (entry 6). Since the CLS is more reactive than the SOY and LSS, the resulting CLS polymer possesses a higher degree of crosslinking than the corresponding SOY and LSS polymers. As a result, the glass transitions of the CLS polymers appear at relatively higher temperatures, shifting the efficient damping region of the CLS polymers to higher temperatures compared to those of the corresponding SOY and LSS polymers.

(3) Polymers Based on Various Alkene Comonomers

NBD and DCP have the same number of reactive C═C bonds per molecule as the DVB, and thus may serve as crosslinking agents like DVB in the preparation of soybean oil polymers. However, NBD and DCP are clearly less reactive than DVB toward cationic copolymerization. For example, when DVB is replaced by NBD or DCP in polymers of the composition OIL45-ST32-DVB15-(NFO5-BFE3), the resulting SOY and LSS polymers possess very low average molecular weights, and appear to be viscous fluids at room temperature. Due to the relatively high reactivity of the CLS, its copolymerization with ST and NBD or DCP affords solid polymer materials. The effects of different comonomers on the damping behavior of the resulting CLS polymers can thus be easily determined as shown in Table 42, entries 1-3. The DVB-based CLS polymer exhibits a (tan δ)ₘₐₓ value of 0.79, and a ΔT value of 72° C. (entry 1). When NBD or DCP is utilized, the glass transitions of the resulting CLS polymers obviously shift to lower temperatures. Although the temperature region of the damping peaks becomes narrower, their damping intensities (tan δ)ₘₐₓ are greatly increased, resulting in a significant increase in the TA values (entries 2 and 3).

TABLE 41
Damping properties of the CLS polymers

| | | T_{g} | vₑ | | | ΔT at | TA | Half width^{a} |
|---|---|---|---|---|---|---|---|---|
| Entry | Polymer sample | (° C.) | (mol/m³) | (Tan δ)ₘₐₓ | | tan δ > 0.3 | (K) | (° C.) |
| 1 | CLS35-St39-DVB18-(NFO5-BFE3) | 82 | 3.4 × 10³ | 0.94 | 0.07 | 58-116 (58) | 41.8 | 42 |
| 2 | CLS45-St32-DVB15-(NFO5-BFE3) | 76 | 2.2 × 10³ | 0.79 | 0.18 | 48-120 (72) | 43.1 | 53 |
| 3 | CLS55-St25-DVB12-(NFO5-BFE3) | 38 | 6.5 × 10² | 1.08 | 0.80 | 10-77 (67) | 52.9 | 44 |
| 4 | CLS45-St47-DVB00-(NFO5-BFE3) | 10 | 1.0 × 10² | 2.02 | 1.85 | 8-68 (60) | 58.9 | 25 |
| 5 | CLS45-St42-DVB05-(NFO5-BFE3) | 45 | 4.0 × 10² | 1.80 | 1.60 | 9-69 (60) | 61.5 | 32 |
| 6 | CLS45-St37-DVB10-(NFO5-BFE3) | 60 | 1.3 × 10³ | 1.50 | 0.30 | 25-118 (93) | 76.7 | 60 |
| 7 | CLS45-St32-DVB15-(NFO5-BFE3) | 76 | 2.2 × 10³ | 0.79 | 0.18 | 48-120 (72) | 43.1 | 53 |
| 8 | CLS45-St27-DVB20-(NFO5-BFE3) | 75 | 2.6 × 10³ | 0.70 | 0.11 | 49-108 (59) | 34.0 | 50 |
| 9 | CLS45-St00-DVB47-(NFO5-BFE3) | 105 | 4.0 × 10⁴ | 0.21 | 0.10 | 0 | 5.6 | >200 |

^{a}Width of the damping peak at the half maxima point.

TABLE 42
Damping properties of soybean oil polymers prepared from various alkene comonomers

| | | T_{g} | vₑ | | | ΔT at | | Half width^{a} |
|---|---|---|---|---|---|---|---|---|
| Entry | Polymers | (° C.) | (mol/m³) | (tan δ)ₘₐₓ | (tan δ)ᵣₜ | tan δ > 0.3 | TA | (° C.) |
| 1 | CLS45-ST32-DVB15-(NFO5-BFE3) | 76 | 2.2 × 10³ | 0.79 | 0.18 | 48-120 (72) | 45.1 | 53 |
| 2 | CLS45-ST32-NBD15-(NFO5-BFE3) | 43 | 3.3 × 10² | 2.70 | 0.60 | 20-73 (53) | 83.9 | 24 |
| 3 | CLS45-ST32-DCP15-(NFO5-BFE3) | 14 | 1.2 × 10² | 4.30 | 2.30 | −8-50 (58) | 107.1 | 20 |
| 4 | SOY45-ST32-DVB15-(NFO5-BFE3) | 68 | 1.8 × 10² | 0.85 | 0.32 | 23-113(90) | 48.4 | 61 |
| 5 | SOY45-ST32-(DVB5+NBD5+DCP5)- | 42 | 9.8 × 10 | 2.56 | 0.74 | 13-85(72) | 85.1 | 27 |
| | (NFO5-BFE3) | | | | | | | |
| 6 | (SOY22.5+LSS22.5)-ST32- | 43 | 1.3 × 10² | 2.25 | 0.71 | 14-79(65) | 78.1 | 29 |
| | (DVB5+NBD5+DCP5)-(NFO5-BFE3) | | | | | | | |
| 7 | (SOY15+LSS15+CLS15)-ST32- | 44 | 2.7 × 10² | 1.90 | 0.49 | 20-77(57) | 66.1 | 28 |
| | (DVB5+NBD5+DCPS)-(NFO5-BFE3) | | | | | | | |

^{a}Width of the damping peak at the half maxima point.

As expected, a combination of the three comonomers (DVB+NBD+DCP) also yields higher damping properties, like pure NBD or DCP, for each of the soybean oil polymers than the DVB-based polymeric material (Table 42). Specifically, the (tan δ)ₘₐₓ value of the SOY45-ST32-(DVB5+NBD5+DCP5)-(NFO5−BFE3) is about three times higher than that of the polymer SOY45-ST32-DVB15-(NFO5-BFE3) (compare entries 4 and 5). The TA value also increases from 48 to 85 K, and the ΔT value decreases to 72° C., which is still broad enough for practical applications. When combined soybean oils are employed (entries 6 and 7), the damping properties decrease slightly, indicating that SOY-based polymers are better damping materials than the LSS- and CLS-based polymers in these combined compositions.

Crosslinking Dependence of the Damping Behavior

DVB has two reactive C═C bonds per molecule, and thus significantly contributes to crosslinking of the soybean oil polymers. In addition to DVB, soybean oils themselves also possess a high degree of unsaturation. The three side-chains of the three soybean triglyceride oils possess reactive C═C bonds, which also contribute to crosslinking during cationic copolymerization. As expected, the more reactive CLS affords polymers with higher crosslinking densities than those of the corresponding SOY and LSS polymers, when the same stoichiometries are employed.

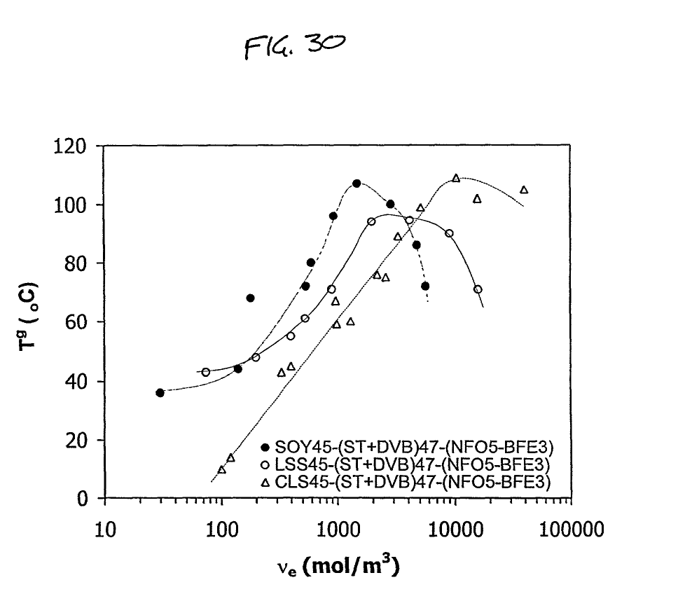

Crosslinking plays a role in determining the damping behavior of the thermosetting materials. FIG. 30 shows that crosslinking significantly increases the glass transition temperatures (damping peaks) of the soybean oil polymers. It is interesting to note that the three different soybean oil polymers exhibit similar characteristics. As the degree of crosslinking increases, the glass transition temperature of the polymers first increases and reaches a maximum, and then gradually decreases. The three different soy oil polymers differ in the crosslink densities at which the maximum glass transition temperatures are reached. Nielsen has reported that glass transition temperatures increase monotonically with increasing crosslink densities for most polymers. The unique characteristics in FIG. 30 may be ascribed to extensive interactions between the heterogeneous polymer segments, e.g., rigid aromatic segments from ST and DVB, and the flexible segments from the soybean oil triglycerides.

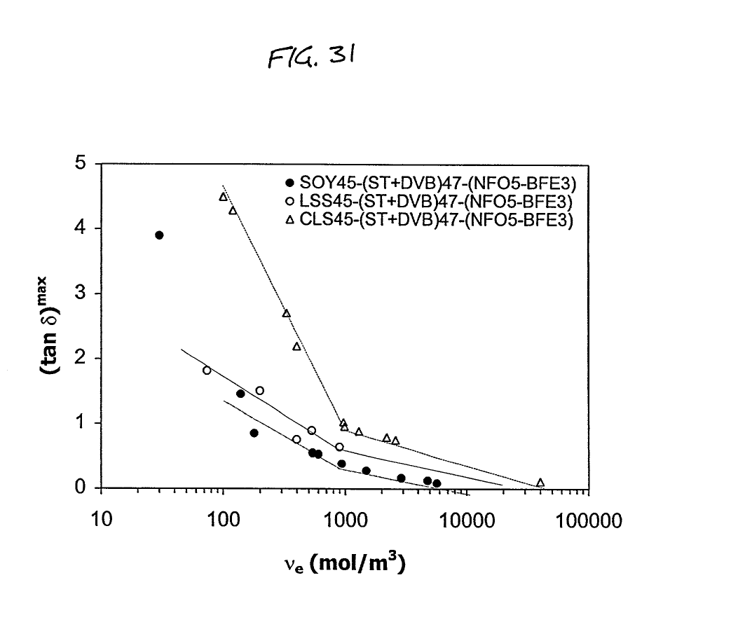

The crosslinking density νₑ is known to greatly affect the tan δ intensity of a polymer. Crosslinking restricts the segmental motion of the polymer chains, and thus reduces the energy that can be dissipated during the glass-rubber transition. FIG. 31 clearly shows that the (tan δ)ₘₐₓ of the polymers decreases when increasing the degree of crosslinking. Interestingly, two distinct νₑ regions have been observed, in which linear relationships between (tan δₘₐₓ and logarithmic νₑ can be established by neglecting some individual scattered data. When the crosslinking density νₑ is lower than 1×10³ mol/m³, the (tan δ)ₘₐₓ for the SOY, LSS and CLS polymers decreases markedly upon increasing the logarithmic νₑ. When the crosslinking density νₑ is higher than 1×10³ mol/m³, however, the decrease in (tan δ)ₘₐₓ as a function of the logarithmic νₑ is less pronounced. A plausible explanation for the division into two distinct regions may be ascribed to the existence of two kinds of segments with very different mobilities. The crosslinked polymer chains are composed primarily of soybean oil-ST-DVB copolymers. The soybean oil segments in the copolymers are very flexible, whereas the aromatic ST-DVB segments are very rigid. Both the rigid and flexible segments apparently interact well with each other in a homogeneous single-phase system at the molecular level. So, within the low crosslinking density νₑ region, the mobility of the polymer segments is very much affected by crosslinking. As the crosslinking density further increases as a result of increasing the crosslinking agent DVB, the flexible soybean oil segments may be easily restricted, and the rigid aromatic segments then become dominant. Thus, the effect of crosslinking on the mobility of the rigid segment-dominated polymer chains is no longer as pronounced.

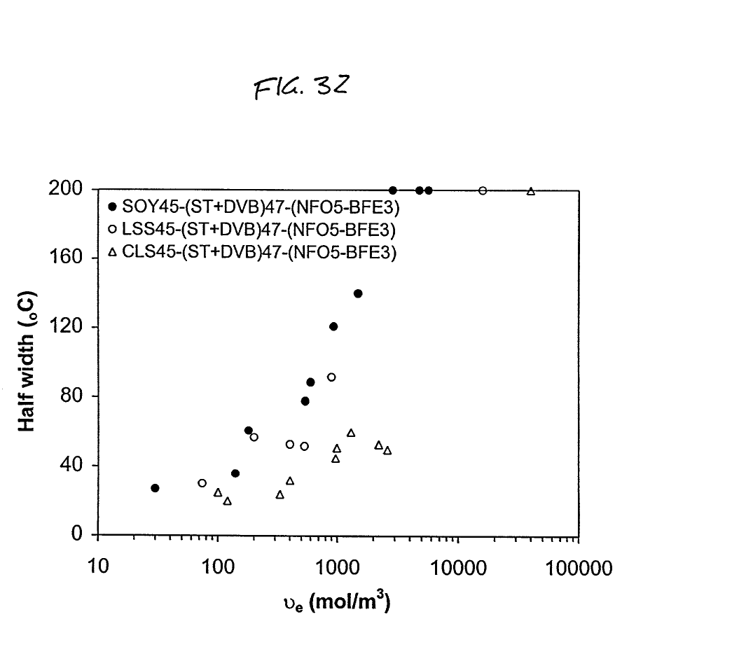

In addition to reducing the (tan δ)ₘₐₓ, crosslinking obviously increases segmental heterogeneities, and thus broadens the glass transition (damping) region. FIG. 32 shows that the half-peak width of the damping peaks increases, though not in a regular manner, as the crosslinking density of the soybean oil polymers is increased. It is interesting to note that the half-peak widths of the soybean oil polymers are much broader than those (38° C.) of the segmented polyether urethane-based damping materials. The tan δ area (TA), an expression describing the damping of the soybean oil polymers over the whole temperature range, is presumably determined by the heights and widths of the damping peaks (refer to FIGS. 31 and 32). The regular decrease in the TA values as a function of the crosslinking density of the polymers in FIG. 6 indicates that the (tan δ)ₘₐₓ value plays a larger role than the damping width in determining the TA values.

In general, the damping behavior of the SOY, LSS and CLS polymers follows the same trend as the crosslink density varies (FIGS. 30-33). With the same degree of crosslinking, however, the damping properties of the resulting polymers are clearly related to the type of soybean oil employed. The three soybean oils have different degrees of unsaturation, and the reactivities of their C═C bonds towards cationic polymerization differ significantly from one another. Typically, the least reactive SOY results in polymers with the highest T_{g}, the broadest damping region, and the lowest (tan δ)ₘₐₓ and TA values, whereas the most reactive CLS affords polymers with the lowest T_{g}, the narrowest damping region, and the highest (tan δ)ₘₐₓ and TA values. The above results may be rationalized by the difference in the segmental structures of the various soybean oil polymers with the same crosslink density. For example, compared with SOY and LSS, the most reactive CLS contributes more to crosslinking, like the DVB does, in the cationic copolymerization. When the same amount of soybean oil (45 wt %) is used in the original composition, less of the crosslinking agent DVB is actually needed for the more reactive CLS systems to achieve the same degree of crosslinking as the SOY and LSS systems. When the CLS polymer has the same crosslink density as the SOY and LSS polymers, more CLS side chains actually bridge the crosslinked polymer network, and less DVB is required for crosslinking. The high damping properties of the CLS polymers are presumably due to the greater concentration of flexible CLS segments in the crosslinked polymer networks, which contain a lot of ester groups, which contribute to damping.

Frequency Dependence of the Damping Behavior

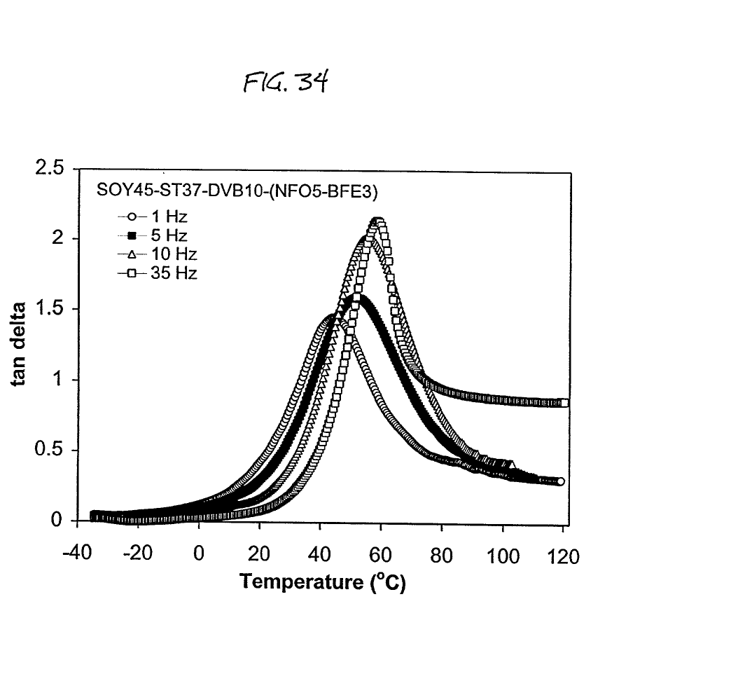

The sound and vibration absorption of a polymer is often observed to increase with an increase in frequency. FIG. 34 shows the loss tangent-temperature curves of the polymer SOY45-ST37-DVB10-(NFO5-BFE3) measured at the frequencies of 1 Hz, 5 Hz, 10 Hz and 35 Hz, respectively. As expected, an increase in frequency displaces the tan δ response to higher temperatures and also induces a change in the shape of the curve. Although the damping peaks measured at higher frequencies appear to be narrower, their tan δ intensities obviously increase, and an intense loss tangent tail appears at higher temperatures. Table 43 indicates that an increase in frequency increases the (tan δ)ₘₐₓ from 1.46 to 2.14, and significantly broadens the temperature region for efficient damping (ΔT>110° C.). It follows that the SOY polymer material exhibits good damping ability over a wide temperature and frequency range.

TABLE 43
Damping properties of the polymer
SOY45-ST37-DVB10-(NFO5-BFE3)
at different frequencies.

| | | T_{g} | | | ΔT at | | Half width^{b} |
|---|---|---|---|---|---|---|---|
| Entry | frequency | (° C.) | (tan δ)ₘₐₓ | (tan δ)ᵣₜ | tan δ > 0.03 | TA | (° C.) |
| 1 | 1 Hz | 44 | 1.46 | 0.60 | 15-125(110) | 53.5 | 36 |
| 2 | 5 Hz | 52 | 1.61 | 0.41 | (>110) | 61.8 | 35 |
| 3 | 10 Hz | 55 | 2.03 | 0.24 | (>110) | 65.5 | 35 |
| 4 | 35 Hz | 58 | 2.14 | 0.12 | (>110) | 48.3^{a} | 25 |

^{a}The value is obtained after removing the background. The actual integral under the curve is much larger than 48.3.
^{b}Width of the damping peak at the half maxima point.

The effect of frequency on the damping process of the SOY polymer can be further described by the Arrhenius rate equation:

$$f = {f}_{0} exp ( - \frac{Δ E}{{RT}_{g}} ) \qquad \text{(EX6-1)}$$

where f is the frequency, f₀ is a constant frequency for each polymer, R is the gas constant, ΔE is the activation energy of the glass transition process, and T_{g} is the glass transition temperature. The equation (EX6-1) can be re-written as

$$log f = log {f}_{0} - \frac{Δ E}{2.303 R} \cdot \frac{1}{{T}_{g}} \qquad \text{(EX6-2)}$$

From the slope of the linear regression in the plot of log f versus 1/T_{g}, the ΔE for the polymer SOY45-ST37-DVB10-(NFO5-BFE3) is calculated to be 228 kJ/mol (˜53 kcal/mol), which is the same order of magnitude as those of other petroleum-based polymers (20-100 kcal/mol). Apparently, even though the new SOY polymer is composed of very different polymer segments, e.g., flexible triglyceride oil segments and rigid aromatic segments, its glass transition process occurs as easily as those of other polymers.

Soybean oil polymers with appropriate compositions exhibit good damping behavior over a broad temperature and frequency range. By tailoring the polymer composition so that the glass transition is in the required temperature and frequency range, the resulting polymers become effective damping materials. These promising damping materials show a loss factor maximum (tan δ)ₘₐₓ of 0.8-4.3, a TA value of 50-124 K after correcting the background, and a temperature range for high damping (tan δ>0.3) of ΔT=80-110° C.

Typically, the high damping intensities are ascribed to the contribution from a large number of ester groups directly attached to the soybean oil-ST-DVB copolymer chains. The broad damping regions are due to the segmental inhomogeneities upon crosslinking. However, crosslinking also reduces the damping intensities by restricting the polymer segmental motions of the homogeneous polymeric materials. Thus, it is expected that, when chemically or physically combining two or more structurally dissimilar soybean oil-based polymer components to form IPNs with phase separated morphologies, more efficient damping materials would be obtained. In this case, broad damping regions are facilitated by the phase microheterogeneities resulting from the formation of IPNs, rather than by the segmental inhomogeneities resulting from a relatively high degree of crosslinking at the expense of reduced damping intensity.

The above description and examples are only illustrative of preferred embodiments which achieve the objects, features and advantages of the present invention. It is not intended that the present invention be limited to the illustrated embodiments. Any modification of the present invention which comes within the spirit and scope of the following claims should be considered part of the present invention.

What is claimed as new and desired to be protected by Letters Patent of the United States is:

1. A thermoset plastic, comprising a polymerized conjugated biological oil, wherein said plastic is characterized by a 5% weight loss at about 200° C. to about 270° C. and a 10% weight loss at about 250° C. to about 330° C. by thermogravimetric analysis.

2. The thermoset plastic of claim 1, wherein said plastic has a glass transition temperature of from about 30° C. to about 130° C.

3. The thermoset plastic of claim 1, wherein said plastic has a storage modulus at room temperature of between about 1×10⁸ and about 1×10⁹ Pa.

4. The thermoset plastic of claim 2, wherein said plastic has a deformability of between about 8% to about 100% at about 50° C. above the glass transition temperature.

5. The thermoset plastic of claim 1, wherein said plastic has a fixed deformation of between about 11% to about 100% at room temperature.

6. The thermoset plastic of claim 2, wherein said plastic has a shape recovery of between about 80% to about 100% upon heating to about 50° C. above the glass transition temperature

7. The thermoset plastic of claim 1, wherein said plastic exhibits damping characteristics including a loss tangent between about 0.09 to about 4.30 when subjected to vibrational energy of about 1 Hz frequency.

8. The thermoset plastic of claim 7, wherein said plastic has a lost tangent of at least about 0.30 for 1 Hz frequency.

9. The thermoset plastic of claim 8, wherein said plastic exhibits efficient damping from about −8° C. to about 127° C.

10. The thermoset plastic of claim 9, wherein said plastic exhibits efficient damping over a temperature range of about 80° C. to 110° C.

11. The thermoset plastic of claim 1, further comprising a polymerized comonomer selected from the group consisting of divinylbenzene, norbornadiene, dicyclopentadiene, styrene, alpha-methylstyrene, furfural, ρ-benzoquinone, ρ-mentha-1,8-diene, and furan.

12. The thermoset plastic of claim 11, wherein said polymerized comonomer is present in an amount of up to about 47% by weight.

13. The thermoset plastic of claim 12, wherein said polymerized comonomer comprises a mixture of styrene and divinylbenzene.

14. The thermoset plastic of claim 13, wherein said polymerized comonomer further comprises norbornadiene and dicyclopentadiene.

15. The thermoset plastic of claim 1, wherein at least a portion of said plastic is insoluble in CH₂Cl₂, DMF and THF, and said insoluble portion is characterized by a 5% weight loss at about 350° C. to about 375° C. and a 10% weight loss at about 420° C. by thermogravimetric analysis.

16. The thermoset plastic of claim 1, wherein said polymerized conjugated biological oil comprises an oil selected from the group consisting of soybean, low saturated soybean, fish, tung, corn, safflower, canola, peanut, sesame, palm, coconut, walnut, olive, castor, and combinations thereof.

17. The thermoset plastic of claim 1, wherein said polymerized conjugated biological oil comprises a mixture of fish oil and soybean oil.

18. The thermoset plastic of claim 1, wherein said polymerized conjugated biological oil is soybean oil.

19. The thermoset plastic of claim 1, wherein said polymerized conjugated biological oil comprises a mixture of soybean oil and low saturation soybean oil.

20. The thermoset plastic of claim 19, wherein said polymerized conjugated biological oil further comprises conjugated low saturation soybean oil.

21. A thermoset plastic, comprising a polymerized metathesized biological oil, wherein said plastic is characterized by a 5% weight loss at about 200° C. to about 270° C. and a 10% weight loss at about 250° C. to about 330° C. by thermogravimetric analysis.

22. The thermoset plastic of claim 21, wherein said plastic has a glass transition temperature of from about 30° C. to about 130° C.

23. The thermoset plastic of claim 21, wherein said plastic has a storage modulus at room temperature of between about 1×10⁸ and about 1×10⁹ Pa.

24. The thermoset plastic of claim 22, wherein said plastic has a deformability of between about 8% to about 100% at about 50° C. above the glass transition temperature.

25. The thermoset plastic of claim 21, wherein said plastic has a fixed deformation of between about 11% to about 100% at room temperature.

26. The thermoset plastic of claim 22, wherein said plastic has a shape recovery of between about 80% to about 100% upon heating to about 50° C. above the glass transition temperature

27. The thermoset plastic of claim 21, wherein said plastic exhibits damping characteristics including a loss tangent between about 0.09 to about 4.30 when subjected to vibrational energy of about 1 Hz frequency.

28. The thermoset plastic of claim 27, wherein said plastic has a lost tangent of at least about 0.30 for 1 Hz frequency.

29. The thermoset plastic of claim 28, wherein said plastic exhibits efficient damping from about −8° C. to about 127° C.

30. The thermoset plastic of claim 29, wherein said plastic exhibits efficient damping over a temperature range of about 80° C. to 110° C.

31. The thermoset plastic of claim 21, further comprising a polymerized comonomer selected from the group consisting of divinylbenzene, norbornadiene, dicyclopentadiene, styrene, alpha-methylstyrene, furfural, ρ-benzoquinone, ρ-mentha-1,8-diene, and furan.

32. The thermoset plastic of claim 31, wherein said polymerized comonomer is present in an amount of up to about 47% by weight.

33. The thermoset plastic of claim 32, wherein said polymerized comonomer comprises a mixture of styrene and divinylbenzene.

34. The thermoset plastic of claim 33, wherein said polymerized comonomer further comprises norbornadiene and dicyclopentadiene.

35. The thermoset plastic of claim 21, wherein at least a portion of said plastic is insoluble in CH₂Cl₂, DMF and THF, and said insoluble portion is characterized by a 5% weight loss at about 350° C. to about 375° C. and a 10% weight loss at about 420° C. by thermogravimetric analysis.

36. The thermoset plastic of claim 21, wherein said polymerized metathesized biological oil comprises an oil selected from the group consisting of soybean, low saturated soybean, fish, tung, corn, safflower, canola, peanut, sesame, palm, coconut, walnut, olive, castor, and combinations thereof.

37. The thermoset plastic of claim 21, wherein said polymerized metathesized biological oil comprises a mixture of fish oil and soybean oil.

38. The thermoset plastic of claim 21, wherein said polymerized metathesized biological oil is soybean oil.

39. The thermoset plastic of claim 21, wherein said polymerized metathesized biological oil comprises a mixture of soybean oil and low saturation soybean oil.

40. The thermoset plastic of claim 29, wherein said polymerized metathesized biological oil further comprises conjugated low saturation soybean oil.

41. A thermoset plastic, comprising a copolymerized biological oil, wherein said plastic is characterized by a 5% weight loss at about 200° C. to about 270° C. and a 10% weight loss at about 250° C. to about 330° C. by thermogravimetric analysis, and said biological oil is copolymerized with a comonomer selected from the group consisting of divinylbenzene, norbornadiene, dicyclopentadiene, styrene, alpha-methylstyrene, furfural, ρ-benzoquinone, ρ-mentha-1,8-diene, and furan.

42. The thermoset plastic of claim 41, wherein said plastic has a glass transition temperature of from about 30° C. to about 130° C.

43. The thermoset plastic of claim 41, wherein said plastic has a storage modulus at room temperature of between about 1×10⁸ and about 1×10⁹ Pa.

44. The thermoset plastic of claim 42, wherein said plastic has a deformability of between about 8% to about 100% at about 50° C. above the glass transition temperature.

45. The thermoset plastic of claim 41, wherein said plastic has a fixed deformation of between about 11% to about 100% at room temperature.

46. The thermoset plastic of claim 42, wherein said plastic has a shape recovery of between about 80% to about 100% upon heating to about 50° C. above the glass transition temperature

47. The thermoset plastic of claim 41, wherein said plastic exhibits damping characteristics including a loss tangent between about 0.09 to about 4.30 when subjected to vibrational energy of about 1 Hz frequency.

48. The thermoset plastic of claim 47, wherein said plastic has a lost tangent of at least about 0.30 for 1 Hz frequency.

49. The thermoset plastic of claim 48, wherein said plastic exhibits efficient damping from about −8° C. to about 127° C.

50. The thermoset plastic of claim 49, wherein said plastic exhibits efficient damping over a temperature range of about 80° C. to 110° C.

51. The thermoset plastic of claim 41, wherein said comonomer is present in an amount of up to about 47% by weight.

52. The thermoset plastic of claim 51, wherein said comonomer comprises a mixture of styrene and divinylbenzene.

53. The thermoset plastic of claim 52, wherein said comonomer further comprises norbornadiene and dicyclopentadiene.

54. The thermoset plastic of claim 41, wherein at least a portion of said plastic is insoluble in CH₂Cl₂, DMF and THF, and said insoluble portion is characterized by a 5% weight loss at about 350° C. to about 375° C. and a 10% weight loss at about 420° C. by thermogravimetric analysis.

55. The thermoset plastic of claim 41, wherein said copolymerized biological oil comprises an oil selected from the group consisting of soybean, low saturated soybean, fish, tung, corn, safflower, canola, peanut, sesame, palm, coconut, walnut, olive, castor, and combinations thereof.

56. The thermoset plastic of claim 41, wherein said copolymerized biological oil comprises a mixture of fish oil and soybean oil.

57. The thermoset plastic of claim 41, wherein said copolymerized biological oil is soybean oil.

58. The thermoset plastic of claim 41, wherein said copolymerized biological oil comprises a mixture of soybean oil and low saturation soybean oil.

59. The thermoset plastic of claim 58, wherein said copolymerized biological oil further comprises conjugated low saturation soybean oil.

60. A composite material comprising:
a thermoset plastic, wherein said plastic contains a comonomer and a polymerized conjugated biological oil selected from the group consisting of fish oil, soybean oil, and tung oil, and is characterized by a 5% weight loss at about 200° C. to about 270° C. and a 10% weight loss at about 250° C. to about 330° C.; and
at least one second material selected from the group consisting of sheets, flakes, fibers, rods and particles, wherein said second material is insoluble in said plastic and provides a filler or reinforcement for said plastic.

61. The composite material of claim 60, wherein said composite is in the form of a laminate.

62. The composite material of claim 60, wherein said comonomer is selected from the group consisting of styrene, divinylbenzene, norbornadiene, dicyclopentadiene, styrene, α-methylstyrene, furfural, ρ-benzoquinone, ρ-mentha-1,8-diene, and furan.

63. The composite material of claim 60, wherein said plastic has a storage modulus at room temperature of from about 1×10⁸ to about 1×10⁹ Pa.

64. The composite material of claim 60, wherein said plastic has a glass transition temperature of from about 30° C. to about 130° C.

65. The composite material of claim 60, further comprising a coupling agent.

66. The composite material of claim 60, wherein said plastic exhibits shape memory effect.

67. The composite material of claim 60, wherein said plastic exhibits efficient damping characteristics including a loss tangent at or above 0.30.

68. An industrial plastic product comprising a metathesized biological oil polymer that has at least one comonomer selected from the group consisting of divinylbenzene, norbornadiene, dicyclopentadiene, styrene, alpha-methylstyrene, furfural, ρ-benzoquinone, ρ-mentha-1,8-diene, and furan to form a biological oil-comonomer mixture;
wherein said metathesized biolological oil polymer has a glass transition temperature above about 30° C., a deformability between about 8% and about 100%, a fixed deformation at room temperature of between about 11% and about 100%, and a shape recovery of about 100% upon reheating to T_{g}+50° C.

69. The industrial plastic of claim 68, wherein said biological oil is selected from the group consisting of fish oil, tung oil, soybean oil, low saturated soybean oil, conjugated low saturation soybean oil, corn oil, safflower oil, canola oil, peanut oil, sesame oil, palm oil, coconut oil, walnut oil, olive oil, castor oil, and combinations thereof.

70. The industrial plastic of claim 68, wherein said additive comprises at least one member selected from the group consisting of fish oil ethyl ester, soybean oil methyl esters and tetrahydrofuran.

71. The industrial plastic of claim 70, wherein said biological oil comprises soybean oil, said comonomer comprises a mixture of styrene and divinylbenzene, and said additive comprises a mixture of boron trifluoride diethyl etherate and fish oil ethyl ester.

72. The industrial plastic of claim 71, wherein said biological oil is present in an amount of about 20% to about 60% by weight, said comonomer is present in an amount of about 25% to about 47% by weight, and said additive is present in an amount of about 5% to about 10% by weight.

73. The industrial plastic of claim 68, wherein said comonomer comprises a mixture of divinylbenzene and styrene.

74. The industrial plastic of claim 73 wherein said biological oil comprises low saturated soybean oil.

75. The industrial plastic of claim 68 wherein said comonomer is at least one member selected from the group consisting of styrene, divinylbenzene, norbornadiene and dicyclopentadiene.

76. An industrial plastic product comprising a metathesized biological oil polymer that has at least one comonomer selected from the group consisting of divinylbenzene, norbornadiene, dicyclopentadiene, styrene, alpha-methylstyrene, furfural, ρ-benzoquinone, ρ-mentha-1,8-diene, and furan to form a biological oil-comonomer mixture;
wherein said metathesized biolological oil polymer has a loss tangent greater than 0.3 over a range of temperature change of up to 110° C., and a glass transition temperature between about 14° C. to about 107° C.

77. The industrial plastic of claim 76, wherein said biological oil is selected from the group consisting of fish oil, tung oil, soybean oil, low saturated soybean oil, conjugated low saturation soybean oil, corn oil, safflower oil, canola oil, peanut oil, sesame oil, palm oil, coconut oil, walnut oil, olive oil, castor oil, and combinations thereof.

78. The industrial plastic of claim 76, wherein said additive comprises at least one member selected from the group consisting of fish oil ethyl ester, soybean oil methyl esters and tetrahydrofuran.

79. The industrial plastic of claim 78, wherein said biological oil comprises soybean oil, said comonomer comprises a mixture of styrene and divinylbenzene, and said additive comprises a mixture of boron trifluoride diethyl etherate and fish oil ethyl ester.

80. The industrial plastic of claim 79, wherein said biological oil is present in an amount of about 20% to about 60% by weight, said comonomer is present in an amount of about 25% to about 47% by weight, and said additive is present in an amount of about 5% to about 10% by weight.

81. The industrial plastic of claim 76, wherein said comonomer comprises a mixture of divinylbenzene and styrene.

82. The industrial plastic of claim 81 wherein said biological oil comprises low saturated soybean oil.

83. The industrial plastic of claim 76 wherein said comonomer is at least one member selected from the group consisting of styrene, divinylbenzene, norbornadiene and dicyclopentadiene.

84. A damping product comprising a polymerized biological oil which is copolymerized with at least one olefin of styrene or divinylbenzene, wherein said polymeraized biological oil is characterized by a 5% weight loss at about 200° C. to about 270° C. and a 10% weight loss at about 250° C. to about 330° C. by thermogravimetric analysis.

85. The damping product of claim 84 wherein said biological oil is at least one member selected from the group consisting of soybean oil, low saturated soybean oil, and conjugated low saturated soybean oil.

86. The damping product of claim 85, comprising co-polymerization of about 20% to about 60% by weight of said biological oil with about 25% to about 47% by weight of said combination of styrene and divinylbenzene.

87. The damping product of claim 86, wherein said biological oil and said olefins are copolymerized in the presence of fish oil or fish oil ethyl ester as said additive.

88. The damping product of claim 87, wherein said additive is present in an amount of about 3% to about 10%.

89. The damping product of claim 88, wherein said Lewis acid catalyst is boron trifluoride diethyl etherate in an amount of about 3% to about 10%.

90. The damping product of claim 84, wherein said polymerized biological oil has a loss tangent greater than 0.3 over a range of temperature change of up to 110° C., and has a glass transition temperature between about 14° C. to about 107° C.

91. A shape memory industrial plastic product comprising a biological polymer copolymerized with a comonomer selected from the group consisting of styrene, divinylbenzene, norbornadiene, dicyclopentadiene, and mixtures thereof, and initiated with an initiator comprising boron trifluoride diethyl etherate and fish oil ethyl ester, wherein said shape memory industrial plastic product is characterized by a 5% weight loss at about 200° C. to about 270° C. and a 10% weight loss at about 250° C. to about 330° C. by thermogravimetric analysis.

92. The shape memory industrial plastic product of claim 91, wherein the biological polymer comprises soybean oil.

93. The shape memory industrial plastic product of claim 92, wherein said soybean oil undergoes a modification process prior to said copolymerizing.

94. The shape memory industrial plastic product of claim 93, wherein said modification comprises a process selected from the group consisting of conjugation, metathesis, and cometathesis.

95. The shape memory industrial plastic product of claim 94, wherein said soybean oil comprises low saturation soybean oil.

96. The shape memory industrial plastic product of claim 94, wherein said soybean oil comprises conjugated low saturation soybean oil.

97. The shape memory industrial plastic product of claim 94, wherein said soybean oil comprises low saturation soybean oil and conjugated low saturation soybean oil.

98. The shape memory industrial plastic product of claim 94, wherein said biological polymer exhibits about 100% shape recovery from deformation upon reheating.

99. The shape memory industrial plastic product of claim 94, wherein said biological polymer exhibits a loss tangent of at least 0.3.

100. The shape memory industrial plastic product of claim 94, wherein said biological polymer is about 20% to about 60% said biological oil, about 25% to about 47% said comonomer, and about 5% to about 10% said initiator.

101. The shape memory industrial plastic product of claim 94, wherein said biological polymer is about 45% soybean oil, about 27-30% styrene, about 17-20% divinylbenzene, about 5% fish oil ethyl ester, and about 3% boron trifluoride diethyl etherate.

102. The shape memory industrial plastic product of claim 94, wherein said biological polymer is about 45% soybean oil, about 47% comonomer, and at least 5% divinylbenzene.

103. The shape memory industrial plastic product of claim 94, wherein said biological polymer has a crosslinking density of at least about 1×10³ mol/m³. of at least about 1×10³ mol/m³.
